(19) United States
(12) Patent Application Publication
(10) Pub. No.: US 2014/0006231 A1
(43) Pub. Date: Jan. 2, 2014

(54) CONSISTENT INTERFACE FOR CUSTOMER INVOICE

(71) Applicants: Andréa Nemes Salgueiro, Heidelberg (DE); Boon Hwa Hauser, Angelbachtal (DE); Yashu Liang, Rauenberg (DE)

(72) Inventors: Andréa Nemes Salgueiro, Heidelberg (DE); Boon Hwa Hauser, Angelbachtal (DE); Yashu Liang, Rauenberg (DE)

(21) Appl. No.: 13/535,512

(22) Filed: Jun. 28, 2012

(51) Int. Cl. G06Q 30/04

(52) U.S. Cl. 705/30

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a customer invoice business object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about customer invoices. The medium comprises program code for receiving, via a message-based interface exposing at least one service as defined in a service registry and from a heterogeneous application executing in an environment of computer systems providing message-based services, a first message for requesting to post-process a customer invoice, including a binding statement of amounts receivable, receivables adjustments, and credit memos to a business partner specifying terms of delivery and payment. The first message includes a message package hierarchically organized as a customer invoice post-processing request message entity and a customer invoice package including a customer invoice entity. The customer invoice entity includes a watermark name, an identifier (ID), a processing type code, a type code, a receivables payables property movement direction code and a date. The customer invoice entity includes a status entity from a status package, a buyer party entity from a party package, a seller party entity from the party package, a pricing terms entity from a price information package, and at least one item entity from an item package. The status entity includes a release status code. The buyer party entity includes a buyer party internal ID. The seller party entity includes a seller party internal ID. The pricing terms entity includes a currency code. Each item entity includes an ID, a type code and a receivables property movement direction code. Each item entity includes at least one business process variant entity from a business process variant package. Each business process variant entity includes a business process variant type code. The medium further comprises program code for sending a second message to the heterogeneous application responsive to the first message.

Implementations can include the following. The customer invoice entity further includes at least one of the following: a bill to party from the party package, a bill from party from the party package, a payer party from the party package, a tax reporting unit party from the party package, a price and tax entity from the price information package, at least one product tax details entity from the price information package, a taxation terms entity from the price information package, a cash discount terms entity from a payment information package, a payment control entity from the payment information package, a delivery terms entity from a delivery information package, an origin customer invoice reference entity from a business transaction document reference package, an attachment folder entity from an attachment package, a text collection entity from a text collection package, and at least one due item entity from a due item package. The customer invoice entity further includes at least one of the following: a universally unique identifier, a processing type name, a type name, a receivables payables property movement direction name, a creation date time, a cancellation document indicator, a customer invoice request name, a reference business transaction document ID, and a simulation origin code simulation origin code.

In another aspect, a distributed system operates in a landscape of computer systems providing message-based services defined in a service registry. The system comprises a graphical user interface comprising computer readable instructions, embedded on tangible media, for requesting to post-process a customer invoice, including a binding statement of amounts receivable, receivables adjustments, and credit memos to a business partner specifying terms of delivery and payment, the instructions using a request. The system further comprises a first memory storing a user interface controller for processing the request and involving a message including a message package hierarchically organized as a customer invoice post-processing request message entity and a customer invoice package including a customer invoice entity. The customer invoice entity includes a watermark name, an identifier (ID), a processing type code, a type code, a receivables payables property movement direction code and a date. The customer invoice entity includes a status entity from a status package, a buyer party entity from a party package, a seller party entity from the party package, a pricing terms entity from a price information package, and at least one item entity from an item package. The status entity includes a release status code. The buyer party entity includes a buyer party internal ID. The seller party entity includes a seller party internal ID. The pricing terms entity includes a currency code. Each item entity includes an ID, a type code and a receivables property movement direction code. Each item entity includes at least one business process variant entity from a business process variant package. Each business process variant entity includes a business process variant type code. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-6 depict an example CustomerInvoice object model.

FIGS. 33-1 through 33-9 depict an example CustomerInvoicePostProcessingRequest message data type.

FIG. 34 depicts an example CustomerInvoicePostProcessingConfirmation message data type.

FIGS. 35-1 through 35-99 depict an example CustomerInvoicePostProcessingRequest element structure.

FIGS. 36-1 through 36-2 depict an example CustomerInvoicePostProcessingConfirmation element structure.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

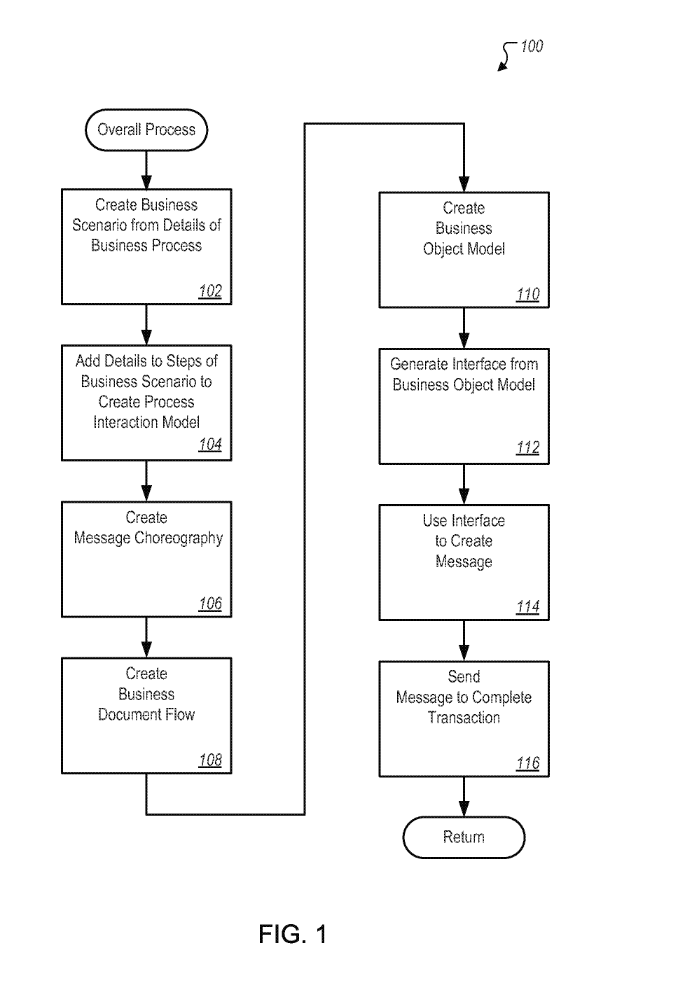

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

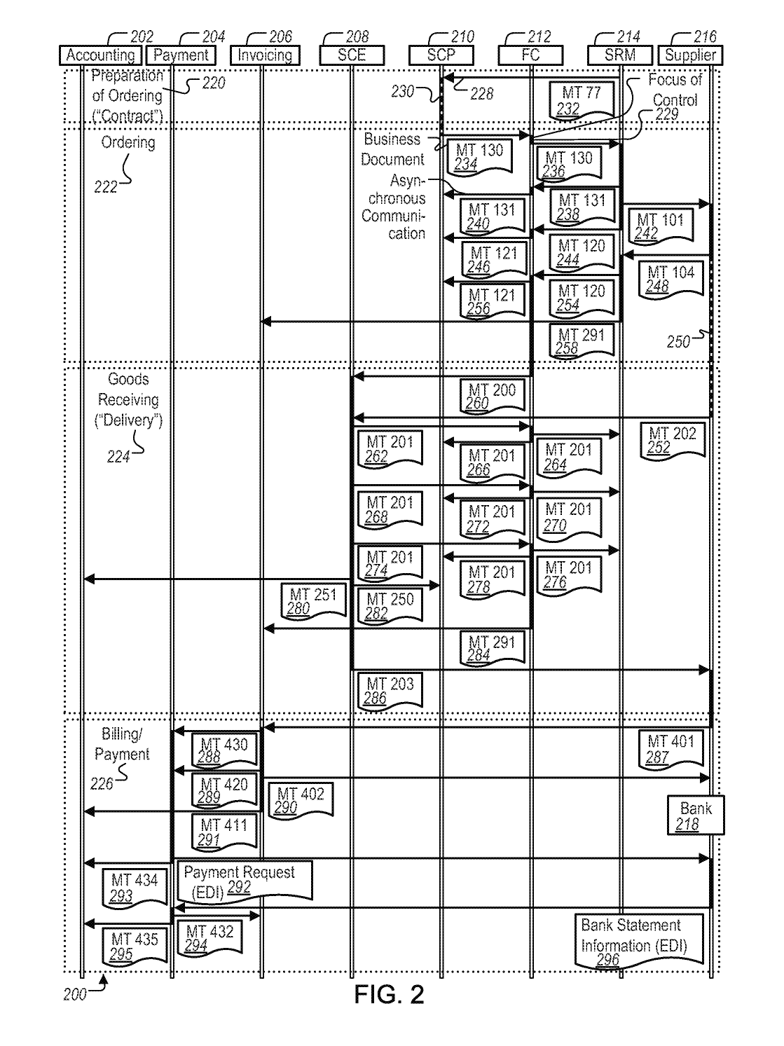

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

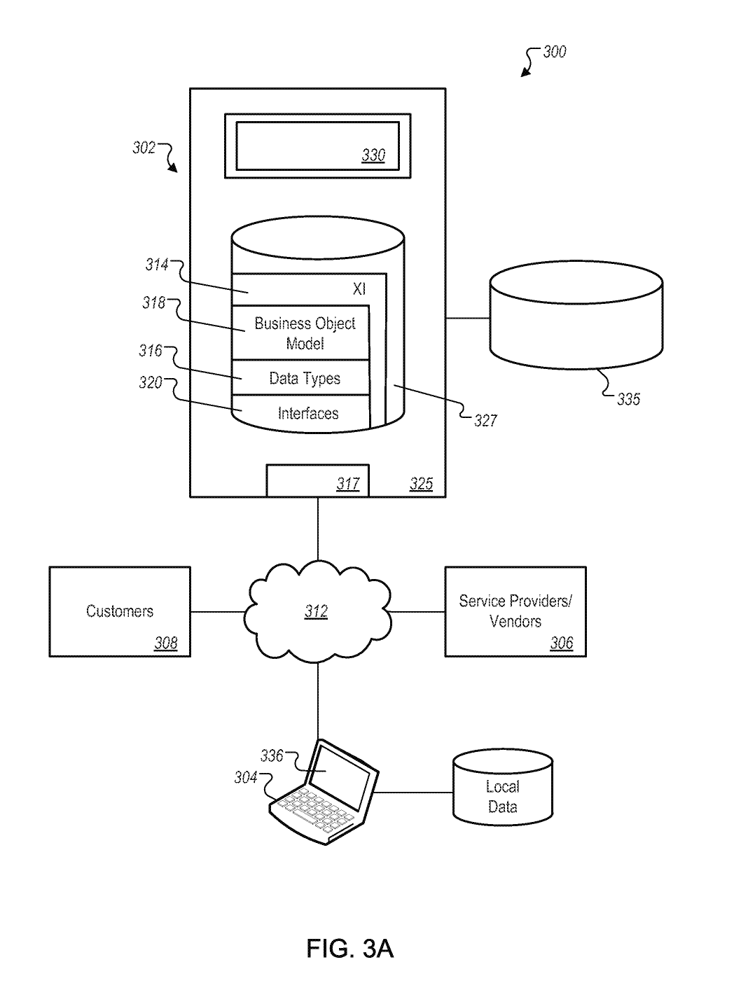

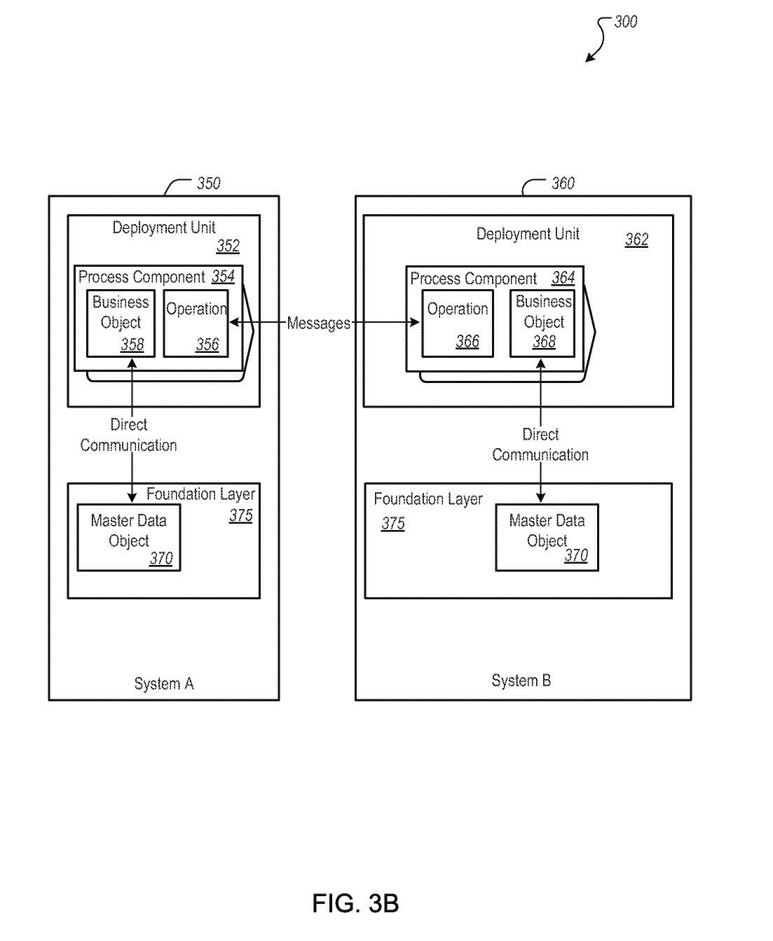

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

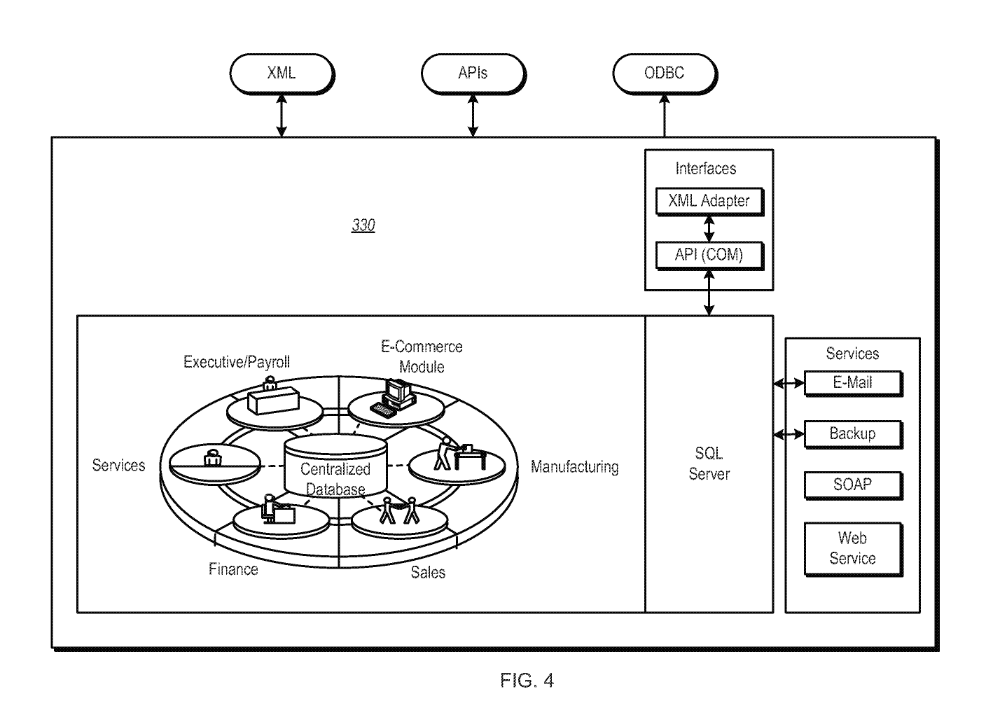

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

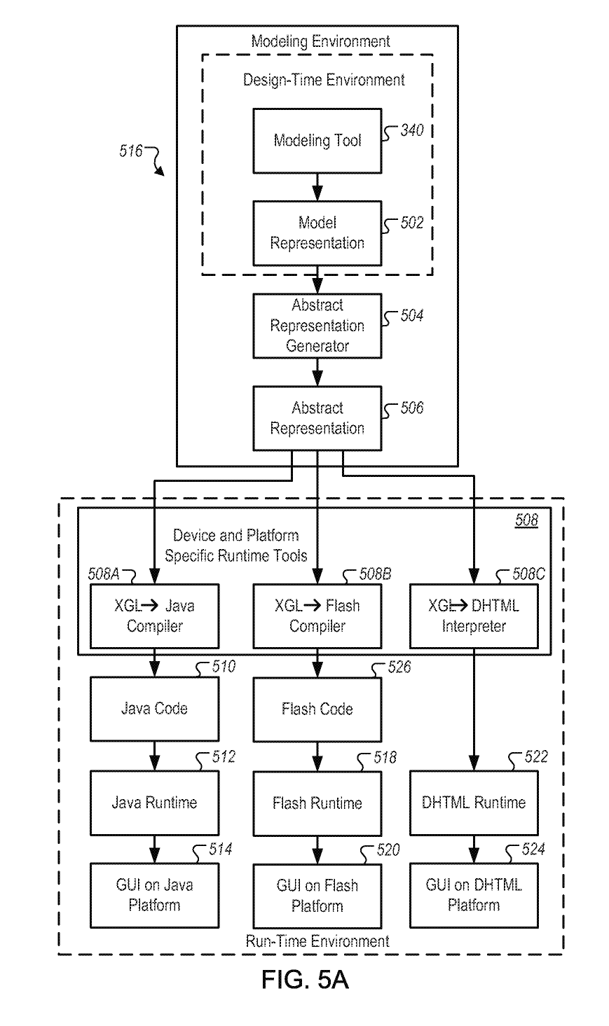

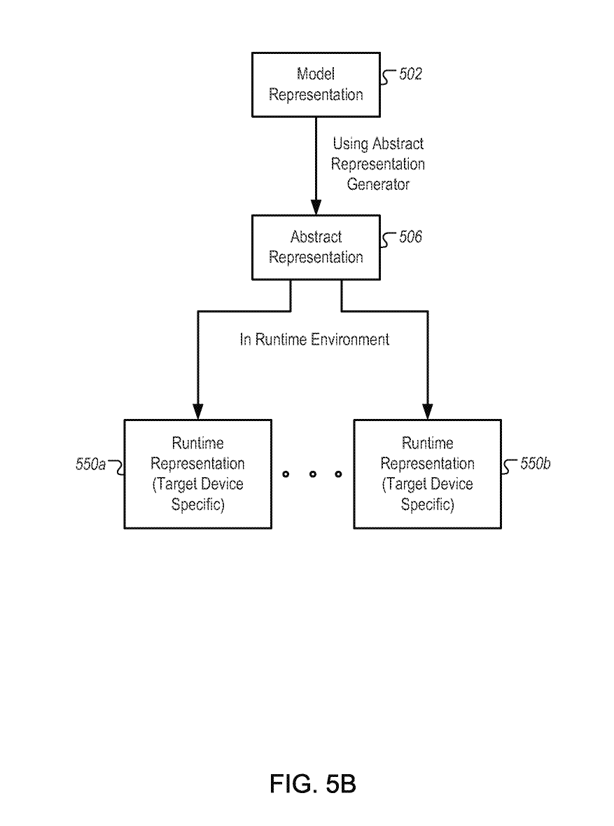

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

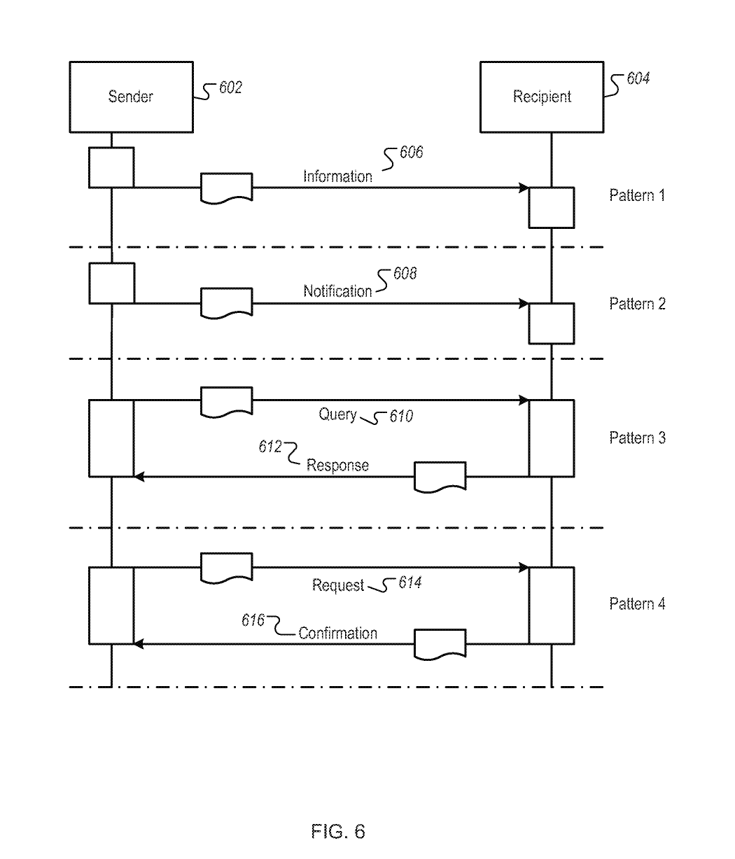

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

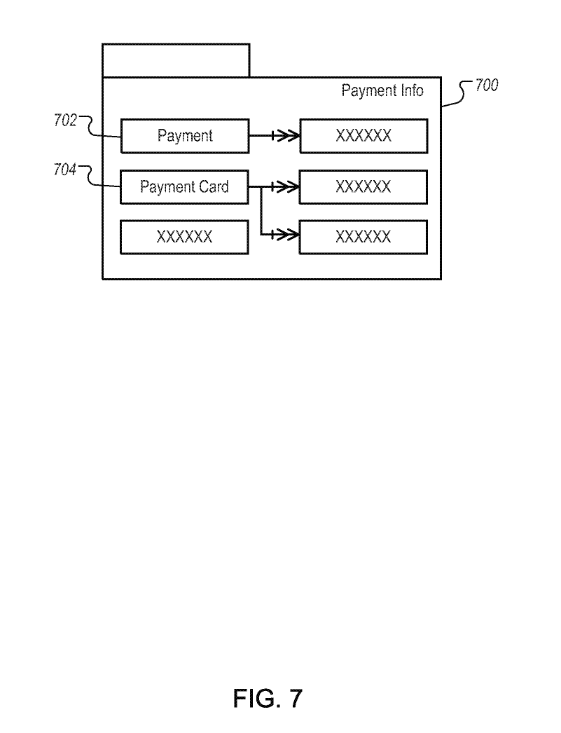

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

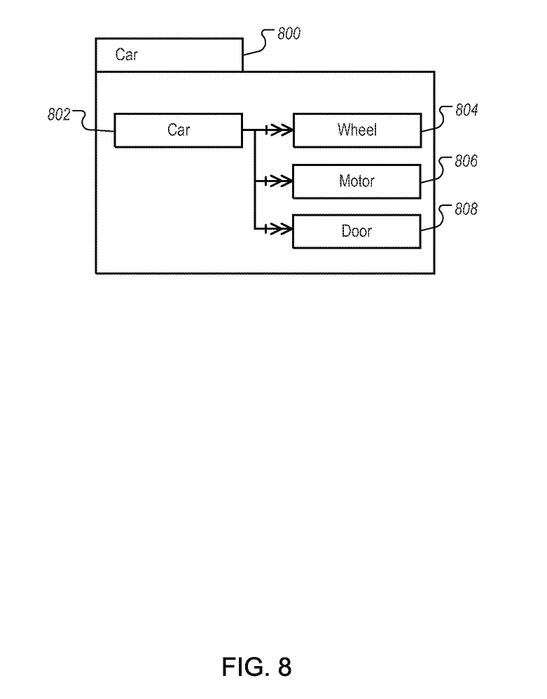

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

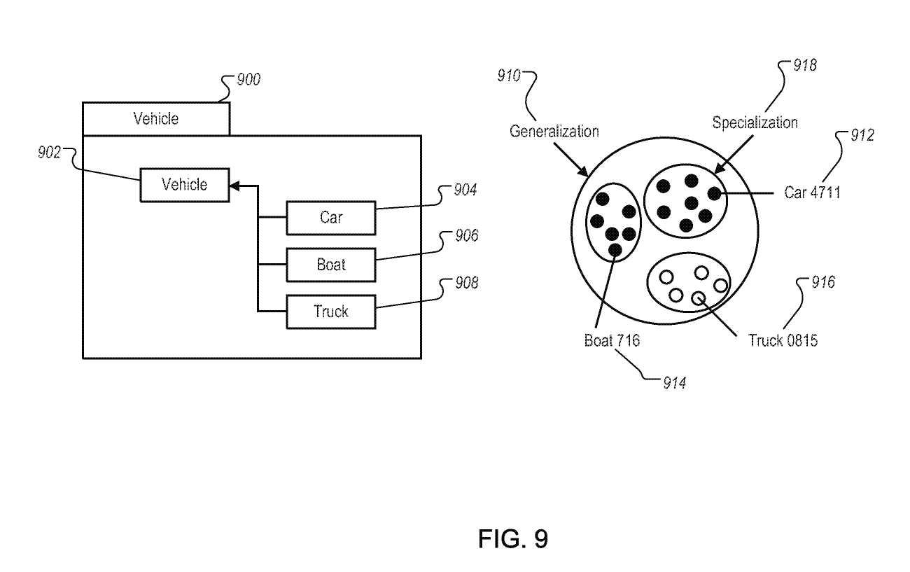

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

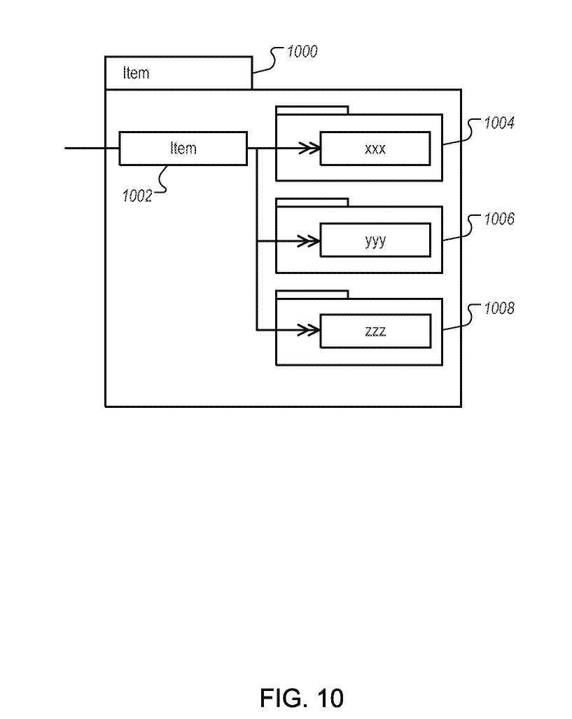

Packages also may be used to represent hierarchy levels. For example, as depicted in FIG. 10, the Item Package 1000 includes Item 1002 with subitem xxx 1004, subitem yyy 1006, and subitem zzz 1008.

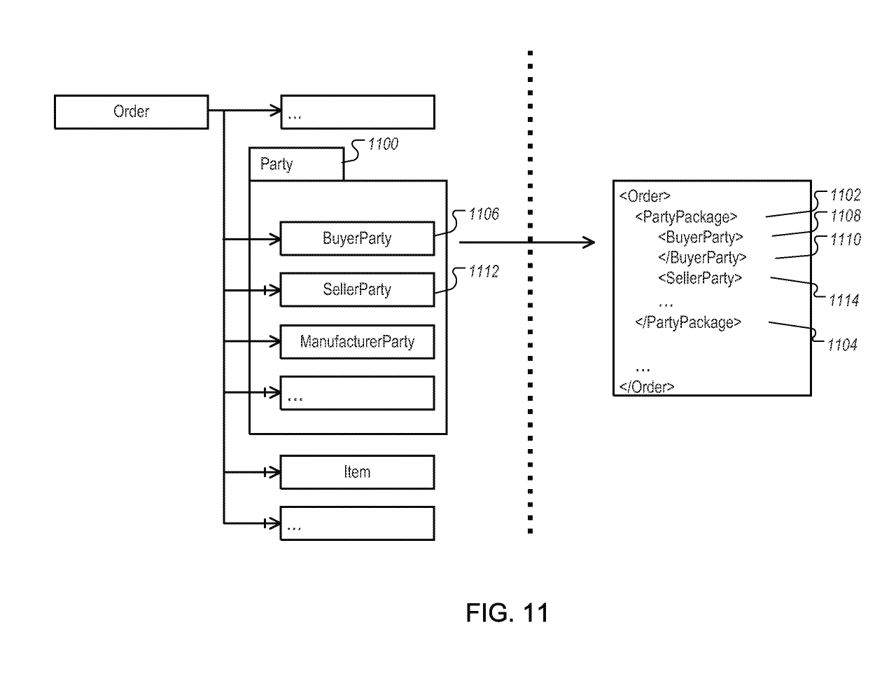

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

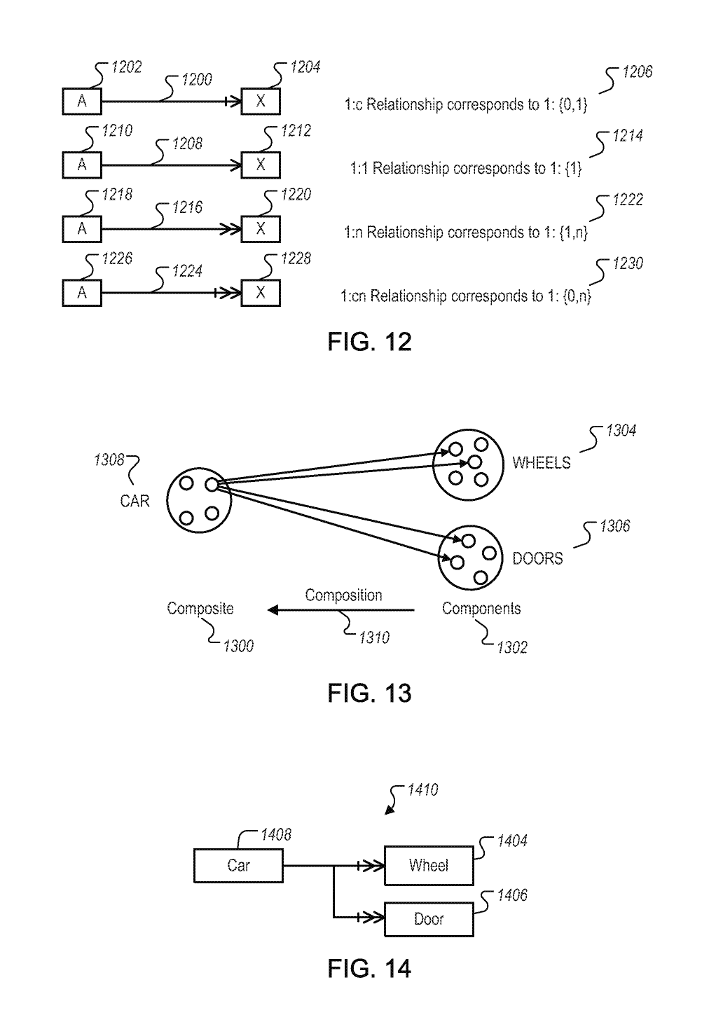

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

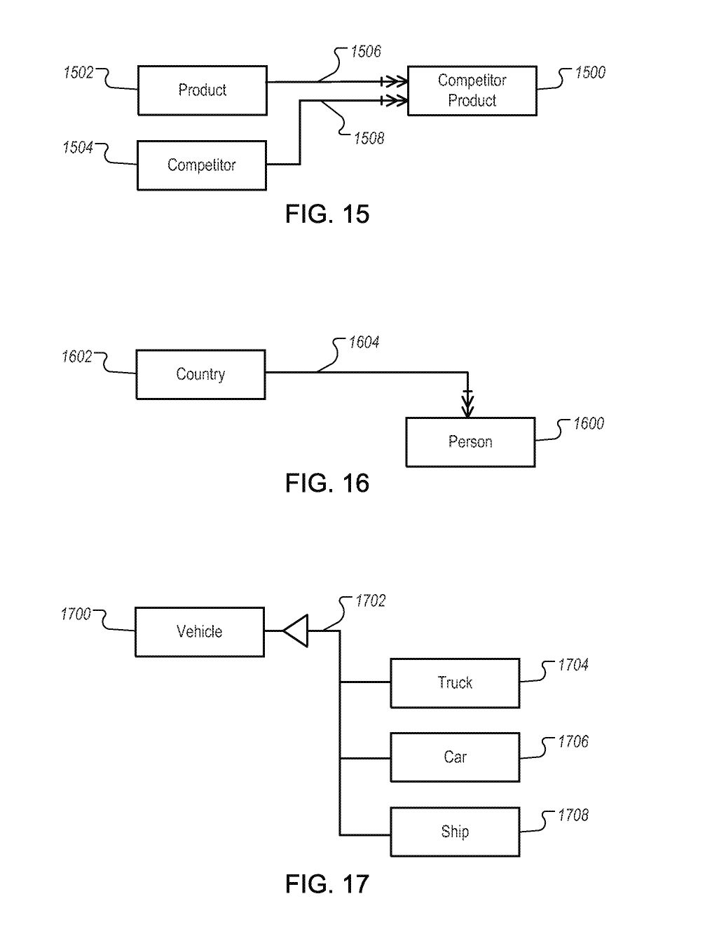

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

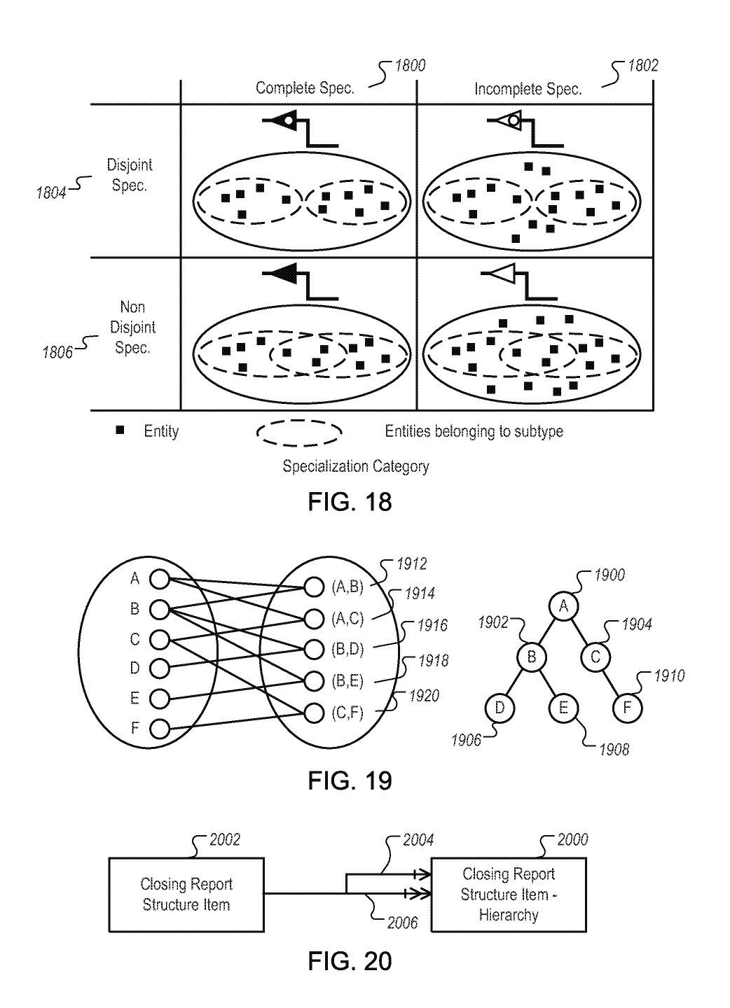

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

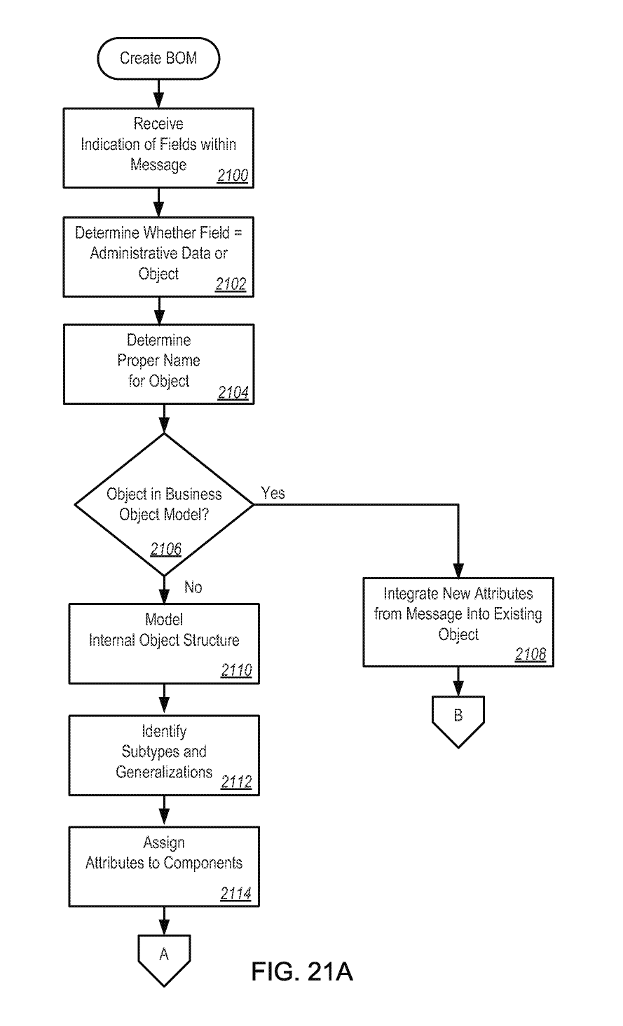

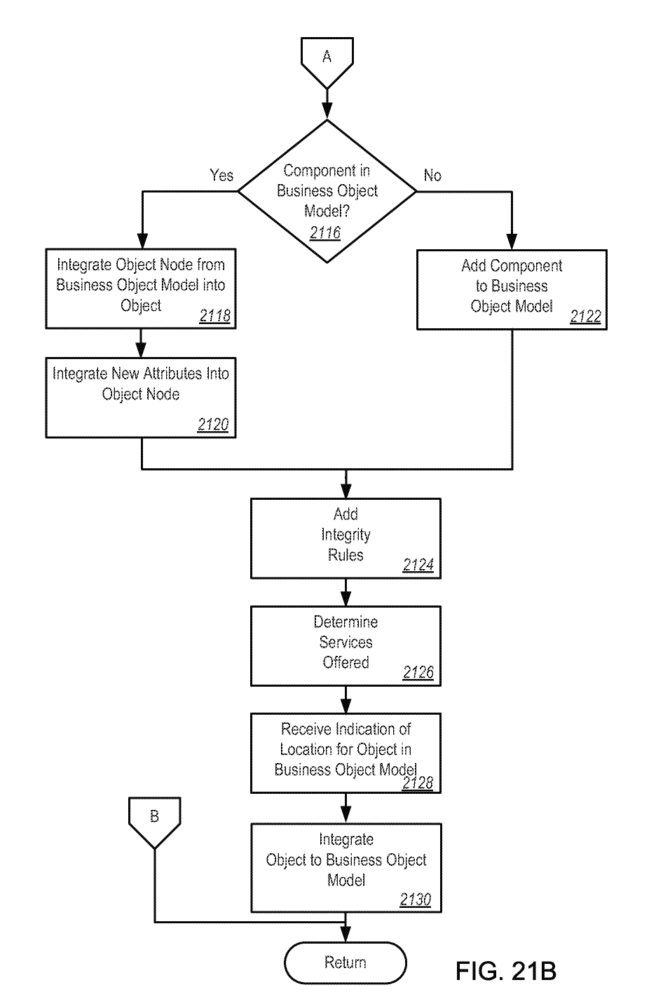

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase- | | |
| AdditionalID | Order | | |
| PostingDate | | | |
| LastChangeDate | | | |
| AcceptanceStatus | | | |
| Note | | | |
| CompleteTransmission- | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCard- | | | |
| ReferenceID | | | |
| SequenceID | | | |
| Holder | | | |
| ExpirationDate | | | |
| AttachmentID | | | |
| AttachmentFilename | | | |
| DescriptionofMessage | | | |
| Confirmation- | | | |
| Descriptionof- | | | |
| Message | | | |
| FollowUpActivity | | | |
| ItemID | | PurchaseOrder- | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation- | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItem- | | | |
| GroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportService- | | | |
| Level | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedSchedule- | | | |
| LineID | | | |
| ConfirmedDelivery- | | | |
| Period | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount- | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation- | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase- | | | | | 1 |
| Order | | | | | |
| | PurchaseOrder- | | | | |
| | Update | | | | |
| | | PurchaseOrder Request | | | |
| | | PurchaseOrder Change | | | |
| | | PurchaseOrder- | | | |
| | | Confirmation | | | |
| | PurchaseOrder- | | | | |
| | Cancellation | | | | |
| | PurchaseOrder- | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount- | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation- | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo- | | 0 . . . 1 |
| | | | Location | | |
| | | | ShipFrom- | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation- | | | 0 . . . 1 |
| | | Description | | | |
| | | ScheduleLine | | | 0 . . . n |
| | | | Delivery- | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

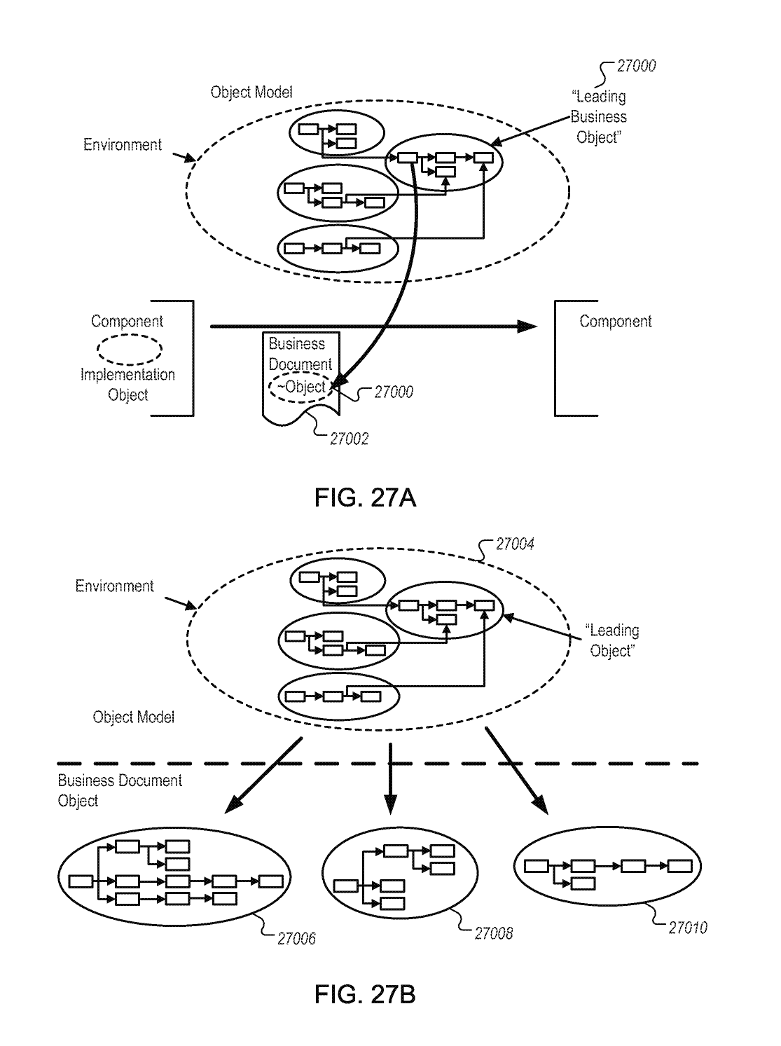

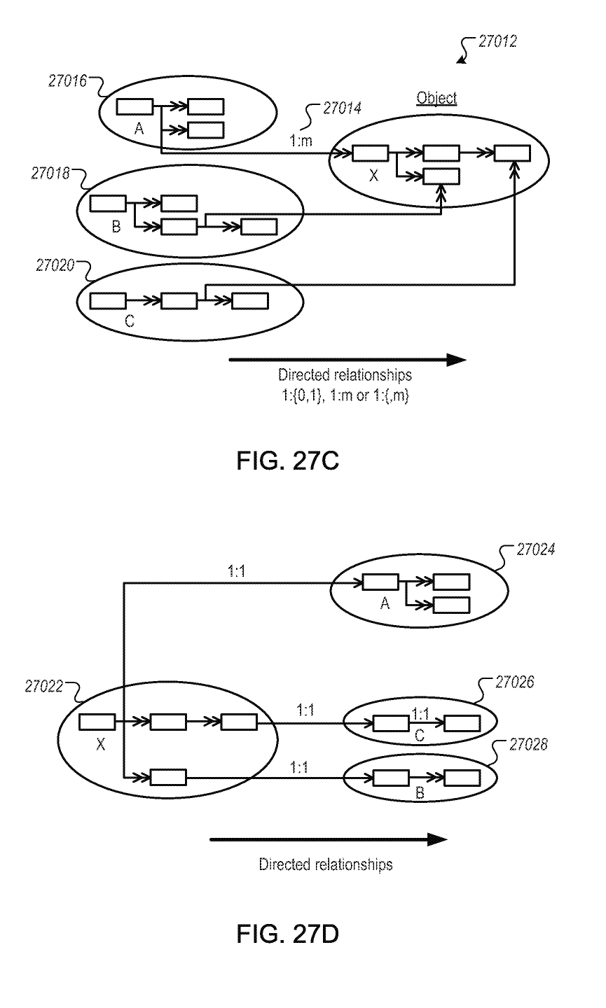

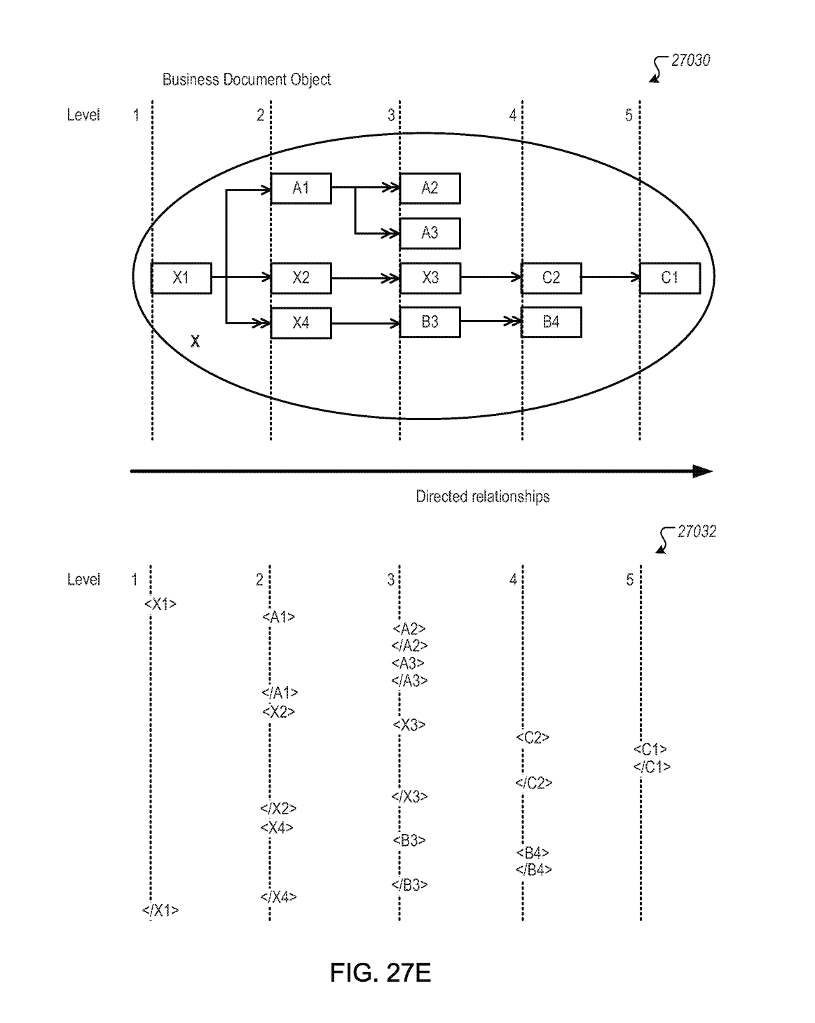

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

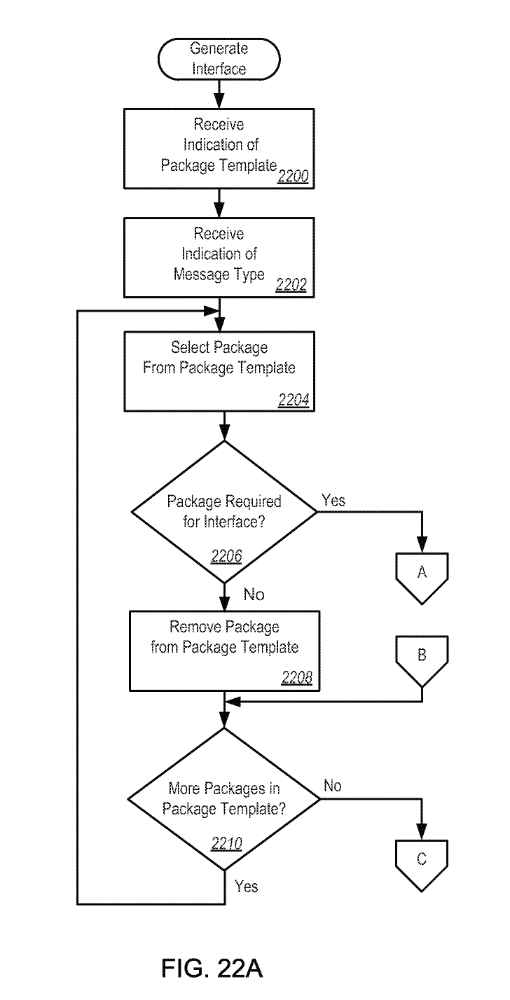

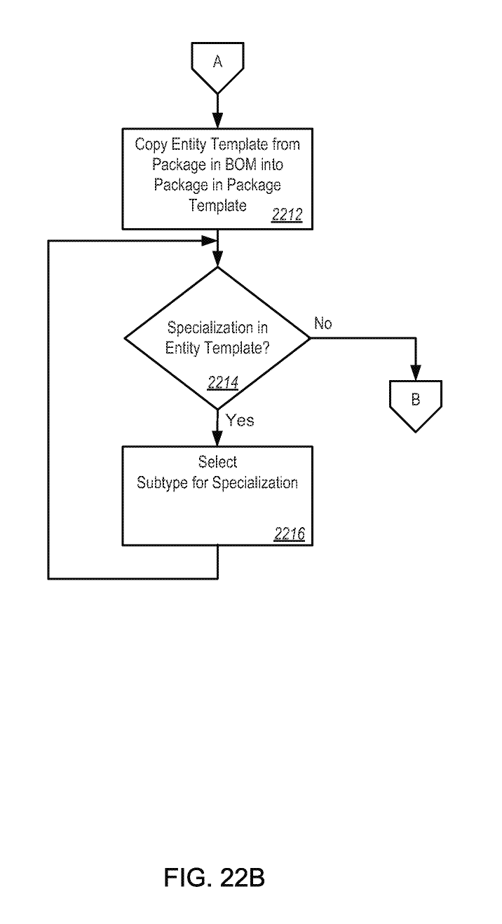

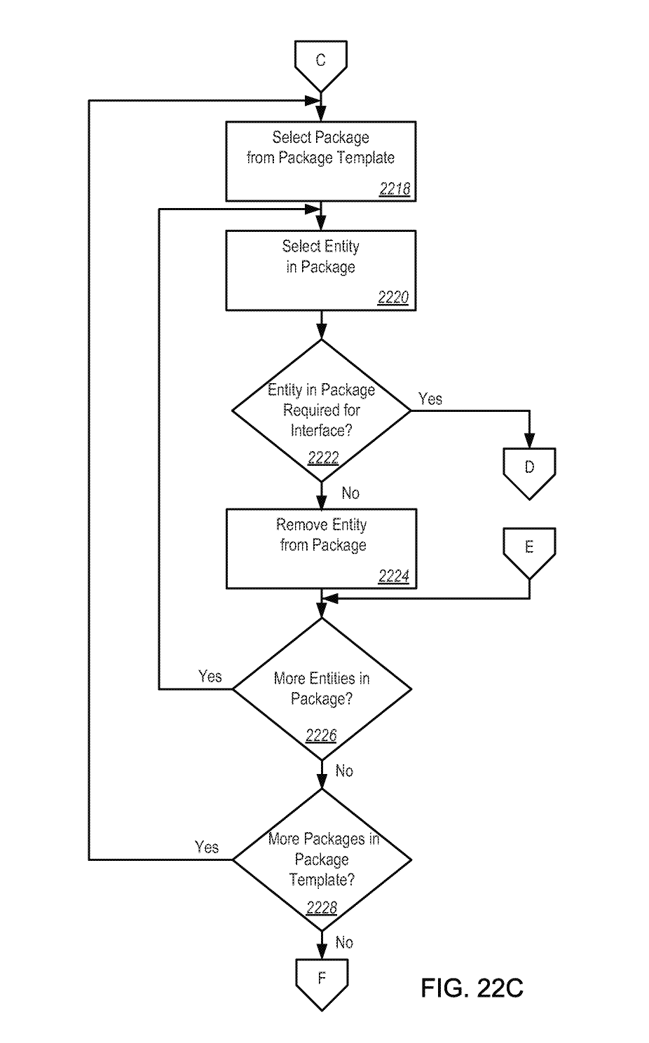

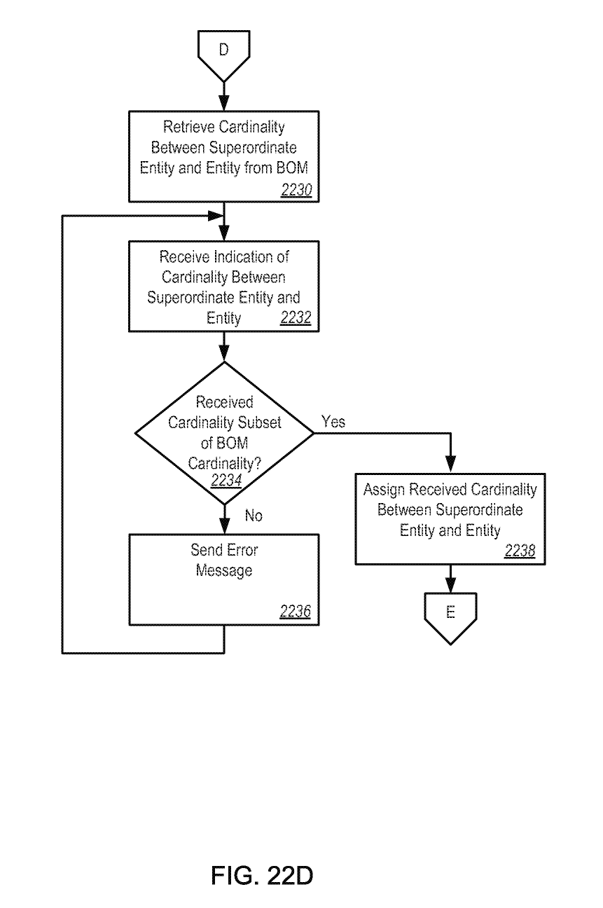

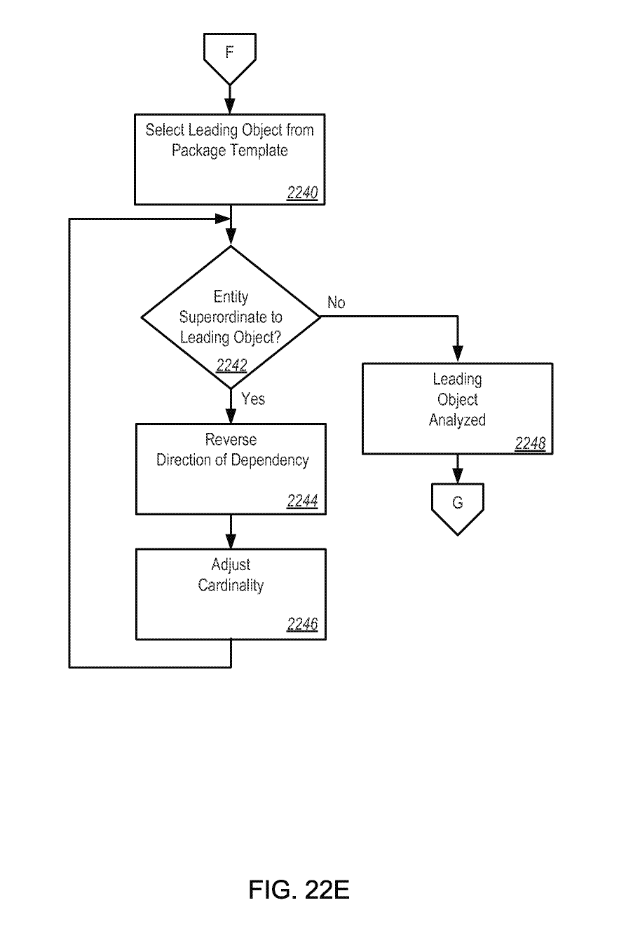

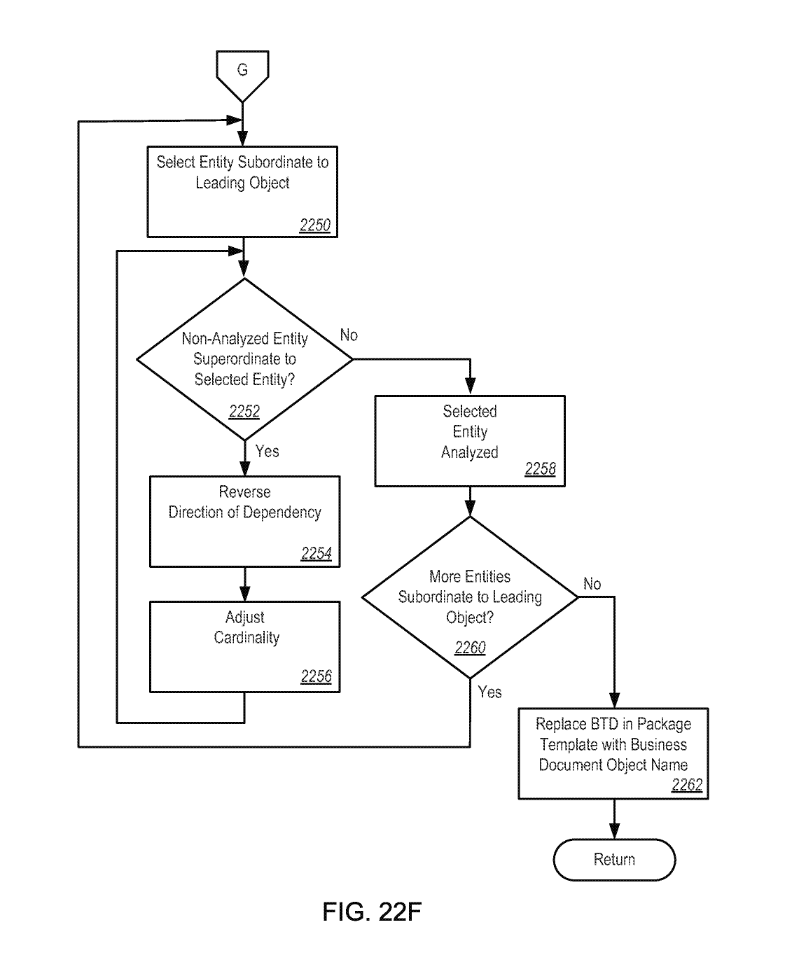

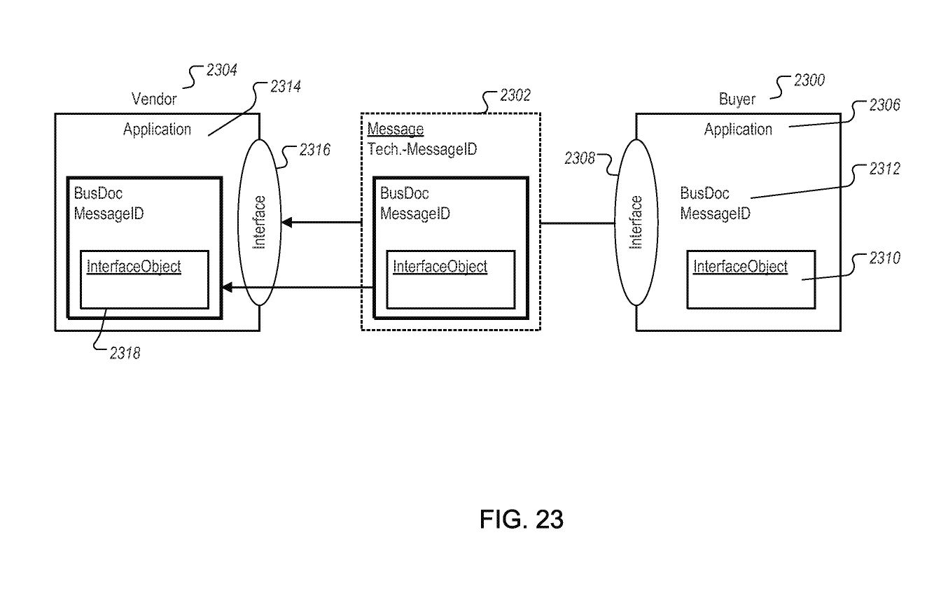

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

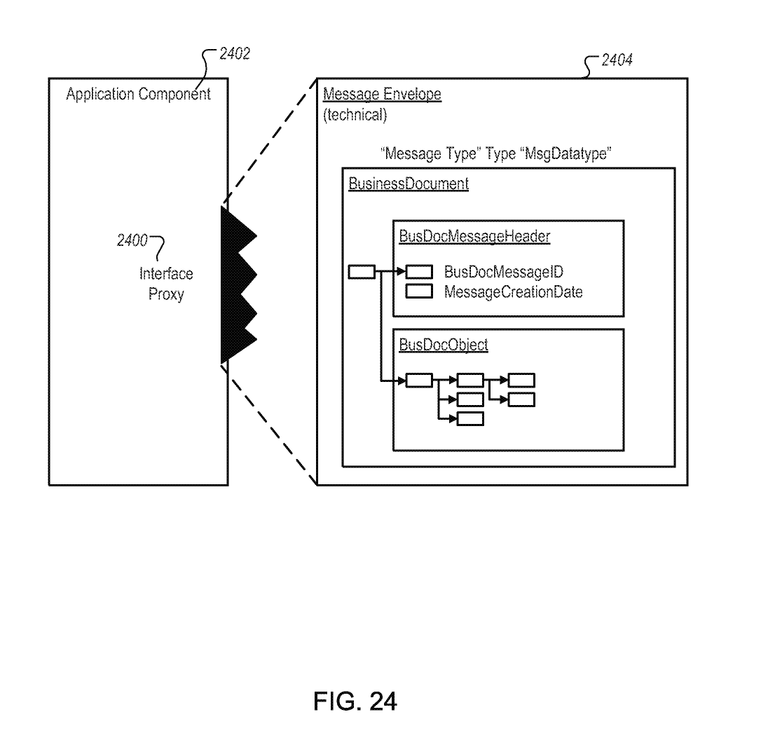

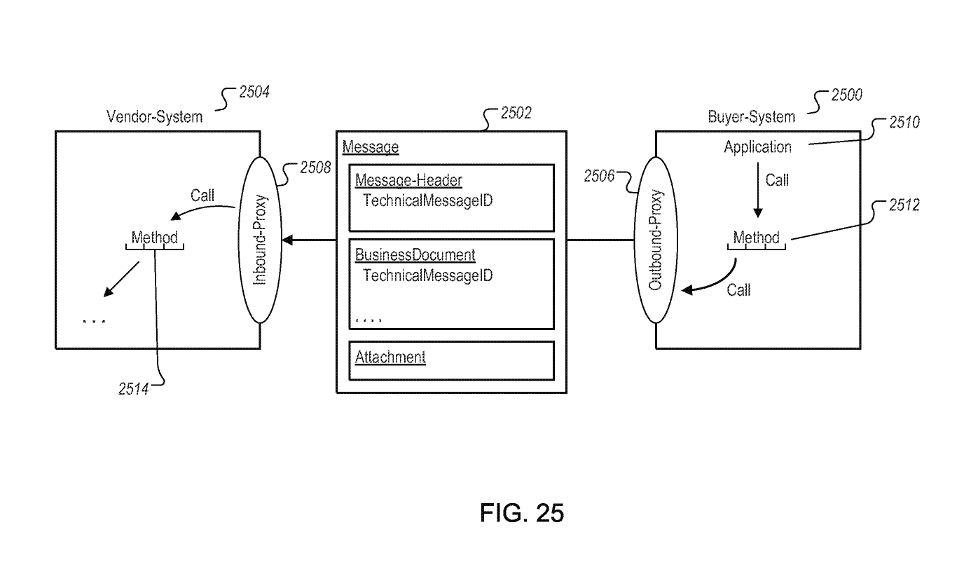

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

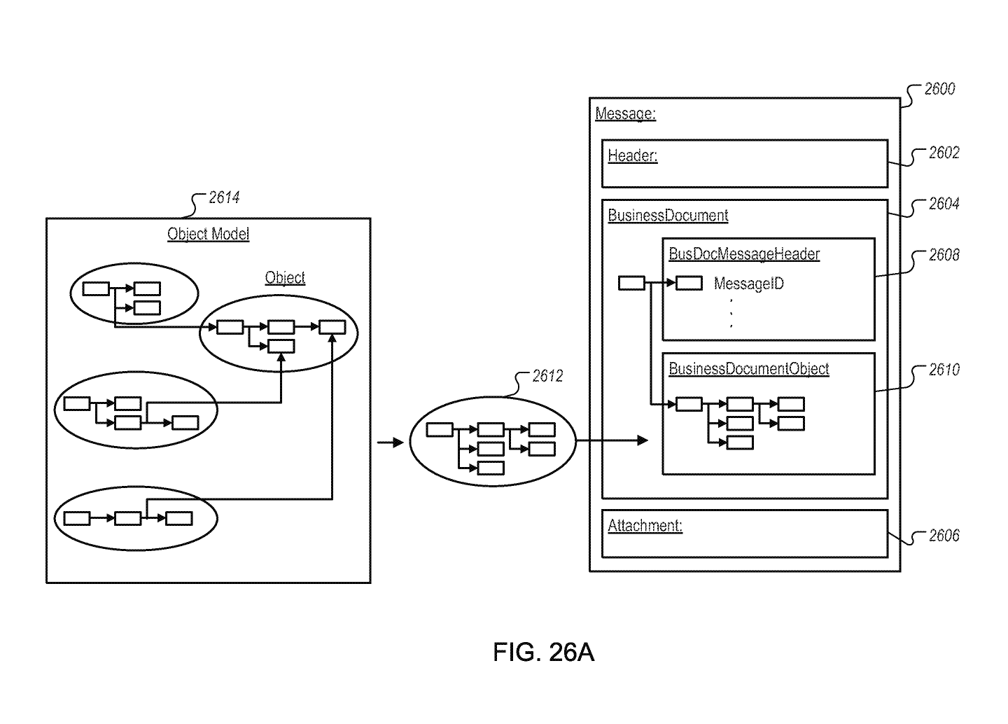

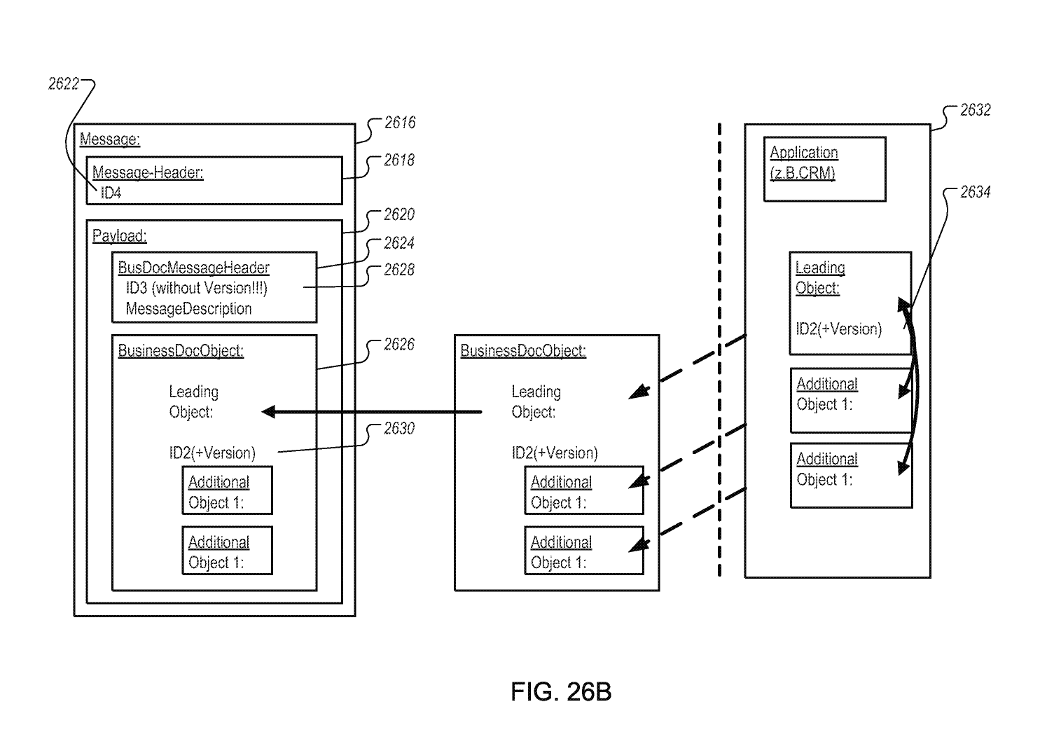

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

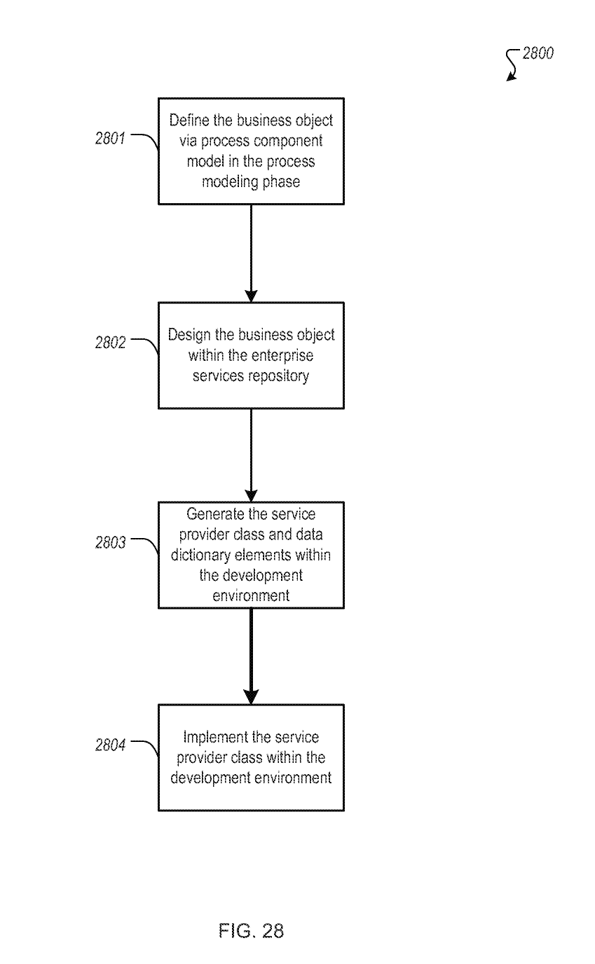

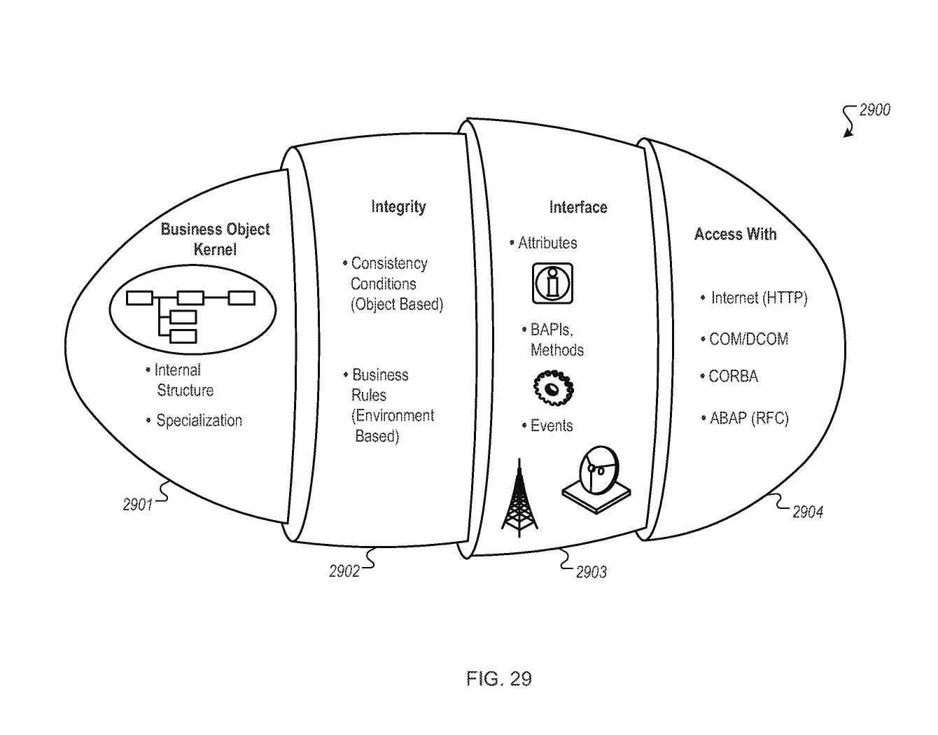

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

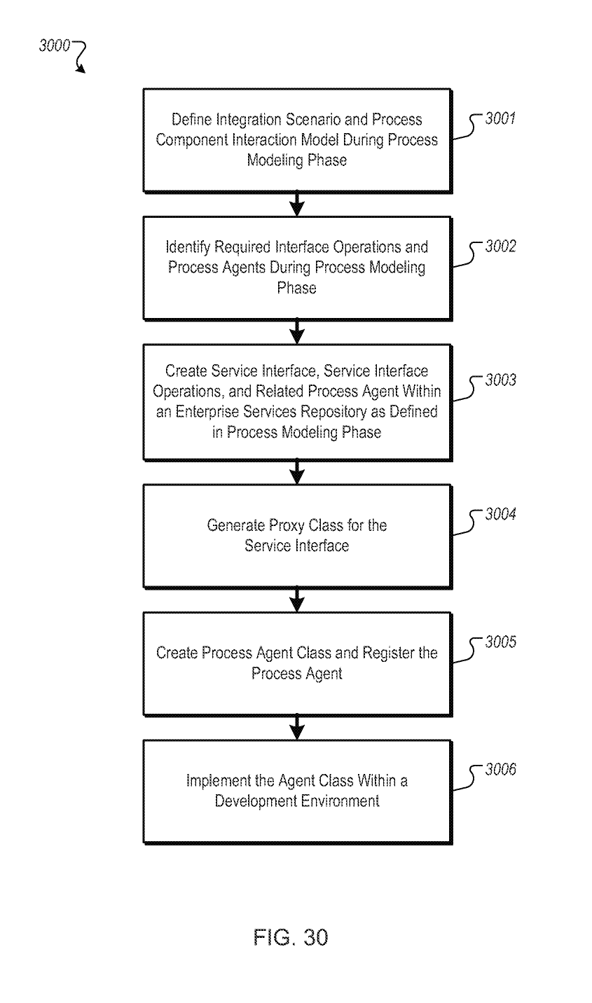

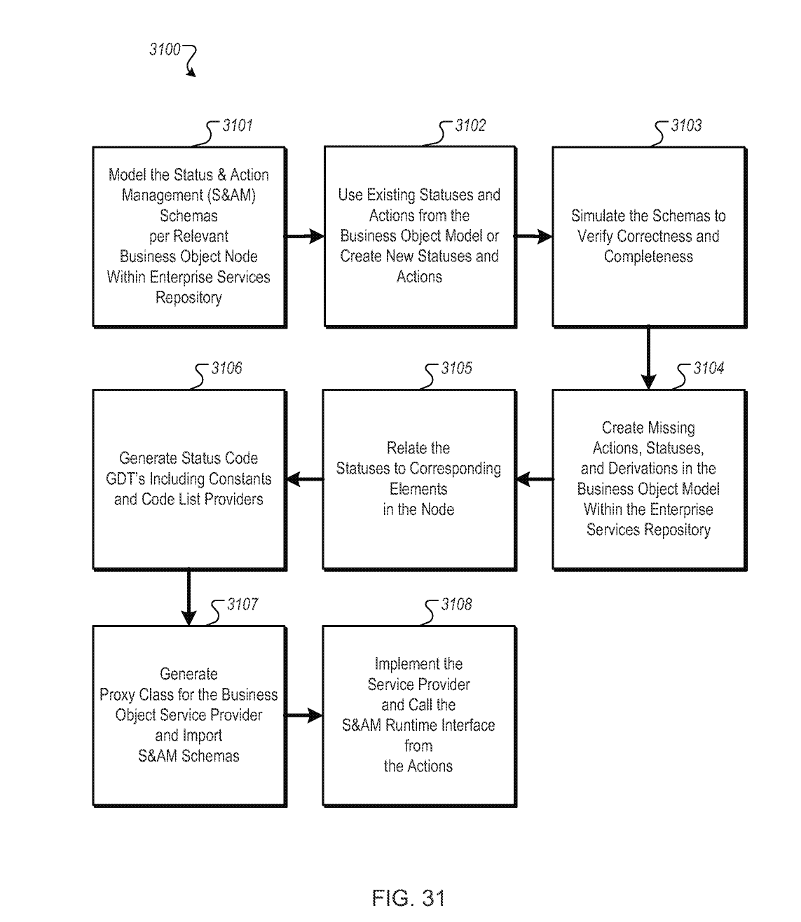

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

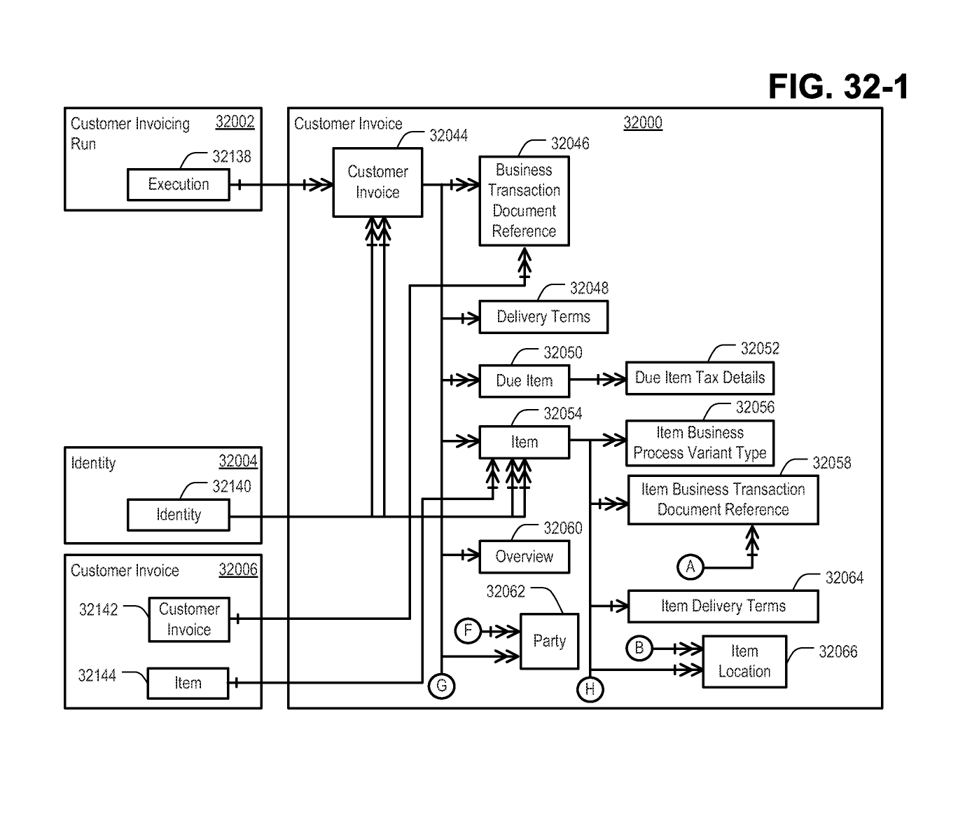

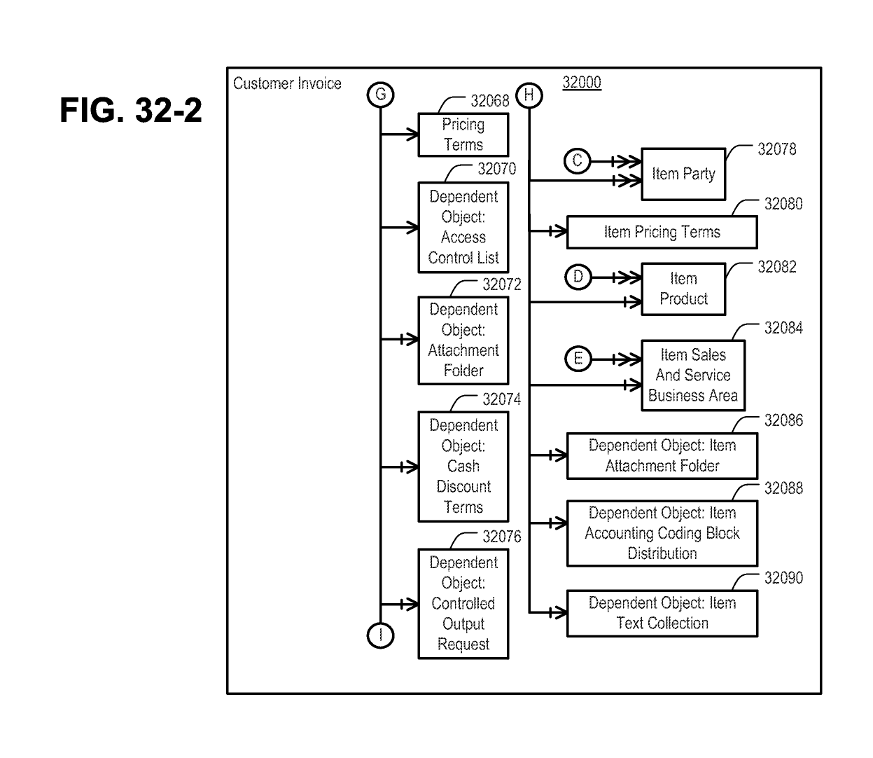

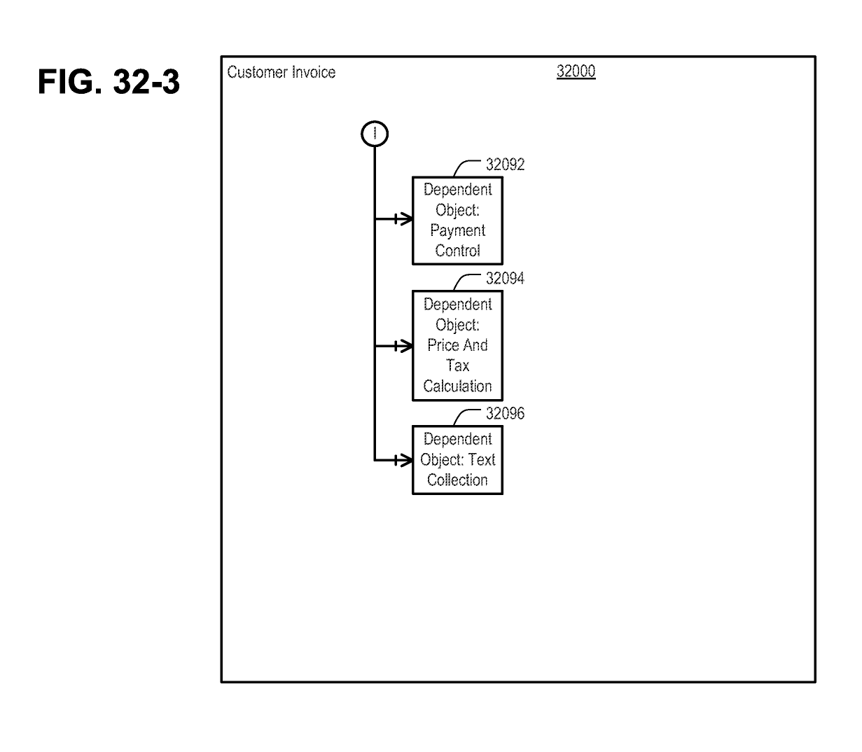

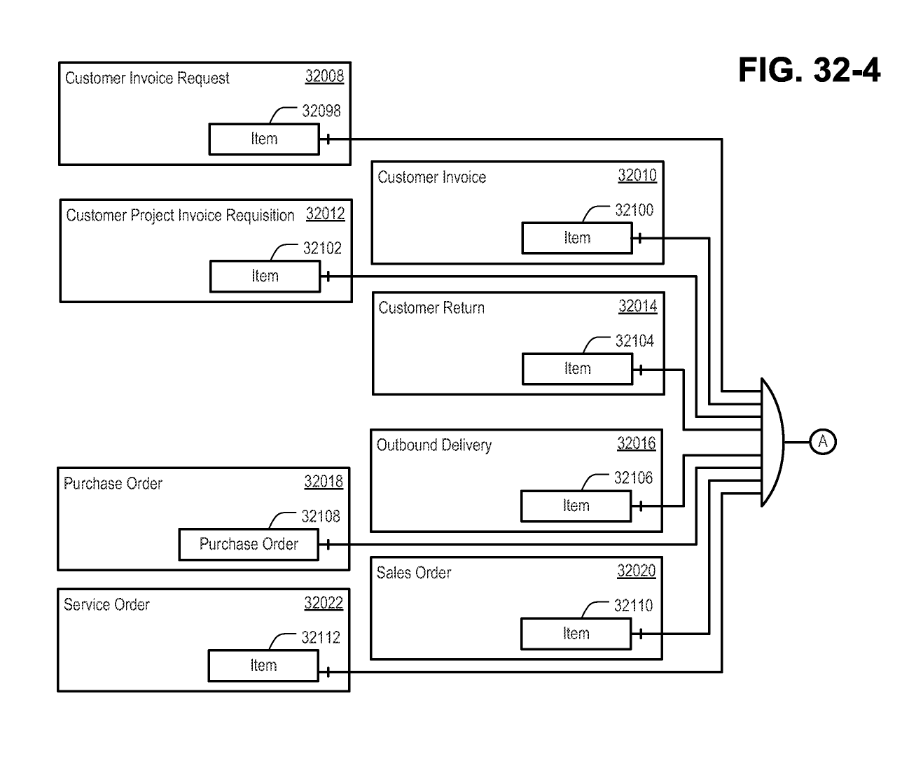

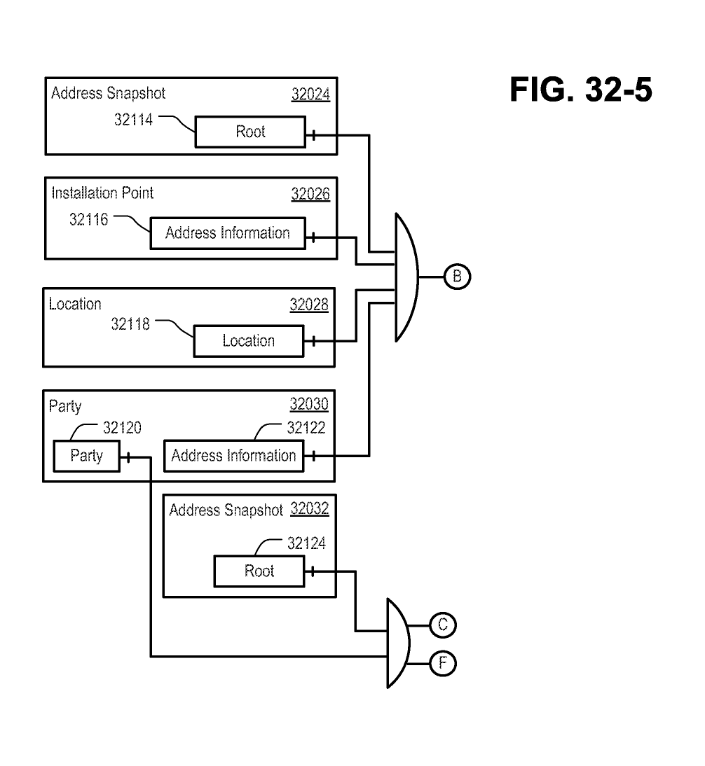

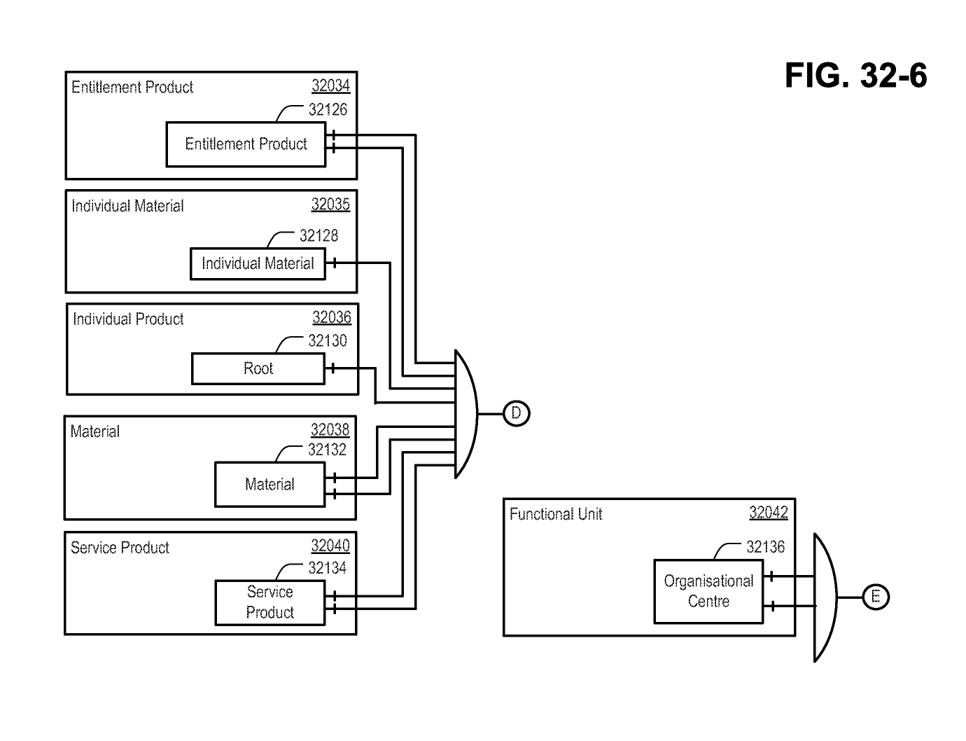

FIGS. 32-1 through 32-6 illustrate an example object model for a Customer Invoice business object 32000. Specifically, the object model depicts interactions among various components of the Customer Invoice business object 32000, as well as external components that interact with the Customer Invoice business object 32000 (shown here as 32002 through 32040 and 32098 through 32144). The Customer Invoice business object 32000 includes elements 32044 through 32096 that can be hierarchical, as depicted. For example, Customer Invoice entity 32044 hierarchically includes zero or more Business Transaction Document Reference entities 32046, zero or one Delivery Terms entities 32048, zero or more Due Item entities 32050, and various other entities. Similarly, each Due Item entity 32050 includes zero or more Due Item Tax Details entities 32052. Some or all of the entities 32044 through 32096 can correspond to packages and/or entities in the message data types described below.

The business object Customer Invoice is a binding statement of amounts receivable resulting, for example, from deliveries to a customer, services performed for a customer, adjustments to receivables, or credit memos to a customer. The Customer Invoice business object belongs to the process component Customer Invoice Processing. The Customer Invoice business object belongs to the deployment unit Customer Invoicing. A CustomerInvoice can include two main structures: 1) a CustomerInvoice, with dependent data such as parties involved, a status, and references, which can apply for a whole document; and 2) items of the CustomerInvoice, including information on invoiced goods and services and dependent data such as parties involved, a status, and references, which can apply for one item of a CustomerInvoice. The business object Customer Invoice has an object category of Business Transaction Document and a technical category of Standard Business Object. The business object Customer Invoice is involved in the following Process Component

Interactions: Customer Contract Processing_Customer Invoice Processing, Customer Invoice Processing_Accounting, Customer Invoice Processing_Balance Of Foreign Payment Management, Customer Invoice Processing_Business Transaction Legal Authorisation Processing, Customer Invoice Processing_Customer Invoice Post-Processing at Authority, Customer Invoice Processing_Customs Processing, Customer Invoice Processing_Form External Financials, Customer Invoice Processing_Intrastat Valuation, Customer Invoice Processing_Supplier Invoice Processing, Customer Invoice Processing_Supplier Invoice Processing at Customer, Customer Project Invoice Preparation_Customer Invoice Processing, Customer Return Processing_Customer Invoice Processing, Customer Return Processing_Customer Invoice Processing_Read, Due Item Processing_Customer Invoice Processing, Intrastat Valuation_Customer Invoice Processing_Information Requesting, Sales Order Processing_Customer Invoice Processing, Service Confirmation Processing_Customer Invoice Processing, and Service Order Processing_Customer Invoice Processing.

A service interface Authorisation Internal Request Out has a technical name of CustomerInvoiceProcessingAuthorisationInternalRequestOut. The service interface Authorisation Internal Request Out is part of the following Process Component Interactions: Customer Invoice Processing_Business Transaction Legal Authorisation Processing. An operation Request of Internal Authorisation has a technical name of CustomerInvoiceProcessingAuthorisationInternalRequestOut.RequestOfInternalAuthorisation and is based on a message type Business Transaction Authorisation Internal Request that is derived from business object Business Transaction Authorisation Request.

A service interface Business Transaction Document Intrastat Valuation Notification Out has a technical name of CustomerInvoiceProcessingBusinessTransactionDocumentIntrastatValuationNotificationOut. The service interface Business Transaction Document Intrastat Valuation Notification Out is part of the following Process Component Interactions: Customer Invoice Processing_Intrastat Valuation and is an interface to send a notification about a released, posted, or cancelled business transaction document to Intrastat Valuation. An operation Notify Of Customer Invoice has a technical name of CustomerInvoiceProcessingBusinessTransactionDocumentIntrastatValuationNotificationOut. NotifyOfCustomerInvoice, can be used to send a notification about a released or canceled customer invoice, and is based on a message type Business Transaction Document Intrastat Valuation Notification that is derived from business object/FTA/FOREIGN_TRADE_MANAGEMENTIntrastat Valuation.

A service interface Customer Invoice Authorisation Internal Request In has a technical name of CustomerInvoiceProcessingCustomerInvoiceAuthorisationInternalRequestIn. The service interface Customer Invoice Authorisation Internal Request In is part of the following Process Component Interactions Customer Invoice Processing_Business Transaction Legal Authorisation Processing. An operation Process Authorisation Confirmation has a technical name of CustomerInvoiceProcessingCustomerInvoiceAuthorisationInternalRequestIn. ProcessAuthorisationConfirmation and is based on a message type Business Transaction Authorisation Confirmation that is derived from business object Business Transaction Authorisation Request.

A service interface Customer Invoice Post-Processing In has a technical name of CustomerInvoiceProcessingCustomerInvoicePostProcessingIn. The service interface Customer Invoice Post-Processing In is part of the Process Component Interaction Customer Invoice Processing_Customer Invoice Post-Processing at Authority, and is an interface to process a confirmation of a customer invoice post-processing. An operation Process Post-Processing Confirmation has a technical name of CustomerInvoiceProcessingCustomerInvoicePostProcessingIn.ProcessPostProcessingConfirmation, can be used to process a confirmation of post-processing for a customer invoice, and is based on a message type Customer Invoice Post-Processing Confirmation that is derived from business object Customer Invoice.

A service interface Customer Invoice Post-Processing Out has a technical name of CustomerInvoiceProcessingCustomerInvoicePostProcessingOut. The service interface Customer Invoice Post-Processing Out is part of the process component interaction Customer Invoice Processing_Customer Invoice Post-Processing at Authority and is an interface to request customer invoice post-processing. An operation Request Post-Processing has a technical name of CustomerInvoiceProcessingCustomerInvoicePostProcessingOut.RequestPostProcessing and is based on a message type Customer Invoice Post-Processing Request that is derived from business object Customer Invoice.

A service interface Due Clearing In has a technical name of CustomerInvoiceProcessingDueClearingIn. The service interface Due Clearing In is part of the process component interaction Due Item Processing_Customer Invoice Processing and is an interface to change customer invoices based on due clearing. An operation Change Customer Invoice has a technical name of CustomerInvoiceProcessingDueClearingIn.ChangeCustomerInvoice, can be used to change a customer invoice based on due clearing, and is based on a message type Due Clearing Notification that is derived from business object Due Clearing.

A service interface Export Declaration Requesting Out has a technical name of CustomerInvoiceProcessingExportDeclarationRequestingOut. The service interface Export Declaration Requesting Out is part of the process component interaction Customer Invoice Processing_Customs Processing and is an interface to request an export declaration. An operation Request Export Declaration has a technical name of CustomerInvoiceProcessingExportDeclarationRequestingOut.RequestExportDeclaration, can be used to send a request for the creation of an export declaration, and is based on a message type Export Declaration Request Request that is derived from business object Export Declaration Request.

A service interface External Financials Out has a technical name of CustomerInvoiceProcessingExternalFinancialsOut. The service interface External Financials Out is part of the process component interaction Customer Invoice Processing_Form External Financials and is an interface to notify External Financials of the creation or cancellation of a customer invoice. An operation Notify of Invoice has a technical name of CustomerInvoiceProcessingExternalFinancialsOut.NotifyOfInvoice, can be used to inform External Financials about the creation or cancellation of invoices or credit memos, and is based on a message type Form Customer Invoice External Financials Notification that is derived from business object Customer Invoice.

A service interface Foreign Receivable Payable Notification Out has a technical name of CustomerInvoiceProcessingForeignReceivablePayableNotificationOut. The service interface Foreign Receivable Payable Notification Out is part of the process component interaction Customer Invoice Processing_Balance Of Foreign Payment Management and is an interface to notify Balance of Foreign Payment Management of a creation/cancellation of a customer invoice. An operation Notify of Invoice has a technical name of CustomerInvoiceProcessingForeignReceivablePayableNotificationOut.NotifyOfInvoice, can be used to inform about an invoice in order to track a receivable from or a payable to a non-resident business partner, and is based on a message type Foreign Receivable Payable Notification that is derived from business object Foreign Receivable Payable. An operation Notify of Invoice Cancellation has a technical name of CustomerInvoiceProcessingForeignReceivablePayableNotificationOut.NotifyOfInvoiceCancellation, can be used to inform about a cancellation of an invoice in order to also cancel information about a receivable from or a payable to a non-resident business partner, and is based on a message type Foreign Receivable Payable Cancellation Notification that is derived from business object Foreign Receivable Payable.

A service interface Invoice Accounting Out has a technical name of CustomerInvoiceProcessingInvoiceAccountingOut. The service interface Invoice Accounting Out is part of the process component interaction Customer Invoice Processing_Accounting and is an interface to notify Accounting of a creation or cancellation of a customer invoice. An operation Notify of Invoice has a technical name of CustomerInvoiceProcessingInvoiceAccountingOut.NotifyOfInvoice, can be used to inform accounting about a creation of invoices or credit memos, and is based on a message type Invoice Accounting Notification that is derived from business object Accounting Notification. An operation Notify of Invoice Accounting Notification Reconciliation Collection has a technical name of CustomerInvoiceProcessingInvoiceAccountingOut.NotifyOfInvoiceAccountingNotificationReconciliationCollection, can be used to send a notification about a creation of new or changes to existing customer invoices as well as a cancellation of customer invoices for a purpose of reconciliation, and is based on a message type Invoice Accounting Notification Reconciliation Collection Notification that is derived from business object Accounting Notification. An operation Notify of Invoice Cancellation has a technical name of CustomerInvoiceProcessingInvoiceAccountingOut.NotifyOfInvoiceCancellation, can be used to inform accounting about a cancellation of invoices or credit memos, and is based on a message type Invoice Cancellation Accounting Notification that is derived from business object Accounting Notification.

A service interface Invoicing Out has a technical name of CustomerInvoiceProcessingInvoicingOut. The service interface Invoicing Out is part of the following Process Component Interactions: Customer Invoice Processing_Supplier Invoice Processing, and Customer Invoice Processing_Supplier Invoice Processing at Customer. The service interface Invoicing Out is an interface to inform an invoice recipient. An operation Notify of Invoice has a technical name of CustomerInvoiceProcessingInvoicingOut.NotifyOfInvoice, can be used to inform a recipient of a customer invoice about invoicing, and is based on a message type Invoice Request that is derived from business object Supplier Invoice.

A service interface MX_Manage Customer Invoice Legal Authorisation In has a technical name of

MX_ManageCustomerInvoiceIn. The service interface MX_Manage Customer Invoice Legal Authorisation In is an interface to manage legal authorisation information received from the Mexican government for customer invoices. An operation MX_Maintain Legal Authorisation Bundle has a technical name of MX_ManageCustomerInvoiceIn.MaintainLegalAuthorisationBundle, can be used to maintain one or more customer invoices with legal authorisation information received from the Mexican government, and is based on a message type MX_Customer Invoice Legal Authorisation Bundle Maintain Confirmation_sync that is derived from business object Customer Invoice and on a message type MX_Customer Invoice Legal Authorisation Bundle Maintain Request_sync that is derived from business object Customer Invoice.

A service interface Manage Customer Invoice In has a technical name of CustomerInvoiceProcessingManageCustomerInvoiceIn. The service interface Manage Customer Invoice In is part of the following Process Component Interactions: Customer Return Processing_Customer Invoice Processing_Read, and Intrastat Valuation_Customer Invoice Processing_Information Requesting. The service interface Manage Customer Invoice In is an interface to provide customer invoice information. An operation Read Customer Invoice has a technical name of CustomerInvoiceProcessingManageCustomerInvoiceIn.ReadCustomerInvoice, can be used to provide information about a customer invoice, and is based on a message type Customer Invoice By ID Query that is derived from business object Customer Invoice and on a message type Customer Invoice By ID Response that is derived from business object Customer Invoice.

A service interface Request Invoicing Out has a technical name of CustomerInvoiceProcessingRequestInvoicingOut. The service interface Request Invoicing Out is part of the following Process Component Interactions: Customer Contract Processing_Customer Invoice Processing, Customer Project Invoice Preparation_Customer Invoice Processing, and Customer Return Processing_Customer Invoice Processing, Sales Order Processing_Customer Invoice Processing, Service Confirmation Processing_Customer Invoice Processing, and Service Order Processing_Customer Invoice Processing. The service interface Request Invoicing Out is an interface to inform about a creation of a customer invoice. An operation Confirm Invoicing has a technical name of CustomerInvoiceProcessingRequestInvoicingOut.ConfirmInvoicing, can be used to confirm that invoicing has taken place, and based on a message type Customer Invoice Issued Confirmation that is derived from business object Customer Invoice.

A CustomerInvoice root node can include information relating to a binding statement of amounts receivable, receivables adjustments, or credit memos to a business partner specifying one or more terms of delivery and payment. Receivables, receivables adjustments, and credit memos can be described in detail in items, where applicable, with reference to goods or services. A CustomerInvoice root node can also include identifying and administrative data. The elements located directly at the node Customer Invoice are defined by the data type CustomerInvoiceElements. These elements include: UUID, ID, TypeCode, ProcessingTypeCode, ReceivablesPropertyMovementDirectionCode, Date, DeviatingPostingDate, CancellationDocumentIndicator, TotalGrossAmount, TotalNetAmount, TotalTaxAmount, TaxCountryCode, AccountsReceivableDueItemTypeCode, SellerRegistrationCountryCode, LegalApprovalRequiredIndicator, ReferenceBusinessTransactionDocumentID, SimulationOriginCodeSimulationOriginCode, CustomerInvoicingRunExecutionUUID, SystemAdministrativeData, and Status.

UUID may be an alternative key, is an internally assigned universally unique ID of a Customer Invoice on which other business objects foreign keys can be defined, and may be based on datatype GDT: UUID. ID may be an alternative key, is a unique identifier for a Customer Invoice assigned by a BillFromParty invoice number, and may be based on datatype GDT: BusinessTransactionDocumentID. TypeCode is a coded representation of a type of a Customer Invoice, and may be based on datatype GDT: BusinessTransactionDocumentTypeCode. ProcessingTypeCode is a processing type of a Customer Invoice which can control behavior of a Customer Invoice within a process component, and may be based on datatype GDT: BusinessTransactionDocumentProcessingTypeCode. ReceivablesPropertyMovementDirectionCode is a coded representation of whether a Customer Invoice increases or decreases receivables, and may be based on datatype GDT: PropertyMovementDirectionCode, with a qualifier of Receivables. Date is an issue date of a Customer Invoice, and may be based on datatype GDT: Date. DeviatingPostingDate may be optional, is a date to post an invoice in accounting if a deviation from an invoice date is required, and may be based on datatype GDT: Date. CancellationDocumentIndicator may be optional, indicates whether an invoice is a cancellation invoice, and may be based on datatype GDT: Indicator, with a qualifier of CancellationDocument. TotalGrossAmount is a total gross value of a Customer Invoice, and may be based on datatype GDT: Amount, with a qualifier of Gross. TotalNetAmount is a total net value of a Customer Invoice, and may be based on datatype GDT: Amount, with a qualifier of Net. TotalTaxAmount is a total tax value of a Customer Invoice, and may be based on datatype GDT: Amount, with a qualifier of Tax. TaxCountryCode may be optional, is a country determined in tax calculation, and may be based on datatype GDT: CountryCode. AccountsReceivableDueItemTypeCode may be optional, is a coded representation of a type of an accounts receivable in due item overwritten by a customer invoice, and may be based on datatype GDT: AccountsReceivableDueItemTypeCode. SellerRegistrationCountryCode may be optional, represents a country of registration of a company represented by a seller party, and may be based on datatype GDT: CountryCode. LegalApprovalRequiredIndicator may be optional, is an indicator that specifies whether a legal approval is required, and may be based on datatype GDT: Indicator. In some implementations, the setting of LegalApprovalRequiredIndicator can influence the usage of a status variable Legal Approval. ReferenceBusinessTransactionDocumentID may be optional, is an identifier for a business document that is used as a reference for a customer invoice, and may be based on datatype GDT: BusinessTransactionDocumentID. SimulationOriginCodeSimulationOriginCode may be optional, is a coded representation of an origin for a simulation of a customer invoice, and may be based on datatype GDT: CustomerInvoiceProcessingSimulationOriginCode. CustomerInvoicingRunExecutionUUID may be optional, is a universally unique identifier of an execution of a Customer Invoicing Run that created a Customer Invoice, and may be based on datatype GDT: UUID. SystemAdministrativeData is administrative data recorded by a system that can include, for example, system user and change times. SystemAdministrativeData may be based on datatype GDT: SystemAdministrativeData. Status represents a current step in the life cycle of a Customer Invoice, and may be based on datatype BOIDT: CustomerInvoiceStatus.

Status can include Status/ConsistencyStatusCode, Status/ItemListConsistencyStatusCode, Status/ReleaseStatusCode, Status/CorrectionProcessingStatusCode, Status/DueItemClearingStatusCode, Status/InvoicingClearingStatusCode, and Status/LegalApprovalStatusCode. Status/ConsistencyStatusCode is a coded representation of a description of whether the node Customer Invoice and associated nodes, except Item, are consistent. Status/ConsistencyStatusCode may be based on datatype GDT: INCONSISTENTCONSISTENT_ConsistencyStatusCode. Status/ItemListConsistencyStatusCode is a coded representation of an aggregated status of the consistency status of all items of an Customer Invoice, and may be based on datatype GDT: INCONSISTENTCONSISTENT_ConsistencyStatusCode. Status/ReleaseStatusCode is a coded representation of a status of a release of a customer invoice that can control activities possible for and notifications to subsequent business processes. Status/ReleaseStatusCode may be based on datatype GDT: ReleaseStatusCode. Status/CorrectionProcessingStatusCode is a coded representation of a status of a correction process of a customer invoice that can control notifications of subsequent business process, and may be based on datatype GDT: NOTSTARTEDINPROCESSFINISHED_ProcessingStatusCode, with a qualifier of Correction. Status/DueItemClearingStatusCode is a coded representation of a status of a clearing process of a customer invoice in the process component due item processing, and may be based on datatype GDT: ClearingStatusCode, with a qualifier of DueItem. The clearing process can be performed in the process component Due Item Processing. If, for the Customer Invoice, the Due Item Clearing is relevant, the notification can be performed with a message from Due Item Processing. Status/InvoicingClearingStatusCode is a coded representation of a status of a clearing process of a customer invoice, and may be based on datatype GDT: ClearingStatusCode, with a qualifier of Invoicing. Status/LegalApprovalStatusCode may be optional, is a coded representation of a status for a legal approval of a customer invoice, and may be based on datatype GDT: ApprovalStatusCode.

The following composition relationships to subordinate nodes can exist: Business Transaction Document Reference, with a cardinality of 1:CN; Delivery Terms, with a cardinality of 1:C; Due Item, with a cardinality of 1:CN; Item, with a cardinality of 1:N; Overview, with a cardinality of 1:C, where composition can be disabled; Party, with a cardinality of 1:N; and Pricing Terms, with a cardinality of 1:1.

The following composition relationships to dependent objects can exist: Access Control List, with a cardinality of 1:1, which is a list of access groups that have access to a Customer Invoice during a validity period; Attachment Folder, with a cardinality of 1:C, which is a collection of documents that are assigned to the Customer Invoice, where the Attachment Folder root is the collection of all documents attached to a business object or a part of a business object that includes administrative data and attached documents, which are in turn independent documents, and where a Dependent Object can be integrated into a Customer Invoice business object by means of an AttachmentFolder prefix; Cash Discount Terms, with a cardinality of 1:C, which are terms for a payment of goods delivered or services provided that business partners have agreed on with regard to a payment period and discounts allowed in case of payment on time, where the and conditions agreed on by business partners for the payment of goods delivered or services provided consist of incremental payment periods and cash discounts that are allowed when payment is made within one of these periods, and where a Dependent Object is integrated into the Customer Invoice business object by means of a CashDiscountTerms prefix; Controlled Output Request, with a cardinality of 1:C, which is a controller of output requests and processed output requests related to a Customer Invoice, where the request is a controller of output requests and output history entries related to a hosting business object, where several output channels are supported for sending out documents, and where a Dependent Object is integrated into a Customer Invoice business object by means of a ControlledOutputRequest prefix; Payment Control, with a cardinality of 1:C; which is an agreement between a company and a business partner on processing payments for a Customer Invoice, where a Dependent Object is integrated into a Customer Invoice business object by means of a PaymentControl prefix; Price And Tax Calculation, with a cardinality of 1:C; which is a summary of determined price and tax components for a Customer Invoice; Item, where a Dependent Object is integrated into the Customer Invoice business object by means of a PriceAndTaxCalculation prefix; Text Collection, with a cardinality of 1:C, which is text in natural language which describes a Customer Invoice, where a TextCollection is a collection of textual descriptions which are related to a business object or a part of a business object where each text can be specified in different languages and can include formatting information, and where a Dependent Object is integrated into the Customer Invoice business object by means of a TextCollection prefix. As an example, correspondence or an accounting note for a business partner can be stored as text in a Text Collection of a particular node.

The following inbound aggregation relationships may exist from the business object Customer Invoicing Run/node Execution: Customer Invoicing Run Execution, with a cardinality of C:CN, which represents execution of a Customer Invoicing Run that created a Customer Invoice. The following inbound association relationships may exist: Creation Identity, from the business object Identity/node Identity, with a cardinality of 1:CN; which is an identity of a user that created a Customer Invoice; Last Change Identity, from the business object Identity/node Identity, with a cardinality of 1:CN, which is an identity of a user that last changed a Customer Invoice.

The following specialization associations for navigation may exist: Business Document Flow, to the business object Business Document Flow/node Business Document Flow, with a target cardinality of C, which is a business document flow of a customer invoice; Origin Customer Invoice Reference, to the node Business Transaction Document Reference, with a target cardinality of C, which is an association to a Business Transaction Document Reference in the OriginCustomerInvoiceReference specialization; and Cancellation Customer Invoice, to the node Customer Invoice, with a target cardinality of C, which is an association to a Customer Invoice that has been created to cancel an invoice.

The following specialization associations for navigation may exist to the node Party: Tax Reporting Unit Party, with a target cardinality of C; Bill From Party, with a target cardinality of C; Bill to Party, with a target cardinality of C; Buyer Party, with a target cardinality of 1; Payer Party, with a target cardinality of C, which is an association to a Party that occurs in a PayerParty specialization; and Seller Party, with a target cardinality of 1, which is an association to a Party that occurs in a SellerParty specialization.

In some implementations, the elements TotalNetAmount, TotalGrossAmount, and TotalTaxAmount describe the total of the values NetAmount, GrossAmount, and TaxAmount across all items and are not set explicitly. In some implementations, the currency in the elements TotalNetAmount, TotalGrossAmount, and TotalTaxAmount always matches the value of the CurrencyCode element in the PricingTerms node. In some implementations, once a Customer Invoice has been created, it can be canceled but not deleted, which means that a second Customer Invoice is created with CancellationDocumentIndicator ‘true’ and a reference to the Customer Invoice to be cancelled OriginCustomerInvoice.

An Adjust Responsible Agent and Access Control List action adjusts responsible agents and corresponding entries in an access control list based on current responsibility settings. In the case of Customer Invoices, responsible agents can be functional units. After the Adjust Responsible Agent and Access Control List action, responsible functional units and an access control list can be adjusted. The Adjust Responsible Agent and Access Control List action can be used for adjustments of responsible functional units and an access control list resulting from changes in responsibility settings for functional units.

A Cancel action cancels a Customer Invoice which had been previously released to reverse amounts receivables or credits. A precondition of the Cancel action can be that the Customer Invoice has already been released (e.g., Release status is ‘Released’). After the Cancel action, a new Customer Invoice is generated, which creates a copy of the current invoice and is marked by the CancellationDocumentIndicator, which is set to ‘True’. The Cancel action sets the status variable Release to ‘Release Cancelled’.

A Check Consistency action checks whether node Customer Invoice and all nodes directly attached (except Item) are consistent, and sets a status variable Consistency according to a result of the check.

A Check Due Item Clearing Relevance action checks whether a customer invoice is relevant for notification of clearing from due item processing. If a relevance is given, a message from the process component Due Item Processing can be provided. In some implementations, the Customer Invoice is released before the Check Due Item Clearing Relevance action occurs. After the Check Due Item Clearing Relevance action, the status variable Due Item Clearing is set according to the result of the check. If the clearing from Due Item Processing is expected the status variable Due Item Clearing can be set to ‘Open’. If the clearing is not expected the status can be set to ‘Not Relevant’.

A Check Invoicing Clearing Relevance action checks whether a customer invoice is relevant for clearing in invoicing. In some implementations, a Customer Invoice is in the state ‘Cleared’ in the status variable Due Item Clearing before the Check Invoicing Clearing Relevance action is performed. After the Check Invoicing Clearing Relevance action, the Status variable Invoicing Clearing can be set according to the result of the check. If the clearing in the invoice processing is expected the status variable Invoicing Clearing can be set to ‘Open’. If the clearing is not expected the status can be set to ‘Not Relevant’.

A Create Cancellation Customer Invoices with Reference action creates Customer Invoices marked as cancellation documents with reference to Customer Invoices that are not cancelled. After the Create Cancellation Customer Invoices with Reference action, a number of Customer Invoice instances carrying CancellationDocumentIndicator ‘true’ are created based on data from the Customer Invoice that was used to trigger the action. In some implementations, after the Create Cancellation Customer Invoices with Reference action is performed, after creation of the Customer Invoices, item identification of the Customer Invoices is stored in node Item Customer Invoice Item of the business object Customer Invoice Request and the InvoicingStatusCode in node Item of Customer Invoice Request is set accordingly using the action Notify Of Invoice Cancellation. The Customer Invoice Requests can be determined from the Customer Invoices that have been cancelled and those Customer Invoices can get a ReleaseStatusCode as described by actions Cancel and Discard. In some implementations, after the Create Cancellation Customer Invoices with Reference action is performed, ConsistencyStatusCode, ItemListConsistencyStatusCode of node Customer Invoice and ConsistencyStatusCode of node Item will be set according the result of action CheckConsistency and ReleaseStatusCode is set according to the status value in the Customer Invoice that is cancelled,

A Create with Customer Invoice Request Reference action creates Customer Invoices with reference to Customer Invoice Request Items. In some implementations, after the Create with Customer Invoice Request Reference action is performed, a number of Customer Invoice instances are created based on data from the Customer Invoice Requests that have been used to trigger the action. In some implementations, after creation of the Customer Invoices item identification of the Customer Invoices is stored in node ItemCustomerInvoiceItem of business object Customer Invoice Request and the InvoicingStatusCode in node Item of Customer Invoice Request can be set accordingly using the action NotifyOfInvoiceCreation. In some implementations, ConsistencyStatusCode and ItemListConsistencyStatusCode of node Customer Invoice and ConsistencyStatusCode of node Item can be set according to the result of action CheckConsistency and ReleaseStatusCode can be set according to a result of these checks in combination with the parameter AutomaticReleaseAllowedIndicator.

The action elements for the Create with Customer Invoice Request Reference action can be defined by the data type CustomerInvoiceCreateWithCustomerInvoiceRequestReferenceActionElements. These elements include: CustomerInvoiceDate, CustomerInvoicingRunExecutionUUID, AutomaticReleaseAllowedIndicator, BaseBusinessTransactionDocumentBasedCustomerInvoiceSeparationRequiredIndicator, UnderlyingOrderOrContractBasedCustomerInvoiceSeparationRequiredIndicator, ProvisionDateBasedCustomerInvoiceSeparationRequiredIndicator, InvoicingClearingRequestedIndicator, and SimulationOriginCode. CustomerInvoiceDate may be optional and may be based on datatype GDT: Date, with a qualifier of Invoice. CustomerInvoicingRunExecutionUUID may be optional and may be based on datatype GDT: UUID. AutomaticReleaseAllowedIndicator may be optional and may be based on datatype GDT: Indicator, with a qualifier of Allowed. BaseBusinessTransactionDocumentBasedCustomerInvoiceSeparationRequiredIndicator may be optional, indicates whether separate Customer Invoices are required per BaseBusinessTransactionDocument of a Customer Invoice Request, and may be based on datatype GDT: Indicator, with a qualifier of Required. UnderlyingOrderOrContractBasedCustomerInvoiceSeparationRequiredIndicator may be optional, indicates whether separate Customer Invoices are required per order or contract that is the basis for a business transaction document to be invoiced, and may be based on datatype GDT: Indicator, with a qualifier of Required. ProvisionDateBasedCustomerInvoiceSeparationRequiredIndicator may be optional, indicates whether separate Customer Invoices are required for Customer Invoice Request items with different provision dates, and may be based on datatype GDT: Indicator, with a qualifier of Required. InvoicingClearingRequestedIndicator may be optional, indicates whether invoicing clearing is requested during an invoicing process, and may be based on datatype GDT: Indicator, with a qualifier of Requested. If invoicing clearing is requested then business transaction documents with an existing down payment can be invoiced. A Customer Invoice can include information on allocated down payments. SimulationOriginCode may be optional, is a coded representation of an origin for the simulation of a customer invoice, and may be based on datatype GDT: CustomerInvoiceProcessingSimulationOriginCode.

A Discard action invalidates a Customer Invoice which has not yet been released. A precondition of the Discard action can be that the Customer Invoice has not been released (e.g., a Release status is ‘Not released’). Changes to status resulting from the action Discard can include the setting of the status variable Release to ‘Release Discarded’.

A Notify of Due Item Clearing action notifies a Customer Invoice of a result of a clearing from due item processing. The clearing process can be performed in the process component Due Item Processing. The notification can be performed with a message from Due Item Processing. A precondition of the Notify of Due Item Clearing action can be that the Customer Invoice is released. Changes to status resulting from the Notify of Due Item Clearing action can include setting the status variable Due Item Clearing according to a result of a clearing process. In the case that clearing is done in Due Item Processing, the status variable Due Item Clearing can be set to ‘Cleared’. In the case that clearing is open, the status can be set to ‘Open’.

A Notify of Invoicing Clearing Cancellation action notifies a customer invoice that a clearing has taken place within invoicing by cancellation of an invoice. A precondition of the Notify of Invoicing Clearing Cancellation action can be that the status of the Customer Invoice is cleared in the status variable invoicing clearing. Changes to status resulting from the action Notify of Invoicing Clearing Cancellation can include the setting of the status variable Invoicing Clearing to ‘Open’.

A Notify of Invoicing Clearing Creation action notifies a customer invoice that a clearing has taken place within invoicing by creation of an invoice. A precondition of the Notify of Invoicing Clearing Creation action can be that the Customer Invoice is in the state ‘Cleared’ in the status variable Due Item Clearing. Changes to status resulting from the Notify of Invoicing Clearing Creation action can include setting the status variable Invoicing Clearing to ‘Cleared’.

A Notify for Revision action can be used to notify that a legal approval process has ended with a request for the revision of a customer invoice. A precondition of the Notify for Revision action can be that the customer invoice is not released. Changes to status resulting from the action Notify for Revision can include the setting of the status variable Legal Approval to ‘In Revision’.

A Notify of Correction Invoice Request Cancellation action can be used to notify about cancellation of a Correction Invoice Request. A Notify of Correction Invoice Request Creation action can be used to notify about creation of a Correction Invoice Request. A Notify of Correction Invoice Cancellation action can be used to notify about cancellation of a Correction Invoice. A Notify of Correction Invoice Creation action can be used to notify about a creation of a Correction Invoice.

A Release action releases a CustomerInvoice for subsequent processes such as posting to accounting. A precondition of the Release action can be that the CustomerInvoice is consistent. Changes to status resulting from the action Release can include setting the status variable Release to ‘Released’.

A Notify of Legal Approval action can be used to notify that a customer invoice is approved by legal approval. A precondition of the Notify of Legal Approval action can be that the customer invoice is not released. Changes to status resulting from the Notify of Legal Approval action can include setting the status variable Legal Approval to ‘Approved’.

A Skip Legal Approval action can be used to skip a legal approval process for a customer invoice. Changes to status resulting from the action Skip Legal Approval can include the setting of the status variable Legal Approval to ‘Approval Not Necessary’. A Start Legal Approval action can be used to request the start of a legal approval process for a customer invoice. A precondition of the Start Legal Approval action can be that the customer invoice is consistent. Changes to the status resulting from the Start Legal Approval action can include setting the status variable Legal Approval to ‘In Approval’.

A Query By Customer Invoicing Run Execution UUID query provides a list of all CustomerInvoices which have been created in a specific execution of a CustomerinvoicingRun. The query elements are defined by the inline structure: APCI_S_CI_CI_R_EXEC_QUERY_EL. These elements include CustomerInvoicingRunExecutionUUID, which may be based on datatype GDT: UUID. A Query By Company And Date query provides a list of all Customer Invoices for the given dates where the SellerParty matches specified Company/Companies. The query elements are defined by the inline structure: APCI_S_CI_COMP_DATE_QUERY_EL. These elements include: Company_ID, Date, LastChangeDateTime, and ReleaseStatusCode. Company_ID is an ID of a Company represented by an ID of a Party in the specialization SellerParty, and may be based on datatype GDT: OrganisationalCentreID. Date may be based on datatype GDT: Date. LastChangeDateTime may be based on datatype GDT: GLOBAL_DateTime. ReleaseStatusCode may be based on datatype GDT: ReleaseStatusCode.

A Query By Elements query provides a list of all Customer Invoices which meet specified selection criteria. The query elements are defined by the inline structure: APCI_S_CI_ELEMENTS_QUERY_EL. These elements include: ID, ProcessingTypeCode, Date, CancellationDocumentIndicator, PartySellerPartyKey, PartyBuyerPartyKey, PartyBillFromPartyKey, PartyBillToPartyKey, PartyPayerPartyKey, PartyPartyKey, PartyName, PartyAdditionalName, PartySortingFormattedName, SellerRegistrationCountryCode, ReferenceBusinessTransactionDocumentID, ItemBusinessTransactionDocumentReference, ItemAccountingCodingBlockDistributionProjectTaskKey, ItemAccountingCodingBlockDistributionProjectID, ItemAccountingCodingBlockDistributionCostObjectKey, ItemAccountingCodingBlockDistributionCostObjectKey/CostObjectID, ItemAccountingCodingBlockDistributionTypeCode, ItemCustomerInvoiceRequestName, ItemDescription, ProductKey, ProductBuyerID, ProductUUID, LastChangeDateTime, ReleaseStatusCode, ConsistencyStatusCode, ItemListConsistencyStatusCode, CorrectionProcessingStatusCode, DueItemClearingStatusCode, InvoicingClearingStatusCode, LegalApprovalStatusCode, and SearchText.

ID may be based on datatype GDT: BusinessTransactionDocumentID. ProcessingTypeCode may be based on datatype GDT: BusinessTransactionDocumentProcessingTypeCode. Date may be based on datatype GDT: Date. CancellationDocumentIndicator may be based on datatype GDT: Indicator, with a qualifier of CancellationDocument. PartySellerPartyKey may be based on datatype KDT: PartyKey. PartySellerPartyKey may include PartySellerPartyKey/PartyID, which is an identifier for a party, and may be based on datatype GDT: PartyID. PartyBuyerPartyKey may be based on datatype KDT: PartyKey. PartyBuyerPartyKey may include PartyBuyerPartyKey/PartyID, which is an identifier for a party, and may be based on datatype GDT: PartyID. PartyBillFromPartyKey may be based on datatype KDT: PartyKey. PartyBillFromPartyKey may include PartyBillFromPartyKey/PartyID, which is an identifier for a party, and may be based on datatype GDT: PartyID. PartyBillToPartyKey may be based on datatype KDT: PartyKey. PartyBillToPartyKey may include PartyBillToPartyKey/PartyID, which is an identifier for a party, and may be based on datatype GDT: PartyID. PartyPayerPartyKey may be based on datatype KDT: PartyKey and may include PartyPayerPartyKey/PartyID, which is an identifier for a party and may be based on datatype GDT: PartyID. PartyPartyKey is a key of a party that occurs in a Customer Invoice, and may be based on datatype KDT: PartyKey. PartyPartyKey may include PartyPartyKey/PartyID, which is an identifier for a party and may be based on datatype GDT: PartyID. PartyName is a name of a party that occurs in a Customer Invoice, such as FamilyName of a business partner, such as BusinessPartnerCommonPersonNameFamilyName, and may be based on datatype GDT: MEDIUM_Name, with a qualifier of Party. PartyAdditionalName is an additional name of a party that occurs in a Customer Invoice, such as a given name of a business partner, such as BusinessPartnerCommonPersonNameGivenName, and may be based on datatype GDT: LANGUAGEINDEPENDENT_MEDIUM_Name, with a qualifier of PartyAdditional. PartySortingFormattedName is a sorting formatted name of a party that occurs in a Customer Invoice, such as a SortingFormattedName of a business partner, such as BusinessPartnerCommonSortingFormattedName, and may be based on datatype GDT: LONG_Name. SellerRegistrationCountryCode may be based on datatype GDT:

CountryCode. ReferenceBusinessTransactionDocumentID may be based on datatype GDT: BusinessTransactionDocumentID. ItemBusinessTransactionDocumentReference may be based on datatype GDT: BusinessTransactionDocumentReference. ItemAccountingCodingBlockDistributionProjectTaskKey is a Project Task Key as part of an assignment node of an attached Accounting Coding Block Distribution of an item, and may be based on datatype KDT: ProjectTaskKey. ItemAccountingCodingBlockDistributionProjectTaskKey can include ItemAccountingCodingBlockDistributionProjectTaskKey/TaskID, which is an identifier of a project task and may be based on datatype GDT: ProjectElementID. ItemAccountingCodingBlockDistributionProjectID may be based on datatype GDT: ProjectID. ItemAccountingCodingBlockDistributionCostObjectKey may be based on datatype KDT: FinancialAccountingViewOfCostObjectKey. ItemAccountingCodingBlockDistributionCostObjectKey may include ItemAccountingCodingBlockDistributionCostObjectKey/CostObjectTypeCode, which is a type of a cost object and may be based on datatype GDT: CostObjectTypeCode. ItemAccountingCodingBlockDistributionCostObjectKey may include ItemAccountingCodingBlockDistributionCostObjectKey/CostObjectID, which may be based on datatype GDT: FinancialAccountingViewOfCostObjectID. ItemAccountingCodingBlockDistributionTypeCode may be based on datatype GDT: AccountingCodingBlockTypeCode. ItemCustomerInvoiceRequestName may be based on datatype GDT: LANGUAGEINDEPENDENT_MEDIUM_Name, with a qualifier of CustomerInvoiceRequest. ItemDescription may be based on datatype GDT: SHORT_Description. ProductKey may be based on datatype KDT: ProductUnformattedKey. ProductKey may include ProductKey/ProductTypeCode, which is a coded representation of a product type, such as material or service, and may be based on datatype GDT: ProductTypeCode. ProductKey may include ProductKey/ProductidentifierTypeCode, which is a coded representation of a product identifier type and may be based on datatype GDT: ProductidentifierTypeCode. ProductKey may include ProductKey/ProductID, which is an identifier for a product, and may be based on datatype GDT: NOCONVERSION_ProductID. ProductBuyerID may be based on datatype GDT: ProductPartyID. ProductUUID may be based on datatype GDT: UUID. LastChangeDateTime is a time date and time stamp of a last change of a Customer Invoice, and may be based on datatype GDT: GLOBAL_DateTime, with a qualifier of Change. ReleaseStatusCode may be based on datatype GDT: ReleaseStatusCode. ConsistencyStatusCode may be based on datatype GDT: INCONSISTENTCONSISTENT_ConsistencyStatusCode.

ItemListConsistencyStatusCode may be based on datatype GDT: INCONSISTENTCONSISTENT_ConsistencyStatusCode. CorrectionProcessingStatusCode is a status of a correction process of a Customer Invoice that can control notifications of a subsequent business process, and may be based on datatype GDT: NOTSTARTEDINPROCESSFINISHED_ProcessingStatusCode. DueItemClearingStatusCode is a status of a clearing process of a Customer Invoice in the process component due item processing, and may be based on datatype GDT: ClearingStatusCode. InvoicingClearingStatusCode is a status of a clearing process of a Customer Invoice in invoicing, and may be based on datatype GDT: ClearingStatusCode. LegalApprovalStatusCode may be based on datatype GDT: ApprovalStatusCode, with a qualifier of Legal. SearchText is free text including one or several word search terms to search for Customer Invoices, and may be based on datatype GDT: SearchText. For every query that includes SearchText as a query parameter, an application-specific subset of other query parameters can be defined. A query result can be calculated in the following manner: search terms can be assigned to the subset of query parameters in such a way that every search term is used exactly once in the assignment. Several search terms may be assigned to the same query parameter. For each of these assignments, a query result can be calculated. A total result can be the union of the results calculated per assignment. A Select All query provides the NodeIDs of all instances of this node and can be used to enable an initial load of data for a Fast Search Infrastructure.

Business Transaction Document Reference is a reference to a business document on which a Customer Invoice is based. The elements located directly at the node Business Transaction Document Reference are defined by the inline structure: APCI_S_CI_BTD_REFERENCE_EL. These elements include BusinessTransactionDocumentReference and Business TransactionDocumentRelationshipRoleCode. BusinessTransactionDocumentReference is a unique identification of a referenced business document item related to a CustomerInvoice item, and may be based on datatype GDT: BusinessTransactionDocumentReference. BusinessTransactionDocumentRelationshipRoleCode is a coded representation of a role of a referenced business transaction document, and may be based on datatype GDT: BusinessTransactionDocumentRelationshipRoleCode. The following inbound association relationships may exist Origin Customer Invoice, from the business object Customer Invoice/node Customer Invoice, with a cardinality of C:CN, which is an invoice to which a current invoice refers. The following specialization associations for navigation may exist to the node Customer Invoice Parent, with a target cardinality of 1; and Root, with a target cardinality of 1.

Delivery Terms are agreements that apply for the delivery of the invoiced goods. The elements located directly at the node Delivery Terms are defined by the inline structure: APCI_S_CI_DELIVERY_TERMS_EL. These elements include Incoterms, which are conventional contract formulations for delivery terms that may be based on datatype GDT: Incoterms. The following specialization associations for navigation may exist to the node Customer Invoice Parent, with a target cardinality of 1; and Root, with a target cardinality of 1.

Due Item is a summarized open or cleared receivables information collected in due item management for an invoice. A Due Item includes amounts and, if relevant, a date and reference to an underlying document, and corresponding tax details. Cleared receivables can be paid or balanced receivables of a down payment invoice. Open receivables are, for example, a final payment calculated from values of an invoice, minus values typed as down payment. Cleared information collected in a due item management are paid or balanced receivables sent by message to an invoice. A DueItem can occur in the following specializations: DueItemClearingDueItem, which is a due item that specifies values for items in Due Item Management that have been cleared through, e.g., through a payment process; DownPaymentDueItem, which is a due item that specifies values of an invoice for which only a part of a total price has been initially paid, with a balance expected at a later date; and FinalPaymentDueItem, which is a due item that specifies values relevant for a final payment of an invoice.

The elements located directly at the node Due Item are defined by the data type CustomerInvoiceDueItemElements. These elements include: TypeCode, CancelledIndicator, GrossAmount, NetAmount, TaxAmount, CashDiscountAppliedIndicator, InvoiceDate, BaseBusinessTransactionDocumentID, BaseBusinessTransactionDocumentUUID, and BaseBusinessTransactionDocumentTypeCode. TypeCode is a type of a due item, and may be based on datatype GDT: CustomerInvoiceDueItemTypeCode. CancelledIndicator indicates whether an item is cancelled, and may be based on datatype GDT: Indicator, with a qualifier of Cancelled. GrossAmount is a gross value of a node due item, and may be based on datatype GDT: Amount, with a qualifier of Gross. NetAmount is a net value of a node due item, and may be based on datatype GDT: Amount, with a qualifier of Net. TaxAmount is a tax value of a node due item, and may be based on datatype GDT: Amount, with a qualifier of Tax. CashDiscountAppliedIndicator indicates that a cash discount has been applied to a due item, and may be based on datatype GDT: Indicator, with a qualifier of Applied. InvoiceDate may be optional, is an invoice date of an underlying Customer Invoice, and may be based on datatype GDT: Date, with a qualifier of Invoice. In some implementations, the invoice date is only used in the case that the BaseBusinessTransactionDocumentTypeCode is set to a code representing Customer Invoice. An example invoice date is a date of a down payment invoice. BaseBusinessTransactionDocumentID is a unique identifier for a business document that is referenced in a due item, and may be based on datatype GDT: BusinessTransactionDocumentID, with a qualifier of Base. BaseBusinessTransactionDocumentUUID is a universally unique identifier for a business document that is referenced in a due item, and may be based on datatype GDT: UUID, with a qualifier of BusinessTransactionDocument. BaseBusinessTransactionDocumentTypeCode may be optional, is a coded representation of a business document type referenced in a due item, and may be based on datatype GDT: BusinessTransactionDocumentTypeCode, with a qualifier of Base. The following composition relationships to subordinate nodes exist: Due Item Tax Details, with a cardinality of 1:CN. the following specialization associations for navigation may exist to the node Customer Invoice: Parent, with a target cardinality of 1; and Root, with a target cardinality of 1.

DueItemTaxDetails are tax details of a due item based on a tax determination in a preceding Customer Invoice that has been communicated to Due Item Management. Such tax details might not be determined by a tax calculation in a Customer Invoice, but may be created based on a notification from Due Item Management. The elements located directly at the node DueItemTaxDetails are defined by the inline structure: APCI_S_CI_DUE_ITEM_TAX_DET_EL. These elements include: CountryCode, RegionCode, TaxJurisdictionCode, TaxJurisdictionSubdivisionCode, ProductTaxEventTypeCode, TaxTypeCode, TaxRateTypeCode, BaseAmount, Percent, and Amount. CountryCode may be optional, is a country code specifying a country for which a tax is calculated in due item tax details, and may be based on datatype GDT: CountryCode. RegionCode is a coded representation of geographical or political regions that are logically or physically coherent and for which a tax is calculated in due item tax details, and may be based on datatype GDT: RegionCode. TaxJurisdictionCode is a coded representation identifying one or more tax authorities for due item tax details, and may be based on datatype GDT: TaxJurisdictionCode. TaxJurisdictionSubdivisionCode is a coded representation of a type of a subdivision of tax jurisdiction for due item tax details, and may be based on datatype GDT: TaxJurisdictionSubdivisionCode. ProductTaxEventTypeCode is a coded representation of a type of a taxable event for which a tax is calculated in due item tax details, and may be based on datatype GDT: ProductTaxEventTypeCode. TaxTypeCode is a coded representation of a type of a tax for which a tax is calculated in due item tax details, and may be based on datatype GDT: TaxTypeCode. TaxRateTypeCode is a coded representation of a type of a percentage or quantity based tax rate of a calculated tax in due item tax details, and may be based on datatype GDT: TaxRateTypeCode. BaseAmount is a basis for calculating percentage taxes, and may be based on datatype GDT: Amount, with a qualifier of Base. Percent may be optional, is a declaration of a tax rate for percentage taxes, and may be based on datatype GDT: Percent. Amount is a calculated tax amount of due item tax details, and may be based on datatype GDT: Amount. The following specialization associations for navigation may exist: Root, to the node Customer Invoice, with a target cardinality of 1; and Parent, to the node Due Item, with a target cardinality of 1.

Item is a statement of an individual receivable, receivables adjustment, or credit memo relating to an invoiced product or service. An item can include quantity information for a product or service and/or an invoice value or value to be credited. Item also includes information about parties involved, locations, and references to underlying business documents. In some implementations, invoice items and items describing an amount to be credited to a customer are not distinguished by element TypeCode, but rather show a different value of element ReceivablesPropertyMovementDirectionCode.

The elements located directly at the node Item are defined by the data type CustomerInvoiceItemElements. These elements include: UUID, ID, TypeCode, ProcessingTypeCode, ReceivablesPropertyMovementDirectionCode, Description, HierarchyRelationship, GrossAmount, NetAmount, TaxAmount, Quantity, QuantityTypeCode, CustomerInvoiceRequestName, CorrectedCustomerInvoiceItemID, InvoiceScheduleItemSourceUUID, InvoiceScheduleTypeCode, FulfilmentPartyCategoryCode, SystemAdministrativeData, and Status.

UUID may be an alternative key, is an internally assigned universally unique identifier of a Customer Invoice Item on which other business objects' foreign keys can be defined, and may be based on datatype GDT: UUID. ID is a unique identifier for an item within a Customer Invoice, may be assigned by a BillFromParty, and may be based on datatype GDT: BusinessTransactionDocumentItemID TypeCode is a coded representation of a type of a Customer Invoice item, and may be based on datatype GDT: BusinessTransactionDocumentItemTypeCode. ProcessingTypeCode is a processing type of a Customer Invoice Item which controls the behavior of an item within a process component, and may be based on datatype GDT: BusinessTransactionDocumentItemProcessingTypeCode. ReceivablesPropertyMovementDirectionCode is a coded representation of whether an Item increases or decreases receivables, and may be based on datatype GDT: PropertyMovementDirectionCode, with a qualifier of Receivables. Description may be optional, is a description of an item, and may be based on datatype GDT: SHORT_Description. HierarchyRelationship is a relationship between a subitem and a main item to describe item hierarchies, and may be based on datatype BOIDT: CustomerInvoiceItemHierarchyRelationship. HierarchyRelationship/ParentItemID is an identification of the parent item in an item hierarchy, and may be based on datatype GDT: BusinessTransactionDocumentItemID HierarchyRelationship may include HierarchyRelationship/TypeCode, which is a type of hierarchical relationship between items, and may be based on datatype GDT: BusinessTransactionDocumentItemHierarchyRelationshipTypeCode. GrossAmount is a gross value of an invoice item, and may be based on datatype GDT: Amount, with a qualifier of Gross. NetAmount is a net value of an invoice item, and may be based on datatype GDT: Amount, with a qualifier of Net. TaxAmount is a sum of tax values allotted to an invoice item, and may be based on datatype GDT: Amount, with a qualifier of Tax. Quantity is an invoiced quantity of goods delivered or service provided, and may be based on datatype GDT: Quantity. QuantityTypeCode is a coded representation of a type of an invoiced quantity, and may be based on datatype GDT: QuantityTypeCode. CustomerInvoiceRequestName may be optional, is a user-defined name of a related Customer Invoice Request, and may be based on datatype GDT: LANGUAGEINDEPENDENT_EXTENDED_Name. CorrectedCustomerInvoiceItemID may be optional, is an identification of a Customer Invoice item that has been corrected by an item, and may be based on datatype GDT: BusinessTransactionDocumentItemID, with a qualifier of Corrected. InvoiceScheduleItemSourceUUID may be optional, is a universally unique identifier of an invoice schedule item of a source business transaction document that is a basis for a customer invoice item, and may be based on datatype GDT: UUID. InvoiceScheduleTypeCode may be optional, is a type of an invoice schedule from which a customer invoice item has been created, and may be based on datatype GDT: InvoiceScheduleTypeCode. FulfilmentPartyCategoryCode may be optional, is a coded representation of a party category that describes how a customer invoice item is fulfilled, may be based on datatype GDT: FulfilmentPartyCategoryCode, and defines if the delivery of a material or provision of a service is performed internally or by an external supplier. In some implementations, if a fulfillment party category code is not specified, it is assumed that fulfillment is done internally. SystemAdministrativeData is administrative data recorded by a system, can include system user and change times, and may be based on datatype GDT: SystemAdministrativeData. Status is a status of a Customer Invoice item, and may be based on datatype BOIDT: CustomerInvoiceItemStatus. Status can include Status/ConsistencyStatusCode, which describes whether a node Item and all associated nodes are consistent, and may be based on datatype GDT: INCONSISTENTCONSISTENT_ConsistencyStatusCode.

The following composition relationships to subordinate nodes exist: Item Business Process Variant Type, with a cardinality of 1:N; Item Business Transaction Document Reference, with a cardinality of 1:CN; Item Delivery Terms, with a cardinality of 1:C; Item Location, with a cardinality of 1:CN; Item Party, with a cardinality of 1:CN; Item Pricing Terms, with a cardinality of 1:C; Item Product, with a cardinality of 1:C; and Item Sales And Service Business Area, with a cardinality of 1:C.

The following composition relationships to dependent objects exist: Item Attachment Folder, with a cardinality of 1:C, which is a collection of documents that are assigned to an invoice item, where, in general, an Attachment Folder root is a collection of documents attached to a business object or a part of a business object that includes administrative data and attached documents, which are in turn independent documents, and where a dependent object is integrated into a Customer Invoice business object by means of an ItemAttachmentFolder prefix; Item Accounting Coding Block Distribution, with a cardinality of 1:C, which distributes value changes from a customer invoice item to coding blocks, where the distribution may occur on the basis of amounts or quantities, and where, in general, a distribution of coding blocks includes an identification of the distribution and information that is valid for coding blocks, such as company performing reporting, a date on which the coding blocks are valid, or a quantity-based or amount-based total for which assignments need to be made, and where a dependent object is integrated into the Customer Invoice business object by means of an ItemAccountingCodingBlockDistribution prefix; Item Text Collection, with a cardinality of 1:C, which is a text in natural language which describes an invoice item, and where, in general, a TextCollection is a collection of textual descriptions which are related to a business object or a part of a business object, where each text can be specified in different languages and can include formatting information, and where a dependent object is integrated into a Customer Invoice business object by means of an ItemTextCollection prefix. As an example, a Correspondence or an Accounting Note for a Business Partner can be stored as text in a Text Collection of a particular node. The following inbound association relationships may exist: Child Item, from the business object Customer Invoice/node Item, with a cardinality of C:CN, which is a child item in an item hierarchy; Creation Identity, from the business object Identity/node Identity, with a cardinality of 1:CN, which is an identity of a user that created a CustomerInvoice Item; and Last Change Identity, from the business object Identity/node Identity, with a cardinality of 1:CN, which is an identity of a user that last changed a Customer Invoice Item.

The following specialization associations for navigation may exist: Parent, to the node Customer Invoice, with a target cardinality of 1; Root, to the node Customer Invoice, with a target cardinality of 1; Price and Tax Calculation Item, to the node Item, with a target cardinality of C; Main Item Business Process Variant Type, to the node Item Business Process Variant Type, with a target cardinality of 1, which is an association to a main Business Process Variant Type; Item Origin Customer Invoice Item Reference, to the node Item Business Transaction Document Reference, with a target cardinality of C; and Item Predecessor Business Transaction Document Item Reference, with a target cardinality of CN, which may be filtered. The filter elements are defined by the inline structure: APCI_CI_ITEM_BTD_REF_FLT_EL. These elements include BusinessTransactionDocumentTypeCode, which may be optional, is a type code of a business transaction document as a filter, and may be based on datatype GDT: BusinessTransactionDocumentTypeCode.

The following specialization associations for navigation may exist to the node Item Location: Service Point Item Location, with a target cardinality of C, which is an association to an ItemLocation that occurs in a Service Point Item Location specialization; Ship From Item Location, with a target cardinality of C; and Ship to Item Location, with a target cardinality of C.

The following specialization associations for navigation may exist to the node Item Party: Product Recipient Item Party, with a target cardinality of C; Sales Employee Item Party, with a target cardinality of C; Sales Unit Item Party, with a target cardinality of C, which is an association to an Item Party that occurs in a specialization SalesUnitItemParty; and Vendor Item Party, with a target cardinality of C. The following specialization associations for navigation may exist to the node Item Product Tax Details: Price and Tax Calculation Item Product Tax Details, with a target cardinality of CN. The following specialization associations for navigation may exist to the node Item Withholding Tax Details: Price and Tax Calculation Item Withholding Tax Details, with a target cardinality of CN, which represents withholding tax details assigned to an invoice item. In some implementations, if a quantity or a measure is set, a corresponding quantity or measure type is also set.

A Check Consistency action checks whether node Item and nodes directly attached are consistent and sets status variable Consistency according to the result of the check. A Query by Item Business Transaction Document Reference query can be used to return a list of customer invoice items according to an item business transaction document reference. The query elements are defined by the inline structure: APCI_S_CII_BTD_REF_QUERY_EL. These elements include ItemBusinessTransactionDocumentReference, which may be based on datatype GDT: BusinessTransactionDocumentReference.

Item Business Process Variant Type defines the character of a business process variant of an Item in a Customer Invoice, and represents a typical way of processing an Item within a process component from a business point of view. The elements located directly at the node Item Business Process Variant Type are defined by the inline structure: APCI_S_CI_ITEM_BPVT_ELEMENTS. These elements include BusinessProcessVariantTypeCode and MainIndicator. BusinessProcessVariantTypeCode is a coded representation of a business process variant type of a CustomerInvoiceRequest, and may be based on datatype GDT: BusinessProcessVariantTypeCode. MainIndicator specifies whether a current Business Process Variant Type is a main type, and may be based on datatype GDT: Indicator, with a qualifier of Main.

The following specialization associations for navigation may exist: Root, to the node Customer Invoice, with a target cardinality of 1; and Parent, to the node Item, with a target cardinality of 1. In some implementations, there is exactly one BusinessProcessVariantType with MainIndicator set to ‘true’.

Item Business Transaction Document Reference is a reference to a business document on which an invoice item is based. The elements located directly at the node Item Business Transaction Document Reference are defined by the inline structure: APCI_S_CII_BTD_REFERENCE_EL. These elements include: BusinessTransactionDocumentReference, Business TransactionDocumentRelationshipRoleCode, and Business TransactionDocumentUpdateRequiredIndicator. BusinessTransactionDocumentReference is a unique identification of a referenced business document item related to a CustomerInvoice item, and may be based on datatype GDT: BusinessTransactionDocumentReference. BusinessTransactionDocumentRelationshipRoleCode is a coded representation of a role of a referenced business transaction document or a business transaction document item, and may be based on datatype GDT: BusinessTransactionDocumentRelationshipRoleCode. In some implementations, the values of “predecessor” and “copy template” are supported. BusinessTransactionDocumentUpdateRequiredIndicator indicates whether a referenced business transaction document uses an update regarding invoiced quantities and amounts via Customer Invoice Issued Confirmation, and may be based on datatype GDT: Indicator, with a qualifier of Required. In some implementations, BusinessTransactionDocumentUpdateRequiredIndicator is evaluated if a corresponding process component interaction model exists such that a confirmation can be sent to a referenced business transaction document.

The following inbound association relationships may exist: Corresponding Customer Invoice Request Item, from the business object Customer Invoice Request/node Item, with a cardinality of C:CN, which is a Customer Invoice Request Item that is based on a referenced business transaction document item; Origin Customer Invoice Item, from the business object Customer Invoice/node Item, with a cardinality of C:CN, which is an invoice item to which a current invoice item refers; Customer Project Invoice Requisition Item, from the business object Customer Project Invoice Requisition/node Item Cross DU, with a cardinality of C:CN, which is a Customer Project Invoice Requisition Item for which an invoice item was created; Customer Return Item, from the business object Customer Return/node Item Cross DU, with a cardinality of C:CN, which is a customer return item for which an invoice item was created; Outbound Delivery Item, from the business object Outbound Delivery/node Item Cross DU, with a cardinality of C:CN, which is an outbound delivery item for which an invoice item was created; Purchase Order, from the business object Purchase Order/node Purchase Order Cross DU, with a cardinality of C:CN, which is a purchase order on which an invoiced sales process is based; Sales Order Item, from the business object Sales Order/node Item Cross DU, with a cardinality of C:CN, which is a sales order item for which an invoice item was created; Service Confirmation Item, from the business object Service Confirmation/node Item Cross DU, with a cardinality of C:CN, which is a service confirmation item for which an invoice item was created; and Service Order Item, from the business object Service Order/node Item Cross DU, with a cardinality of C:CN, which is a service order item for which an invoice item was created.

The following specialization associations for navigation may exist: Root, to the node Customer Invoice, with a target cardinality of 1; and Parent, to the node Item, with a target cardinality of 1. In some implementations, for a Reference element, ItemID is specified in GDT: BusinessTransactionDocumentReference except for an ItemPurchaseOrderReference. The following documents can occur in the references and can be implemented as disjoint specializations: Customer Invoice, Sales Order, Service Order, Service Confirmation, Outbound Delivery, Customer Return, Customer Project Invoice Requisition, Purchase Order, and Customer Invoice Request.

Item Delivery Terms are agreements that apply for delivery of invoiced goods on an item. The elements located directly at the node Item Delivery Terms are defined by the inline structure: APCI_S_CII_DELIVERY_TERMS_EL. These elements include Incoterms, which are conventional contract formulations for delivery terms, and may be based on datatype GDT: Incoterms. The following specialization associations for navigation may exist: Root, to the node Customer Invoice, with a target cardinality of 1; and Parent, to the node Item, with a target cardinality of 1.

Item Location is a physical or logical location that is involved in an Item of a Customer Invoice in a LocationRole. A physical place can be determined using spatial coordinates, for example an address including a street and house number. In some implementations, a logical place cannot be determined using spatial coordinates, and can be, for example a PO box or an email address. It is not necessary to know a physical location of a logical location. Item Location is either a reference to a business object Location or a reference to an address of a Transformed Object Party representative of a business partner and an organizational unit, or a reference to an address of a business object Installation Point. Item Location can occur in the following specializations: ShipFromItemLocation, which is an Item Location from which goods were/will be delivered; ShipToItemLocation, which is an Item Location to which goods were/will be delivered; and ServicePointItemLocation, which is an Item Location where a service has been or will be performed. The elements located directly at the node Item Location are defined by the inline structure: APCI_S_CI_ITEM_LOCATION_EL. These elements include: RoleCode, RoleCategoryCode, AddressReference, LocationUUID, and LocationID. LocationID is a unique identifier for a location, and may be based on datatype GDT: LocationID. LocationUUID is a universally unique identifier for referencing a business object Location, and may be based on datatype GDT: UUID. AddressReference is a reference to an address of an ItemLocation, and may be based on datatype BOIDT: ObjectNodeLocationAddressReference. AddressReference can include AddressReference/AddressHostUUID, AddressReference/AddressHostTypeCode, AddressReference/BusinessObjectTypeCode, AddressReference/InstallationPointID, and AddressReference/PartyKey. AddressReference/AddressHostUUID is a universally unique identifier for an address of a business partner, an organizational unit or associated specializations, a business object InstalledBase, or a business object InstallationPoint, and may be based on datatype GDT: UUID. AddressReference/AddressHostTypeCode may be optional, is a coded representation of an address host type of an address referenced by an AddressUUID or an address included using a Location Address composition, and may be based on datatype GDT: AddressHostTypeCode. AddressReference/BusinessObjectTypeCode may be optional, is a coded representation of a type of a business object in which an address referenced in a LocationAddressUUID is integrated as a dependent object, and may be based on datatype GDT: BusinessObjectTypeCode. AddressReference/InstallationPointID is an identifier for an installation point that references an address using an AddressUUID, and may be based on datatype GDT: InstallationPointID. AddressReference/PartyKey is an alternative identifier of a party that represents a business partner or an organizational unit that references an address using an AddressUUID, and may be based on datatype KDT: PartyKey. AddressReference/PartyKey can include AddressReference/PartyKey/PartyTypeCode, which is a coded representation of a type of party, and may be based on datatype GDT: Business ObjectTypeCode. AddressReference/PartyKey can include AddressReference/PartyKey/PartyID, which is an identifier for a party, and may be based on datatype GDT: PartyID. RoleCode may be optional, is a coded representation of a location role, and may be based on datatype GDT: LocationRoleCode. RoleCategoryCode is a coded representation of a grouping of location roles by process-controlling criteria, and may be based on datatype GDT: LocationRoleCategoryCode.

The following inbound aggregation relationships may exist: Address Snapshot, from the business object Address Snapshot/node Root, with a cardinality of C:CN; InstallationPointAddressInformation, from the business object Installation Point/node Address Information, with a cardinality of C:CN, which is address information of an installation point corresponding to an ItemLocation; Location, from the business object Location/node Location, with a cardinality of C:CN, which is a location from which or to which invoiced goods were/will be delivered; and PartyAddressInformation, from the business object Party/node Address Information, with a cardinality of C:CN, which is address information of a representative of a business partner or organizational centre corresponding to an ItemLocation.

The following specialization associations for navigation may exist: Root, to the node Customer Invoice, with a target cardinality of 1; Parent, to the node Item, with a target cardinality of 1; and Used Address, to the business object Used Address/node Used Address, with a target cardinality of C, which is a master data or document specific address used for an Item Location. In some implementations, it is possible to determine which type of address applies by means of an AddressHostTypeCode element. The instance of the TO Used Address represents the address. In a first case, the node ID of a node in a master data object is determined via the BusinessObjectTypeCode, AddressHostUUID and AddressHostTypeCode elements. If changes to the TO Used Address take place, the master data address is copied by the TO Used Address, the changes can take place in the copy, and a corresponding DO Address can be created at an Item Location via an Item Location Address composition relationship. In a second case, the TO Used Address represents the DO Address used at an Item Location via an Item Location Address composition relationship. In some implementations, if an aggregation relationship to a business object Location exists, the LocationID element is filled with the ID of the business object Location and element PartyID remains empty. In some implementations, if an aggregation relationship to an address of a party representative of a business partner or OrganizationalCentre exists, the PartyID attribute is filled with the ID of the party and LocationID and InstallationPointID remain empty. In some implementations, if there is an aggregation relationship to an address of an Installation Point, the InstallationPointID attribute is filled with the ID of the Installation Point and LocationID and PartyID remain empty.

An Item Party is a natural or legal person, organization, organizational unit or group that is involved in an invoice item. A PartyRole specifies which rights and obligations the Party has regarding the Customer Invoice and corresponding processes. An Item Party may keep a reference to a business partner or one of its specializations, for example, Customer, Supplier, or Employee. An Item Party may keep a reference to one of the following specializations of an organizational unit: Company, CostCentre, Reporting Line Unit, or Functional Unit.

An Item Party can occur in the following specializations: ProductRecipientItemParty, which is a party Customer to which a good is delivered or a service provided; VendorItemParty, which is a party Company or Supplier that delivers a good or that provides a service; SalesEmployeeItemParty, which is a party Employee that is responsible for an underlying business transaction document invoiced by a Customer Invoice item; SalesUnitItemParty, which is a party Functional Unit that acts as a sales unit for an underlying business transaction document invoiced by a Customer Invoice item.

The elements located directly at the node Item Party are defined by the inline structure: APCI_S_CI_ITEM_PARTY_ELEMENTS. These elements include: PartyKey, PartyUUID, RoleCategoryCode, RoleCode, AddressReference, and MainIndicator. PartyKey is a unique identifier of a Party, and may be based on datatype KDT: PartyKey. PartyKey may include PartyKey/PartyTypeCode, which is a coded representation of a type of party, and may be based on datatype GDT: BusinessObjectTypeCode. PartyKey may include PartyKey/PartyID, which is an identifier for a party, and may be based on datatype GDT: PartyID. PartyUUID is a universally unique identifier for referencing a business partner or organizational unit, and may be based on datatype GDT: UUID. RoleCategoryCode is a coded representation of a grouping of partner roles by process-controlling criteria, and may be based on datatype GDT: PartyRoleCategoryCode. RoleCode is a coded representation of a partner role, and may be based on datatype GDT: PartyRoleCode. AddressReference is a reference to an address of an ItemParty, and may be based on datatype GDT: PartyAddressReference. MainIndicator indicates whether a Party has a predominant position towards other parties of a same role, and may be based on datatype GDT: Indicator, with a qualifier of Main. The following inbound aggregation relationship may exist: Address Snapshot, from the business object Address Snapshot/node Root, with a cardinality of C:CN; Party, from the business object Party/node Party, with a cardinality of C:CN, which is a customer involved in sales and service processes that caused an invoice to be issued or a supplier involved in sales and service processes that are billed for in a Customer Invoice. The following specialization associations for navigation may exist: Root, to the node Customer Invoice, with a target cardinality of 1; Parent, to the node Item, with a target cardinality of 1; and Used Address, to the business object Used Address/node Used Address, with a target cardinality of C, which is a master data or document specific address used for an Item Party. In some implementations, it is possible to determine which of two types of addresses apply by means of an AddressHostTypeCode element. An instance of the TO Used Address can represent an address. In a first case, the node ID of a node in a master data object can be determined via PartyTypeCode, AddressHostUUID and AddressHostTypeCode elements. If changes to the TO Used Address take place, a master data address can be copied by the TO Used Address, the changes can take place to the copy, and a corresponding DO Address can be created at an ItemParty via an Item Party Address composition relationship. In a second case, the TO UsedAddress represents the DO Address used at an Item Party via an Item Party Address composition relationship.

In some implementations, BusinessObjectTypeCode refers to one of the business objects for which Inbound Aggregation Relationships to node ItemParty exist. In some implementations, if a PartyUUID is specified, a PartyTypeCode is also present. In some implementations, There is at most one Party with MainIndicator ‘true’ per distinct value of element RoleCode.

Item Pricing Terms are agreements in a sales or service process on which an invoice item is based and which are used to determine an invoice item value. The elements located directly at the node Item Pricing Terms are defined by the inline structure: APCI_S_CII_PRICING_TERMS_EL. These elements include PriceDateTime and ProvisionDate. PriceDateTime is a date and time used to determine price components for an item of a Customer Invoice, and may be based on datatype GDT: LOCALNORMALISED_DateTime, with a qualifier of Price. ProvisionDate may be optional, is a pricing and taxation relevant date when goods have been delivered or services provided, and may be based on datatype GDT: Date, with a qualifier of Provision. The following specialization associations for navigation may exist: Root, to the node Customer Invoice, with a target cardinality of 1; and Parent, to the node Item, with a target cardinality of 1.

Item Product is an identification, description, and classification of a product or service that is invoiced. The elements located directly at the node Item Product are defined by the inline structure: APCI_S_CI_ITEM_PRODUCT_EL. These elements include: ProductKey, ProductBuyerID, CashDiscountDeductibleIndicator, and ProductUUID. ProductKey is an identification of a product, and may be based on datatype KDT: ProductUnformattedKey. ProductKey may include ProductKey/ProductTypeCode, which is a coded representation of a product type, such as material or service, and may be based on datatype GDT: ProductTypeCode. ProductKey may include ProductKey/ProductidentifierTypeCode, which is a coded representation of a product identifier type, and may be based on datatype GDT: ProductidentifierTypeCode. ProductKey may include ProductKey/ProductID, which is an identifier for a product, and may be based on datatype GDT: NOCONVERSION_ProductID. ProductBuyerID may be optional, is an identifier of a product assigned by a buyer, and may be based on datatype GDT: ProductPartyID. CashDiscountDeductibleIndicator is an indicator that a cash discount may be deducted for as product, and may be based on datatype GDT: Indicator, with a qualifier of CashDiscountDeductible. ProductUUID is a universally unique identification of a product, and may be based on datatype GDT: UUID.

The following inbound aggregation relationship may exist: Entitlement Product, from the business object Entitlement Product/node Entitlement Product, with a cardinality of C:CN, which is an invoiced entitlement product; Entitlement Product_V1, from the business object Entitlement Product/node Entitlement Product, with a cardinality of C:CN, which is an invoiced entitlement product; Individual Material, from the business object Individual Material/node Individual Material, with a cardinality of C:CN, which is an invoiced individual material; Individual Product, from the business object IndividualProduct/node Root, with a cardinality of C:CN, which is an invoiced individual product; Material, from the business object Material/node Material, with a cardinality of C:CN, which is an invoiced material; Material_V1, from the business object Material/node Material, with a cardinality of C:CN, which is an invoiced material; Service Product, from the business object Service Product/node Service Product, with a cardinality of C:CN, which is an invoiced service product; and Service Product_V1, from the business object Service Product/node Service Product, with a cardinality of C:CN, which is an invoiced service product. The following specialization associations for navigation may exist: Root, to the node Customer Invoice, with a target cardinality of 1, and Parent, to the node Item, with a target cardinality of 1. In some implementations, either ProductBuyerID or ProductUUID is specified.

Item Sales And Service Business Area is a business or service specific area within an enterprise that is valid for an underlying sales or service business transaction document invoiced by an Item, such as sales organization, service organization, or distribution channel. The elements located directly at the node Item Sales And Service Business Area are defined by the inline structure: APCI_S_CI_ITEM_SAL_SRV_BA_EL. These elements include: SalesOrganisationID, DistributionChannelCode, ServiceOrganisationID, SalesOrganisationUUID, and ServiceOrganisationUUID. SalesOrganisationID may be optional, is an identifier for a sales organization that is responsible for an invoiced business transaction document, and may be based on datatype GDT: OrganisationalCentreID. DistributionChannelCode is a coded representation of a distribution channel by which goods and services reach customers, and may be based on datatype GDT: DistributionChannelCode. ServiceOrganisationID may be optional, is an identifier for a service organization that is responsible for an invoiced business transaction document, and may be based on datatype GDT: OrganisationalCentreID. SalesOrganisationUUID is a universally unique identifier for a sales organization, and may be based on datatype GDT: UUID. ServiceOrganisationUUID is a universally unique identifier for a service organization, and may be based on datatype GDT: UUID. The following inbound aggregation relationship may exist: Sales Organisation, from the business object Functional Unit/node Organisational Centre, with a cardinality of C:CN, which is a functional Unit in the specialization Sales Organisation; and Service Organisation, from the business object Functional Unit/node Organisational Centre, with a cardinality of C:CN, which is a functional Unit in the specialization Service Organisation. The following specialization associations for navigation may exist: Root, to the node Customer Invoice, with a target cardinality of 1; and Parent, to the node Item, with a target cardinality of 1.

Overview Query Response Transformation Node is a general view on a Customer Invoice providing essential information of a Customer Invoice at a first glance. The elements located directly at the node Overview are defined by the data type CustomerInvoiceOverviewElements. These elements include: CustomerInvoiceUUID, CustomerInvoiceID, CustomerInvoiceProcessingTypeCode, Date, CancellationDocumentIndicator, TotalNetAmount, TotalGrossAmount, TotalTaxAmount, Incoterms, CashDiscountTermsCode, PaymentFormCode, ReferenceBusinessTransactionDocumentID, OriginCustomerInvoiceUUID, OriginCustomerInvoiceID, BuyerPartyKey, BuyerPartyUUID, BuyerPartyFormattedName, SellerPartyKey, SellerPartyUUID, SellerPartyFormattedName, SellerRegistrationCountryCode, PayerPartyKey, PayerPartyUUID, PayerPartyFormattedName, BillToPartyKey, BillToPartyUUID, BillToPartyFormattedName, BillFromPartyKey, BillFromPartyUUID, BillFromPartyFormattedName, LastChangeDateTime, CustomerInvoicingRunExecutionUUID, and CustomerInvoiceStatus.

CustomerInvoiceUUID is an internally assigned universally unique identifier of a Customer Invoice, and may be based on datatype GDT: UUID. CustomerInvoiceID is an identifier of a Customer Invoice assigned by a BillFromParty, and may be based on datatype GDT: BusinessTransactionDocumentID. CustomerInvoiceProcessingTypeCode is a processing type of a Customer Invoice that controls the behavior within in a process component, and may be based on datatype GDT: BusinessTransactionDocumentProcessingTypeCode. Date is an issue date of a Customer Invoice, and may be based on datatype GDT: Date. CancellationDocumentIndicator indicates whether an invoice is a cancellation invoice, and may be based on datatype GDT: Indicator, with a qualifier of CancellationDocument. TotalNetAmount is a net value of a Customer Invoice, and may be based on datatype GDT: Amount, with a qualifier of Net. TotalGrossAmount is a gross value of a Customer Invoice, and may be based on datatype GDT: Amount, with a qualifier of Gross. TotalTaxAmount is a total of tax values allotted to an invoice, and may be based on datatype GDT: Amount, with a qualifier of Tax. Incoterms is a conventional contract formulations for delivery terms, and may be based on datatype GDT: Incoterms. CashDiscountTermsCode are cash discount terms that apply to a Customer Invoice, and may be based on datatype GDT: CashDiscountTermsCode. PaymentFormCode may be optional, is a payment form, and may be based on datatype GDT: PaymentFormCode. ReferenceBusinessTransactionDocumentID may be optional, and may be based on datatype GDT: BusinessTransactionDocumentID. OriginCustomerInvoiceUUID is a universally unique identifier of a Customer Invoice that is reversed, credited or corrected by an invoice, and may be based on datatype GDT: UUID. OriginCustomerInvoiceID is an identifier of a Customer Invoice that is reversed, credited or corrected by an invoice, and may be based on datatype GDT: BusinessTransactionDocumentID. BuyerPartyKey is a unique identification of a party that acts as a buyer party in a Customer Invoice, and may be based on datatype KDT: PartyKey. BuyerPartyKey may include BuyerPartyKey/PartyTypeCode, which is a coded representation of a type of party, and may be based on datatype GDT: BusinessObjectTypeCode. BuyerPartyKey may include BuyerPartyKey/PartyID, which is an identifier for a party, and may be based on datatype GDT: PartyID. BuyerPartyUUID is a universally unique identification of a party that acts as a buyer party in a Customer Invoice, and may be based on datatype GDT: UUID. BuyerPartyFormattedName may be optional, is a formatted name of a party that acts as a buyer party in a Customer Invoice, and may be based on datatype GDT: LANGUAGEINDEPENDENT_LONG_Name, with a qualifier of Formatted. SellerPartyKey is a unique identification of a party that acts as a seller party in a Customer Invoice, and may be based on datatype KDT: PartyKey.

SellerPartyKey may include SellerPartyKey/PartyTypeCode, which is a coded representation of a type of party, and may be based on datatype GDT: BusinessObjectTypeCode. SellerPartyKey may include SellerPartyKey/PartyID, which is an identifier for a party, and may be based on datatype GDT: PartyID. SellerPartyUUID is a universally unique identification of a party that acts as a seller party in a Customer Invoice, and may be based on datatype GDT: UUID. SellerPartyFormattedName may be optional, is a formatted name of a party that acts as a seller party in a Customer Invoice, and may be based on datatype GDT: LANGUAGEINDEPENDENT_LONG_Name, with a qualifier of Formatted. SellerRegistrationCountryCode may be optional, and may be based on datatype GDT: CountryCode. PayerPartyKey is a unique identification of a party that acts as a payer party in a Customer Invoice, and may be based on datatype KDT: PartyKey. PayerPartyKey may include PayerPartyKey/PartyTypeCode, which is a coded representation of a type of party, and may be based on datatype GDT: BusinessObjectTypeCode. PayerPartyKey may include PayerPartyKey/PartyID, which is an identifier for a party, and may be based on datatype GDT: PartyID. PayerPartyUUID is a universally unique identification of a party that acts as a payer party in a Customer Invoice, and may be based on datatype GDT: UUID. PayerPartyFormattedName may be optional, is a formatted name of a party that acts as a payer party in a Customer Invoice, and may be based on datatype GDT: LANGUAGEINDEPENDENT_LONG_Name, with a qualifier of Formatted. BillToPartyKey is a unique identification of a party that acts as a bill-to party in a Customer Invoice, and may be based on datatype KDT: PartyKey. BillToPartyKey may include BillToPartyKey/PartyTypeCode, which is a coded representation of a type of party, and may be based on datatype GDT: BusinessObjectTypeCode. BillToPartyKey may include BillToPartyKey/PartyID, which is an identifier for a party, and may be based on datatype GDT: PartyID. BillToPartyUUID is a universally unique identification of a party that acts as a bill-to party in a Customer Invoice, and may be based on datatype GDT: UUID. BillToPartyFormattedName may be optional, is a formatted name of a party that acts as a bill-to party in a Customer Invoice, and may be based on datatype GDT: LANGUAGEINDEPENDENT_LONG_Name, with a qualifier of Formatted. BillFromPartyKey is a unique identification of a party that acts as a bill-from party in a Customer Invoice, and may be based on datatype KDT: PartyKey. BillFromPartyKey may include BillFromPartyKey/PartyTypeCode, which is a coded representation of a type of party, and may be based on datatype GDT: BusinessObjectTypeCode. BillFromPartyKey may include BillFromPartyKey/PartyID, which is an identifier for a party, and may be based on datatype GDT: PartyID. BillFromPartyUUID is a universally unique identification of a party that acts as a bill-from party in a Customer Invoice, and may be based on datatype GDT: UUID. BillFromPartyFormattedName may be optional, is a formatted name of a party that acts as a bill-from party in a Customer Invoice, and may be based on datatype GDT: LANGUAGEINDEPENDENT_LONG_Name, with a qualifier of Formatted. LastChangeDateTime is a time date and time stamp of a last change of a Customer Invoice, and may be based on datatype GDT: GLOBAL_DateTime, with a qualifier of Change. CustomerInvoicingRunExecutionUUID is a universally unique identifier of an execution of a Customer Invoicing Run that created a Customer Invoice, and may be based on datatype GDT: UUID. CustomerInvoiceStatus is a current step in a life cycle of a Customer Invoice, and may be based on datatype BOIDT: CustomerInvoiceStatus.

CustomerInvoiceStatus can include CustomerInvoiceStatus/ConsistencyStatusCode, CustomerInvoice Status/ItemListConsistencyStatusCode, CustomerInvoiceStatus/ReleaseStatusCode, CustomerInvoiceStatus/CorrectionProcessingStatusCode, CustomerInvoiceStatus/DueItemClearingStatusCode, CustomerInvoice Status/InvoicingClearingStatusCode, and CustomerInvoice Status/LegalApprovalStatusCode. CustomerInvoiceStatus/ConsistencyStatusCode is a coded representation of a description whether a node Customer Invoice and all associated nodes, except Item, are consistent, and may be based on datatype GDT: INCONSISTENTCONSISTENT_ConsistencyStatusCode. CustomerInvoiceStatus/ItemListConsistencyStatusCode is coded representation of an aggregated status of a consistency status of items of a Customer Invoice, and may be based on datatype GDT: INCONSISTENTCONSISTENT_ConsistencyStatusCode. CustomerInvoiceStatus/ReleaseStatusCode is a coded representation of a status of a release of a customer invoice that can control possible activities and notifications to subsequent business processes, and may be based on datatype GDT: ReleaseStatusCode. CustomerInvoiceStatus/CorrectionProcessingStatusCode is a coded representation of a status of a correction process of a customer invoice that can control notifications of a subsequent business process, and may be based on datatype GDT: NOTSTARTEDINPROCESSFINISHED_ProcessingStatusCode, with a qualifier of Correction. CustomerInvoiceStatus/DueItemClearingStatusCode is a coded representation of a status of a clearing process of a customer invoice in the process component due item processing, and may be based on datatype GDT: ClearingStatusCode, with a qualifier of DueItem. The clearing process can be performed in the process component Due Item Processing. If, for the Customer Invoice, the Due Item Clearing is relevant, the notification can be performed with a message from Due Item Processing. CustomerInvoiceStatus/InvoicingClearingStatusCode is a coded representation of a status of a clearing process of a customer invoice, and may be based on datatype GDT: ClearingStatusCode, with a qualifier of Invoicing. CustomerInvoiceStatus/LegalApprovalStatusCode may be optional, is a coded representation of a status for a legal approval of a customer invoice, and may be based on datatype GDT: ApprovalStatusCode. The following specialization associations for navigation may exist to the node Customer Invoice: Parent, with a target cardinality of 1; and Root, with a target cardinality of 1.

A Query By Elements query returns Overview information for Customer Invoices which include values in particular elements of the respective Customer Invoice nodes that correspond to query elements. The query elements are defined by the data type CustomerInvoiceOverviewElementsQueryElements. These elements include: CustomerInvoiceID, CustomerInvoiceProcessingTypeCode, Date, CancellationDocumentIndicator, PartySellerPartyKey, PartyBuyerPartyKey, PartyBillToPartyKey, PartyBillFromPartyKey, PartyPayerPartyKey, PartyPartyKey, PartyName, PartyAdditionalName, PartySortingFormattedName, SellerRegistrationCountryCode, ReferenceBusinessTransactionDocumentID, ItemAccountingCodingBlockDistributionProjectTaskKey, ItemAccountingCodingBlockDistributionProjectID, ItemAccountingCodingBlockDistributionTypeCode, ItemCustomerInvoiceRequestName, ItemDescription, ProductKey, ProductBuyerID, ProductUUID, LastChangeDateTime, ItemBusinessTransactionDocumentReference, ReleaseStatusCode, ConsistencyStatusCode, ItemListConsistencyStatusCode, CorrectionProcessingStatusCode, DueItemClearingStatusCode, InvoicingClearingStatusCode, LegalApprovalStatusCode, and SearchText.

CustomerInvoiceID may be based on datatype GDT: BusinessTransactionDocumentID. CustomerInvoiceProcessingTypeCode may be based on datatype GDT: BusinessTransactionDocumentProcessingTypeCode. Date may be based on datatype GDT: Date. CancellationDocumentIndicator may be based on datatype GDT: Indicator, with a qualifier of CancellationDocument. PartySellerPartyKey may be based on datatype KDT: PartyKey. PartySellerPartyKey may include PartySellerPartyKey/PartyID, which is an identifier for a party, and may be based on datatype GDT: PartyID. PartyBuyerPartyKey may be based on datatype KDT: PartyKey and may include PartyBuyerPartyKey/PartyID, which is an identifier for a party and may be based on datatype GDT: PartyID. PartyBillToPartyKey may be based on datatype KDT: PartyKey and may include PartyBillToPartyKey/PartyID, which is an identifier for a party which may be based on datatype GDT: PartyID. PartyBillFromPartyKey may be based on datatype KDT: PartyKey and may include PartyBillFromPartyKey/PartyID, which is an identifier for a party which may be based on datatype GDT: PartyID. PartyPayerPartyKey may be based on datatype KDT: PartyKey and may include PartyPayerPartyKey/PartyID, which is an identifier for a party which may be based on datatype GDT: PartyID. PartyPartyKey may be based on datatype KDT: PartyKey and may include PartyPartyKey/PartyID, which is an identifier for a party which may be based on datatype GDT: PartyID. PartyName may be based on datatype GDT: MEDIUM_Name, with a qualifier of Party. PartyAdditionalName may be based on datatype GDT: LANGUAGEINDEPENDENT_MEDIUM_Name, with a qualifier of PartyAdditional. PartySortingFormattedName may be based on datatype GDT: LONG_Name. SellerRegistrationCountryCode may be based on datatype GDT: CountryCode. ReferenceBusinessTransactionDocumentID may be based on datatype GDT: BusinessTransactionDocumentID.

ItemAccountingCodingBlockDistributionProjectTaskKey is a Project Task Key as part of an assignment node of an attached Accounting Coding Block Distribution of an item, and may be based on datatype KDT: ProjectTaskKey. ItemAccountingCodingBlockDistributionProjectTaskKey may include ItemAccountingCodingBlockDistributionProjectTaskKey/TaskID, which is an identifier of a project task which may be based on datatype GDT: ProjectElementID. ItemAccountingCodingBlockDistributionProjectID may be based on datatype GDT: ProjectID. ItemAccountingCodingBlockDistributionCostObjectKey may be based on datatype KDT: FinaneialAccountingViewOfCostObjectKey. ItemAccountingCodingBlockDistributionCostObjectKey/CostObjectTypeCode is a type of a cost object, and may be based on datatype GDT: CostObjectTypeCode. ItemAccountingCodingBlockDistributionCostObjectKey may include ItemAccountingCodingBlockDistributionCostObjectKey/CostObjectID, which may be based on datatype GDT: FinancialAccountingViewOfCostObjectID. ItemAccountingCodingBlockDistributionTypeCode may be based on datatype GDT: AccountingCodingBlockTypeCode. ItemCustomerInvoiceRequestName may be based on datatype GDT: LANGUAGEINDEPENDENT_MEDIUM_Name, with a qualifier of CustomerInvoiceRequest. ItemDescription may be based on datatype GDT: SHORT_Description. ProductKey may be based on datatype KDT: ProductUnformattedKey. ProductKey/ProductTypeCode is a coded representation of a product type, such as material or service, and may be based on datatype GDT: ProductTypeCode. ProductKey may include ProductKey/ProductidentifierTypeCode, which is a coded representation of a product identifier type, and may be based on datatype GDT: ProductidentifierTypeCode. ProductKey may include ProductKey/ProductID, which is an identifier for a product, and may be based on datatype GDT: NOCONVERSION_ProductID. ProductBuyerID may be based on datatype GDT: ProductPartyID. ProductUUID may be based on datatype GDT: UUID. LastChangeDateTime is a time date and time stamp of a last change of a Customer Invoice, and may be based on datatype GDT: GLOBAL_DateTime, with a qualifier of Change. ItemBusinessTransactionDocumentReference may be based on datatype GDT: BusinessTransactionDocumentReference. ReleaseStatusCode may be based on datatype GDT: ReleaseStatusCode. ConsistencyStatusCode may be based on datatype GDT: INCONSISTENTCONSISTENT_ConsistencyStatusCode. ItemListConsistencyStatusCode may be based on datatype GDT: INCONSISTENTCONSISTENT_ConsistencyStatusCode. CorrectionProcessingStatusCode is a status of a correction process of a Customer Invoice that controls notifications of a subsequent business process, and may be based on datatype GDT: NOTSTARTEDINPROCESSFINISHED_ProcessingStatusCode.

DueItemClearingStatusCode is a status of a clearing process of a Customer Invoice in the process component due item processing, and may be based on datatype GDT: ClearingStatusCode. InvoicingClearingStatusCode is a status of a clearing process of a Customer Invoice in invoicing, and may be based on datatype GDT: ClearingStatusCode. LegalApprovalStatusCode may be based on datatype GDT: ApprovalStatusCode. SearchText is free text including one or several word search terms to search for Overview information of a Customer Invoice, and may be based on datatype GDT: SearchText. For a query that includes SearchText as a query parameter, an application-specific subset of the other query parameters can be defined. The query result can be calculated in the following manner: the search terms can be assigned to the subset of query parameters in such a way that every search term is used exactly once in the assignment; several search terms may be assigned to the same query parameter; for each of these assignments a query result can be calculated; and a total result can be a union of the results calculated per assignment.

A Party is a natural or legal person, organization, organizational unit or group that is involved in a Customer Invoice in a PartyRole. A PartyRole specifies which rights and obligations a Party has regarding a Customer Invoice and processes that belong to the Customer Invoice. A Party may keep a reference to a business partner or one of its specializations for example, Customer, Supplier, or Employee, and may keep a reference to one of the following specializations of an organizational unit: Company, CostCentre, Reporting Line Unit, or Functional Unit. A Party can occur in the following specializations: BillToParty, which is a party Customer that receives an invoice for goods or services; BillFromParty, which is a party Company that carried out a billing process; PayerParty, which is a party Customer that is requested to pay one or more payables from delivery of goods or provision of services or that is a recipient of a credit memo; BuyerParty, which is a party Customer that purchases a good or service; SellerParty, which is a party Company that sells a good or service; and TaxReportingUnitParty, which is a party Functional Unit that acts as a permanent establishment of a company which is responsible for tax reporting to a respective tax authority. In some implementations, if BillFromParty is not specified then SellerParty can be used as a default. In some implementations, if BillToParty and/or PayerParty are not specified then BuyerParty can be used as a default.

The elements located directly at the node Party are defined by the inline structure: APCI_S_CI_PARTY_ELEMENTS. These elements include: PartyKey, PartyUUID, RoleCategoryCode, RoleCode, AddressReference, and MainIndicator. PartyKey is a unique identifier of a Party, and may be based on datatype KDT: PartyKey. PartyKey can include PartyKey/PartyTypeCode, which is a coded representation of a type of party and may be based on datatype GDT: BusinessObjectTypeCode. PartyKey can include PartyKey/PartyID, which is an identifier for a party, and may be based on datatype GDT: PartyID. PartyUUID is a universally unique identifier for referencing a business partner or organizational unit, and may be based on datatype GDT: UUID. RoleCategoryCode is a coded representation of a grouping of partner roles by process-controlling criteria, and may be based on datatype GDT: PartyRoleCategoryCode. RoleCode is a coded representation of a partner role, and may be based on datatype GDT: PartyRoleCode. AddressReference is a reference to an address of a Party, and may be based on datatype GDT: PartyAddressReference. MainIndicator indicates whether a Party has a predominant position towards other parties of a same role, and may be based on datatype GDT: Indicator, with a qualifier of Main.

The following inbound aggregation relationships may exist: Address Snapshot, from the business object Address Snapshot/node Root, with a cardinality of C:CN; Party, from the business object Party/node Party, with a cardinality of C:CN, which is a Customer to whom an invoice is sent who is requested to pay for goods and services invoiced or is otherwise involved in one or more sales and service processes that caused the invoice to be issued, or is a Company for which receivables or liabilities described in the invoice arose or which is responsible for an invoicing process. The following specialization associations for navigation may exist: Parent, to the node Customer Invoice, with a target cardinality of 1; Root, to the node Customer Invoice, with a target cardinality of 1; and Used Address, to the business object Used Address/node Used Address, with a target cardinality of C, which is a master data or document specific address used for a Party. In some implementations, it can be possible to determine which of two types of addresses apply by means of the AddressHostTypeCode element. The instance of the TO Used Address represents an address. In a first case, the node ID of a node in a master data object can be determined via PartyTypeCode, AddressHostUUID and AddressHostTypeCode elements. If changes to the TO Used Address take place, the master data address can be copied by the TO Used Address, the changes can take place to the copy, and a corresponding DO Address can be created at the Party via a Party Address composition relationship. In a second case, the TO Used Address represents the DO Address used at the Party via the Party Address composition relationship. In some implementations, parties in the specializations BuyerParty and SellerParty are specified. In some implementations, PartyTypeCode refers to one of the business objects for which Inbound Aggregation Relationships to node Party exist. In some implementations, if the PartyUUID is specified, the PartyTypeCode is also present. In some implementations, there is at most one Party with MainIndicator ‘true’ per distinct value of element RoleCode.

Pricing Terms are agreements in a sales or service process on which an invoice is based, which are used to determine a net value of a Customer Invoice. The elements located directly at the node Pricing Terms are defined by the inline structure: APCI_S_CI_PRICING_TERMS_EL. These elements include: CurrencyCode, PriceDateTime, and PricingProcedureCode. CurrencyCode is a coded representation of a currency in which an invoice is issued (e.g., invoice currency), and may be based on datatype GDT: CurrencyCode. PriceDateTime is a date and time used to determine price components for a Customer Invoice, and may be based on datatype GDT: LOCALNORMALISED_DateTime, with a qualifier of Price. PricingProcedureCode is a coded representation of a procedure indicating how price components are to be calculated in a Customer Invoice, and may be based on datatype GDT: PricingProcedureCode. The following specialization associations for navigation may exist to the node Customer Invoice: Parent, with a target cardinality of 1; and Root, with a target cardinality of 1.

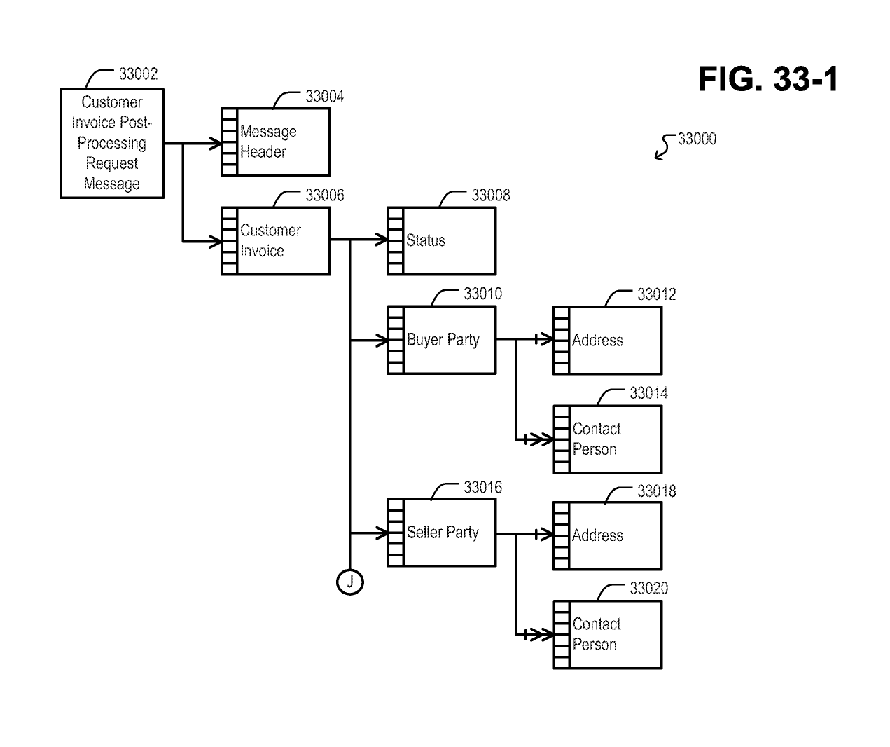

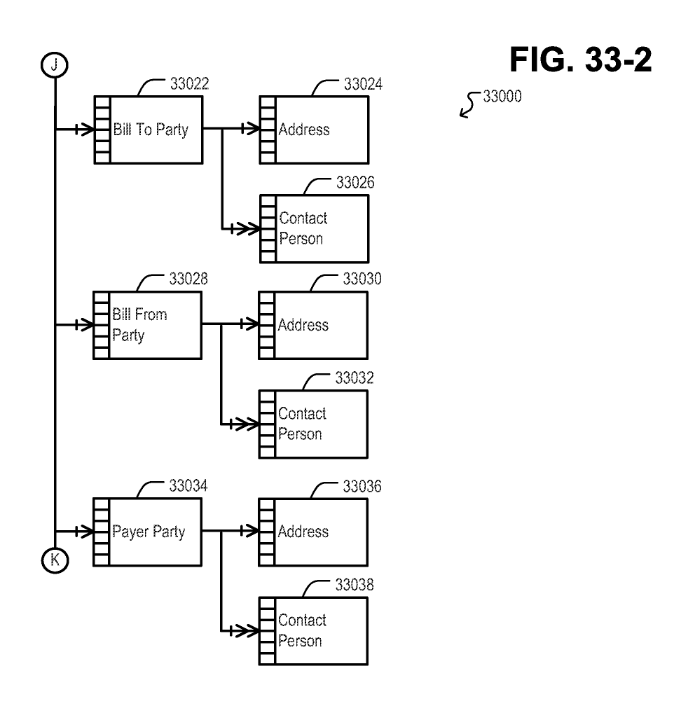

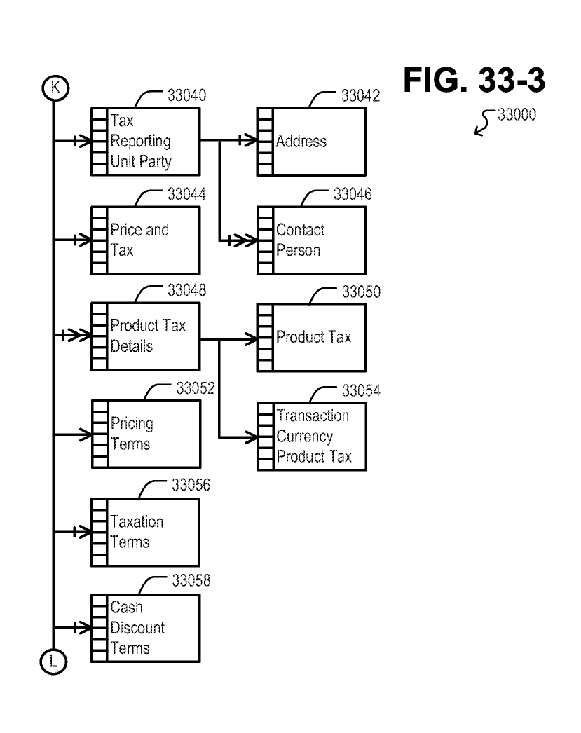

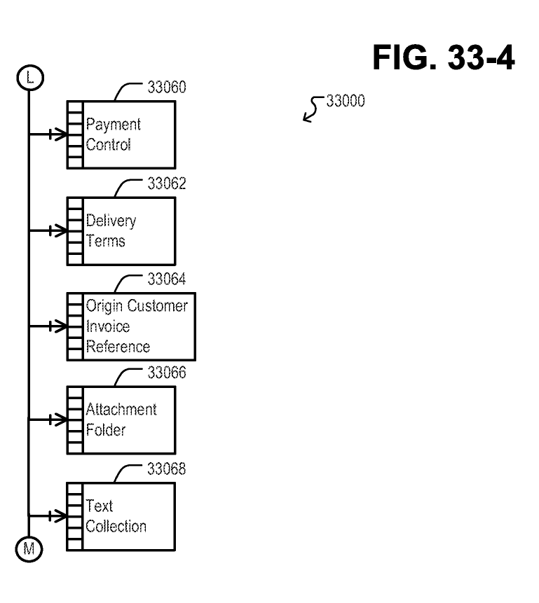

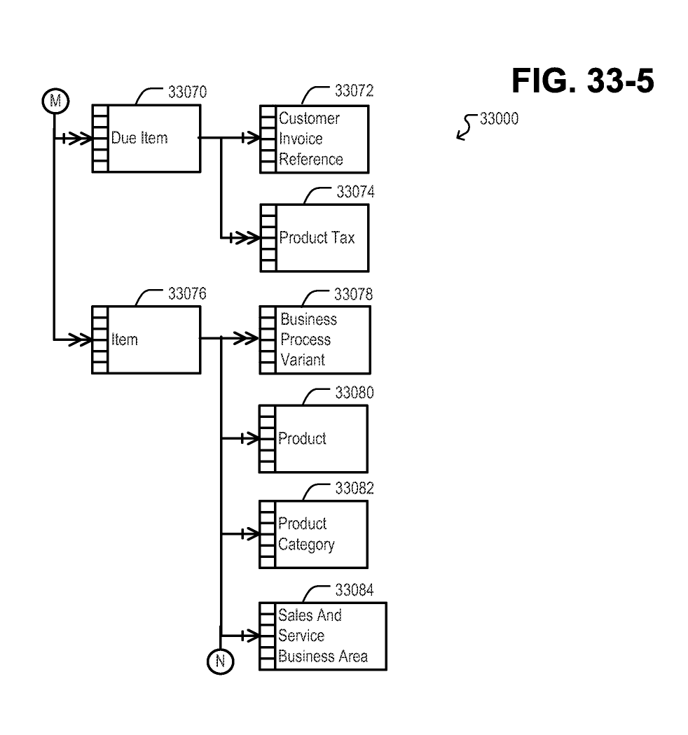

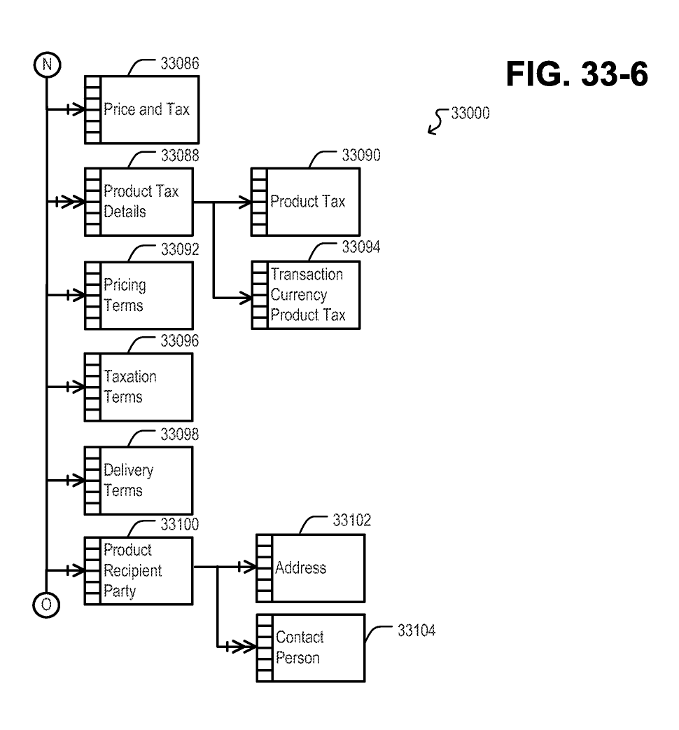

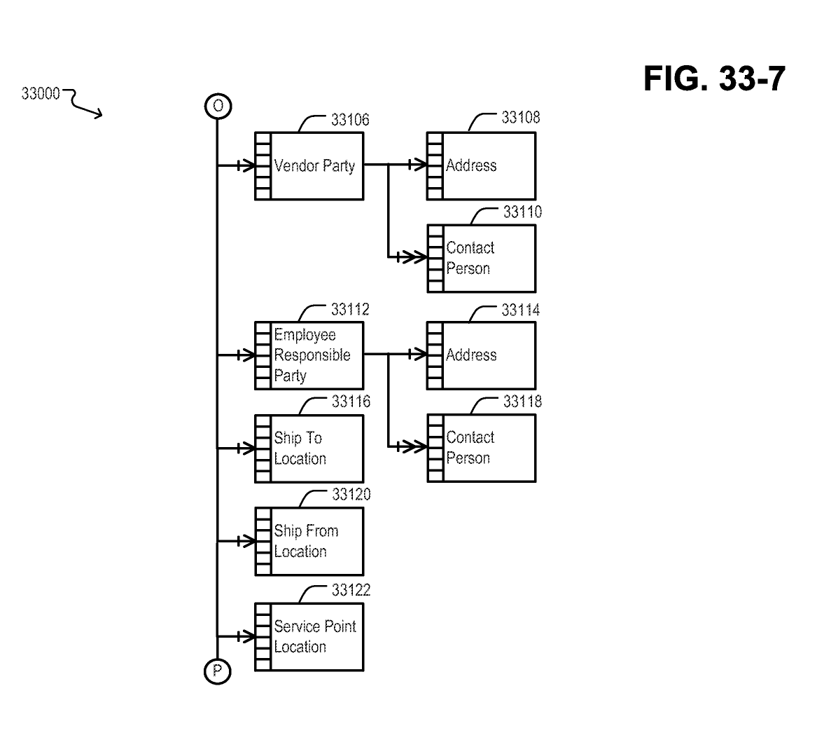

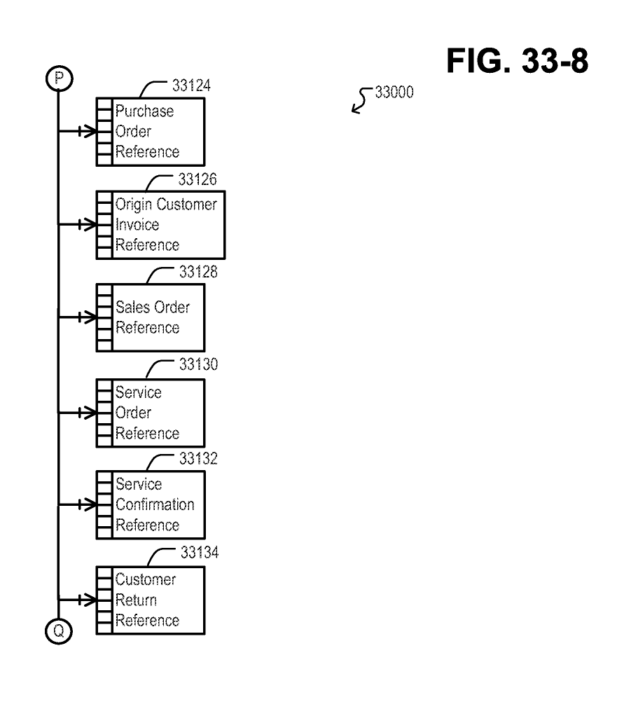

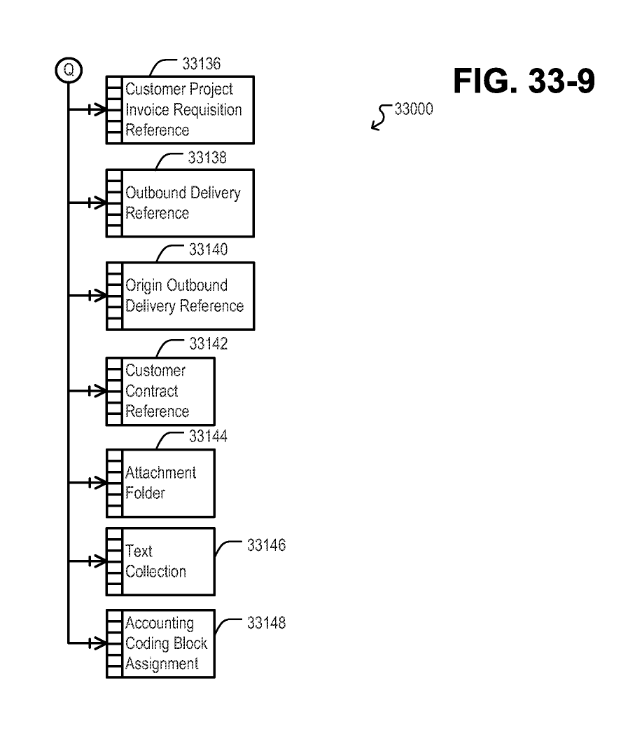

FIGS. 33-1 through 33-9 collectively illustrate one example logical configuration of a Customer Invoice Post-Processing Request message 33000. Specifically, these figures depict the arrangement and hierarchy of various components such as one or more levels of packages, entities, and data types, shown here as 33002 through 33148. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Invoice Post-Processing Request message 33000 includes, among other things, the Customer Invoice entity 33006. Accordingly, heterogeneous applications may communicate using this consistent message configured as such.

The message type Customer Invoice Post-Processing Request is derived from the business object Customer Invoice as a leading object together with its operation signature. The message type Customer Invoice Post-Processing Request is a request to post-process a customer invoice. The structure of the message type Customer Invoice Post-Processing Request is determined by the message data type CustomerInvoiceMessage. The message data type CustomerInvoiceMessage includes the MessageHeader package and the CustomerInvoice package. The package MessageHeader includes the sub-packages Party and Business Scope and the entity MessageHeader. MessageHeader is typed by datatype BusinessDocumentMessageHeader.

The package CustomerInvoice includes the sub-packages Status, Party, PriceInformation, PaymentInformation, DeliveryInformation, BusinessTransactionDocumentReference, Attachment, TextCollection, DueItem, and Item, and the entity CustomerInvoice. A CustomerInvoice is a binding statement of amounts receivables, receivables adjustments, and/or credit memos to a business partner specifying terms of delivery and payment. The receivables, receivables adjustments, and credit memos can be described in detail in items, where applicable with reference to goods or services. A CustomerInvoice root node can include identifying and administrative data. CustomerInvoice includes the following non-node elements: WatermarkName, ID, UUID, ProcessingTypeCode, ProcessingTypeName, TypeCode, TypeName, ReceivablesPayablesPropertyMovementDirectionCode, ReceivablesPayablesPropertyMovementDirectionName, Date, CreationDateTime, CancellationDocumentIndicator, CustomerInvoiceRequestName, and ReferenceBusinessTransactionDocumentID.

WatermarkName may have a multiplicity of 1, is a codename of a watermark, and may be based on datatype CDT:LANGUAGEINDEPENDENT_MEDIUM_Name. ID may have a multiplicity of 1, is a unique identifier of a business document CustomerInvoice, and may be based on datatype BGDT:BusinessTransactionDocumentID. UUID may have a multiplicity of 0 . . . 1, is a universally unique identifier of a CustomerInvoice, and may be based on datatype BGDT:UUID. ProcessingTypeCode may have a multiplicity of 1, is a processing type of a Customer Invoice which controls the behavior of a Customer Invoice within a process component, and may be based on datatype BGDT:BusinessTransactionDocumentProcessingTypeCode. ProcessingTypeName may have a multiplicity of 0 . . . 1, is a processing type of a Customer Invoice which controls the behavior of a Customer Invoice within a process component, and may be based on datatype CDT:Name. TypeCode may have a multiplicity of 1, is a coded representation of a type of a CustomerInvoice, and may be based on datatype BGDT:BusinessTransactionDocumentTypeCode. TypeName may have a multiplicity of 0 . . . 1, is a codename of a type of a CustomerInvoice, and may be based on datatype CDT:Name. ReceivablesPayablesPropertyMovementDirectionCode may have a multiplicity of 1, is a coded representation of whether a CustomerInvoice increases or decreases receivables, and may be based on datatype BGDT:PropertyMovementDirectionCode, with a qualifier of Receivables. ReceivablesPayablesPropertyMovementDirectionName may have a multiplicity of 0 . . . 1, is a codename indicating whether a CustomerInvoice increases or decreases receivables, and may be based on datatype CDT:Name. Date may have a multiplicity of 1, is an issue date of a CustomerInvoice, and may be based on datatype CDT:Date. CreationDateTime may have a multiplicity of 0 . . . 1 and may be based on datatype CDT:GLOBAL_DateTime. CancellationDocumentIndicator may have a multiplicity of 0 . . . 1, indicates whether a CustomerInvoice is a cancellation invoice, and may be based on datatype CDT:Indicator, with a qualifier of CancellationDocument. CustomerInvoiceRequestName may have a multiplicity of 0 . . . 1, is a user-defined name of a related Customer Invoice Request to search for in case of Manual Invoicing, and may be based on datatype CDT:LANGUAGEINDEPENDENT_MEDIUM_Name, with a qualifier of CustomerInvoiceRequest. ReferenceBusinessTransactionDocumentID may have a multiplicity of 0 . . . 1 and may be based on datatype BGDT:BusinessTransactionDocumentID. SimulationOriginCodeSimulationOriginCode may have a multiplicity of 0 . . . 1 and may be based on datatype BGDT:CustomerInvoiceProcessingSimulationOriginCode.

CustomerInvoice includes the following node elements: Status, in a 1:1 cardinality relationship; BuyerParty, in a 1:1 cardinality relationship; SellerParty, in a 1:1 cardinality relationship; BillToParty, in a 1:C cardinality relationship; BillFromParty, in a 1:C cardinality relationship; PayerParty, in a 1:C cardinality relationship; TaxReportingUnitParty, in a 1:C cardinality relationship; PriceAndTax, in a 1:C cardinality relationship; ProductTaxDetails, in a 1:CN cardinality relationship; PricingTerms, in a 1:1 cardinality relationship; TaxationTerms, in a 1:C cardinality relationship; CashDiscountTerms, in a 1:C cardinality relationship; PaymentControl, in a 1:C cardinality relationship; DeliveryTerms, in a 1:C cardinality relationship; OriginCustomerInvoiceReference, in a 1:C cardinality relationship; AttachmentFolder, in a 1:C cardinality relationship; TextCollection, in a 1:C cardinality relationship; DueItem, in a 1:CN cardinality relationship; and Item, in a 1:N cardinality relationship.

The package CustomerInvoiceStatus includes the entity Status. Status includes information about a current step in a life cycle of a CustomerInvoice. Status includes the following non-node elements: ReleaseStatusCode and ReleaseStatusName. ReleaseStatusCode may have a multiplicity of 1, is a status of a release of a CustomerInvoice that controls possible activities and notification to subsequent business processes, and may be based on datatype BGDT:ReleaseStatusCode. ReleaseStatusName may have a multiplicity of 0 . . . 1, is a name of a status of a release of a CustomerInvoice, and may be based on datatype CDT:Name.

The package CustomerInvoiceParty includes the sub-packages Address and Contact Person and the entities BuyerParty, SellerParty, BillToParty, BillFromParty, PayerParty, and TaxReportingUnitParty. A BuyerParty is a company or person that purchase invoiced goods or services. BuyerParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BuyerParty includes the following node elements: Address, in a 1:C cardinality relationship; and ContactPerson, in a 1:CN cardinality relationship. The package CustomerInvoicePartyAddress includes the entity Address. Address is typed by datatype Address. The package CustomerInvoicePartyContact Person includes the sub-package Address and the entity ContactPerson. ContactPerson is typed by datatype INTERNAL_ContactPerson.

A SellerParty is a company or person that sells invoiced goods or services. SellerParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

SellerParty includes the following node elements: Address, in a 1:C cardinality relationship; and ContactPerson, in a 1:CN cardinality relationship. The package CustomerInvoicePartyAddress includes the entity Address. Address is typed by datatype Address. The package CustomerInvoicePartyContact Person includes the sub-package Address and the entity ContactPerson. ContactPerson is typed by INTERNAL_ContactPerson.

A BillToParty is a company or person to which an invoice for goods or services is sent. BillToParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BillToParty includes the following node elements: Address, in a 1:C cardinality relationship; and ContactPerson, in a 1:CN cardinality relationship. The package CustomerInvoicePartyAddress includes the entity Address. Address is typed by datatype Address. The package CustomerInvoicePartyContact Person includes the sub-package Address and the entity ContactPerson. ContactPerson is typed by INTERNAL_ContactPerson.

A BillFromParty is a company or person who carries out a billing process. BillFromParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BillFromParty includes the following node elements: Address, in a 1:C cardinality relationship; and ContactPerson, in a 1:CN cardinality relationship. The package CustomerInvoicePartyAddress includes the entity Address. Address is typed by datatype Address. The package CustomerInvoicePartyContact Person includes the sub-package Address and the entity ContactPerson. ContactPerson is typed by datatype INTERNAL_ContactPerson.

A PayerParty is a company or person that is requested to pay payables from a delivery of goods or a provision of services. In a case of a credit memo, a PayerParty is a recipient of receivables. PayerParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

PayerParty includes the following node elements: Address, in a 1:C cardinality relationship; and ContactPerson, in a 1:CN cardinality relationship. The package CustomerInvoicePartyAddress includes the entity Address. Address is typed by datatype Address. The package CustomerInvoicePartyContact Person includes the sub-package Address and the entity ContactPerson. ContactPerson is typed by datatype INTERNAL_ContactPerson.

A TaxReportingUnitParty is a functional unit which acts as a permanent establishment of a company. TaxReportingUnitParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

TaxReportingUnitParty includes the following node elements: Address, in a 1:C cardinality relationship; and ContactPerson, in a 1:CN cardinality relationship. The package CustomerInvoicePartyAddress includes the entity Address. Address is typed by datatype Address. The package CustomerInvoicePartyContact Person includes the sub-package Address and the entity ContactPerson. ContactPerson is typed by datatype INTERNAL_ContactPerson.

The package CustomerInvoicePriceInformation includes the entities PriceAndTax, ProductTaxDetails, PricingTerms, and TaxationTerms. PriceAndTax includes information about total amounts of a Customer Invoice and details about specific price and tax components. PriceAndTax includes the following non-node elements: GrossAmount, NetAmount, TaxAmount, PriceComponent, Description, MajorLevelOrdinalNumberValue, MinorLevelOrdinalNumberValue, TypeCode, TypeName, CategoryCode, CategoryName, PurposeCode, PurposeName, Rate, RateBaseQuantityTypeCode, RateBaseQuantityTypeName, RateBaseMeasureUnitName, CalculationBasis, CalculationBasisBaseName, CalculationBasisQuantityMeasureUnitName, CalculationBasisQuantityTypeName, and CalculatedAmount.

GrossAmount may have a multiplicity of 0 . . . 1, is a gross invoice amount (e.g., net amount plus tax amount), and may be based on datatype CDT:Amount, with a qualifier of Gross. NetAmount may have a multiplicity of 0 . . . 1, is a net invoice amount, and may be based on datatype CDT:Amount, with a qualifier of Net. TaxAmount may have a multiplicity of 0 . . . 1, is a tax amount of an invoice, and may be based on datatype CDT:Amount, with a qualifier of Tax. PriceComponent may have a multiplicity of 0 . . . *, is a category type for price components, and may be based on datatype FMIDT:FormPriceComponent. Description may have a multiplicity of 0 . . . 1 and may be based on datatype BGDT:Description. MajorLevelOrdinalNumberValue may have a multiplicity of 1 and may be based on datatype BGDT:OrdinalNumberValue. MinorLevelOrdinalNumberValue may have a multiplicity of 1 and may be based on datatype BGDT:OrdinalNumberValue. TypeCode may have a multiplicity of 0 . . . 1 and may be based on datatype BGDT:PriceSpecificationElementTypeCode. TypeName may have a multiplicity of 0 . . . 1 and may be based on datatype CDT:EXTENDED_Name. CategoryCode may have a multiplicity of 0 . . . 1 and may be based on datatype BGDT:PriceSpecificationElementCategoryCode. CategoryName may have a multiplicity of 0 . . . 1 and may be based on datatype CDT:EXTENDED_Name. PurposeCode may have a multiplicity of 0 . . . 1 and may be based on datatype BGDT:PriceSpecificationElementPurposeCode. PurposeName may have a multiplicity of 0 . . . 1 and may be based on datatype CDT:EXTENDED_Name. Rate may have a multiplicity of 1 and may be based on datatype AGDT:Rate. RateBaseQuantityTypeCode may have a multiplicity of 0 . . . 1 and may be based on datatype BGDT:QuantityTypeCode. RateBaseQuantityTypeName may have a multiplicity of 0 . . . 1 and may be based on datatype CDT:EXTENDED_Name. RateBaseMeasureUnitName may have a multiplicity of 0 . . . 1 and may be based on datatype CDT:EXTENDED_Name. CalculationBasis may have a multiplicity of 1 and may be based on datatype AGDT:PriceComponentCalculationBasis. CalculationBasisBaseName may have a multiplicity of 1 and may be based on datatype CDT:EXTENDED_Name. CalculationBasisQuantityMeasureUnitName may have a multiplicity of 0 . . . 1 and may be based on datatype CDT:EXTENDED_Name. CalculationBasisQuantityTypeName may have a multiplicity of 0 . . . 1 and may be based on datatype CDT:EXTENDED_Name. CalculatedAmount may have a multiplicity of 1 and may be based on datatype CDT:Amount.

ProductTaxDetails are details determined for a specific type of product tax. Product taxes are taxes incurred for product-related business cases, such as purchasing, sales or consumption. ProductTaxDetails includes the following non-node elements: ProductTaxationCharacteristicsCode and ProductTaxationCharacteristicsName. ProductTaxationCharacteristicsCode may have a multiplicity of 0 . . . 1, is a coded representation of main characteristics that form a basis of a product taxation, and may be based on datatype BGDT:ProductTaxationCharacteristicsCode. ProductTaxationCharacteristicsName may have a multiplicity of 0 . . . 1, is a code name of main characteristics that form a basis of a product taxation, and may be based on datatype CDT:LONG_Name. ProductTaxDetails includes the following node elements: ProductTax, in a 1:1 cardinality relationship; and TransactionCurrencyProductTax, in a 1:1 cardinality relationship.

ProductTax includes elements of a specific type of product tax which have been calculated in a reporting currency used by a tax authority. ProductTax includes the following non-node elements: CountryCode, RegionCode, JurisdictionCode, EventTypeCode, EventTypeName, TypeCode, TypeName, RateTypeCode, RateTypeName, CurrencyCode, BaseAmount, Percent, BaseQuantity, BaseQuantityTypeCode, Rate, Amount, InternalAmount, NonDeductiblePercent, NonDeductibleAmount, DeductibilityCode, Business Transaction DocumentItemGroupID, EuropeanCommunityVATTriangulationIndicator, DueCategoryCode, StatisticRelevanceIndicator, DeferredIndicator, Exemption, LegallyRequiredPhrase, and ExchangeRate.

CountryCode may have a multiplicity of 0 . . . 1 and may be based on datatype BGDT:CountryCode. RegionCode may have a multiplicity of 0 . . . 1 and may be based on datatype BGDT:RegionCode. JurisdictionCode may have a multiplicity of 0 . . . 1 and may be based on datatype BGDT:TaxJurisdictionCode. EventTypeCode may have a multiplicity of 0 . . . 1 and may be based on datatype BGDT:ProductTaxEventTypeCode. EventTypeName may have a multiplicity of 0 . . . 1 and may be based on datatype CDT:Name. TypeCode may have a multiplicity of 0 . . . 1 and may be based on datatype BGDT:TaxTypeCode. TypeName may have a multiplicity of 0 . . . 1 and may be based on datatype CDT:Name. RateTypeCode may have a multiplicity of 0 . . . 1 and may be based on datatype BGDT:TaxRateTypeCode. RateTypeName may have a multiplicity of 0 . . . 1 and may be based on datatype CDT:Name. CurrencyCode may have a multiplicity of 0 . . . 1 and may be based on datatype BGDT:CurrencyCode. BaseAmount may have a multiplicity of 0 . . . 1 and may be based on datatype CDT:Amount. Percent may have a multiplicity of 0 . . . 1 and may be based on datatype CDT:Percent. BaseQuantity may have a multiplicity of 0 . . . 1 and may be based on datatype CDT:Quantity. BaseQuantityTypeCode may have a multiplicity of 0 . . . 1 and may be based on datatype BGDT:QuantityTypeCode. Rate may have a multiplicity of 0 . . . 1 and may be based on datatype AGDT:Rate. Amount may have a multiplicity of 0 . . . 1 and may be based on datatype CDT:Amount. InternalAmount may have a multiplicity of 0 . . . 1 and may be based on datatype CDT:Amount. NonDeductiblePercent may have a multiplicity of 0 . . . 1 and may be based on datatype CDT:Percent. NonDeductibleAmount may have a multiplicity of 0 . . . 1 and may be based on datatype CDT:Amount. DeductibilityCode may have a multiplicity of 0 . . . 1 and may be based on datatype BGDT:TaxDeductibilityCode. BusinessTransactionDocumentItemGroupID may have a multiplicity of 0 . . . 1 and may be based on datatype BGDT:BusinessTransactionDocumentItemGroupID. EuropeanCommunityVATTriangulationIndicator may have a multiplicity of 0 . . . 1 and may be based on datatype CDT:Indicator. DueCategoryCode may have a multiplicity of 0 . . . 1 and may be based on datatype BGDT:DueCategoryCode. StatisticRelevanceIndicator may have a multiplicity of 0 . . . 1 and may be based on datatype CDT:Indicator. DeferredIndicator may have a multiplicity of 0 . . . 1 and may be based on datatype CDT:Indicator. Exemption may have a multiplicity of 0 . . . 1 and may be based on datatype AGDT:TaxExemption. LegallyRequiredPhrase may have a multiplicity of 0 . . . 1 and may be based on datatype BGDT:LegallyRequiredPhraseText. ExchangeRate may have a multiplicity of 0 . . . 1 and may be based on datatype AGDT:ExchangeRate.

TransactionCurrencyProductTax includes one or more elements of a specific type of product tax which have been calculated in a currency of a business document. TransactionCurrencyProductTax includes the following non-node elements: CountryCode, RegionCode, JurisdictionCode, EventTypeCode, EventTypeName, TypeCode, TypeName, RateTypeCode, RateTypeName, CurrencyCode, BaseAmount, Percent, BaseQuantity, BaseQuantityTypeCode, Rate, Amount, InternalAmount, NonDeductiblePercent, NonDeductibleAmount, DeductibilityCode, BusinessTransactionDocumentItemGroupID, EuropeanCommunityVATTriangulationIndicator, DueCategoryCode, StatisticRelevanceIndicator, DeferredIndicator, Exemption, LegallyRequiredPhrase, and ExchangeRate.

CountryCode may have a multiplicity of 0 . . . 1 and may be based on datatype BGDT:CountryCode. RegionCode may have a multiplicity of 0 . . . 1 and may be based on datatype BGDT:RegionCode. JurisdictionCode may have a multiplicity of 0 . . . 1 and may be based on datatype BGDT:TaxJurisdictionCode. EventTypeCode may have a multiplicity of 0 . . . 1 and may be based on datatype BGDT:ProductTaxEventTypeCode. EventTypeName may have a multiplicity of 0 . . . 1 and may be based on datatype CDT:Name. TypeCode may have a multiplicity of 0 . . . 1 and may be based on datatype BGDT:TaxTypeCode. TypeName may have a multiplicity of 0 . . . 1 and may be based on datatype CDT:Name. RateTypeCode may have a multiplicity of 0 . . . 1 and may be based on datatype BGDT:TaxRateTypeCode. RateTypeName may have a multiplicity of 0 . . . 1 and may be based on datatype CDT:Name. CurrencyCode may have a multiplicity of 0 . . . 1 and may be based on datatype BGDT:CurrencyCode. BaseAmount may have a multiplicity of 0 . . . 1 and may be based on datatype CDT:Amount. Percent may have a multiplicity of 0 . . . 1 and may be based on datatype CDT:Percent. BaseQuantity may have a multiplicity of 0 . . . 1 and may be based on datatype CDT:Quantity. BaseQuantityTypeCode may have a multiplicity of 0 . . . 1 and may be based on datatype BGDT:QuantityTypeCode. Rate may have a multiplicity of 0 . . . 1 and may be based on datatype AGDT:Rate. Amount may have a multiplicity of 0 . . . 1 and may be based on datatype CDT:Amount. InternalAmount may have a multiplicity of 0 . . . 1 and may be based on datatype CDT:Amount. NonDeductiblePercent may have a multiplicity of 0 . . . 1 and may be based on datatype CDT:Percent. NonDeductibleAmount may have a multiplicity of 0 . . . 1 and may be based on datatype CDT:Amount. DeductibilityCode may have a multiplicity of 0 . . . 1 and may be based on datatype BGDT:TaxDeductibilityCode. BusinessTransactionDocumentItemGroupID may have a multiplicity of 0 . . . 1 and may be based on datatype BGDT:BusinessTransactionDocumentItemGroupID. EuropeanCommunityVATTriangulationIndicator may have a multiplicity of 0 . . . 1 and may be based on datatype CDT:Indicator. DueCategoryCode may have a multiplicity of 0 . . . 1 and may be based on datatype BGDT:DueCategoryCode. StatisticRelevanceIndicator may have a multiplicity of 0 . . . 1 and may be based on datatype CDT:Indicator. DeferredIndicator may have a multiplicity of 0 . . . 1 and may be based on datatype CDT:Indicator. Exemption may have a multiplicity of 0 . . . 1 and may be based on datatype AGDT:TaxExemption. LegallyRequiredPhrase may have a multiplicity of 0 . . . 1 and may be based on datatype BGDT:LegallyRequiredPhraseText. ExchangeRate may have a multiplicity of 0 . . . 1 and may be based on datatype AGDT:ExchangeRate.

PricingTerms are agreements in a sales or service process on which an invoice is based, which can be used to determine a net value of a CustomerInvoice. PricingTerms includes the following non-node elements: CurrencyCode, PriceDateTime, and GrossAmountIndicator. CurrencyCode may have a multiplicity of 1, is a coded representation of a currency in which an invoice is issued (e.g., invoice currency), and may be based on datatype BGDT:CurrencyCode. PriceDateTime may have a multiplicity of 0 . . . 1, is a date and time used to determine one or more price components for a CustomerInvoice, and may be based on datatype CDT:LOCALNORMALISED_DateTime, with a qualifier of Price. GrossAmountIndicator may have a multiplicity of 0 . . . 1 and may be based on datatype CDT:Indicator.

TaxationTerms are agreements that are used for taxation of invoiced goods and services. TaxationTerms includes the following non-node elements: SellerCountryCode, SellerCountryName, SellerTaxID, SellerTaxIdentificationNumberTypeCode, SellerTaxIdentificationNumberTypeName, BuyerCountryCode, BuyerCountryName, BuyerTaxID, BuyerTaxIdentificationNumberTypeCode, BuyerTaxIdentificationNumberTypeName, EuropeanCommunityVATTriangulationIndicator, TaxDate, TaxDueDate, TaxExemptionCertificateID, CustomerTaxExemptionCertificateTaxExemptionReasonUUID, TaxExemptionReasonCode, TaxExemptionReasonName, and TaxExemptionReasonCodeRelevanceIndicator. SellerCountryCode may have a multiplicity of 0 . . . 1, is a coded representation of a seller's country, and may be based on datatype BGDT:CountryCode, with a qualifier of Seller. SellerCountryName may have a multiplicity of 0 . . . 1, is a code name of a seller's country, and may be based on datatype CDT:Name. SellerTaxID may have a multiplicity of 0 . . . 1, is a seller's identifier assigned by a tax authority, and may be based on datatype BGDT:PartyTaxID. SellerTaxIdentificationNumberTypeCode may have a multiplicity of 0 . . . 1, is a coded representation of a type of SellerTaxID, and may be based on datatype BGDT:TaxIdentificationNumberTypeCode, with a qualifier of Seller. SellerTaxIdentificationNumberTypeName may have a multiplicity of 0 . . . 1, is a code name of a type of SellerTaxID, and may be based on datatype CDT:Name. BuyerCountryCode may have a multiplicity of 0 . . . 1, is a coded representation of a buyer's country, and may be based on datatype BGDT:CountryCode, with a qualifier of Buyer. BuyerCountryName may have a multiplicity of 0 . . . 1, is a code name of a buyer's country, and may be based on datatype CDT:Name. BuyerTaxID may have a multiplicity of 0 . . . 1, is a buyer's identifier assigned by a tax authority, and may be based on datatype BGDT:PartyTaxID. BuyerTaxIdentificationNumberTypeCode may have a multiplicity of 0 . . . 1, is a coded representation of a type of BuyerTaxID, and may be based on datatype BGDT:TaxIdentificationNumberTypeCode, with a qualifier of Buyer. BuyerTaxIdentificationNumberTypeName may have a multiplicity of 0 . . . 1, is a code name of a type of BuyerTaxID, and may be based on datatype CDT:Name. EuropeanCommunityVATTriangulationIndicator may have a multiplicity of 0 . . . 1, specifies whether a delivery involves an intra-community triangulation trade in terms of a VAT (Value Added Tax) law of a European Community member state, and may be based on datatype CDT:Indicator, with a qualifier of EuropeanCommunityVATTriangulation. TaxDate may have a multiplicity of 0 . . . 1, is a date when a tax is incurred, and may be based on datatype CDT:Date, with a qualifier of Tax. TaxDueDate may have a multiplicity of 0 . . . 1, is a date on which taxes are due based on legal requirements, and may be based on datatype CDT:Date, with a qualifier of Due. TaxExemptionCertificateID may have a multiplicity of 0 . . . 1, is a unique identifier for a tax exemption certificate, and may be based on datatype BGDT:TaxExemptionCertificateID. CustomerTaxExemptionCertificateTaxExemptionReasonUUID may have a multiplicity of 0 . . . 1, is a universally unique identifier for a reason for a tax exemption, and may be based on datatype BGDT:UUID. TaxExemptionReasonCode may have a multiplicity of 0 . . . 1, is a coded representation of a reason for a tax exemption, and may be based on datatype BGDT:TaxExemptionReasonCode. TaxExemptionReasonName may have a multiplicity of 0 . . . 1, is a code name for a reason for a tax exemption, and may be based on datatype CDT:Name. TaxExemptionReasonCodeRelevanceIndicator may have a multiplicity of 1, indicates whether a tax exemption reason code is relevant, and may be based on datatype CDT:Indicator.

The package CustomerInvoicePaymentInformation includes the entities CashDiscountTerms and PaymentControl. CashDiscountTerms include terms of payment, cash discount rates, and payment deadlines. CashDiscountTerms is typed by CashDiscountTerms. PaymentControl includes the following non-node elements: PaymentFormCode, PaymentFormName, PaymentReferenceID, PaymentReferenceTypeCode, and PaymentReferenceTypeName. PaymentFormCode may have a multiplicity of 0 . . . 1 and may be based on datatype BGDT:PaymentFormCode. PaymentFormName may have a multiplicity of 0 . . . 1 and may be based on datatype CDT:Name. PaymentReferenceID may have a multiplicity of 0 . . . 1 and may be based on datatype BGDT:PaymentReferenceID. PaymentReferenceTypeCode may have a multiplicity of 0 . . . 1 and may be based on datatype BGDT:PaymentReferenceTypeCode. PaymentReferenceTypeName may have a multiplicity of 0 . . . 1 and may be based on datatype CDT:Name.

The package CustomerInvoiceDeliveryInformation includes the entity DeliveryTerms. DeliveryTerms include conditions and agreements that are valid for an executed delivery and transport of invoiced goods and for provided services and activities. DeliveryTerms includes the following non-node elements: DeliveryItemGroupID, DeliveryPriorityCode, DeliveryPriorityName, Incoterms, ClassificationCode, ClassificationName, TransferLocationName, OrderCombinationAllowedIndicator, PartialDeliveryControlCode, PartialDeliveryControlName, PartialDeliveryMaximumNumberValue, QuantityTolerance, TimeTolerance, MaximumLeadTimeDuration, Description, PickUpIndicator, and CompleteDeliveryIndicator.

DeliveryItemGroupID may have a multiplicity of 0 . . . 1 and may be based on datatype BGDT:BusinessTransactionDocumentItemGroupID. DeliveryPriorityCode may have a multiplicity of 0 . . . 1 and may be based on datatype BGDT:PriorityCode. DeliveryPriorityName may have a multiplicity of 0 . . . 1 and may be based on datatype CDT:Name. Incoterms may have a multiplicity of 0 . . . 1, include typical contract formulations for delivery conditions that correspond to rules defined by the International Chamber of Commerce (ICC), can relate to material items, and may be based on datatype FMIDT:FormIncoterms. ClassificationCode may have a multiplicity of 1 and may be based on datatype BGDT:IncotermsClassificationCode. ClassificationName may have a multiplicity of 1 and may be based on datatype CDT:Name. TransferLocationName may have a multiplicity of 0 . . . 1 and may be based on datatype BGDT:IncotermsTransferLocationName. OrderCombinationAllowedIndicator may have a multiplicity of 0 . . . 1 and may be based on datatype CDT:Indicator. PartialDeliveryControlCode may have a multiplicity of 0 . . . 1 and may be based on datatype BGDT:PartialDeliveryControlCode. PartialDeliveryControlName may have a multiplicity of 0 . . . 1 and may be based on datatype CDT:Name. PartialDeliveryMaximumNumberValue may have a multiplicity of 0 . . . 1 and may be based on datatype BGDT:NumberValue. QuantityTolerance may have a multiplicity of 0 . . . 1 and may be based on datatype AGDT:QuantityTolerance. TimeTolerance may have a multiplicity of 0 . . . 1 and may be based on datatype AGDT:TimeTolerance. MaximumLeadTimeDuration may have a multiplicity of 0 . . . 1 and may be based on datatype CDT:Duration. Description may have a multiplicity of 0 . . . 1 and may be based on datatype BGDT:Description. PickUpIndicator may have a multiplicity of 0 . . . 1 and may be based on datatype CDT:Indicator. CompleteDeliveryIndicator may have a multiplicity of 0 . . . 1 and may be based on datatype CDT:Indicator.

The package CustomerInvoiceBusinessTransactionDocumentReference includes the entity OriginCustomerInvoiceReference. An OriginCustomerInvoiceReference is a reference to an item of a CustomerInvoice that is reversed, corrected, or credited by a CustomerInvoice. OriginCustomerInvoiceReference is typed by datatype BusinessTransactionDocumentReference.

The package CustomerInvoiceAttachment includes the sub-package Document and the entity AttachmentFolder. An AttachmentFolder is a collection of documents that are assigned to a CustomerInvoice. AttachmentFolder is typed by datatype AttachmentFolder.

The package CustomerInvoiceTextCollection includes the entity TextCollection. A TextCollection is a collection of textual descriptions provided by and valid for an invoice document. TextCollection includes the following non-node elements: Text, TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. Text may have a multiplicity of 0 . . . * and may be based on datatype FMIDT:FormTextCollectionText. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_MEDIUM_Name. SystemAdministrativeData may have a multiplicity of 0 . . . 1 and may be based on datatype FMIDT:FormSystemAdministrativeData. CreationDateTime may have a multiplicity of 1 and may be based on datatype CDT:LOCAL_DateTime. CreationIdentityUUID may have a multiplicity of 0 . . . 1 and may be based on datatype BGDT:UUID. CreationUserAccountID may have a multiplicity of 0 . . . 1 and may be based on datatype BGDT:UserAccountID. CreationBusinessPartnerFormattedName may have a multiplicity of 0 . . . 1 and may be based on datatype CDT:LANGUAGEINDEPENDENT_LONG_Name. LastChangeDateTime may have a multiplicity of 0 . . . 1 and may be based on datatype CDT:LOCAL_DateTime. LastChangeIdentityUUID may have a multiplicity of 0 . . . 1 and may be based on datatype BGDT:UUID. LastChangeUserAccountID may have a multiplicity of 0 . . . 1 and may be based on datatype BGDT:UserAccountID. LastChangeBusinessPartnerFormattedName may have a multiplicity of 0 . . . 1 and may be based on datatype CDT:LANGUAGEINDEPENDENT_LONG_Name. CreationDateTime may have a multiplicity of 0 . . . 1 and may be based on datatype CDT:LOCAL_DateTime. ContentText may have a multiplicity of 1 and may be based on datatype CDT:Text.

The package CustomerInvoiceDueItem includes the entity DueItem. DueItem includes summarized open or cleared receivables information collected in due item management for an invoice. A Due Item includes amounts and, if relevant, a date and reference to an underlying document and corresponding tax details. DueItem includes the following non-node elements: TypeCode, TypeName, CancelledIndicator, GrossAmount, NetAmount, TaxAmount, CashDiscountAppliedIndicator, InvoiceDate, and CustomerInvoice. TypeCode may have a multiplicity of 1, is a type of a due item, and may be based on datatype BGDT:CustomerInvoiceDueItemTypeCode. TypeName may have a multiplicity of 0 . . . 1, is a name of a type of a due item, and may be based on datatype CDT:Name. CancelledIndicator may have a multiplicity of 0 . . . 1, indicates whether a due item is cancelled, and may be based on datatype CDT:Indicator, with a qualifier of Cancelled. GrossAmount may have a multiplicity of 0 . . . 1, is a gross value of the node Due Item, and may be based on datatype CDT:Amount, with a qualifier of Gross. NetAmount may have a multiplicity of 0 . . . 1, is a net value of the node Due Item, and may be based on datatype CDT:Amount, with a qualifier of Net. TaxAmount may have a multiplicity of 0 . . . 1, is a tax value of the node Due Item, and may be based on datatype CDT:Amount, with a qualifier of Tax. CashDiscountAppliedIndicator may have a multiplicity of 0 . . . 1, indicates whether a cash discount has been applied to a Due Item, and may be based on datatype CDT:Indicator, with a qualifier of Applied. InvoiceDate may have a multiplicity of 0 . . . 1, is an invoice date of an underlying Customer Invoice, may be used in a case where the BaseBusinessTransactionDocumentTypeCode is set to a value indicating “Customer Invoice”, and may be based on datatype CDT:Date, with a qualifier of Invoice. Due Item includes the following node elements: CustomerInvoiceReference, in a 1:C cardinality relationship; and ProductTax, in a 1:CN cardinality relationship.

Cleared receivables can be paid and/or balanced receivables of a down payment invoice. Open receivables are, for example, a final payment calculated from values of an invoice, minus values typed as a down payment. Cleared information collected in a due item management can be paid or balanced receivables sent by message to an invoice. A DueItem can occur in the following specializations: DueItemClearing, which is a due item that specifies values of items for which a payment process has been resolved; DownPayment, which is a due item that specifies values of an invoice for which only a part of a total price has been paid initially, with a balance expected at a later date; and FinalPayment, which is a due item that specifies one or more values that are relevant for a final payment of an invoice.

CustomerInvoiceReference is a unique identifier for a business document that is referenced in a due item. CustomerInvoiceReference is typed by datatype BusinessTransactionDocumentReference.

ProductTax includes details determined for a specific type of tax, such as tax codes and amounts. Some tax details may be transferred from due item management with a notification message. ProductTax includes the following non-node elements: CountryCode, RegionCode, JurisdictionCode, EventTypeCode, EventTypeName, TypeCode, TypeName, RateTypeCode, RateTypeName, CurrencyCode, BaseAmount, Percent, BaseQuantity, BaseQuantityTypeCode, Rate, Amount, InternalAmount, NonDeductiblePercent, NonDeductibleAmount, DeductibilityCode, BusinessTransactionDocumentItemGroupID, EuropeanCommunityVATTriangulationIndicator, DueCategoryCode, StatisticRelevanceIndicator, DeferredIndicator, Exemption, LegallyRequiredPhrase, and ExchangeRate. CountryCode may have a multiplicity of 0 . . . 1 and may be based on datatype BGDT:CountryCode. RegionCode may have a multiplicity of 0 . . . 1 and may be based on datatype BGDT:RegionCode. JurisdictionCode may have a multiplicity of 0 . . . 1 and may be based on datatype BGDT:TaxJurisdictionCode. EventTypeCode may have a multiplicity of 0 . . . 1 and may be based on datatype BGDT:ProductTaxEventTypeCode. EventTypeName may have a multiplicity of 0 . . . 1 and may be based on datatype CDT:Name. TypeCode may have a multiplicity of 0 . . . 1 and may be based on datatype BGDT:TaxTypeCode. TypeName may have a multiplicity of 0 . . . 1 and may be based on datatype CDT:Name. RateTypeCode may have a multiplicity of 0 . . . 1 and may be based on datatype BGDT:TaxRateTypeCode. RateTypeName may have a multiplicity of 0 . . . 1 and may be based on datatype CDT:Name. CurrencyCode may have a multiplicity of 0 . . . 1 and may be based on datatype BGDT:CurrencyCode. BaseAmount may have a multiplicity of 0 . . . 1 and may be based on datatype CDT:Amount. Percent may have a multiplicity of 0 . . . 1 and may be based on datatype CDT:Percent. BaseQuantity may have a multiplicity of 0 . . . 1 and may be based on datatype CDT:Quantity. BaseQuantityTypeCode may have a multiplicity of 0 . . . 1 and may be based on datatype BGDT:QuantityTypeCode. Rate may have a multiplicity of 0 . . . 1 and may be based on datatype AGDT:Rate. Amount may have a multiplicity of 0 . . . 1 and may be based on datatype CDT:Amount. InternalAmount may have a multiplicity of 0 . . . 1 and may be based on datatype CDT:Amount. NonDeductiblePercent may have a multiplicity of 0 . . . 1 and may be based on datatype CDT:Percent. NonDeductibleAmount may have a multiplicity of 0 . . . 1 and may be based on datatype CDT:Amount. DeductibilityCode may have a multiplicity of 0 . . . 1 and may be based on datatype BGDT:TaxDeductibilityCode. BusinessTransactionDocumentItemGroupID may have a multiplicity of 0 . . . 1 and may be based on datatype BGDT:BusinessTransactionDocumentItemGroupID. EuropeanCommunityVATTriangulationIndicator may have a multiplicity of 0 . . . 1 and may be based on datatype CDT:Indicator. DueCategoryCode may have a multiplicity of 0 . . . 1 and may be based on datatype BGDT:DueCategoryCode. StatisticRelevanceIndicator may have a multiplicity of 0 . . . 1 and may be based on datatype CDT:Indicator. DeferredIndicator may have a multiplicity of 0 . . . 1 and may be based on datatype CDT:Indicator. Exemption may have a multiplicity of 0 . . . 1 and may be based on datatype AGDT:TaxExemption. LegallyRequiredPhrase may have a multiplicity of 0 . . . 1 and may be based on datatype BGDT:LegallyRequiredPhraseText. ExchangeRate may have a multiplicity of 0 . . . 1 and may be based on datatype AGDT:ExchangeRate.

The package CustomerInvoiceItem includes the sub-packages BusinessProcessVariant, ProductInformation, SalesAndServiceBusinessArea, PriceInformation, DeliveryInformation, Party, Location, Business TransactionDocumentReference, Attachment, TextCollection, and AccountingCodingBlockAssignment, and the entity Item.

Item summarizes information from an invoice document item that is taken into account by a settlement. A CustomerInvoiceItem can include information about a quantity of a product that has been ordered or delivered, as well as about business partners, pricing information and payment conditions and other business documents to be taken into account for a settlement of a product or service. Item includes the following non-node elements: ID, UUID, TypeCode, TypeName, ReceivablesPropertyMovementDirectionCode, ReceivablesPropertyMovementDirectionName, Description, CustomerInvoiceRequestName, CorrectedCustomerInvoiceItemID, CashDiscountDeductibleIndicator, Quantity, QuantityTypeCode, QuantityMeasureUnitName, and QuantityTypeName. ID may have a multiplicity of 1, is a unique identifier for an item in a base business document for a CustomerInvoiceItem, and may be based on datatype BGDT:BusinessTransactionDocumentItemID UUID may have a multiplicity of 0 . . . 1, is a universally unique identifier of a CustomerInvoiceItem, and may be based on datatype BGDT:UUID. TypeCode may have a multiplicity of 1, is a coded representation of a type of a CustomerInvoiceItem, and may be based on datatype BGDT:BusinessTransactionDocumentItemTypeCode. TypeName may have a multiplicity of 0 . . . 1, is a code name of a type of a CustomerInvoiceItem, and may be based on datatype CDT:Name. ReceivablesPropertyMovementDirectionCode may have a multiplicity of 1, is a coded representation of whether a CustomerInvoiceItem increases or decreases receivables, and may be based on datatype BGDT:PropertyMovementDirectionCode, with a qualifier of Receivables. ReceivablesPropertyMovementDirectionName may have a multiplicity of 0 . . . 1, is a code name of whether a CustomerInvoiceItem increases or decreases receivables, and may be based on datatype CDT:Name. Description may have a multiplicity of 0 . . . 1, is a description of an invoice item, and may be based on datatype BGDT:SHORT_Description. CustomerInvoiceRequestName may have a multiplicity of 0 . . . 1, is a user-defined name of a related Customer Invoice Request to search for in a case of Manual Invoicing, may be used if an element assigned in a node business transaction document reference includes a value indicating Customer Invoice Request, and may be based on datatype CDT:LANGUAGEINDEPENDENT_EXTENDED_Name, with a qualifier of CustomerInvoiceRequest. CorrectedCustomerInvoiceItemID may have a multiplicity of 0 . . . 1, is an identifier of a relation to a corrected item for an identifier in an item node, and may be based on datatype BGDT:BusinessTransactionDocumentItemID, with a qualifier of Corrected. CashDiscountDeductibleIndicator may have a multiplicity of 0 . . . 1, indicates whether a cash discount may be deducted for a product, and may be based on datatype CDT:Indicator, with a qualifier of CashDiscountDeductible. Quantity may have a multiplicity of 0 . . . 1 and may be based on datatype CDT:Quantity. QuantityTypeCode may have a multiplicity of 0 . . . 1 and may be based on datatype BGDT:QuantityTypeCode. QuantityMeasureUnitName may have a multiplicity of 0 . . . 1, is a code name of a measure unit of an invoiced quantity, and may be based on datatype CDT:Name. QuantityTypeName may have a multiplicity of 0 . . . 1 and may be based on datatype CDT:Name.

Item includes the following node elements: BusinessProcessVariant, in a 1:N cardinality relationship; Product, in a 1:C cardinality relationship; ProductCategory, in a 1:C cardinality relationship; SalesAndServiceBusinessArea, in a 1:C cardinality relationship; PriceAndTax, in a 1:C cardinality relationship; ProductTaxDetails, in a 1:CN cardinality relationship; PricingTerms, in a 1:C cardinality relationship; TaxationTerms, in a 1:C cardinality relationship; DeliveryTerms, in a 1:C cardinality relationship; ProductRecipientParty, in a 1:C cardinality relationship; VendorParty, in a 1:C cardinality relationship; EmployeeResponsibleParty, in a 1:C cardinality relationship; ShipToLocation, in a 1:C cardinality relationship; ShipFromLocation, in a 1:C cardinality relationship; ServicePointLocation, in a 1:C cardinality relationship; PurchaseOrderReference, in a 1:C cardinality relationship; OriginCustomerInvoiceReference, in a 1:C cardinality relationship; SalesOrderReference, in a 1:C cardinality relationship; ServiceOrderReference, in a 1:C cardinality relationship; ServiceConfirmationReference, in a 1:C cardinality relationship; CustomerReturnReference, in a 1:C cardinality relationship; CustomerProjectInvoiceRequisitionReference, in a 1:C cardinality relationship; OutboundDeliveryReference, in a 1:C cardinality relationship; OriginOutboundDeliveryReference, in a 1:C cardinality relationship; CustomerContractReference, in a 1:C cardinality relationship; AttachmentFolder, in a 1:C cardinality relationship; TextCollection, in a 1:C cardinality relationship; and AccountingCodingBlockAssignment, in a 1:C cardinality relationship.

The package CustomerInvoiceItemBusinessProcessVariant includes the entity BusinessProcessVariant. BusinessProcessVariant includes information about the character of a business process variant of a CustomerInvoiceItem. BusinessProcessVariant includes the following non-node elements: BusinessProcessVariantTypeCode, BusinessProcessVariantTypeName, and MainIndicator. BusinessProcessVariantTypeCode may have a multiplicity of 1, is a coded representation of a business process variant type of a CustomerInvoiceItem, and may be based on datatype BGDT:BusinessProcessVariantTypeCode. BusinessProcessVariantTypeName may have a multiplicity of 0 . . . 1, is a code name of a business process variant type of a CustomerInvoiceItem, and may be based on datatype CDT:Name. MainIndicator may have a multiplicity of 0 . . . 1, specifies whether a current BusinessProcessVariantTypeCode represents a main process, and may be based on datatype CDT:Indicator.

The package CustomerInvoiceItemProductInformation includes the entities Product and ProductCategory. Product is an identification, description, and classification of a product or service that is invoiced. Product includes the following non-node elements: TypeCode, TypeName, InternalID, and Description. TypeCode may have a multiplicity of 0 . . . 1 and may be based on datatype BGDT:ProductTypeCode. TypeName may have a multiplicity of 0 . . . 1 and may be based on datatype CDT:Name. InternalID may have a multiplicity of 0 . . . 1 and may be based on datatype BGDT:ProductInternalID. Description may have a multiplicity of 0 . . . 1 and may be based on datatype BGDT:SHORTDescription.

ProductCategory includes information that is exchanged in business documents about a product category. ProductCategory includes the following non-node elements: InternalID and Description. InternalID may have a multiplicity of 1 and may be based on datatype BGDT:ProductCategoryInternalID. Description may have a multiplicity of 0 . . . 1, is a description of a product category, and may be based on datatype CDT:MEDIUM_Name.

The package CustomerInvoiceItemSalesAndServiceBusinessArea includes the entity SalesAndServiceBusinessArea. SalesAndServiceBusinessArea is a business or service specific area within an enterprise that is valid for an underlying sales or service business transaction document invoiced by an Item, such as, for example, sales organization, service organization, or distribution channel. SalesAndServiceBusinessArea includes the following non-node elements: SalesOrganisationID, SalesOrganisationUUID, DistributionChannelCode, DistributionChannelName, ServiceOrganisationID, and ServiceOrganisationUUID. SalesOrganisationID may have a multiplicity of 0 . . . 1, is an identifier for a sales organization that is responsible for an invoiced business transaction document, and may be based on datatype BGDT:OrganisationalCentreID. SalesOrganisationUUID may have a multiplicity of 0 . . . 1, is a universally unique identifier for a sales organization, and may be based on datatype BGDT:UUID. DistributionChannelCode may have a multiplicity of 0 . . . 1, is a coded representation of a distribution channel by which goods and services reach customers, and may be based on datatype BGDT:DistributionChannelCode. DistributionChannelName may have a multiplicity of 0 . . . 1, is a code name of a distribution channel by which goods and services reach customers, and may be based on datatype CDT:Name. ServiceOrganisationID may have a multiplicity of 0 . . . 1, is an identifier for a service organization that is responsible for an invoiced business transaction document, and may be based on datatype BGDT:OrganisationalCentreID. ServiceOrganisationUUID may have a multiplicity of 0 . . . 1, is a universally unique identifier for a service organization, and may be based on datatype BGDT:UUID.

The package CustomerInvoiceItemPriceInformation includes the entities PriceAndTax, ProductTaxDetails, PricingTerms, and TaxationTerms. PriceAndTax includes information about amounts of a CustomerInvoiceItem and details about specific item price and tax components. PriceAndTax includes the following non-node elements: GrossAmount, NetAmount, TaxAmount, and PriceComponent. PriceComponent may include Description, MajorLevelOrdinalNumberValue, MinorLevelOrdinalNumberValue, TypeCode, TypeName, CategoryCode, CategoryName, PurposeCode, PurposeName, Rate, RateBaseQuantityTypeCode, RateBaseQuantityTypeName, RateBaseMeasureUnitName, CalculationBasis, CalculationBasisBaseName, CalculationBasisQuantityMeasureUnitName, CalculationBasisQuantityTypeName, CalculatedAmount, and MainDiscount.

GrossAmount may have a multiplicity of 0 . . . 1, is a gross invoice amount (e.g., net amount plus tax amount), and may be based on datatype CDT:Amount, with a qualifier of Gross. NetAmount may have a multiplicity of 0 . . . 1, is a net invoice amount, and may be based on datatype CDT:Amount, with a qualifier of Net. TaxAmount may have a multiplicity of 0 . . . 1, is a tax amount of an invoice, and may be based on datatype CDT:Amount, with a qualifier of Tax. PriceComponent may have a multiplicity of 0.*, represents categories of item price components, and may be based on datatype FMIDT:FormPriceComponent. Description may have a multiplicity of 0 . . . 1 and may be based on datatype BGDT:Description. MajorLevelOrdinalNumberValue may have a multiplicity of 1 and may be based on datatype BGDT:OrdinalNumberValue. MinorLevelOrdinalNumberValue may have a multiplicity of 1 and may be based on datatype BGDT:OrdinalNumberValue. TypeCode may have a multiplicity of 0 . . . 1 and may be based on datatype BGDT:PriceSpecificationElementTypeCode. TypeName may have a multiplicity of 0 . . . 1 and may be based on datatype CDT:EXTENDED_Name. CategoryCode may have a multiplicity of 0 . . . 1 and may be based on datatype BGDT:PriceSpecificationElementCategoryCode. CategoryName may have a multiplicity of 0 . . . 1 and may be based on datatype CDT:EXTENDED_Name. PurposeCode may have a multiplicity of 0 . . . 1 and may be based on datatype BGDT:PriceSpecificationElementPurposeCode. PurposeName may have a multiplicity of 0 . . . 1 and may be based on datatype CDT:EXTENDED_Name. Rate may have a multiplicity of 1 and may be based on datatype AGDT:Rate. RateBaseQuantityTypeCode may have a multiplicity of 0 . . . 1 and may be based on datatype BGDT:QuantityTypeCode. RateBaseQuantityTypeName may have a multiplicity of 0 . . . 1 and may be based on datatype CDT:EXTENDED_Name. RateBaseMeasureUnitName may have a multiplicity of 0 . . . 1 and may be based on datatype CDT:EXTENDED_Name. CalculationBasis may have a multiplicity of 1 and may be based on datatype AGDT:PriceComponentCalculationBasis. CalculationBasisBaseName may have a multiplicity of 1 and may be based on datatype CDT:EXTENDED_Name. CalculationBasisQuantityMeasureUnitName may have a multiplicity of 0.1 and may be based on datatype CDT:EXTENDED_Name. CalculationBasisQuantityTypeName may have a multiplicity of 0.1 and may be based on datatype CDT:EXTENDED_Name. CalculatedAmount may have a multiplicity of 1 and may be based on datatype CDT:Amount. MainDiscount may have a multiplicity of 0 . . . 1, is a category of an item price component with a type of MainDiscount, and may be based on datatype FMIDT:FormPriceComponent, with a qualifier of Main.

ProductTaxDetails includes details determined for a specific type of product tax. Product taxes are taxes that are incurred for product-related business cases, such as purchasing, sales or consumption. ProductTaxDetails includes the following non-node elements: ProductTaxationCharacteristicsCode and ProductTaxationCharacteristicsName. ProductTaxationCharacteristicsCode may have a multiplicity of 0 . . . 1, is a coded representation of characteristics that form a basis of a product taxation, and may be based on datatype BGDT:ProductTaxationCharacteristicsCode. ProductTaxationCharacteristicsName may have a multiplicity of 0 . . . 1, is a code name of characteristics that form a basis of a product taxation, and may be based on datatype CDT:LONG_Name. ProductTaxDetails includes the following node elements: ProductTax, in a 1:1 cardinality relationship; and TransactionCurrencyProductTax, in a 1:1 cardinality relationship.

ProductTax includes elements of a specific type of product tax which have been calculated in a reporting currency of a tax authority. ProductTax includes the following non-node elements: CountryCode, RegionCode, JurisdictionCode, EventTypeCode, EventTypeName, TypeCode, TypeName, RateTypeCode, RateTypeName, CurrencyCode, BaseAmount, Percent, BaseQuantity, BaseQuantityTypeCode, Rate, Amount, InternalAmount, NonDeductiblePercent, NonDeductibleAmount, DeductibilityCode, Business Transaction DocumentItemGroupID, EuropeanCommunityVATTriangulationIndicator, DueCategoryCode, StatisticRelevanceIndicator, DeferredIndicator, Exemption, LegallyRequiredPhrase, and ExchangeRate.

CountryCode may have a multiplicity of 0 . . . 1 and may be based on datatype BGDT:CountryCode. RegionCode may have a multiplicity of 0 . . . 1 and may be based on datatype BGDT:RegionCode. JurisdictionCode may have a multiplicity of 0 . . . 1 and may be based on datatype BGDT:TaxJurisdictionCode. EventTypeCode may have a multiplicity of 0 . . . 1 and may be based on datatype BGDT:ProductTaxEventTypeCode. EventTypeName may have a multiplicity of 0 . . . 1 and may be based on datatype CDT:Name. TypeCode may have a multiplicity of 0 . . . 1 and may be based on datatype BGDT:TaxTypeCode. TypeName may have a multiplicity of 0 . . . 1 and may be based on datatype CDT:Name. RateTypeCode may have a multiplicity of 0 . . . 1 and may be based on datatype BGDT:TaxRateTypeCode. RateTypeName may have a multiplicity of 0 . . . 1 and may be based on datatype CDT:Name. CurrencyCode may have a multiplicity of 0 . . . 1 and may be based on datatype BGDT:CurrencyCode. BaseAmount may have a multiplicity of 0 . . . 1 and may be based on datatype CDT:Amount. Percent may have a multiplicity of 0 . . . 1 and may be based on datatype CDT:Percent. BaseQuantity may have a multiplicity of 0 . . . 1 and may be based on datatype CDT:Quantity. BaseQuantityTypeCode may have a multiplicity of 0 . . . 1 and may be based on datatype BGDT:QuantityTypeCode. Rate may have a multiplicity of 0 . . . 1 and may be based on datatype AGDT:Rate. Amount may have a multiplicity of 0 . . . 1 and may be based on datatype CDT:Amount. InternalAmount may have a multiplicity of 0 . . . 1 and may be based on datatype CDT:Amount. NonDeductiblePercent may have a multiplicity of 0 . . . 1 and may be based on datatype CDT:Percent. NonDeductibleAmount may have a multiplicity of 0 . . . 1 and may be based on datatype CDT:Amount. DeductibilityCode may have a multiplicity of 0 . . . 1 and may be based on datatype BGDT:TaxDeductibilityCode. BusinessTransactionDocumentItemGroupID may have a multiplicity of 0 . . . 1 and may be based on datatype BGDT:BusinessTransactionDocumentItemGroupID. EuropeanCommunityVATTriangulationIndicator may have a multiplicity of 0 . . . 1 and may be based on datatype CDT:Indicator. DueCategoryCode may have a multiplicity of 0 . . . 1 and may be based on datatype BGDT:DueCategoryCode. StatisticRelevanceIndicator may have a multiplicity of 0 . . . 1 and may be based on datatype CDT:Indicator. DeferredIndicator may have a multiplicity of 0 . . . 1 and may be based on datatype CDT:Indicator. Exemption may have a multiplicity of 0 . . . 1 and may be based on datatype AGDT:TaxExemption. LegallyRequiredPhrase may have a multiplicity of 0 . . . 1 and may be based on datatype BGDT:LegallyRequiredPhraseText. ExchangeRate may have a multiplicity of 0 . . . 1 and may be based on datatype AGDT:ExchangeRate.

TransactionCurrencyProductTax includes elements of a specific type of product tax which have been calculated in a currency of a business document. TransactionCurrencyProductTax includes the following non-node elements: CountryCode, RegionCode, JurisdictionCode, EventTypeCode, EventTypeName, TypeCode, TypeName, RateTypeCode, RateTypeName, CurrencyCode, BaseAmount, Percent, BaseQuantity, BaseQuantityTypeCode, Rate, Amount, InternalAmount, NonDeductiblePercent, NonDeductibleAmount, DeductibilityCode, BusinessTransactionDocumentItemGroupID, EuropeanCommunityVATTriangulationIndicator, DueCategoryCode, StatisticRelevanceIndicator, DeferredIndicator, Exemption, LegallyRequiredPhrase, and ExchangeRate. CountryCode may have a multiplicity of 0 . . . 1 and may be based on datatype BGDT:CountryCode. RegionCode may have a multiplicity of 0 . . . 1 and may be based on datatype BGDT:RegionCode. JurisdictionCode may have a multiplicity of 0 . . . 1 and may be based on datatype BGDT:TaxJurisdictionCode. EventTypeCode may have a multiplicity of 0 . . . 1 and may be based on datatype BGDT:ProductTaxEventTypeCode. EventTypeName may have a multiplicity of 0 . . . 1 and may be based on datatype CDT:Name. TypeCode may have a multiplicity of 0 . . . 1 and may be based on datatype BGDT:TaxTypeCode. TypeName may have a multiplicity of 0 . . . 1 and may be based on datatype CDT:Name. RateTypeCode may have a multiplicity of 0 . . . 1 and may be based on datatype BGDT:TaxRateTypeCode. RateTypeName may have a multiplicity of 0 . . . 1 and may be based on datatype CDT:Name. CurrencyCode may have a multiplicity of 0 . . . 1 and may be based on datatype BGDT:CurrencyCode. BaseAmount may have a multiplicity of 0 . . . 1 and may be based on datatype CDT:Amount. Percent may have a multiplicity of 0 . . . 1 and may be based on datatype CDT:Percent. BaseQuantity may have a multiplicity of 0 . . . 1 and may be based on datatype CDT:Quantity. BaseQuantityTypeCode may have a multiplicity of 0 . . . 1 and may be based on datatype BGDT:QuantityTypeCode. Rate may have a multiplicity of 0 . . . 1 and may be based on datatype AGDT:Rate. Amount may have a multiplicity of 0 . . . 1 and may be based on datatype CDT:Amount. InternalAmount may have a multiplicity of 0 . . . 1 and may be based on datatype CDT:Amount. NonDeductiblePercent may have a multiplicity of 0 . . . 1 and may be based on datatype CDT:Percent. NonDeductibleAmount may have a multiplicity of 0 . . . 1 and may be based on datatype CDT:Amount. DeductibilityCode may have a multiplicity of 0 . . . 1 and may be based on datatype BGDT:TaxDeductibilityCode. BusinessTransactionDocumentItemGroupID may have a multiplicity of 0 . . . 1 and may be based on datatype BGDT:BusinessTransactionDocumentItemGroupID. EuropeanCommunityVATTriangulationIndicator may have a multiplicity of 0 . . . 1 and may be based on datatype CDT:Indicator. DueCategoryCode may have a multiplicity of 0 . . . 1 and may be based on datatype BGDT:DueCategoryCode. StatisticRelevanceIndicator may have a multiplicity of 0 . . . 1 and may be based on datatype CDT:Indicator. DeferredIndicator may have a multiplicity of 0 . . . 1 and may be based on datatype CDT:Indicator. Exemption may have a multiplicity of 0 . . . 1 and may be based on datatype AGDT:TaxExemption. LegallyRequiredPhrase may have a multiplicity of 0 . . . 1 and may be based on datatype BGDT:LegallyRequiredPhraseText. ExchangeRate may have a multiplicity of 0 . . . 1 and may be based on datatype AGDT:ExchangeRate.

PricingTerms are agreements in a sales or service process on which an invoice is based and which can be used to determine a net value of a CustomerInvoiceItem. PricingTerms includes the following non-node elements: PriceDateTime, which may have a multiplicity of 0 . . . 1, is a date and time used to determine one or more price components for a Customer Invoice, and may be based on datatype CDT:LOCALNORMALISED_DateTime, with a qualifier of Price.

TaxationTerms are agreements that can be used for taxation of invoiced goods and services. TaxationTerms includes the following non-node elements: EuropeanCommunityVATTriangulationIndicator, TaxDate, TaxDueDate, TaxExemptionCertificateID, CustomerTaxExemptionCertificateTaxExemptionReasonUUID, TaxExemptionReasonCode, TaxExemptionReasonName, TaxExemptionReasonCodeRelevanceIndicator, FollowUpTaxExemptionCertificateID, and FollowUpCustomerTaxExemptionCertificateTaxExemptionReasonUUID. EuropeanCommunityVATTriangulationIndicator may have a multiplicity of 0 . . . 1, specifies whether a delivery involves an intra-community triangulation trade in terms of a VAT law of a European Community member state, and may be based on datatype CDT:Indicator, with a qualifier of EuropeanCommunityVATTriangulation. TaxDate may have a multiplicity of 0 . . . 1, is a date when a tax is incurred, and may be based on datatype CDT:Date, with a qualifier of Tax. TaxDueDate may have a multiplicity of 0 . . . 1, is a date on which taxes are due based on legal requirements, and may be based on datatype CDT:Date, with a qualifier of Due. TaxExemptionCertificateID may have a multiplicity of 0 . . . 1, is a unique identifier for a tax exemption certificate, and may be based on datatype BGDT:TaxExemptionCertificateID. CustomerTaxExemptionCertificateTaxExemptionReasonUUID may have a multiplicity of 0 . . . 1, is a universally unique identifier for a reason for a tax exemption, and may be based on datatype BGDT:UUID. TaxExemptionReasonCode may have a multiplicity of 0 . . . 1, is a coded representation of a reason for a tax exemption, and may be based on datatype BGDT:TaxExemptionReasonCode. TaxExemptionReasonName may have a multiplicity of 0 . . . 1, is a code name for a reason for a tax exemption, and may be based on datatype CDT:Name. TaxExemptionReasonCodeRelevanceIndicator may have a multiplicity of 1, indicates whether a tax exemption reason code is relevant, and may be based on datatype CDT:Indicator. FollowUpTaxExemptionCertificateID may have a multiplicity of 0 . . . 1, is a unique identifier for a follow-up tax exemption certificate, and may be based on datatype BGDT:TaxExemptionCertificateID.

FollowUpCustomerTaxExemptionCertificateTaxExemptionReasonUUID may have a multiplicity of 0 . . . 1, is a universally unique identifier for a reason for a follow up tax exemption, and may be based on datatype BGDT:UUID.

The package CustomerInvoiceItemDeliveryInformation includes the entity DeliveryTerms. DeliveryTerms include conditions and agreements that are valid for the executed delivery and transport of invoiced goods and for provided services and activities. DeliveryTerms includes the following non-node elements: DeliveryItemGroupID, DeliveryPriorityCode, DeliveryPriorityName, Incoterms, OrderCombinationAllowedIndicator, PartialDeliveryControlCode, PartialDeliveryControlName, PartialDeliveryMaximumNumberValue, QuantityTolerance, TimeTolerance, MaximumLeadTimeDuration, Description, PickUpIndicator, and CompleteDeliveryIndicator. IncoTerms can include ClassificationCode, ClassificationName, and TransferLocationName. Incoterms can be used for material items.

DeliveryItemGroupID may have a multiplicity of 0 . . . 1 and may be based on datatype BGDT:BusinessTransactionDocumentItemGroupID. DeliveryPriorityCode may have a multiplicity of 0 . . . 1 and may be based on datatype BGDT:PriorityCode. DeliveryPriorityName may have a multiplicity of 0 . . . 1 and may be based on datatype CDT:Name. Incoterms may have a multiplicity of 0 . . . 1, are contract formulations for delivery conditions that correspond to rules defined by the International Chamber of Commerce (ICC), and may be based on datatype FMIDT:FormIncoterms. ClassificationCode may have a multiplicity of 1 and may be based on datatype BGDT:IncotermsClassificationCode. ClassificationName may have a multiplicity of 1 and may be based on datatype CDT:Name. TransferLocationName may have a multiplicity of 0 . . . 1 and may be based on datatype BGDT:IncotermsTransferLocationName. OrderCombinationAllowedIndicator may have a multiplicity of 0 . . . 1 and may be based on datatype CDT:Indicator. PartialDeliveryControlCode may have a multiplicity of 0 . . . 1 and may be based on datatype BGDT:PartialDeliveryControlCode. PartialDeliveryControlName may have a multiplicity of 0 . . . 1 and may be based on datatype CDT:Name. PartialDeliveryMaximumNumberValue may have a multiplicity of 0 . . . 1 and may be based on datatype BGDT:NumberValue. QuantityTolerance may have a multiplicity of 0 . . . 1 and may be based on datatype AGDT:QuantityTolerance. TimeTolerance may have a multiplicity of 0 . . . 1 and may be based on datatype AGDT:TimeTolerance. MaximumLeadTimeDuration may have a multiplicity of 0 . . . 1 and may be based on datatype CDT:Duration. Description may have a multiplicity of 0 . . . 1 and may be based on datatype BGDT:Description. PickUpIndicator may have a multiplicity of 0 . . . 1 and may be based on datatype CDT:Indicator. CompleteDeliveryIndicator may have a multiplicity of 0 . . . 1 and may be based on datatype CDT:Indicator.

The package CustomerInvoiceItemParty includes the sub-packages Address and Contact Person and the entities ProductRecipientParty, VendorParty, and EmployeeResponsibleParty. A ProductRecipientParty is a company or person to whom goods are delivered or for whom services are provided. ProductRecipientParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name. ProductRecipientParty includes the following node elements: Address, in a 1:C cardinality relationship; and ContactPerson, in a 1:CN cardinality relationship.

The package CustomerInvoiceItemPartyAddress includes the entity Address. Address is typed by datatype Address. The package CustomerInvoiceItemPartyContact Person includes the sub-package Address and the entity ContactPerson. ContactPerson is typed by INTERNAL_ContactPerson

A VendorParty is a company or supplier that delivers a good or that provides a service. VendorParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name. VendorParty includes the following node elements: Address, in a 1:C cardinality relationship; and ContactPerson, in a 1:CN cardinality relationship.

The package CustomerInvoiceItemPartyAddress includes the entity Address. Address is typed by datatype Address. The package CustomerInvoiceItemPartyContact Person includes the sub-package Address and the entity ContactPerson. ContactPerson is typed by INTERNAL_ContactPerson.

An EmployeeResponsibleParty is an employee who is responsible for a predecessor document of a CustomerInvoiceItem. EmployeeResponsibleParty includes the following non-node elements: InternalID, TypeCode, AddressReference, FormAddress, and FormattedName. InternalID may have a multiplicity of 1 and may be based on datatype BGDT:PartyInternalID. TypeCode may have a multiplicity of 0 . . . 1 and may be based on datatype BGDT:BusinessObjectTypeCode. AddressReference may have a multiplicity of 0 . . . 1, is a reference to an address of a BusinessTransactionDocumentLocation, and may be based on datatype AGDT:PartyAddressReference. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name. ProductRecipientParty includes the following node elements: Address, in a 1:C cardinality relationship; and ContactPerson, in a 1:CN cardinality relationship.

The package CustomerInvoiceItemPartyAddress includes the entity Address. Address is typed by datatype Address. The package CustomerInvoiceItemPartyContact Person includes the sub-package Address and the entity ContactPerson. ContactPerson is typed by INTERNAL_ContactPerson. The package CustomerInvoiceItemLocation includes the entities ShipToLocation, ShipFromLocation, and ServicePointLocation.

A ShipToLocation is an item location to which goods are delivered. ShipToLocation includes the following non-node elements: InternalID and FormAddress. InternalID may have a multiplicity of 0 . . . 1 and may be based on datatype BGDT:LocationInternalID. FormAddress may have a multiplicity of 0 . . . 1 and may be based on datatype AGDT:FormAddress.

A ShipFromLocation is an item location from which goods are delivered. ShipFromLocation includes the following non-node elements: InternalID and FormAddress. InternalID may have a multiplicity of 0 . . . 1 and may be based on datatype BGDT:LocationInternalID. FormAddress may have a multiplicity of 0 . . . 1 and may be based on datatype AGDT:FormAddress.

A ServicePointLocation is an item location where a service has been or will be performed. ServicePointLocation includes the following non-node elements: InternalID and FormAddress. InternalID may have a multiplicity of 0 . . . 1 and may be based on datatype BGDT:LocationInternalID. FormAddress may have a multiplicity of 0 . . . 1 and may be based on datatype AGDT:FormAddress.

The package CustomerInvoiceItemBusinessTransactionDocumentReference includes the entities PurchaseOrderReference, OriginCustomerInvoiceReference, SalesOrderReference, ServiceOrderReference, ServiceConfirmationReference, CustomerReturnReference, CustomerProjectInvoiceRequisitionReference, OutboundDeliveryReference, OriginOutboundDeliveryReference, and CustomerContractReference. A PurchaseOrderReference is a reference to a purchase order or to an item within a purchase order. PurchaseOrderReference is typed by datatype BusinessTransactionDocumentReference. An OriginCustomerInvoiceReference is a reference to an item of a CustomerInvoice reversed, corrected or credited by a CustomerInvoice. OriginCustomerInvoiceReference is typed by datatype BusinessTransactionDocumentReference. A SalesOrderReference is a reference to an order or an item within an order. SalesOrderReference is typed by datatype BusinessTransactionDocumentReference. ServiceOrderReference is a reference to a service order or an item within a service order. ServiceOrderReference is typed by datatype BusinessTransactionDocumentReference. ServiceConfirmationReference is a reference to a service confirmation or an item within a service confirmation. ServiceConfirmationReference is typed by datatype BusinessTransactionDocumentReference. CustomerReturnReference is a reference to a customer return or an item within a customer return. CustomerReturnReference is typed by datatype BusinessTransactionDocumentReference. CustomerProjectInvoiceRequisitionReference is the reference to a customer's project invoice requisition or an item within a customer's project invoice requisition. CustomerProjectInvoiceRequisitionReference is typed by datatype BusinessTransactionDocumentReference. OutboundDeliveryReference is a reference to an outbound delivery or an item within an outbound delivery. OutboundDeliveryReference is typed by datatype BusinessTransactionDocumentReference. OriginOutboundDeliveryReference is a reference to an origin outbound delivery or to an item within an outbound delivery. OriginOutboundDeliveryReference is typed by datatype BusinessTransactionDocumentReference. CustomerContractReference is a reference to a customer contract or an item within a customer contract. CustomerContractReference is typed by datatype BusinessTransactionDocumentReference.

The package CustomerInvoiceItemAttachment includes the sub-package Document and the entity AttachmentFolder. An AttachmentFolder is a collection of documents that are as signed to a CustomerInvoiceItem. AttachmentFolder is typed by datatype AttachmentFolder.

The package CustomerInvoiceItemTextCollection includes the entity TextCollection. A TextCollection is a collection of textual descriptions provided by and valid for an invoice document. TextCollection includes the Text non-node element. Text may have a multiplicity of 0 . . . * and may be based on datatype FMIDT:FormTextCollectionText. Text can include the following non-node elements: TypeCode, TypeName, SystemAdministrativeData, CreationDateTime, and ContentText. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_MEDIUMName. SystemAdministrativeData may have a multiplicity of 0 . . . 1 and may be based on datatype FMIDT:FormSystemAdministrativeData. SystemAdministrativeData may include CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName. CreationDateTime may have a multiplicity of 1 and may be based on datatype CDT:LOCAL_DateTime. CreationIdentityUUID may have a multiplicity of 0 . . . 1 and may be based on datatype BGDT:UUID. CreationUserAccountID may have a multiplicity of 0 . . . 1 and may be based on datatype BGDT:UserAccountID. CreationBusinessPartnerFormattedName may have a multiplicity of 0 . . . 1 and may be based on datatype CDT:LANGUAGEINDEPENDENT_LONG_Name. LastChangeDateTime may have a multiplicity of 0 . . . 1 and may be based on datatype CDT:LOCAL_DateTime. LastChangeIdentityUUID may have a multiplicity of 0 . . . 1 and may be based on datatype BGDT:UUID. LastChangeUserAccountID may have a multiplicity of 0 . . . 1 and may be based on datatype BGDT:UserAccountID. LastChangeBusinessPartnerFormattedName may have a multiplicity of 0 . . . 1 and may be based on datatype CDT:LANGUAGEINDEPENDENT_LONG_Name. CreationDateTime may have a multiplicity of 0 . . . 1 and may be based on datatype CDT:LOCAL_DateTime. ContentText may have a multiplicity of 1 and may be based on datatype CDT:Text.

The package CustomerInvoiceItemAccountingCodingBlockAssignment includes the entity AccountingCodingBlockAssignment. AccountingCodingBlockAssignment includes accounting objects to which expenses or revenues of an item are assigned. AccountingCodingBlockAssignment is typed by datatype AccountingCodingBlockAssignment. There can be one or more AccountingCodingBlockAssignment for each OrderItem.

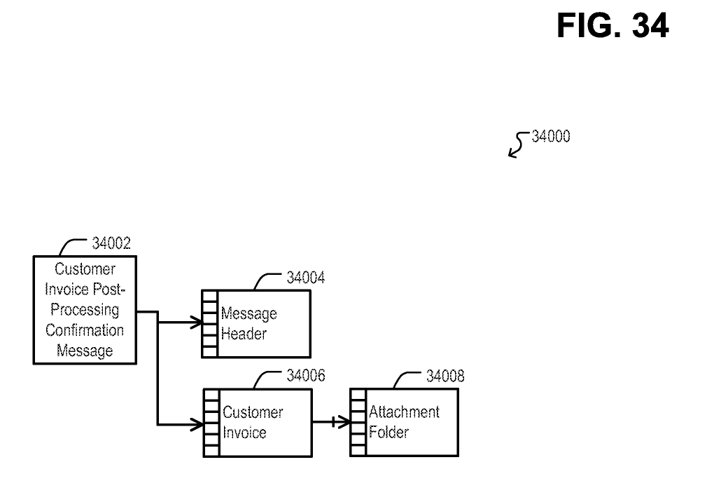

FIG. 34 illustrates one example logical configuration of a Customer Invoice Post-Processing Confirmation message 34000. Specifically, this figure depicts the arrangement and hierarchy of various components such as one or more levels of packages, entities, and data types, shown here as 34002 through 34008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Invoice Post-Processing Confirmation message 34000 includes, among other things, the Customer Invoice entity 34006. Accordingly, heterogeneous applications may communicate using this consistent message configured as such.

The message type Customer Invoice Post-Processing Confirmation is derived from the business object Customer Invoice as a leading object together with its operation signature. The message type Customer Invoice Post-Processing Confirmation is a confirmation about post-processing for a customer invoice. The structure of the message type Customer Invoice Post-Processing Confirmation is determined by the message data type CustomerInvoicePostProcessingMessage. The message data type CustomerInvoicePostProcessingMessage includes the MessageHeader package and the CustomerInvoice package. The package MessageHeader includes the sub-packages Party and Business Scope and the entity MessageHeader. MessageHeader is typed by datatype BusinessDocumentMessageHeader.

The package CustomerInvoice includes the sub-package Attachment and the entity CustomerInvoice. A CustomerInvoice is a binding statement of amounts receivable, receivables adjustments, and/or credit memos to a business partner specifying terms of delivery and payment. The receivables, receivables adjustments, and credit memos can be described in detail in items, where applicable with reference to goods or services. A CustomerInvoice root node can include identifying and administrative data. CustomerInvoice includes the following non-node elements: ID and UUID. ID may have a multiplicity of 1 and may be based on datatype BGDT:BusinessTransactionDocumentID. UUID may have a multiplicity of 0 . . . 1 and may be based on datatype BGDT:UUID, CustomerInvoice includes the following node elements: AttachmentFolder, in a 1:C cardinality relationship.

The package CustomerInvoiceAttachment includes the sub-package Document and the entity AttachmentFolder. AttachmentFolder is a collection of documents that are assigned to a CustomerInvoice. AttachmentFolder is typed by datatype AttachmentFolder.

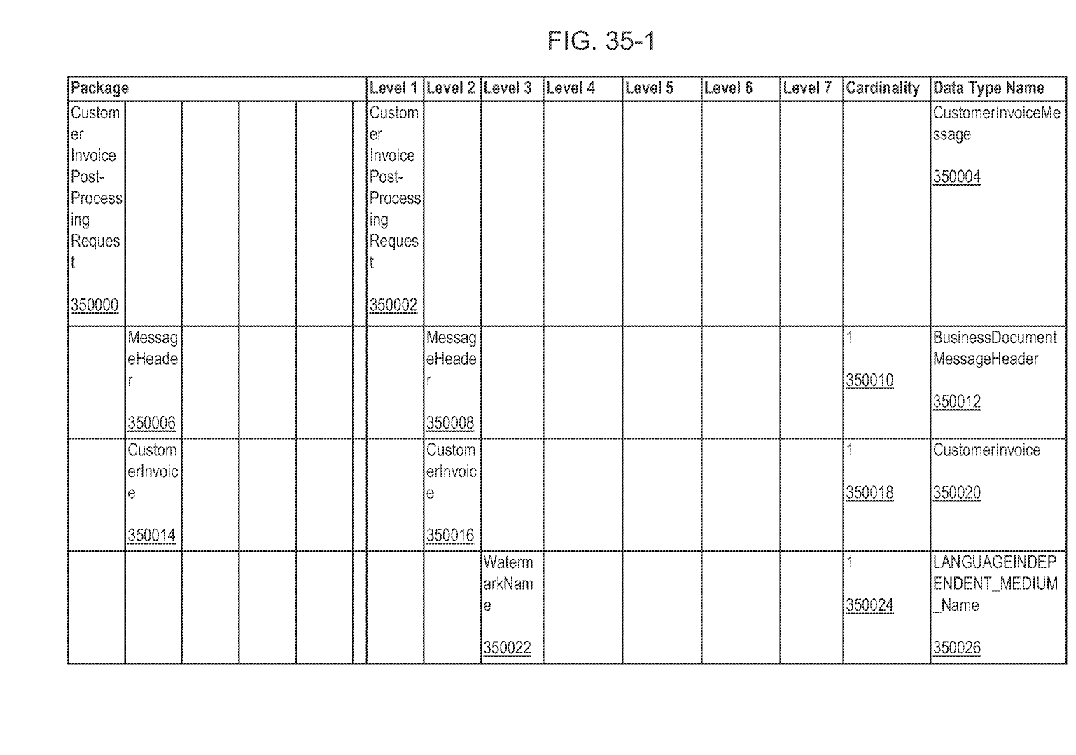

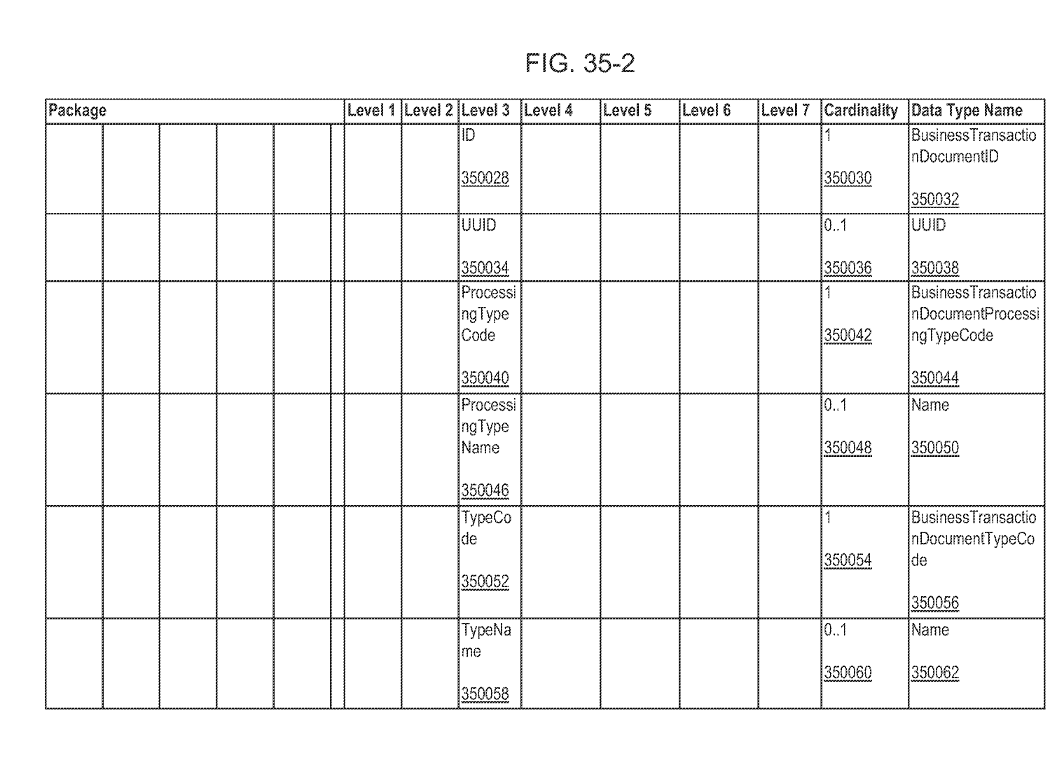

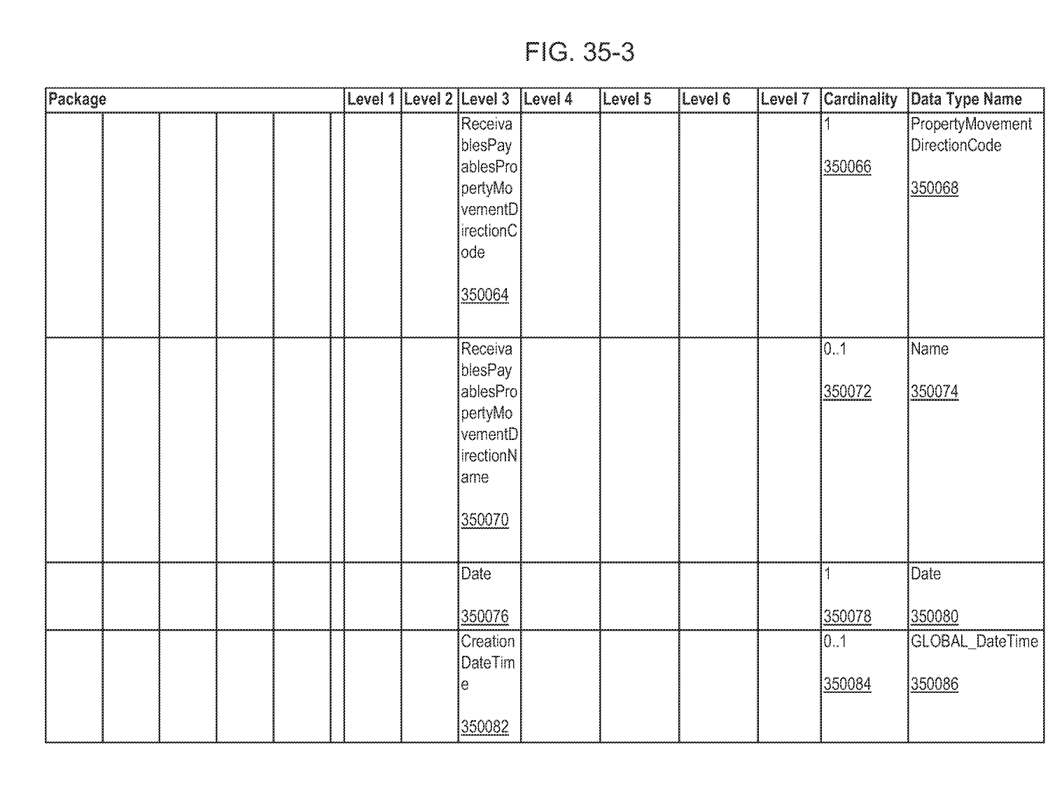

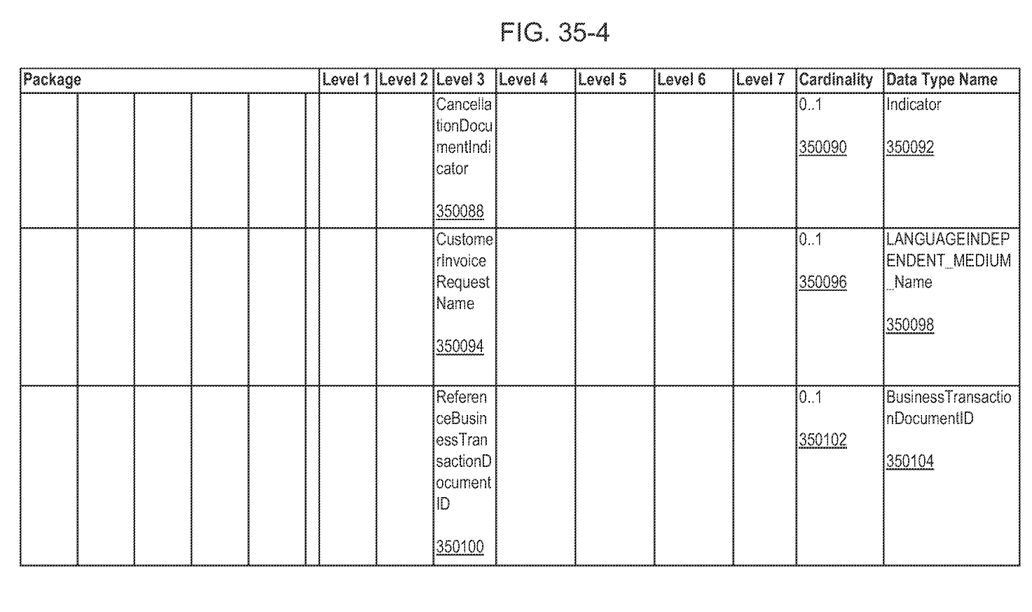

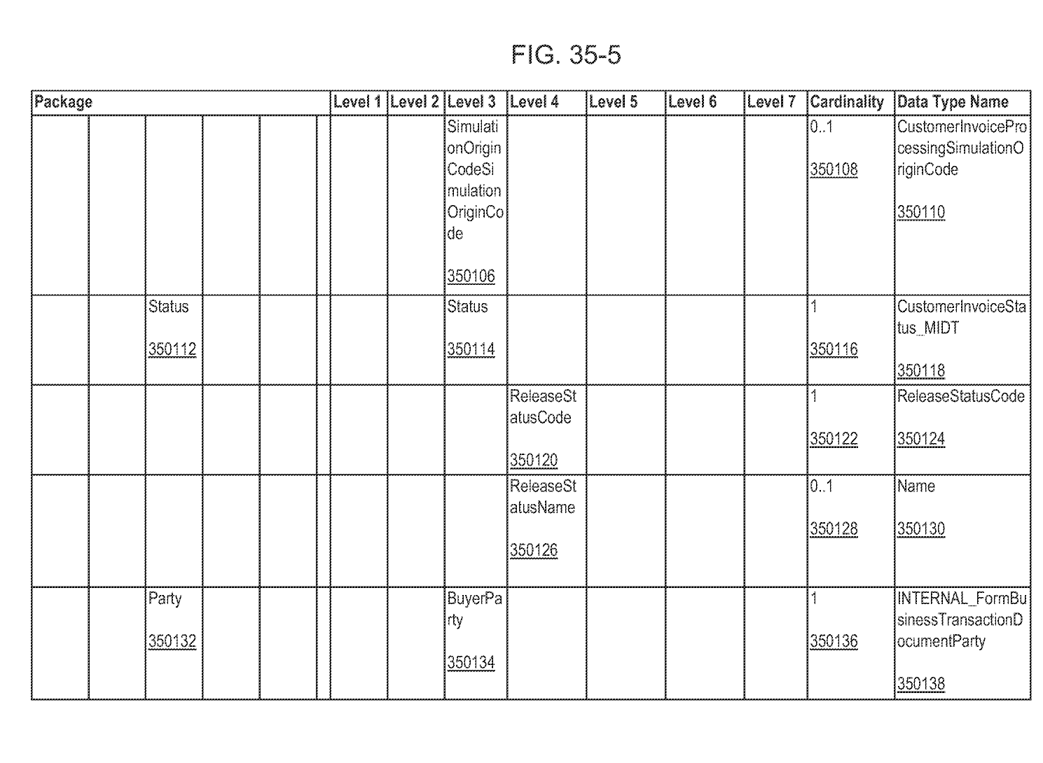

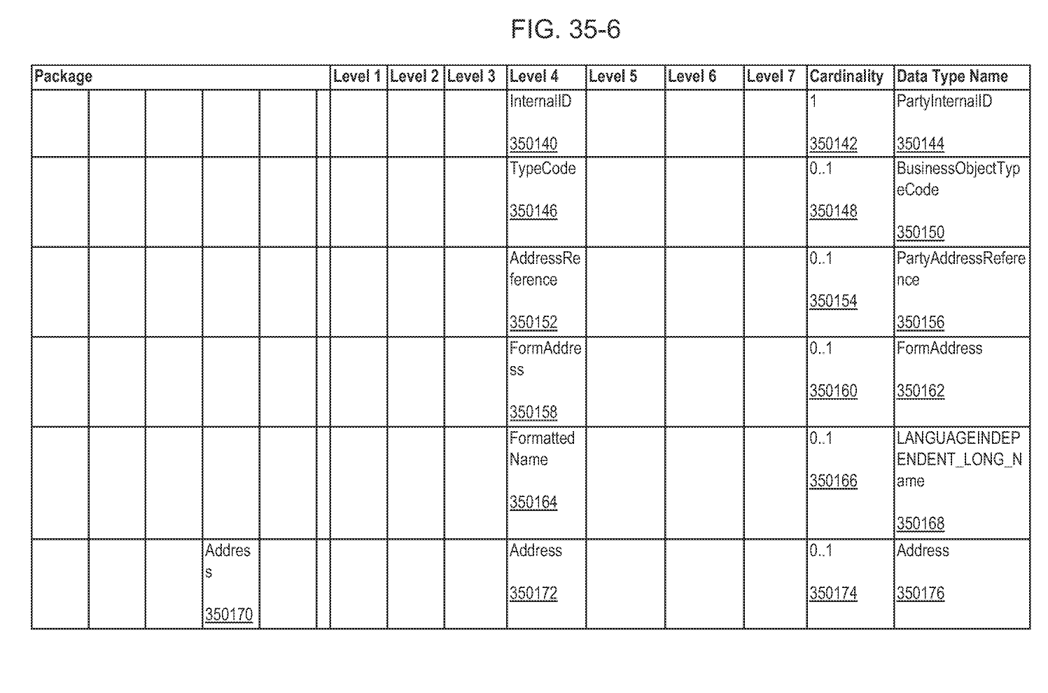

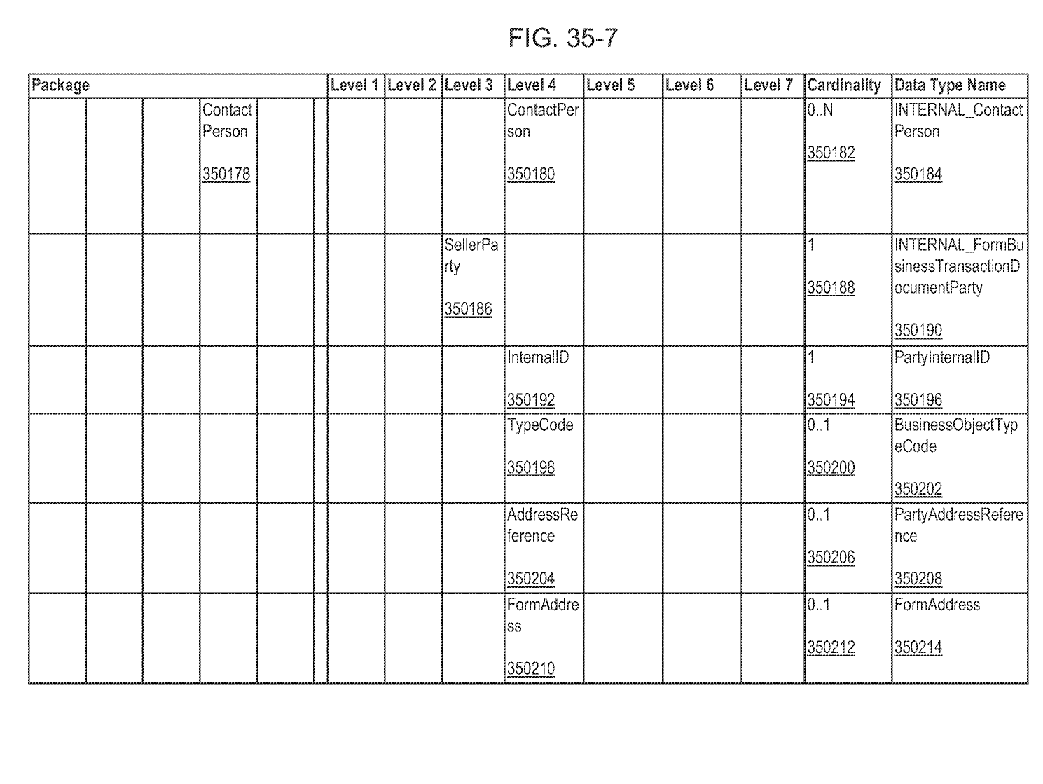

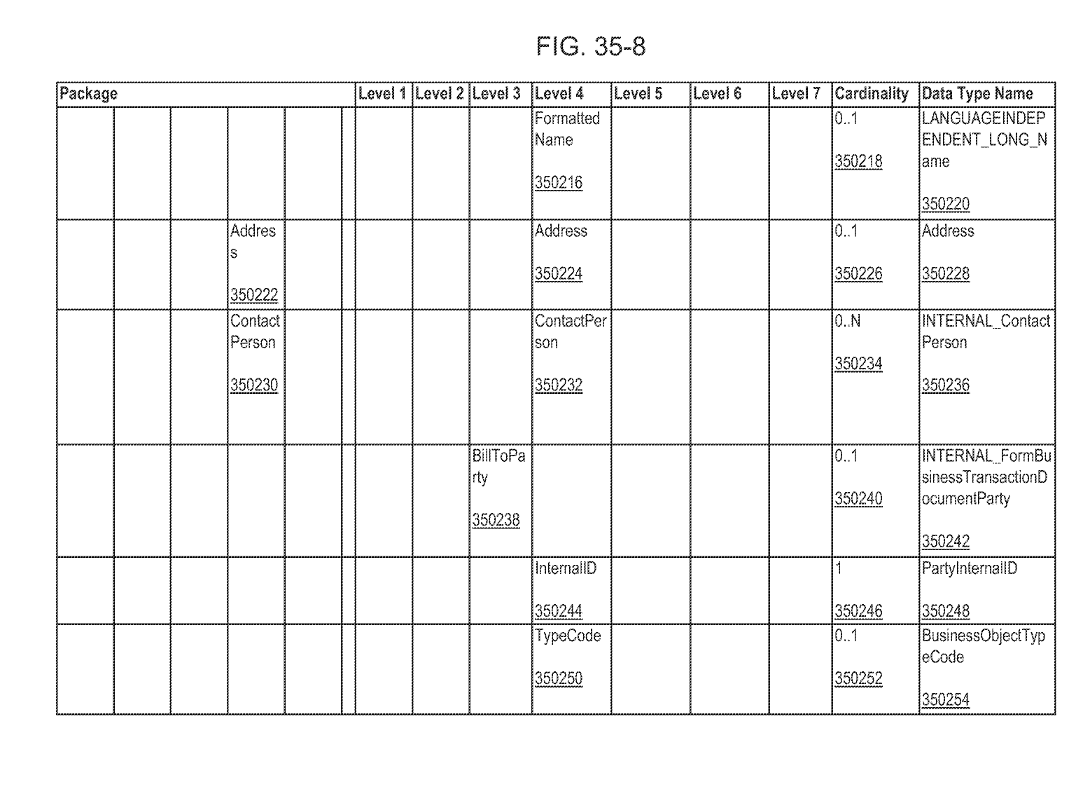

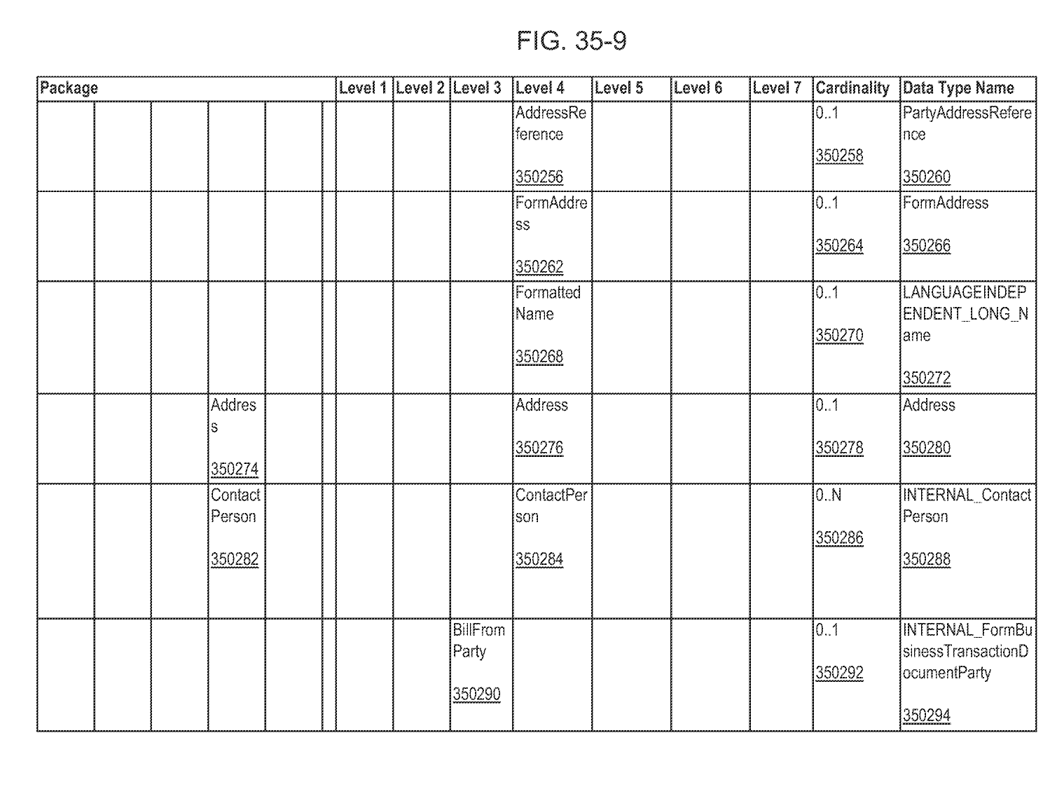

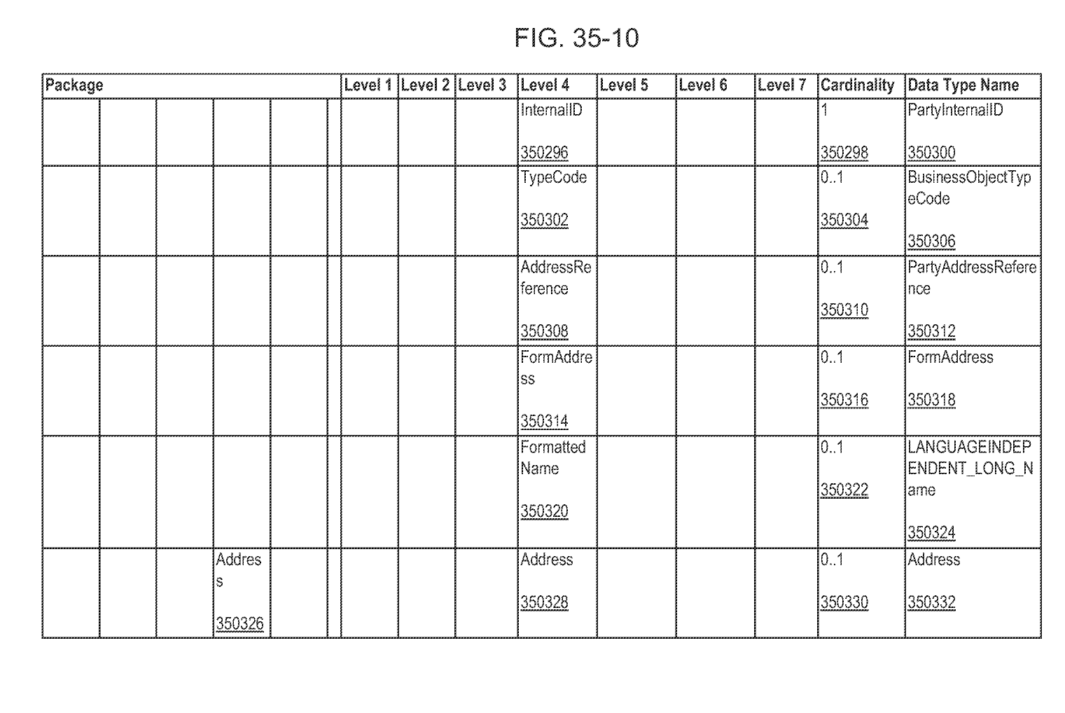

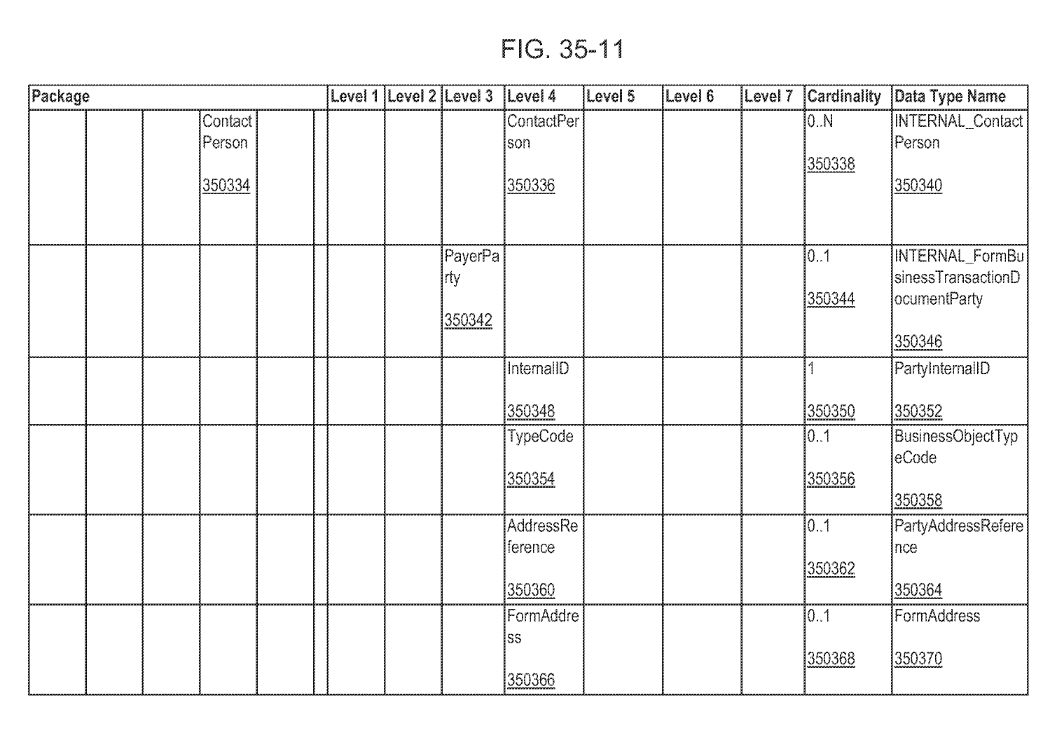

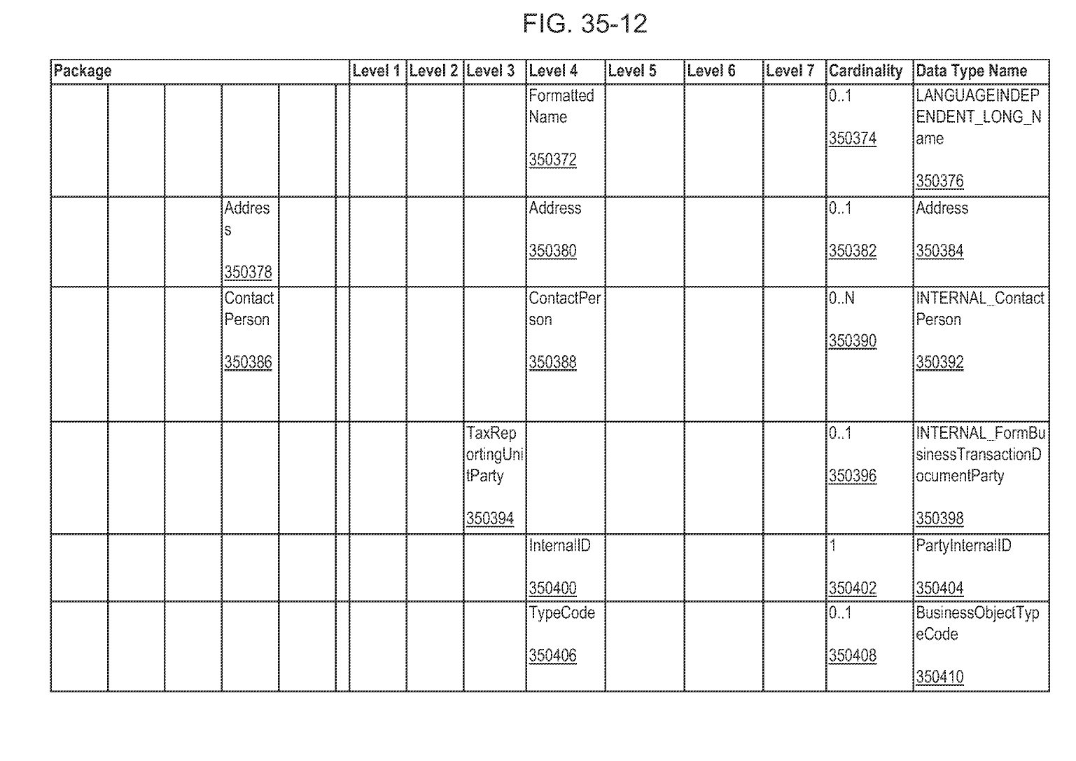

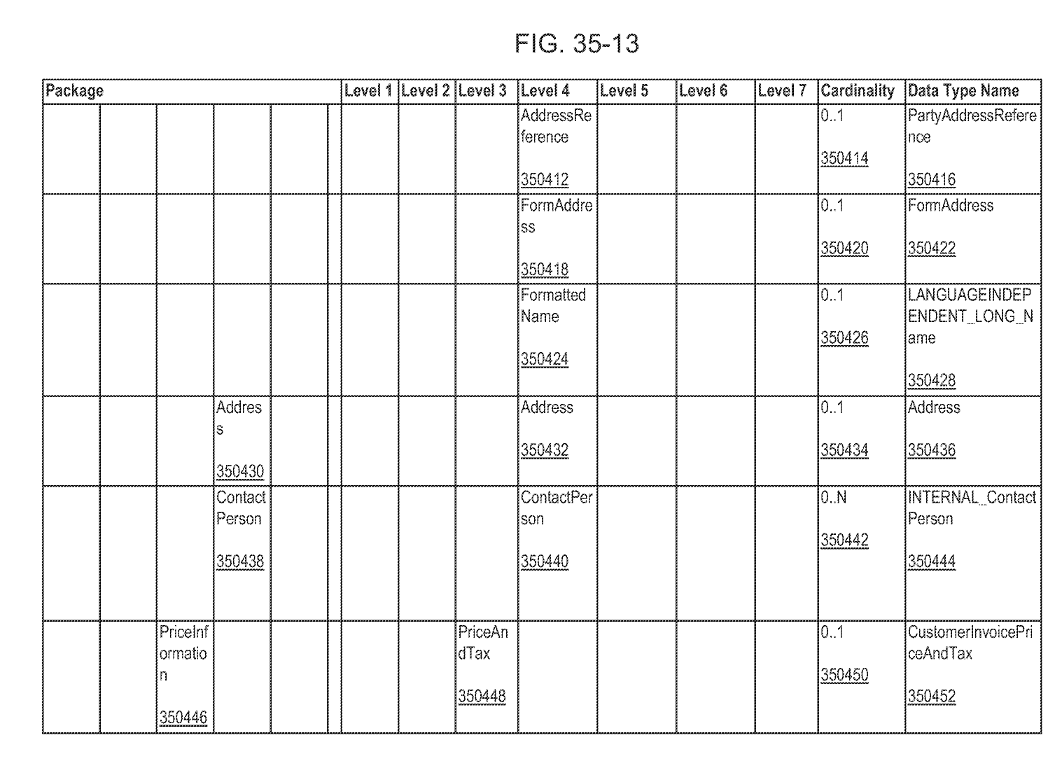

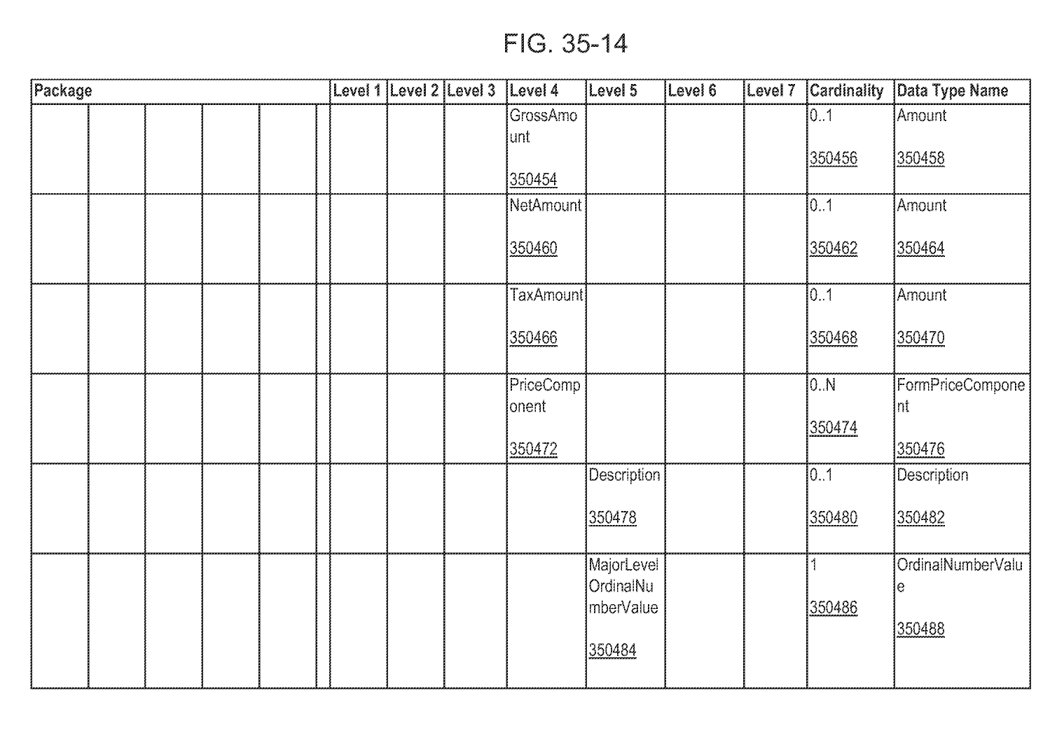

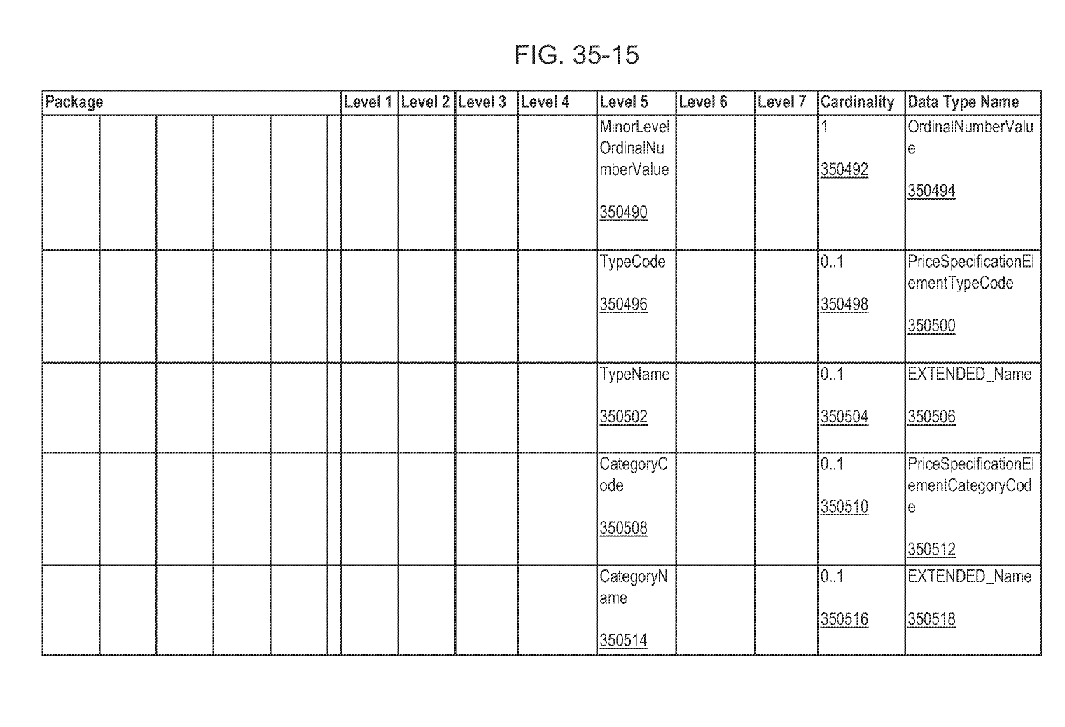

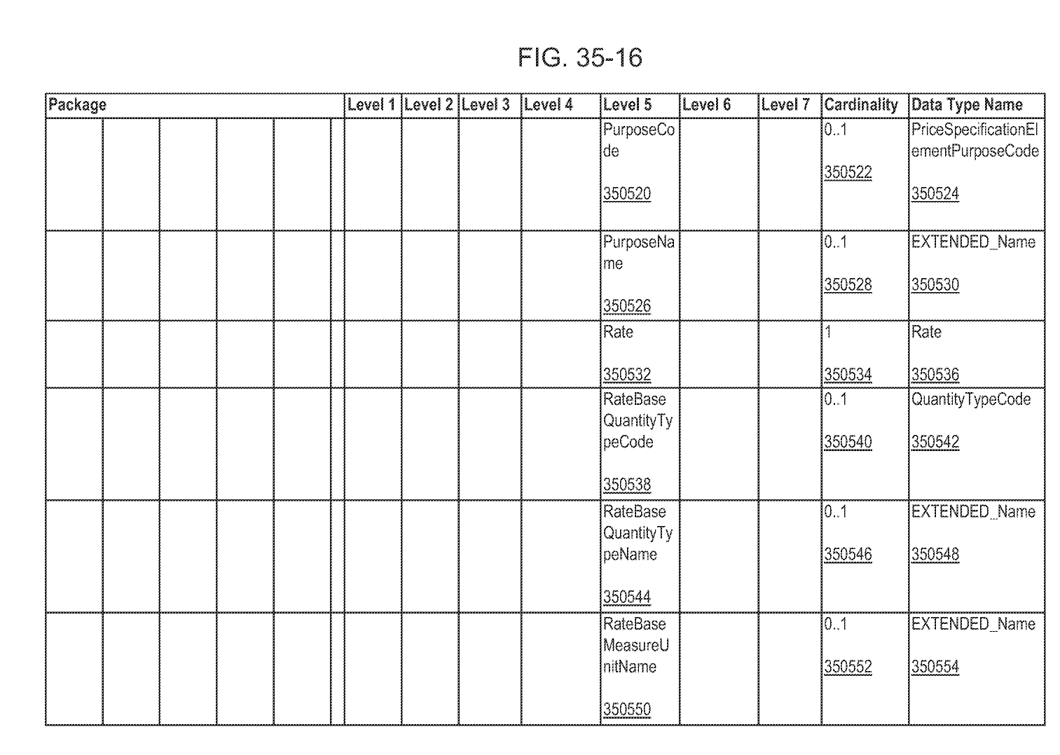

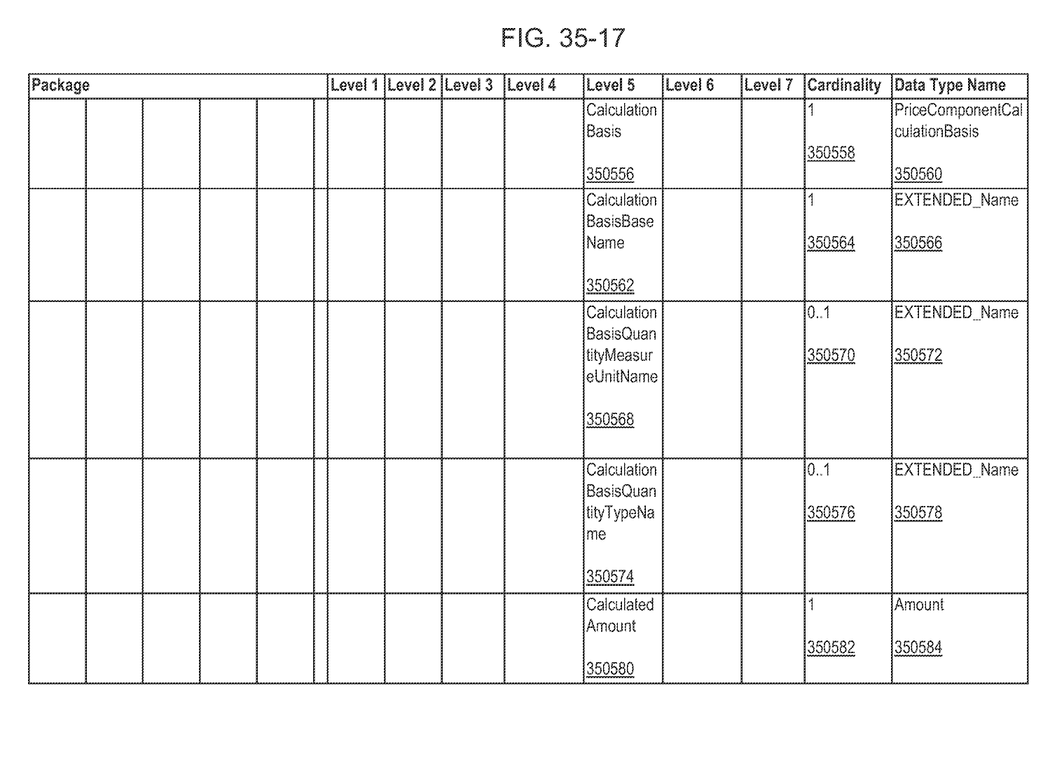

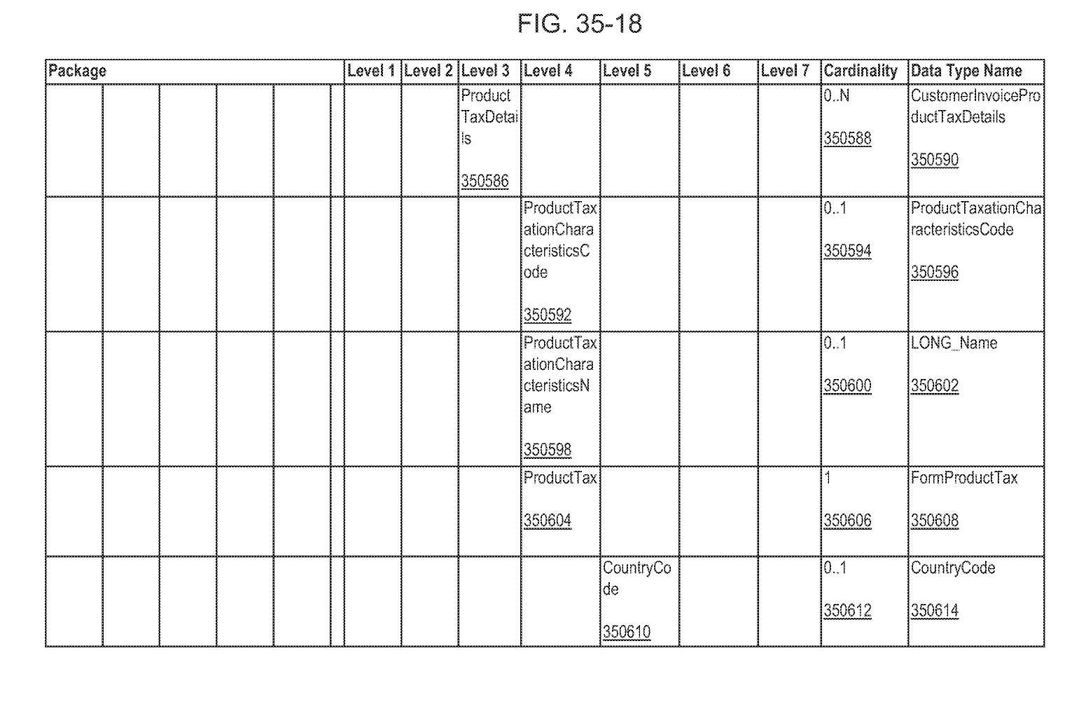

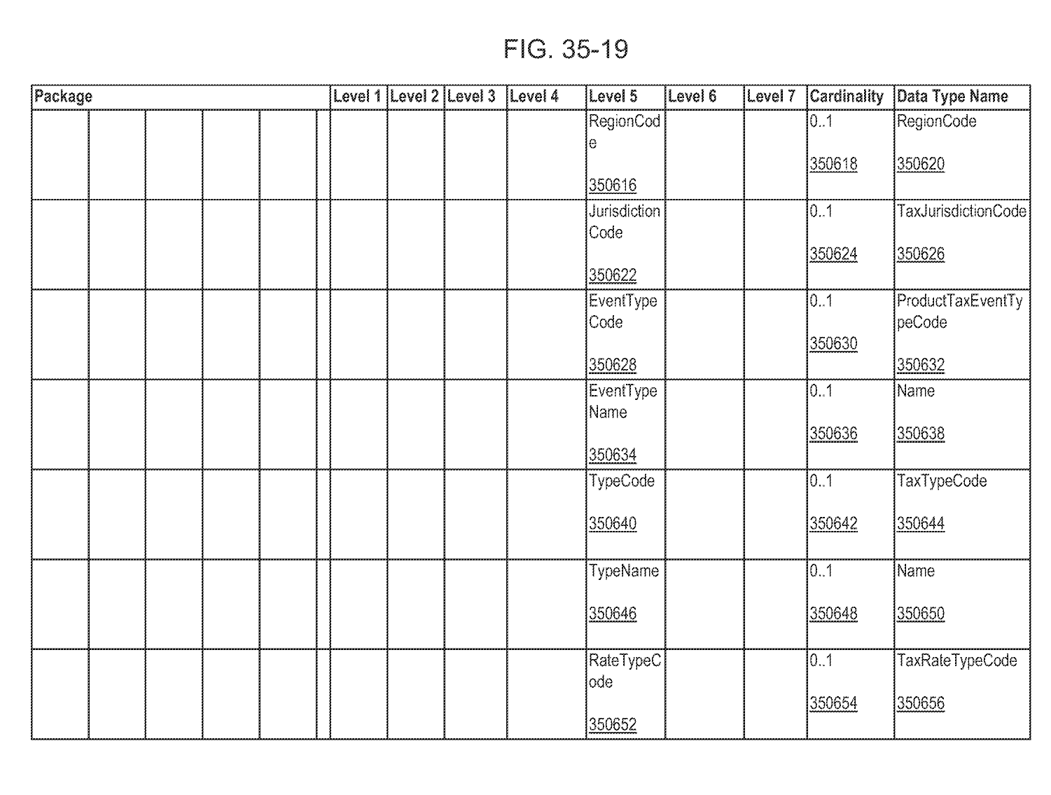

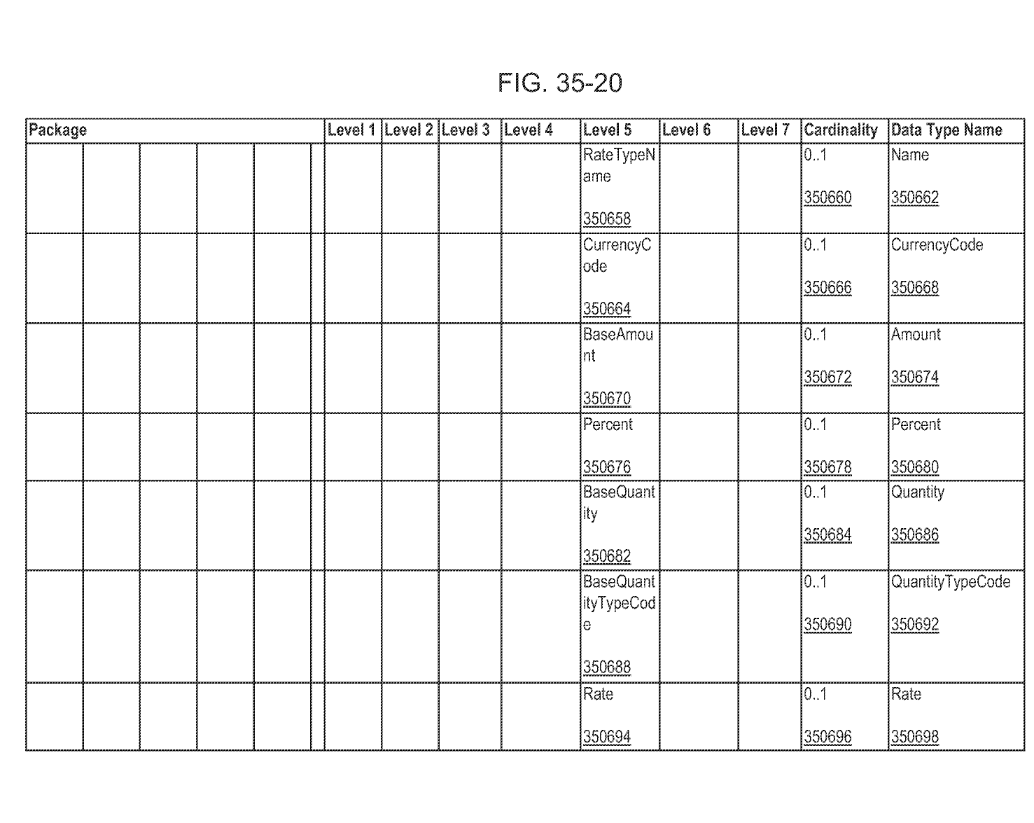

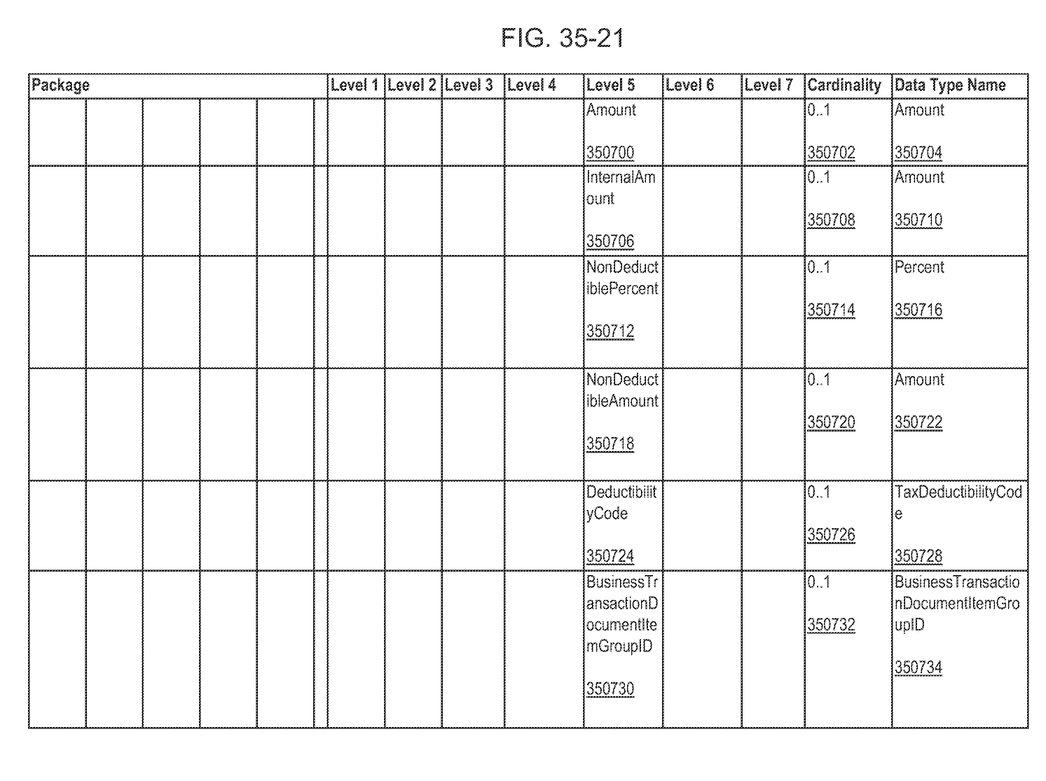

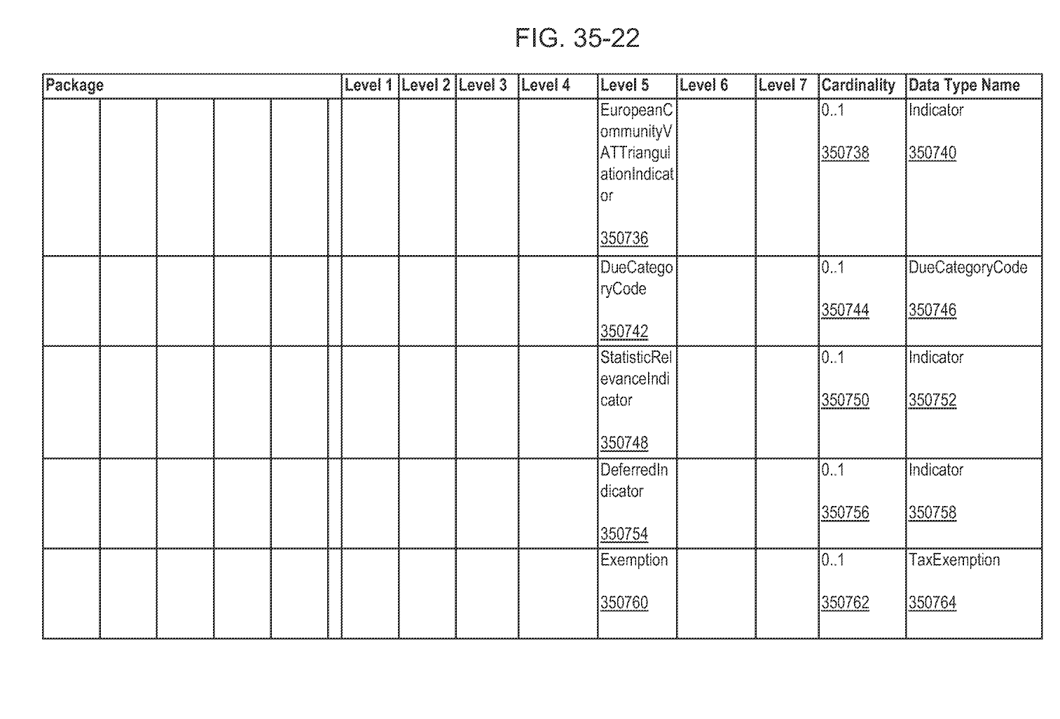

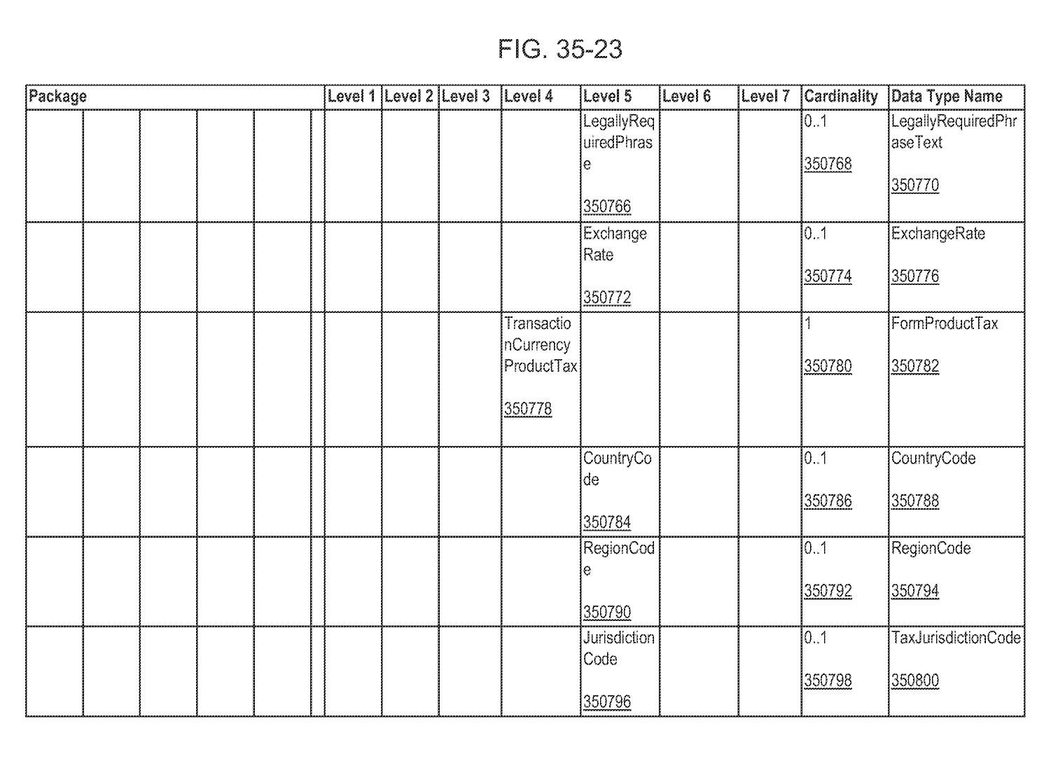

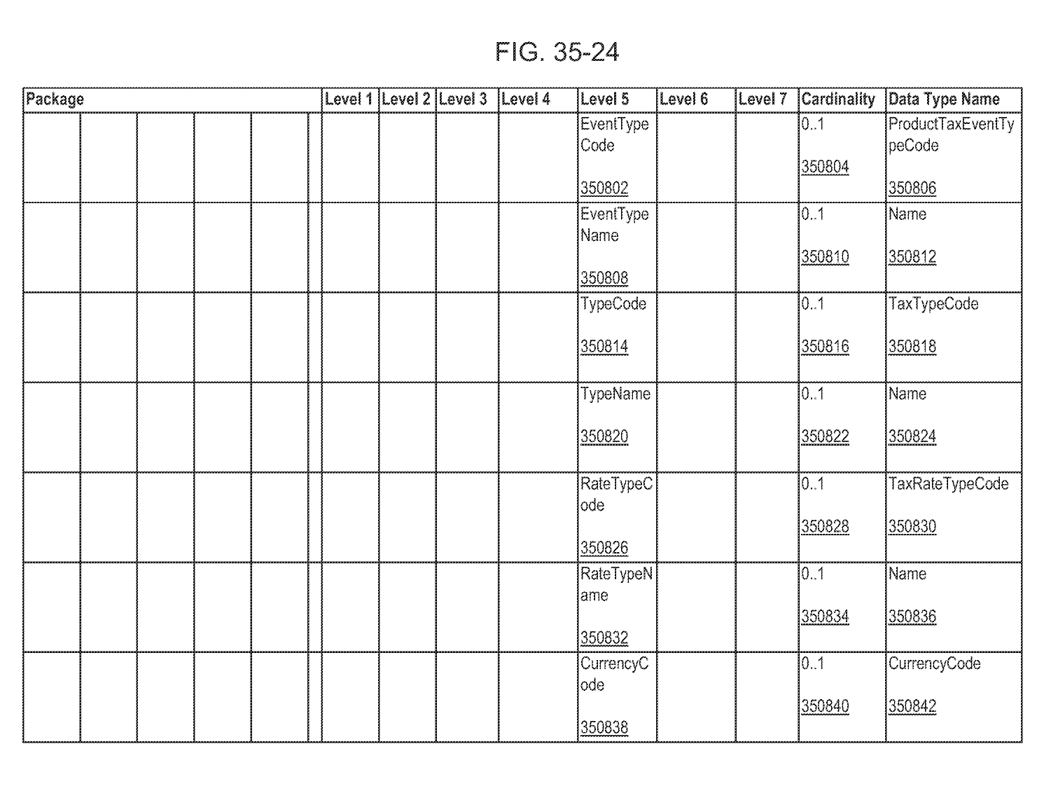

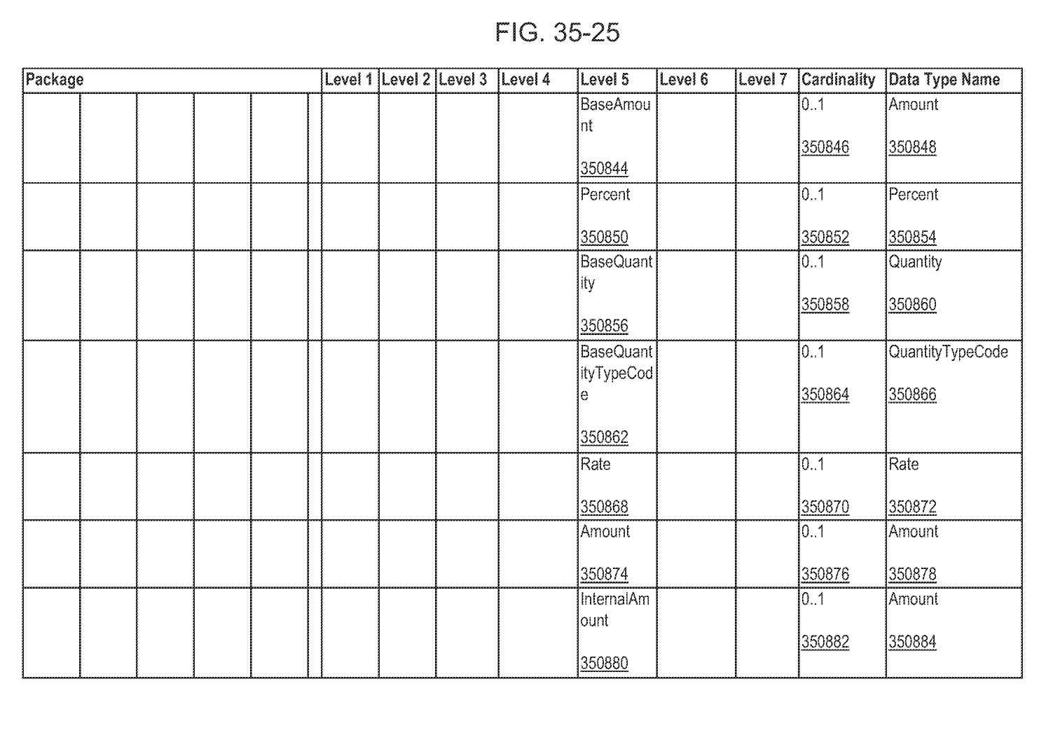

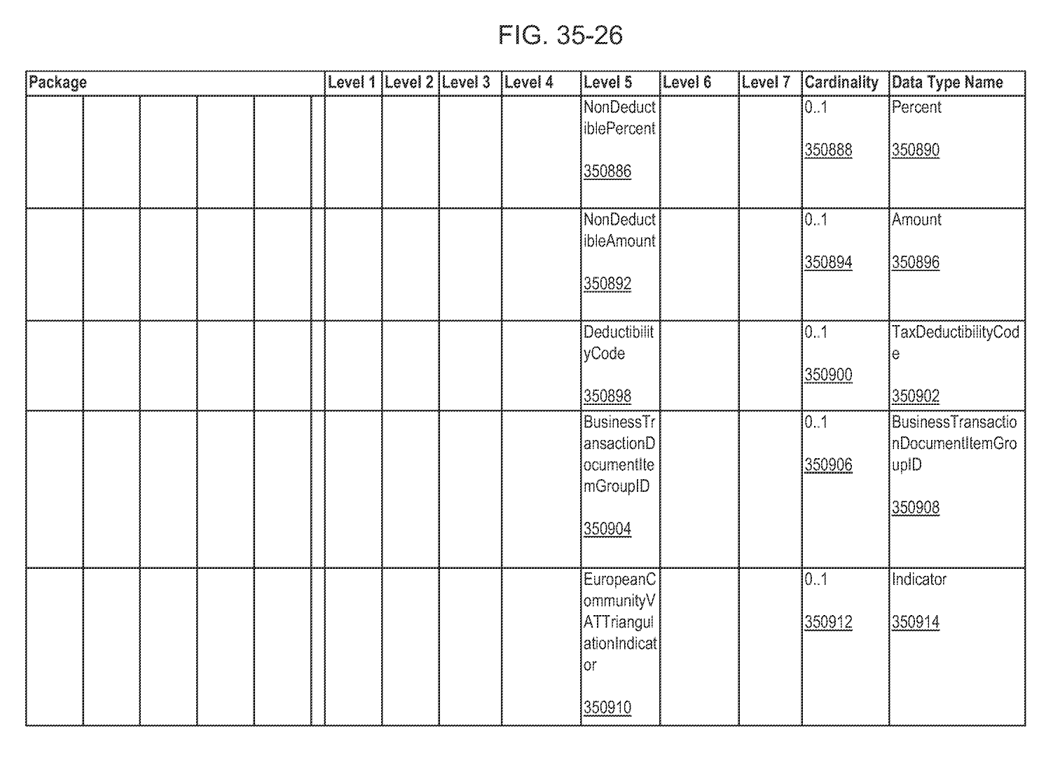

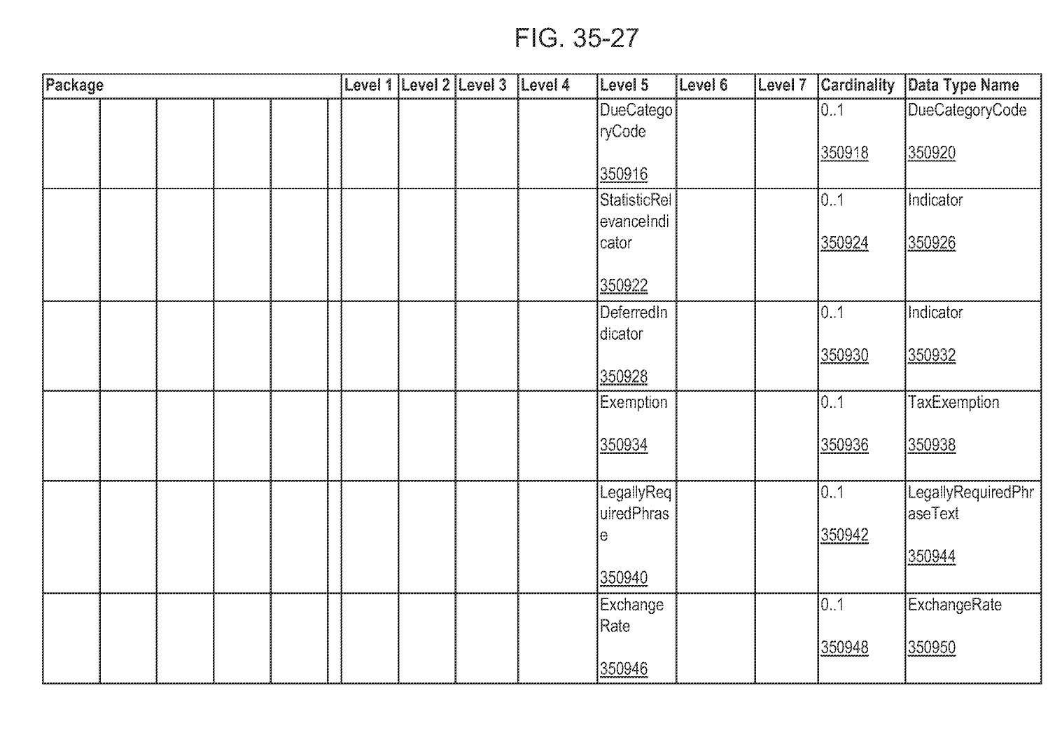

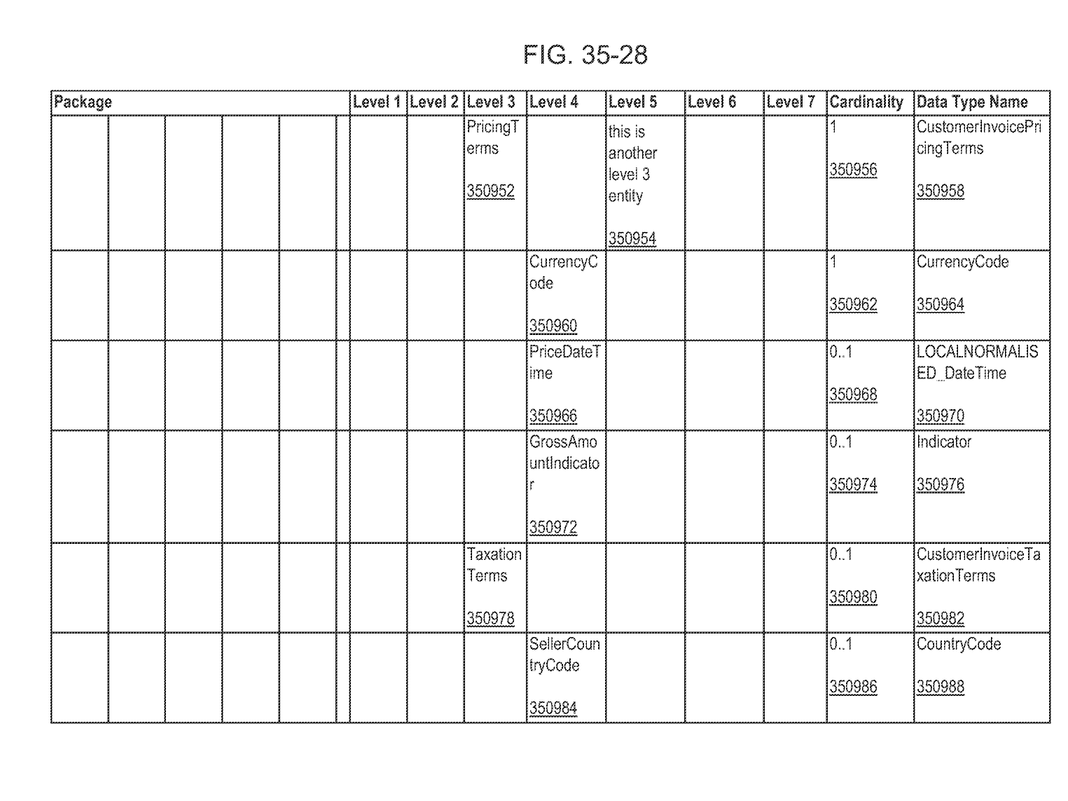

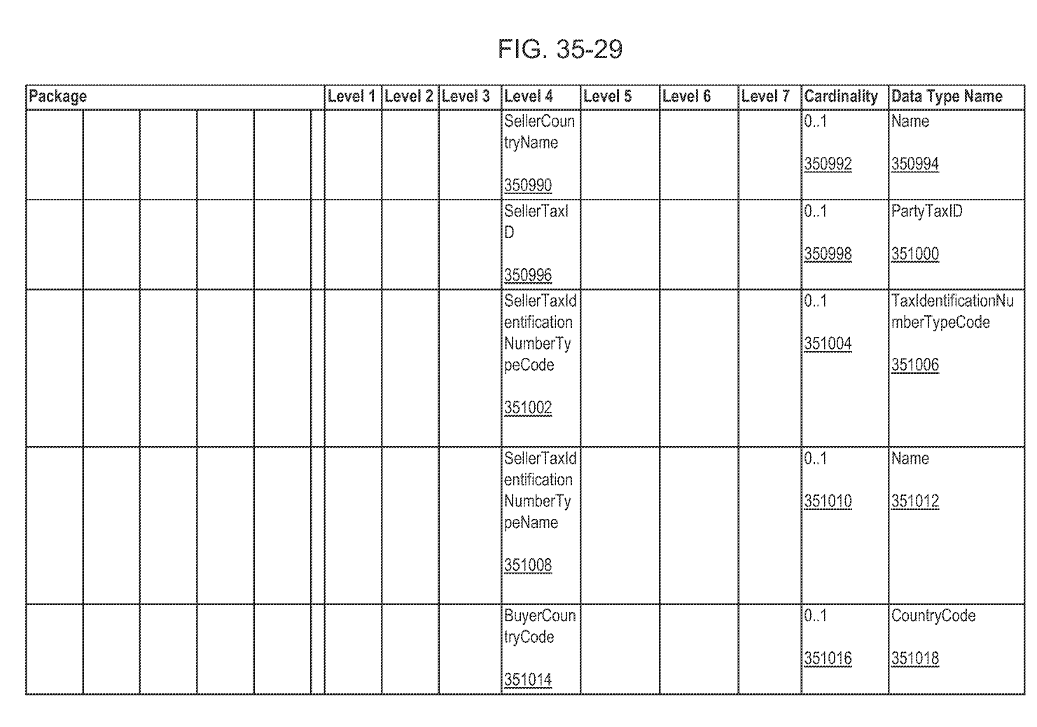

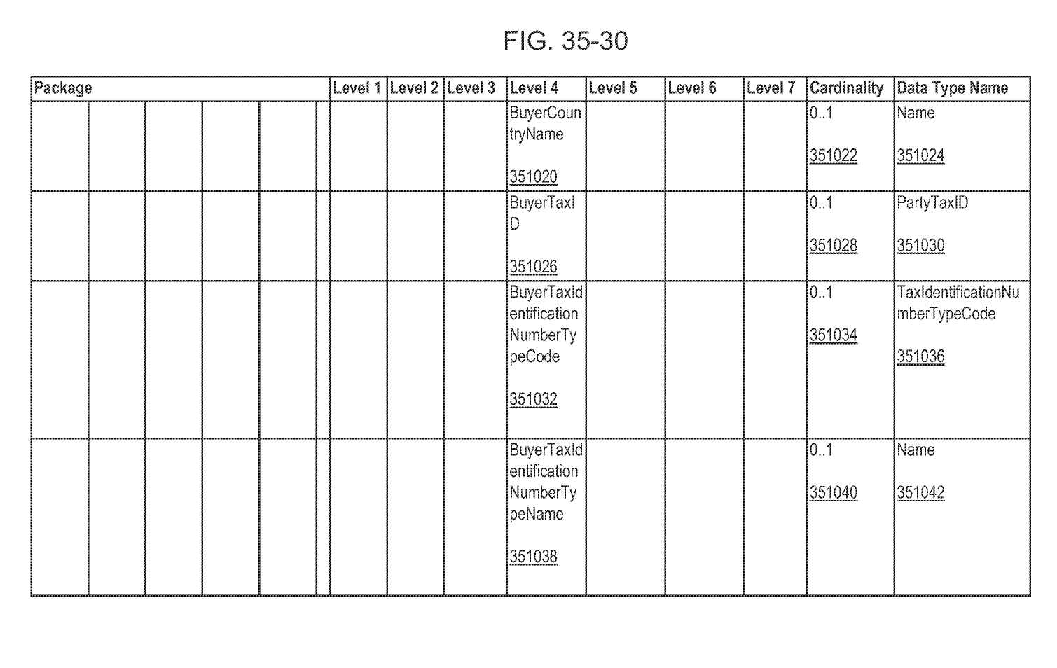

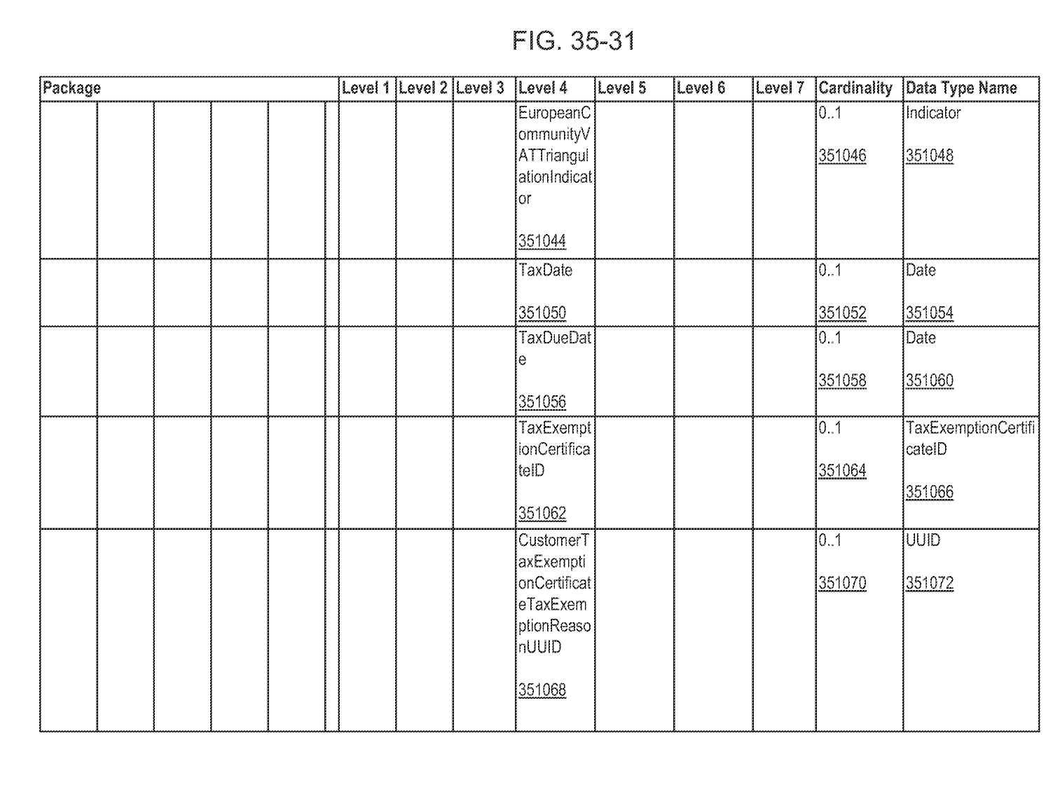

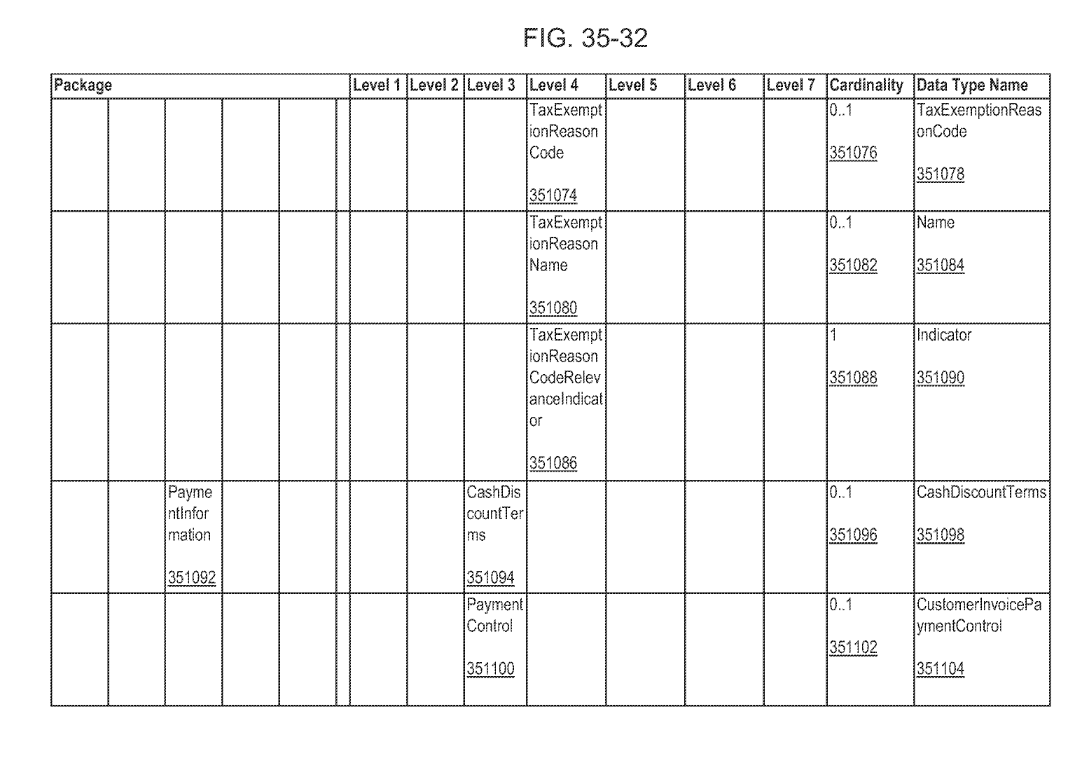

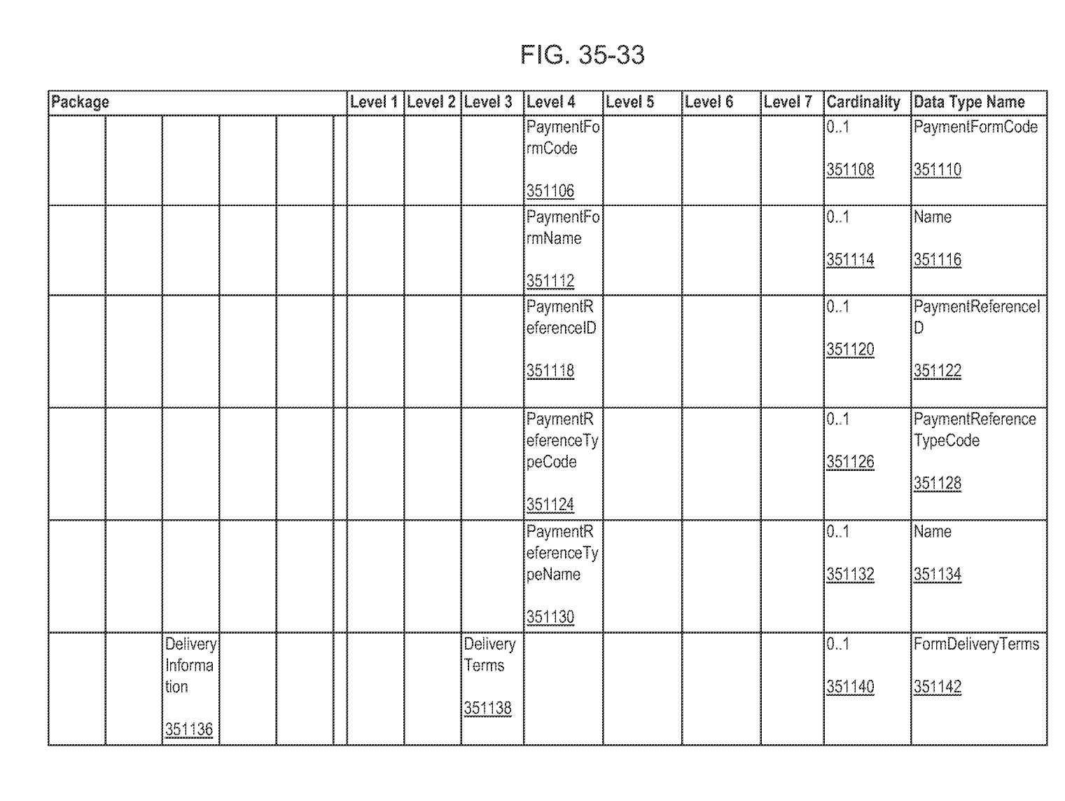

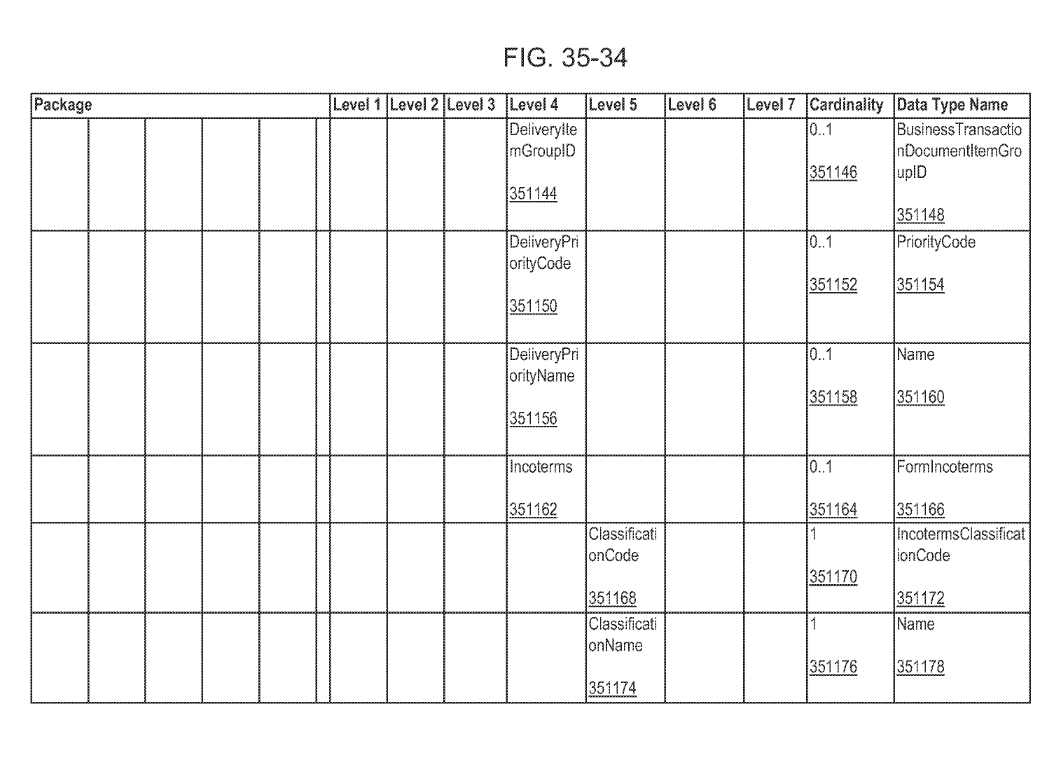

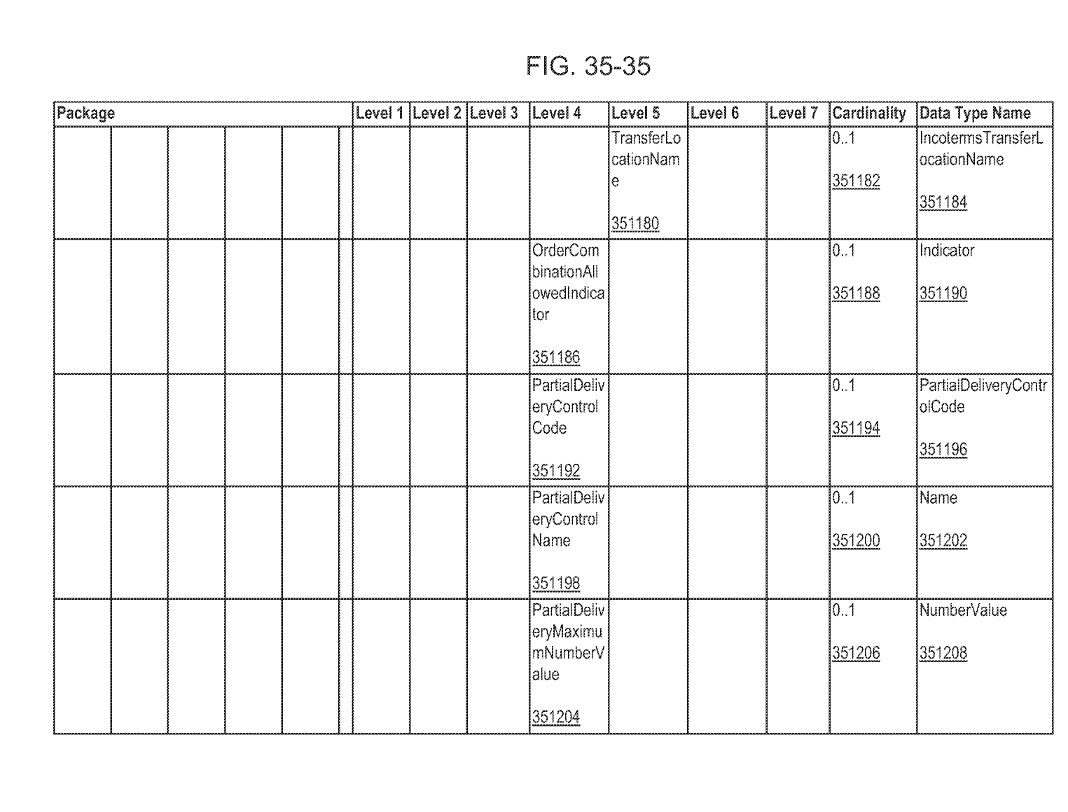

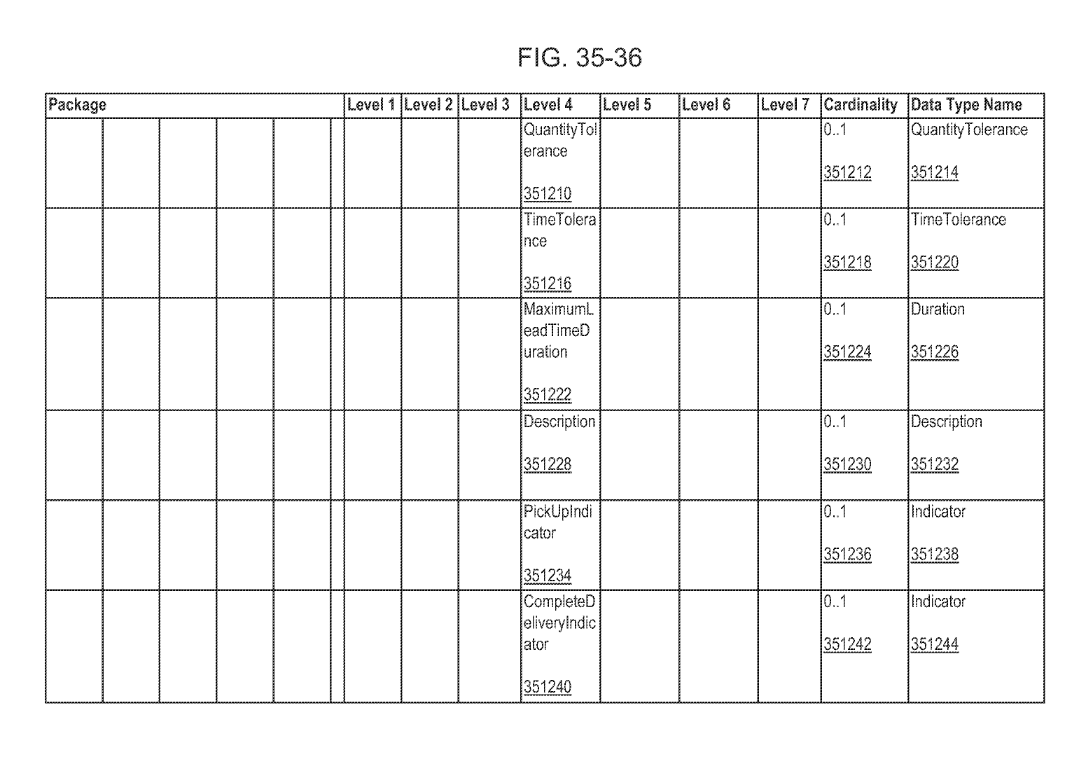

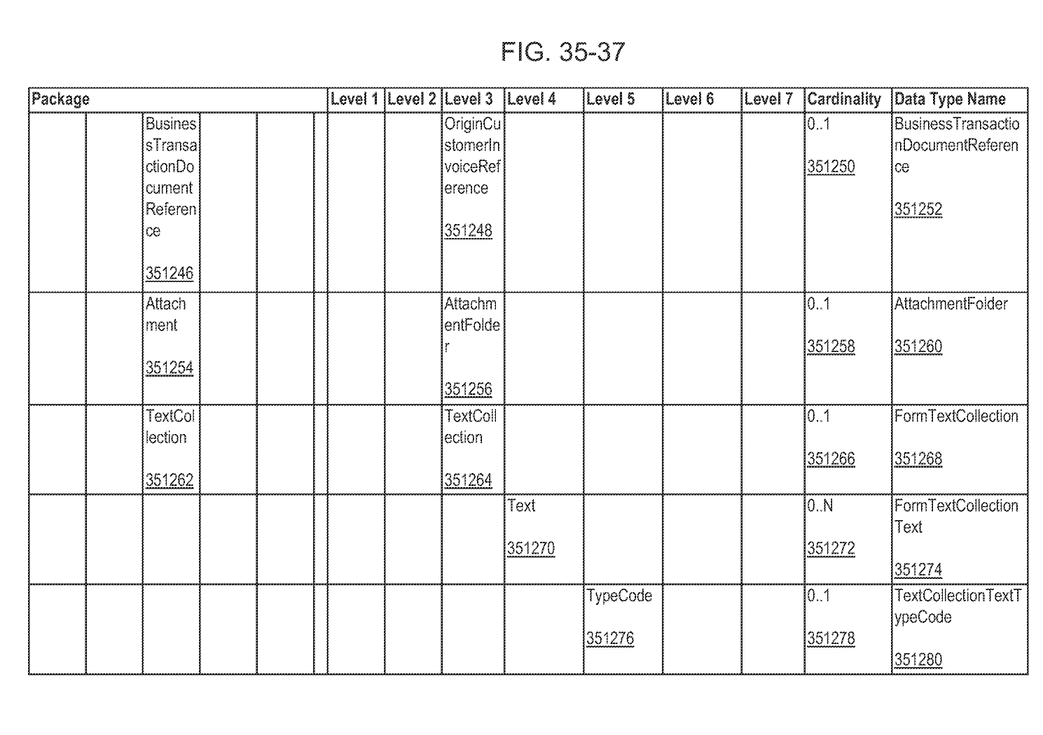

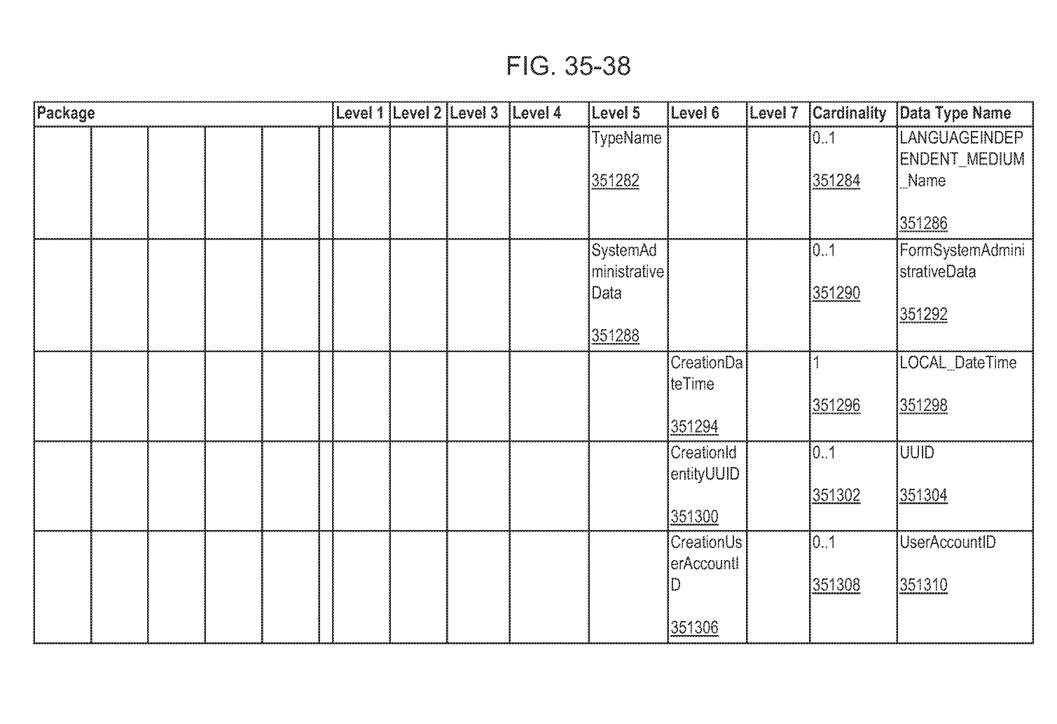

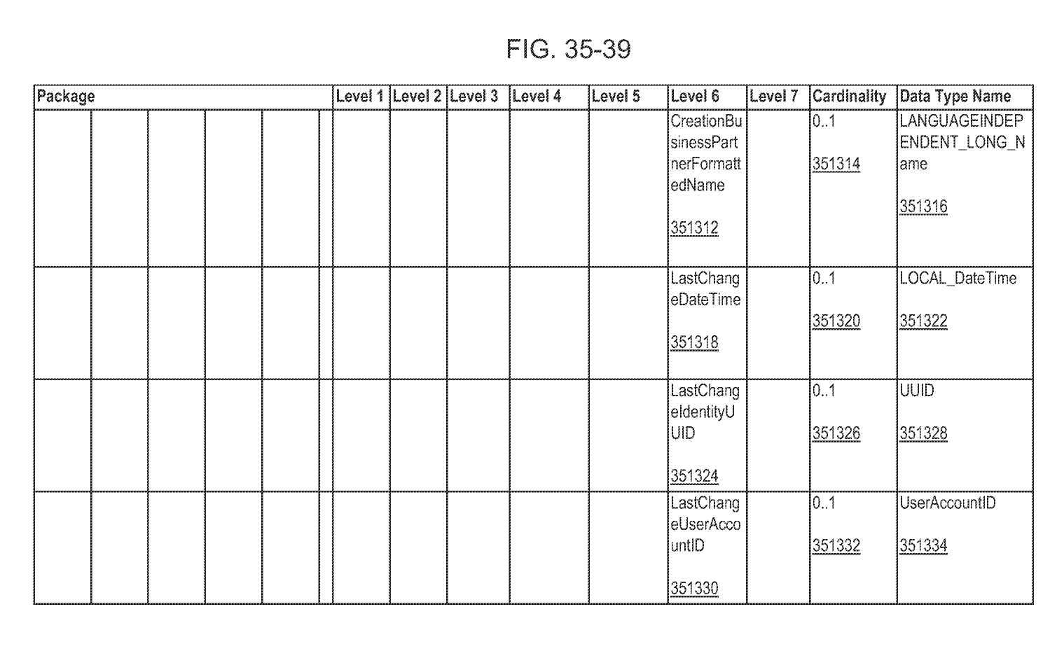

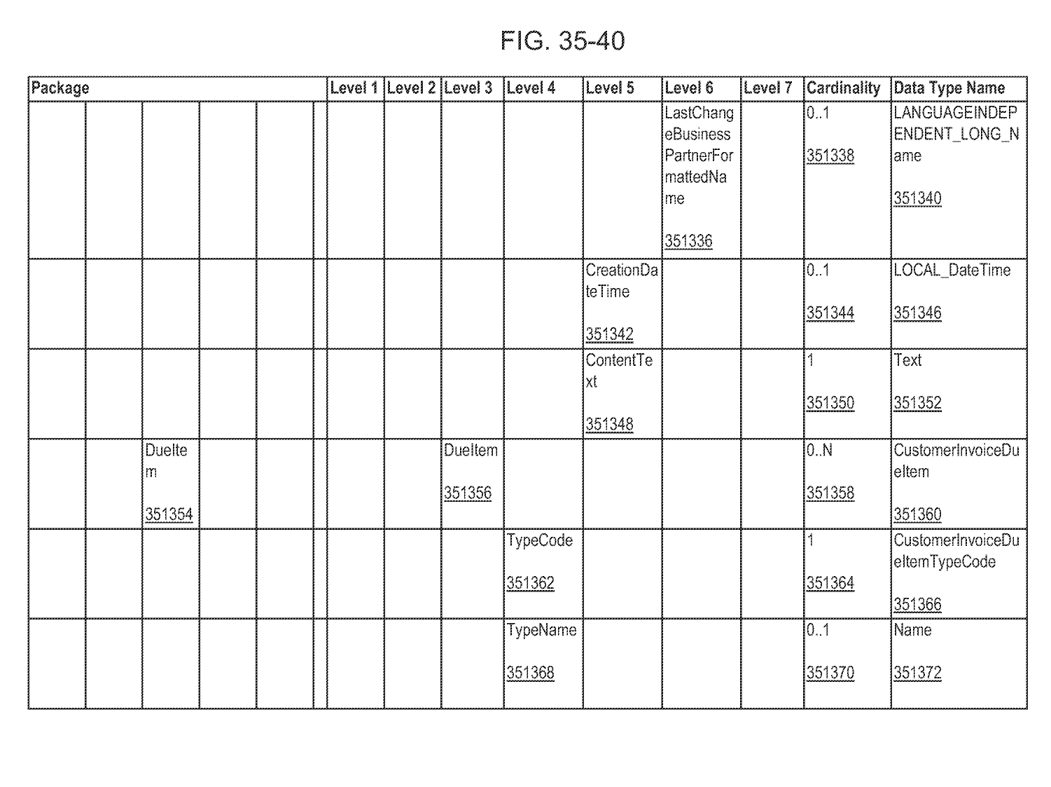

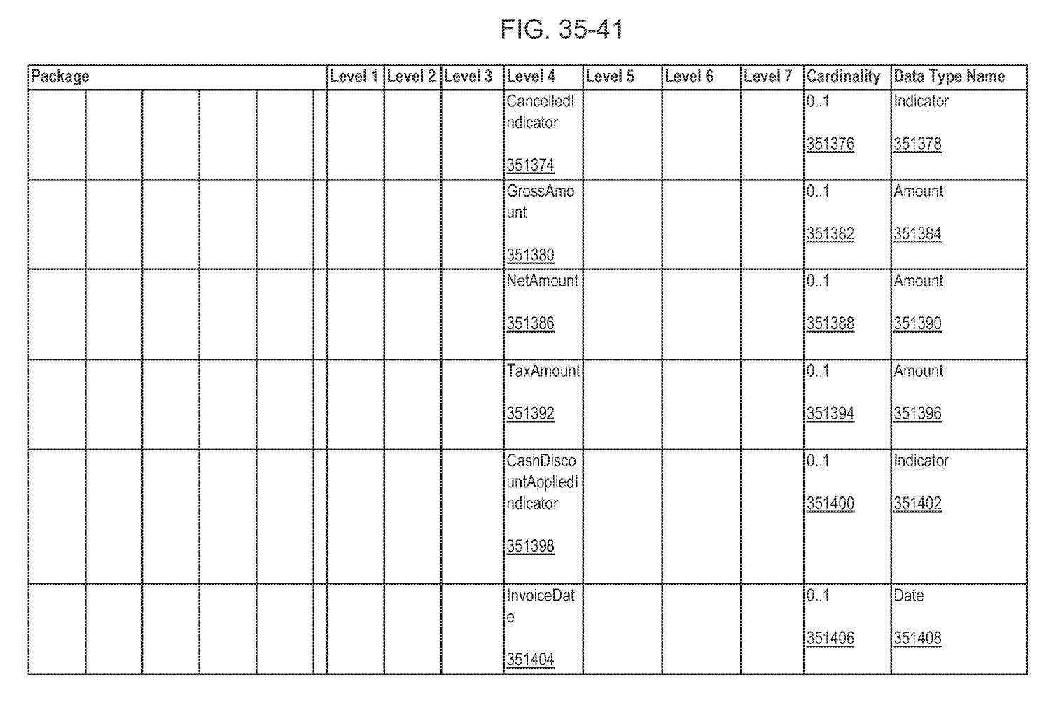

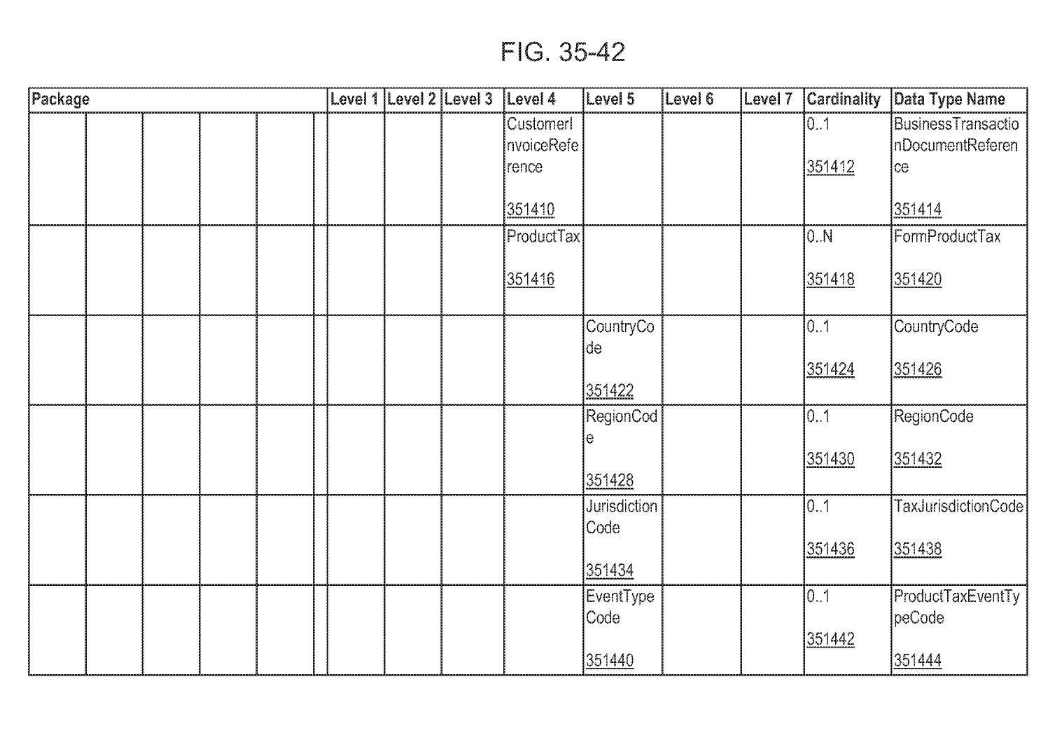

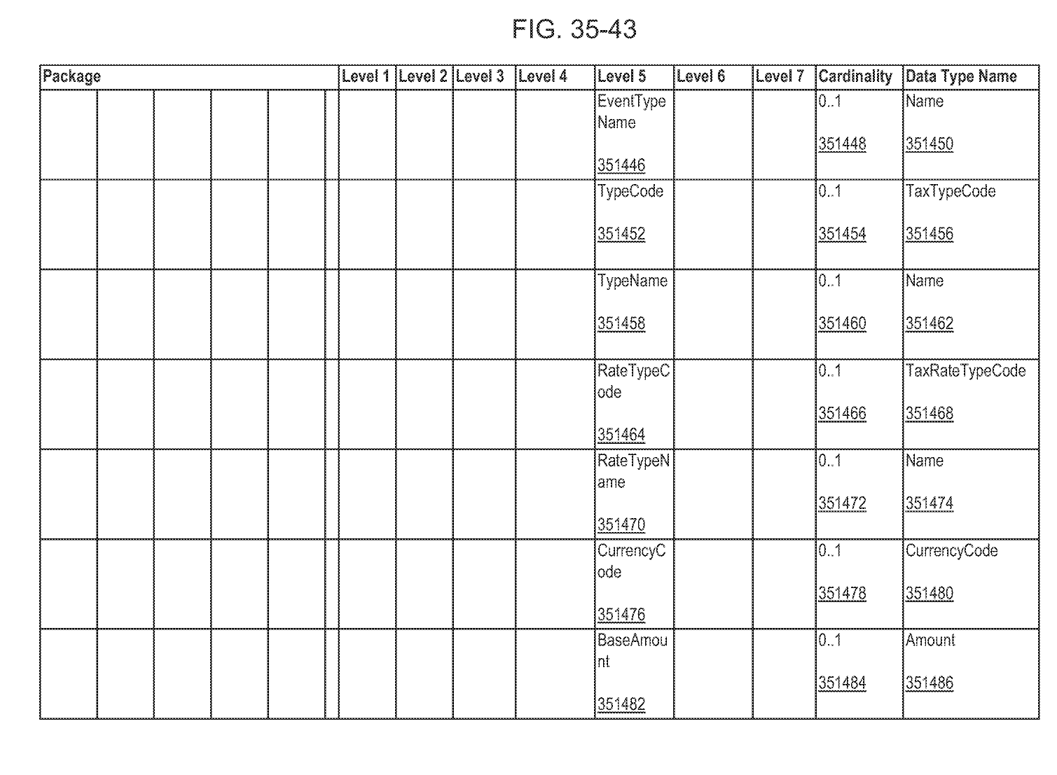

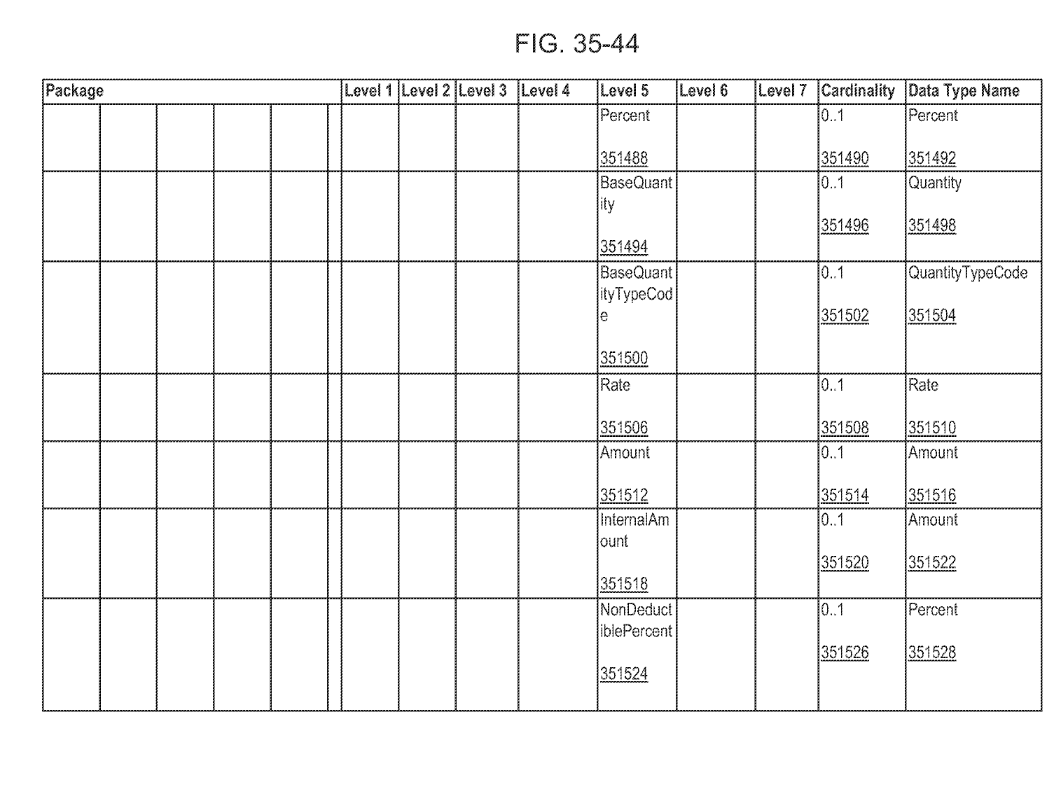

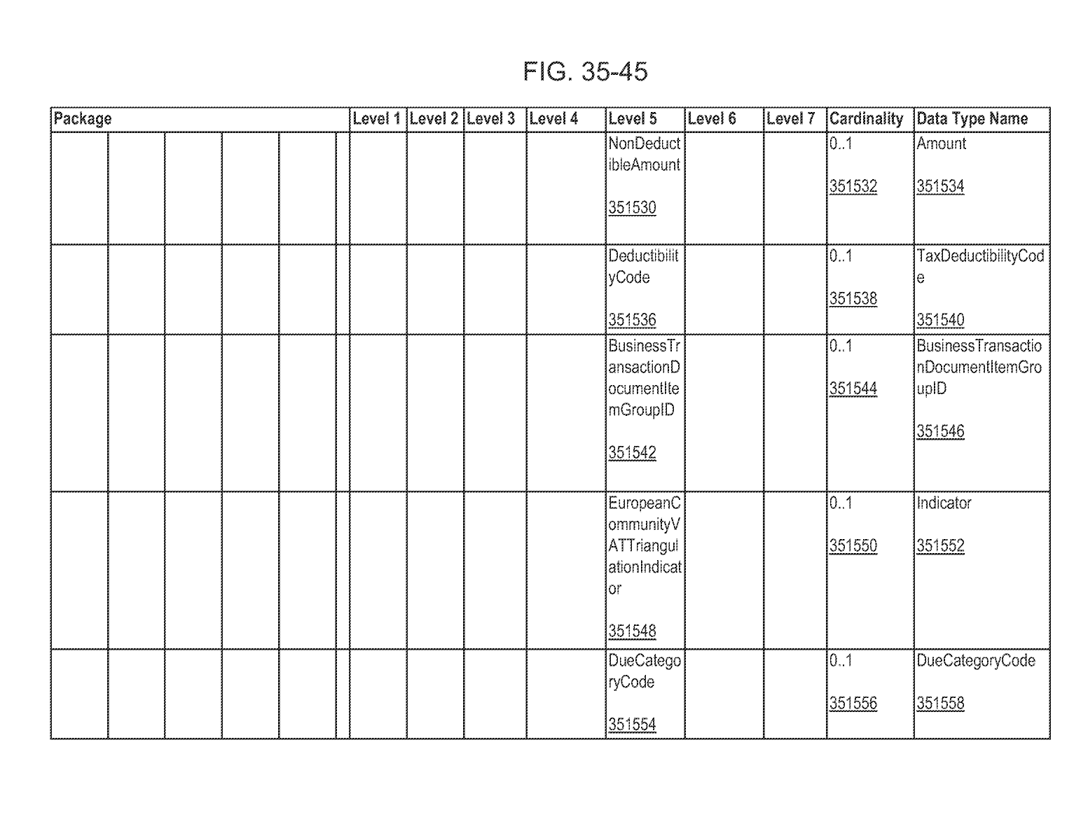

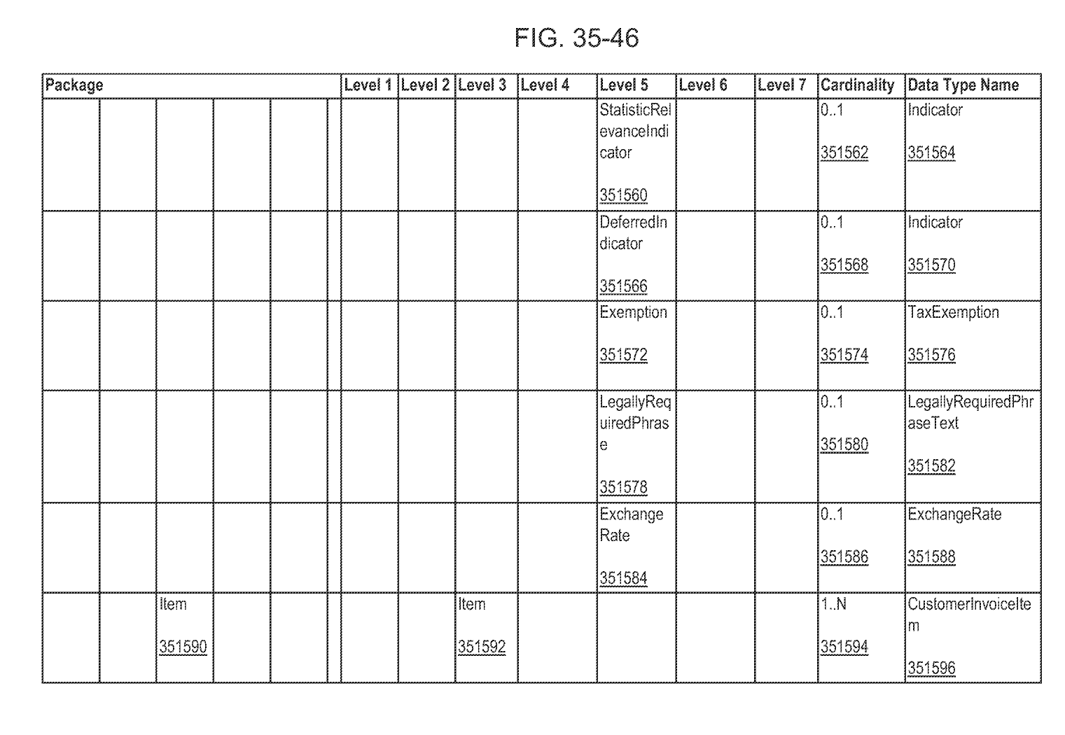

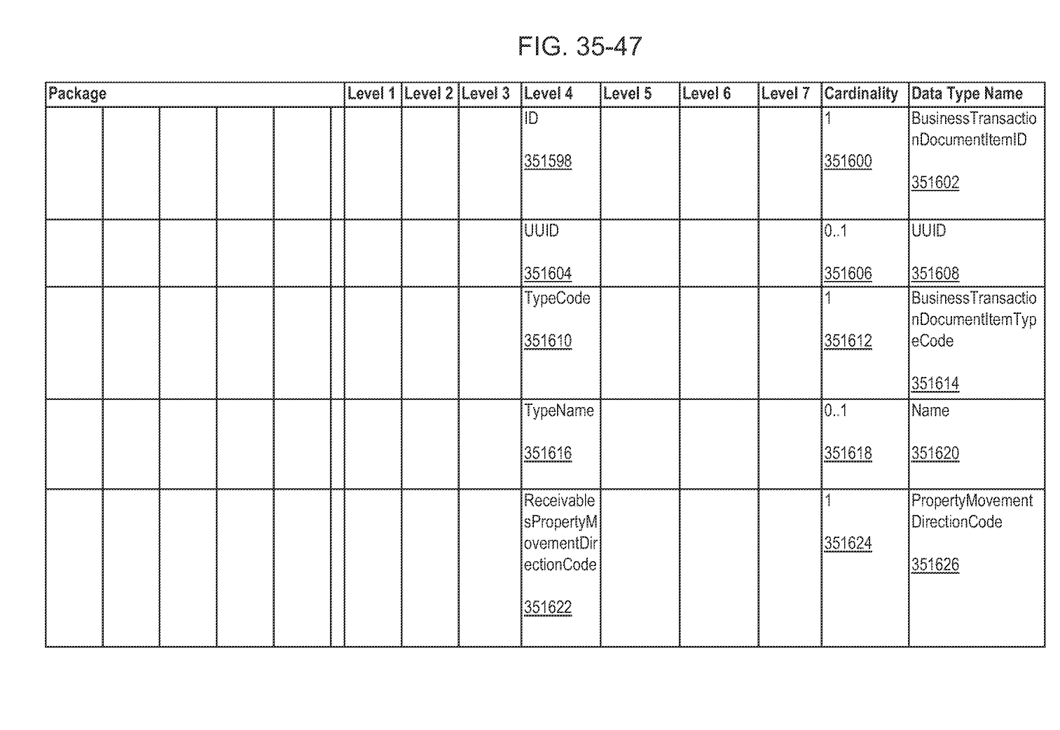

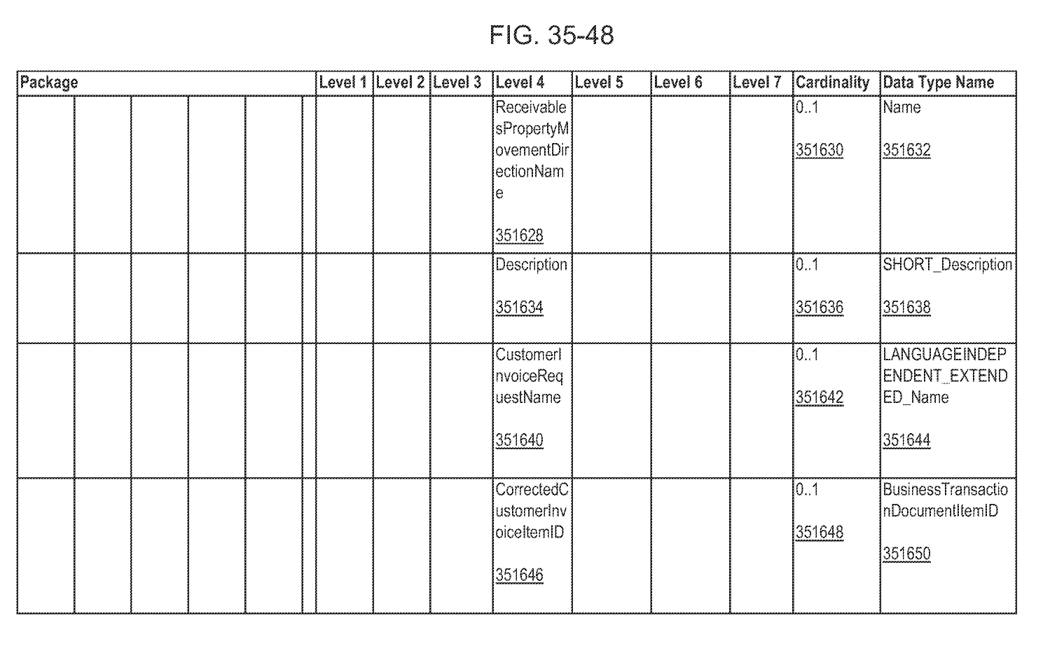

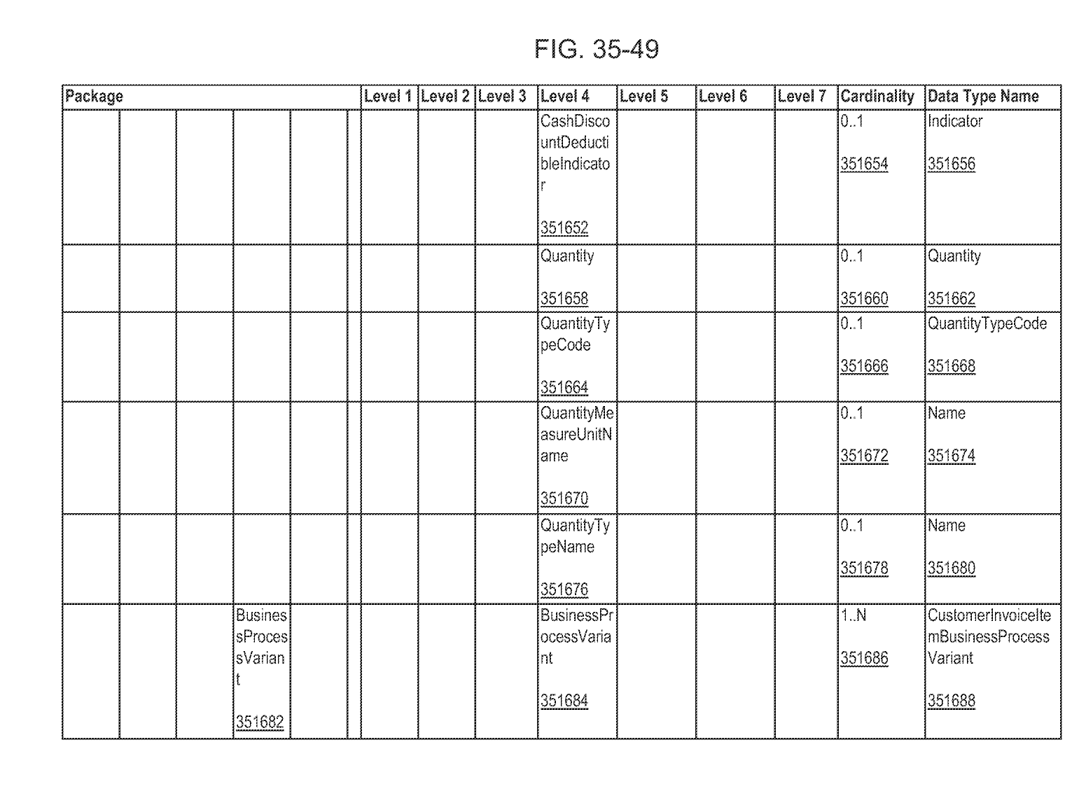

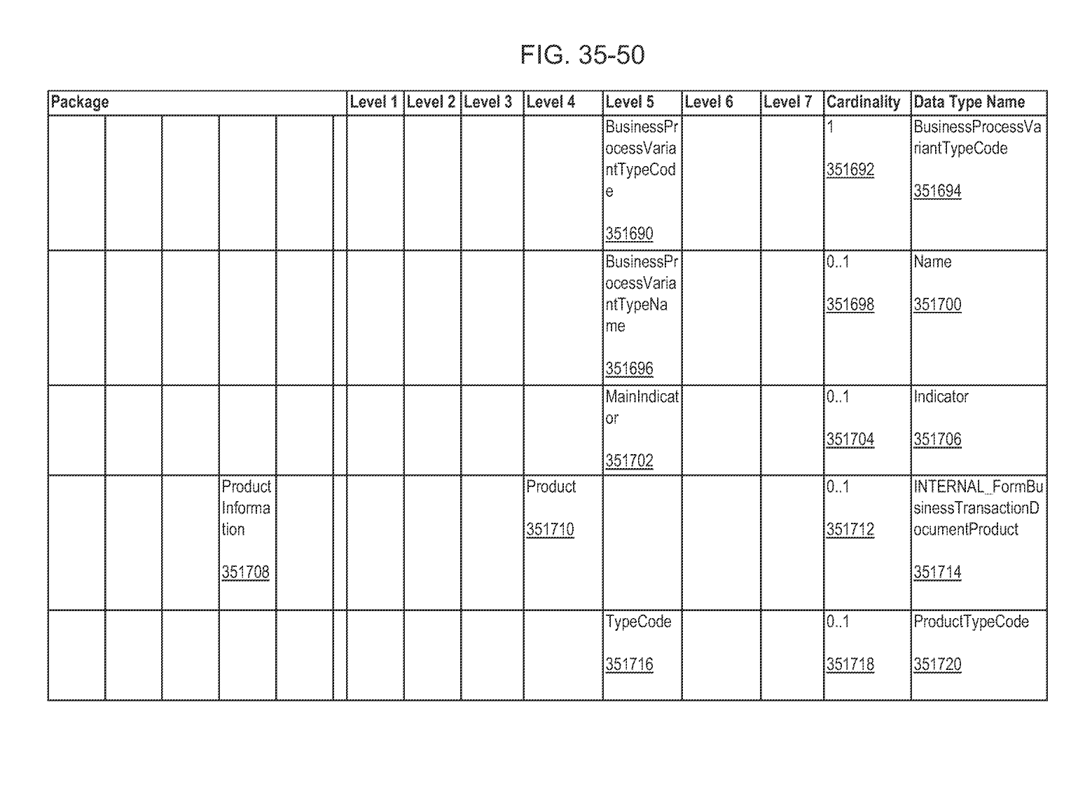

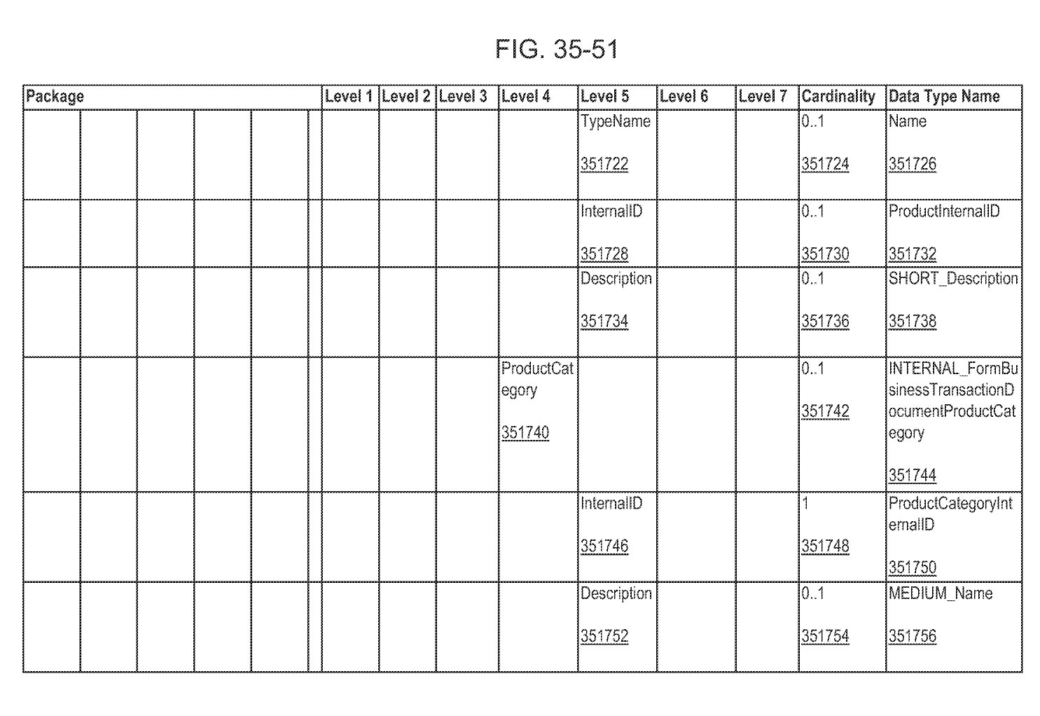

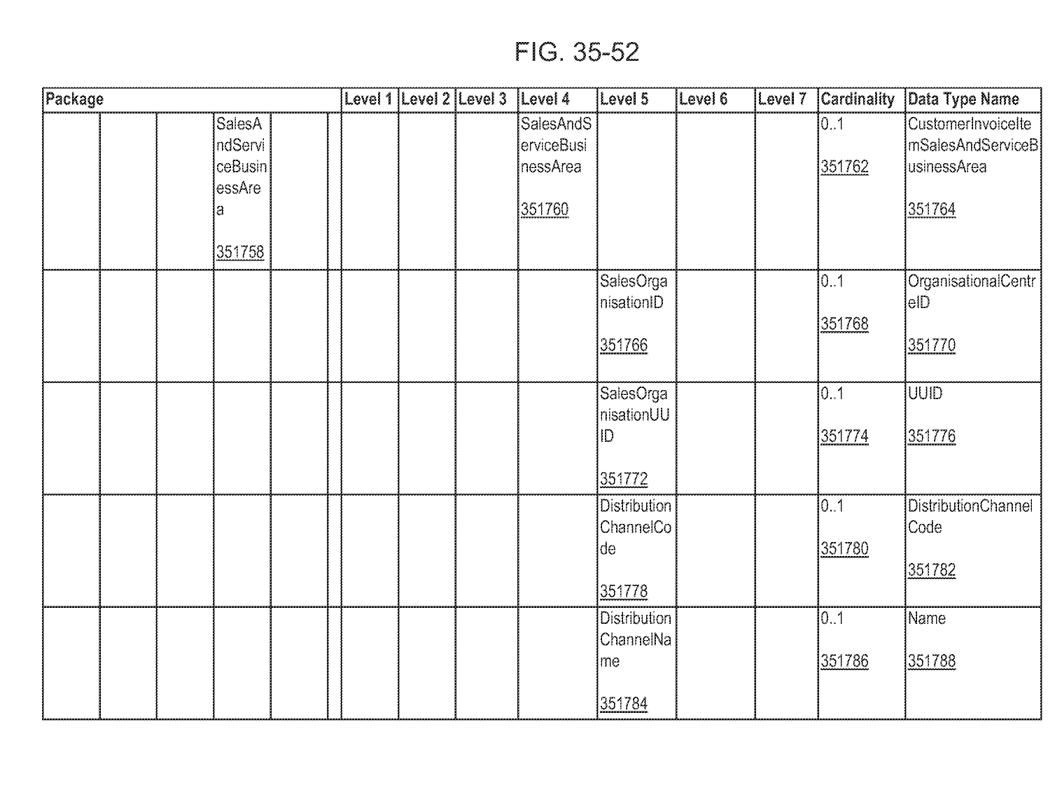

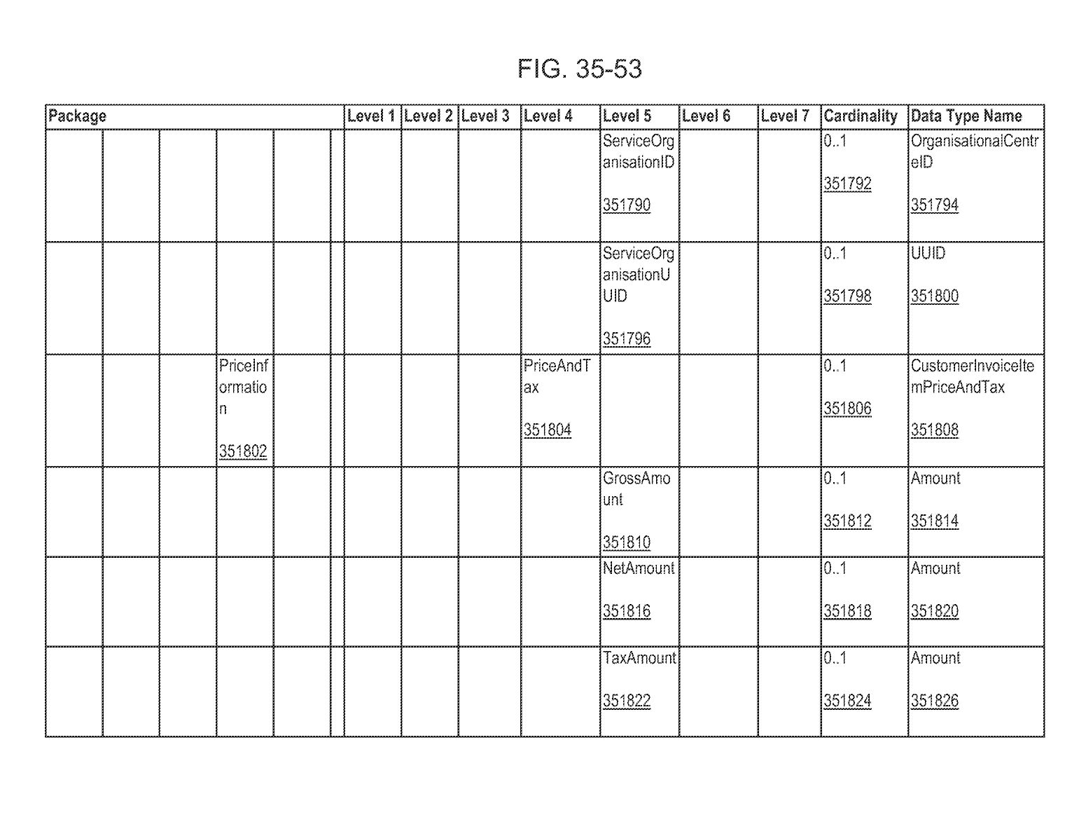

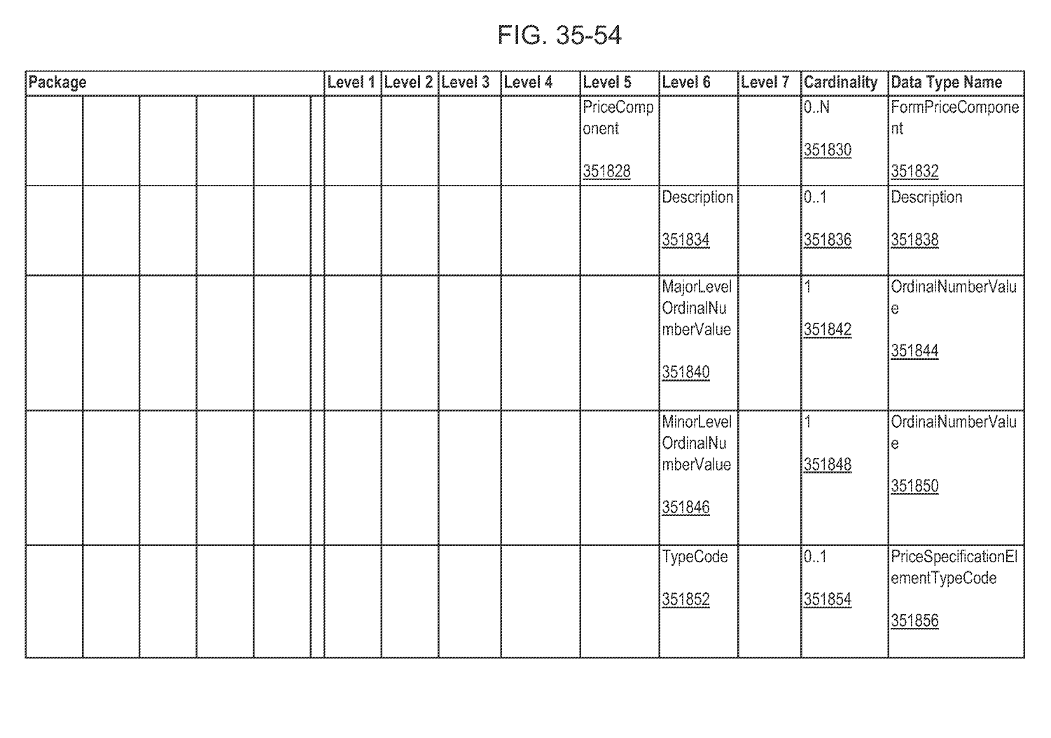

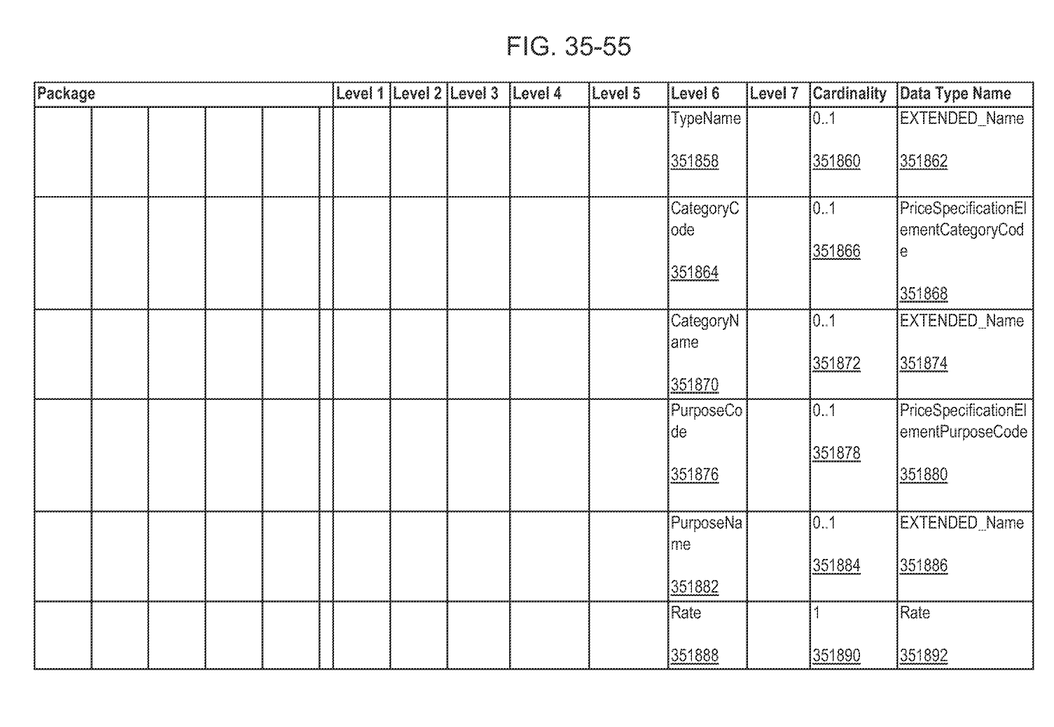

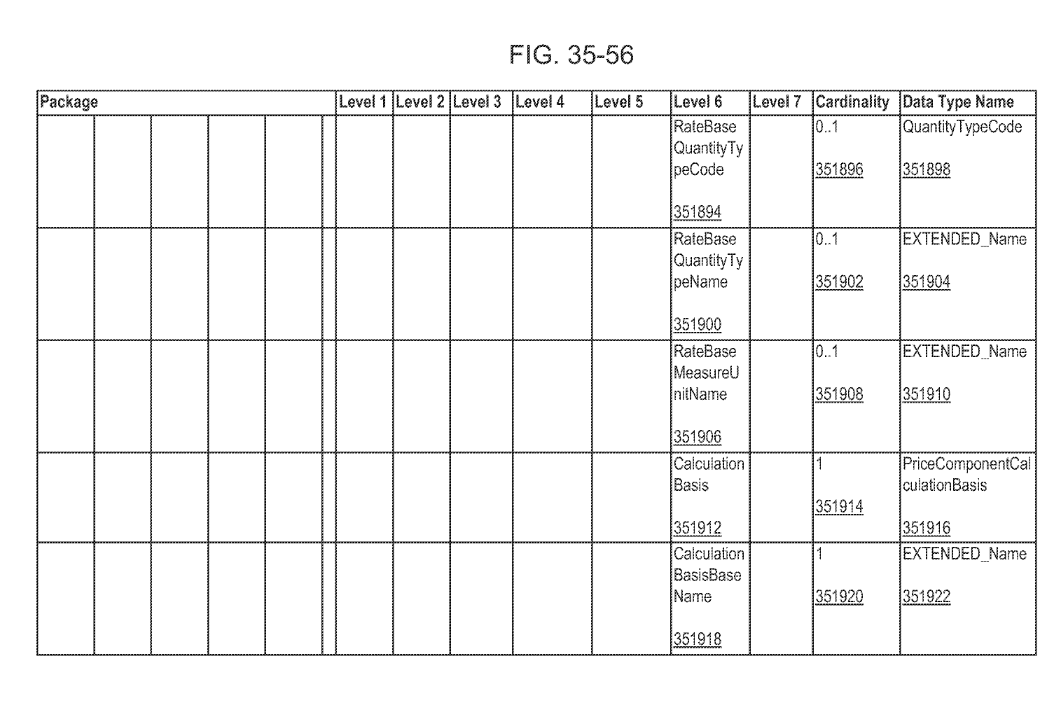

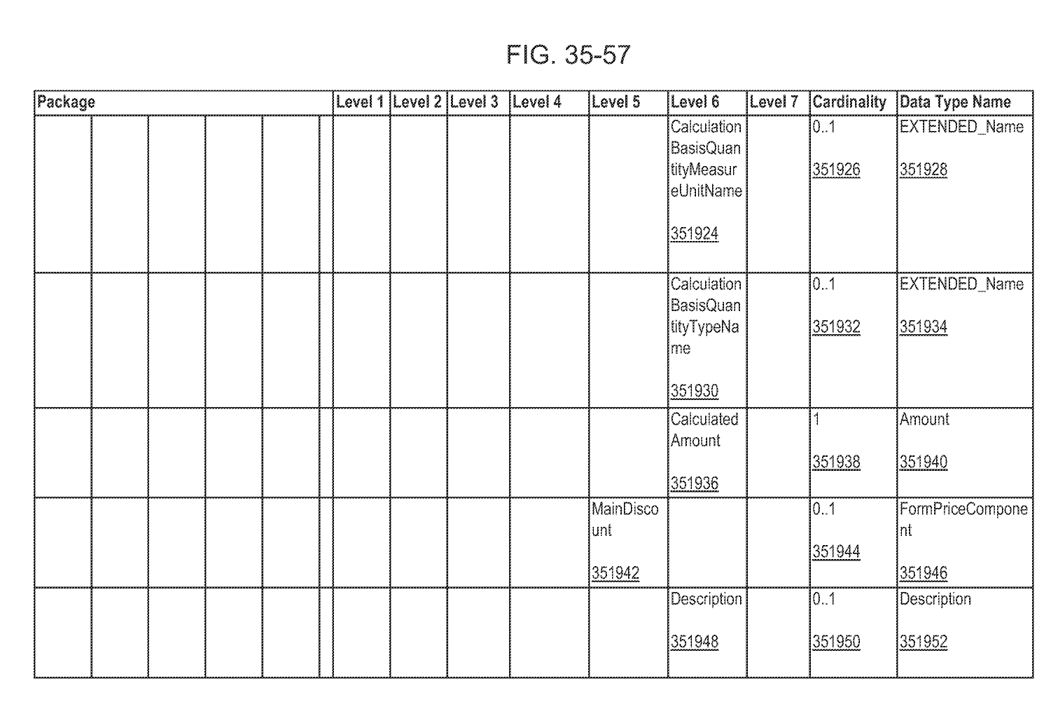

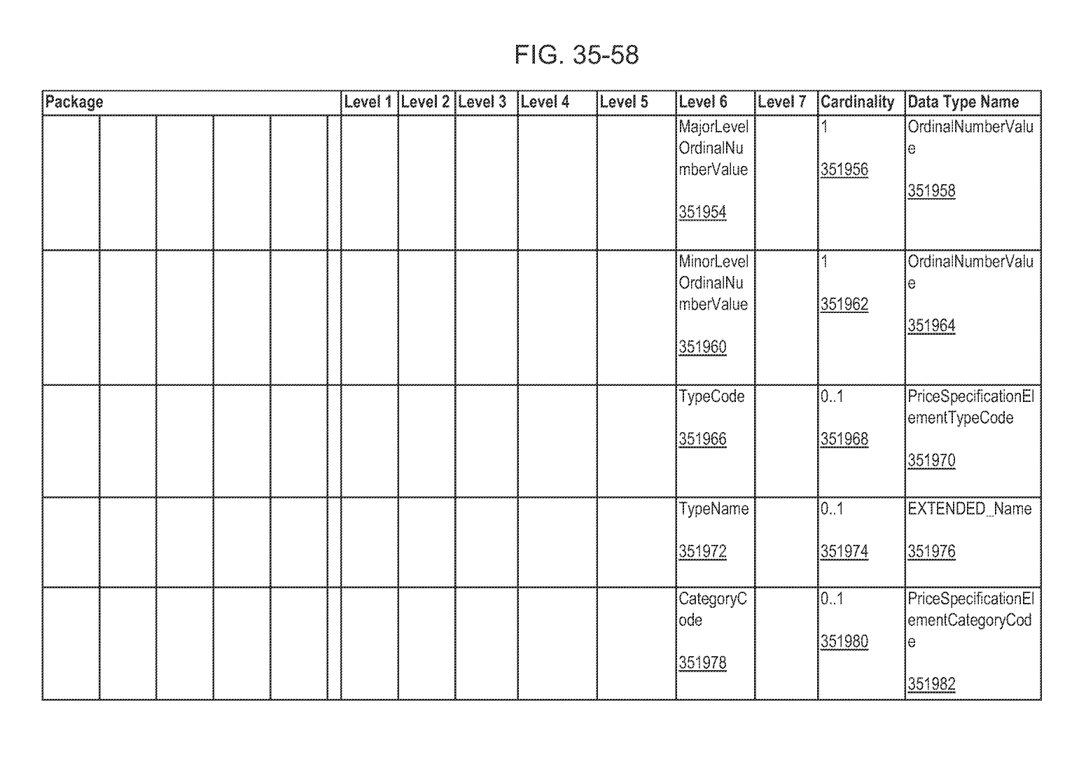

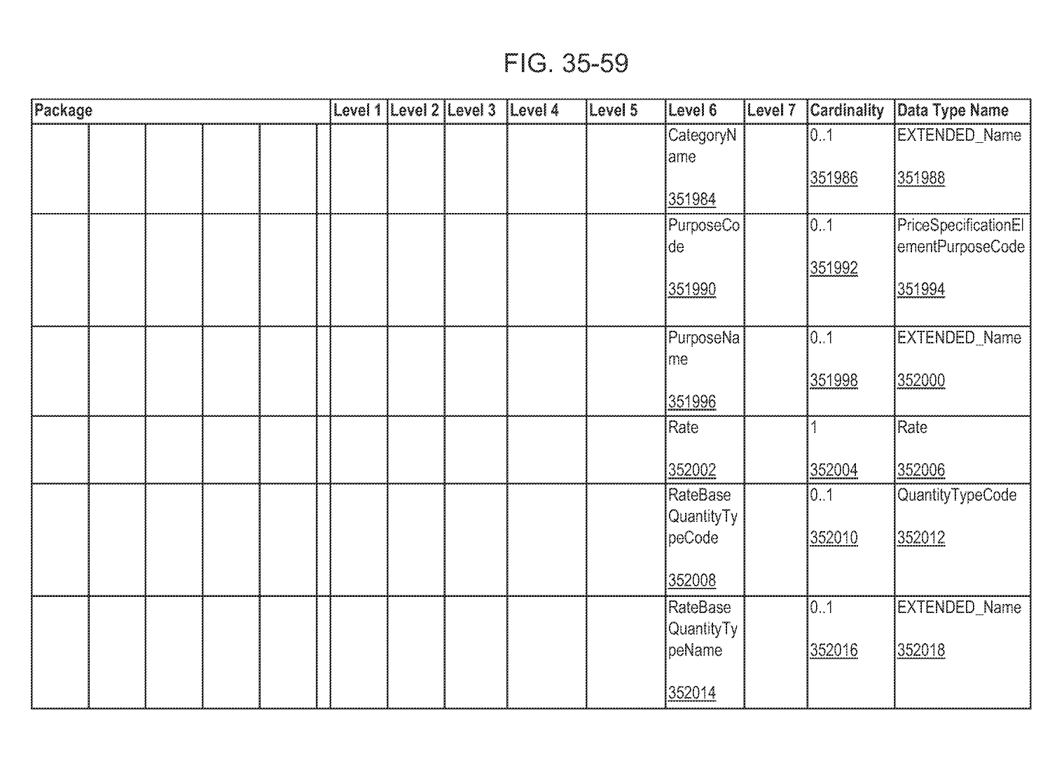

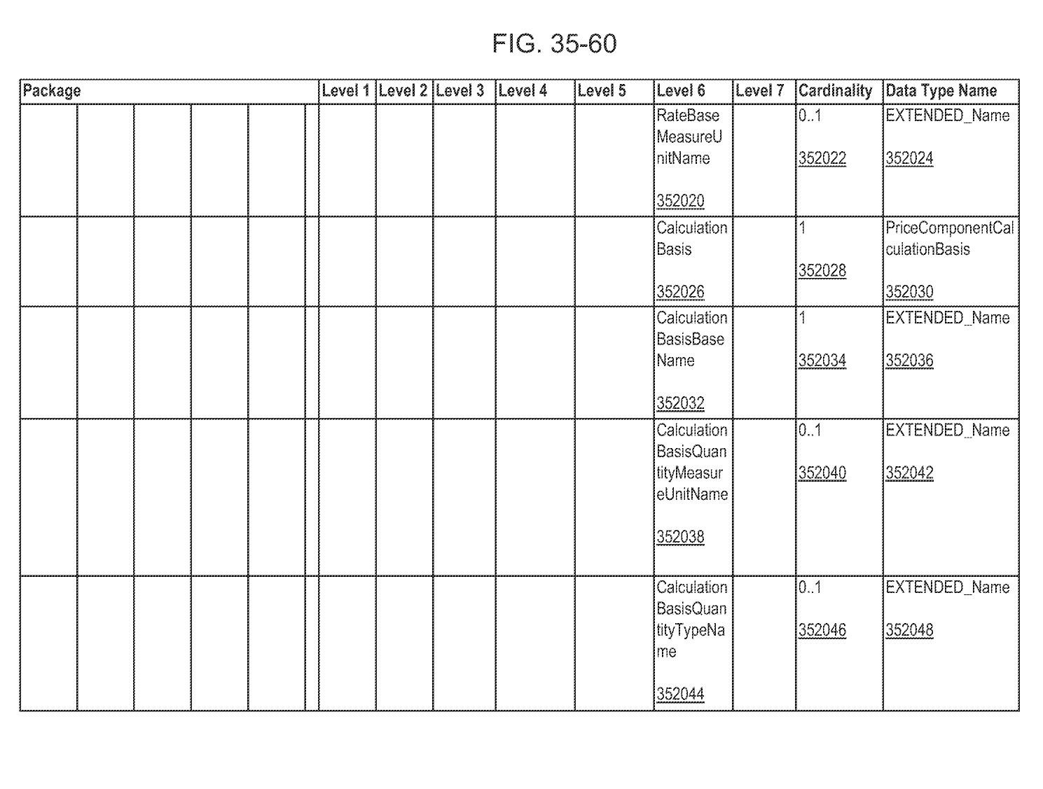

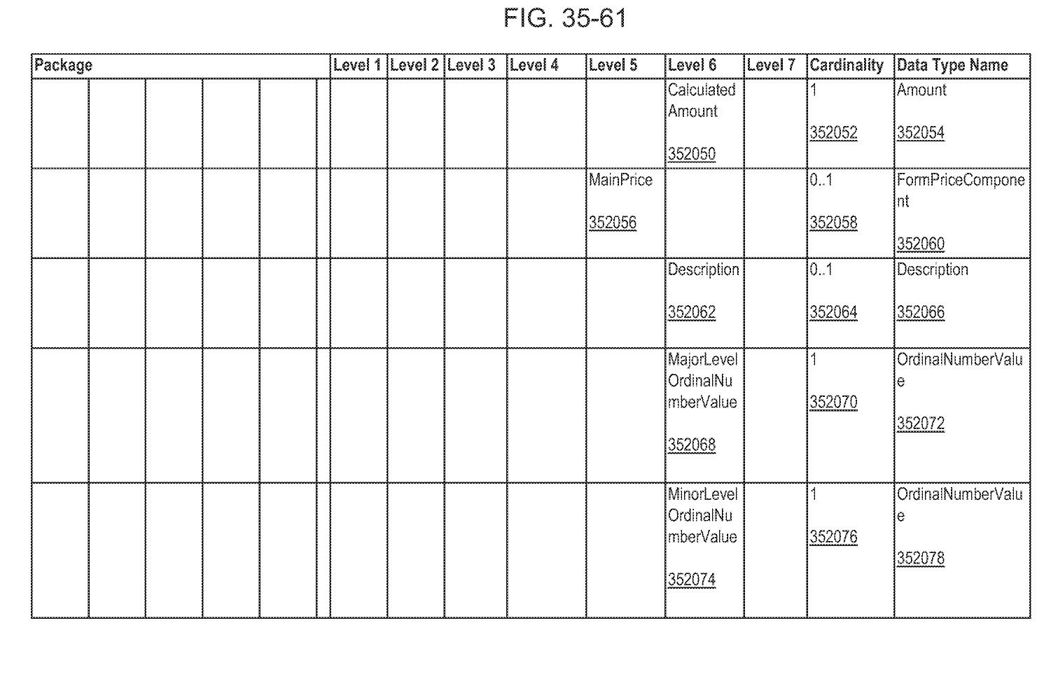

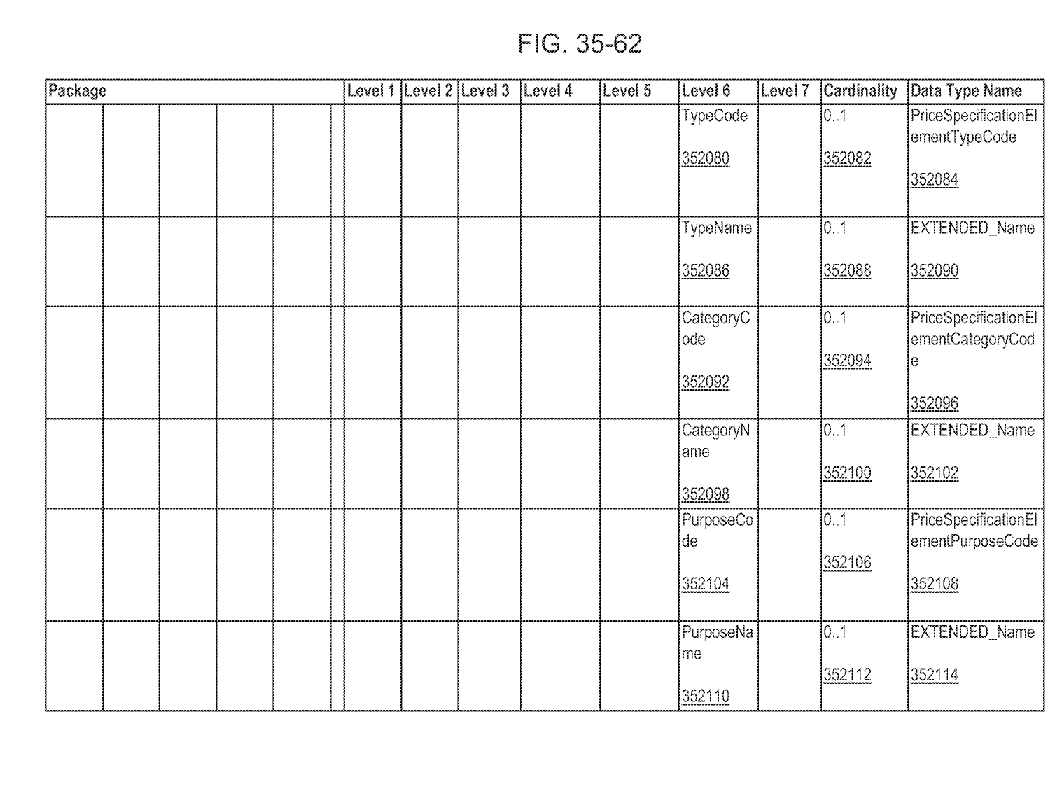

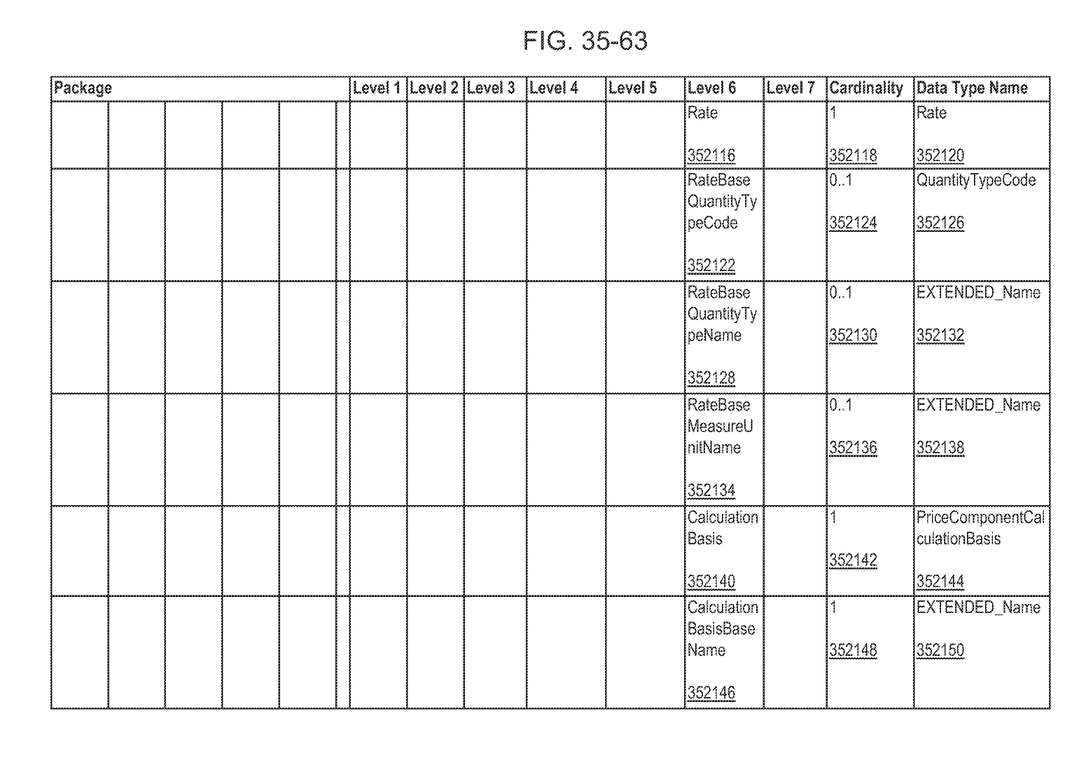

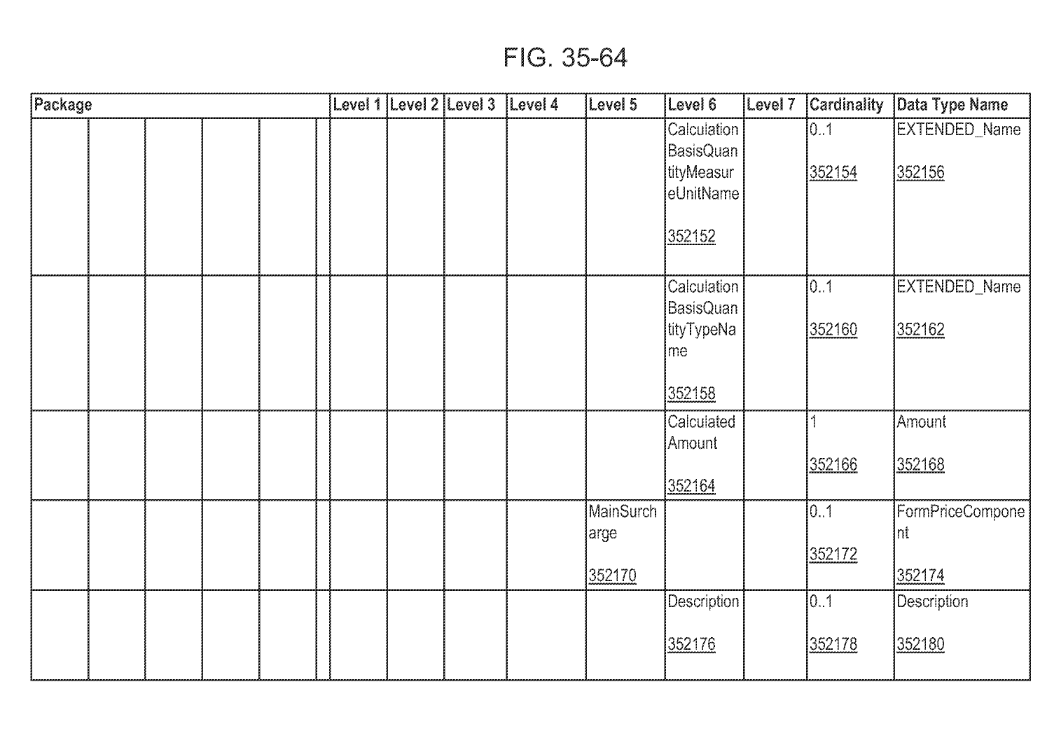

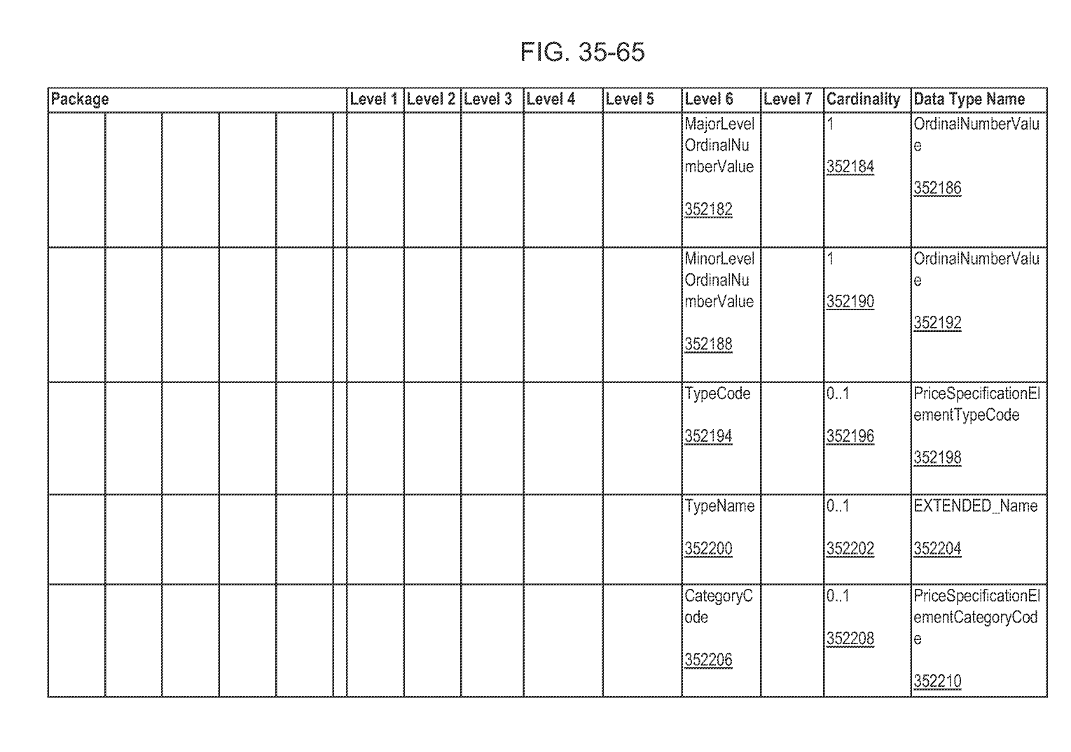

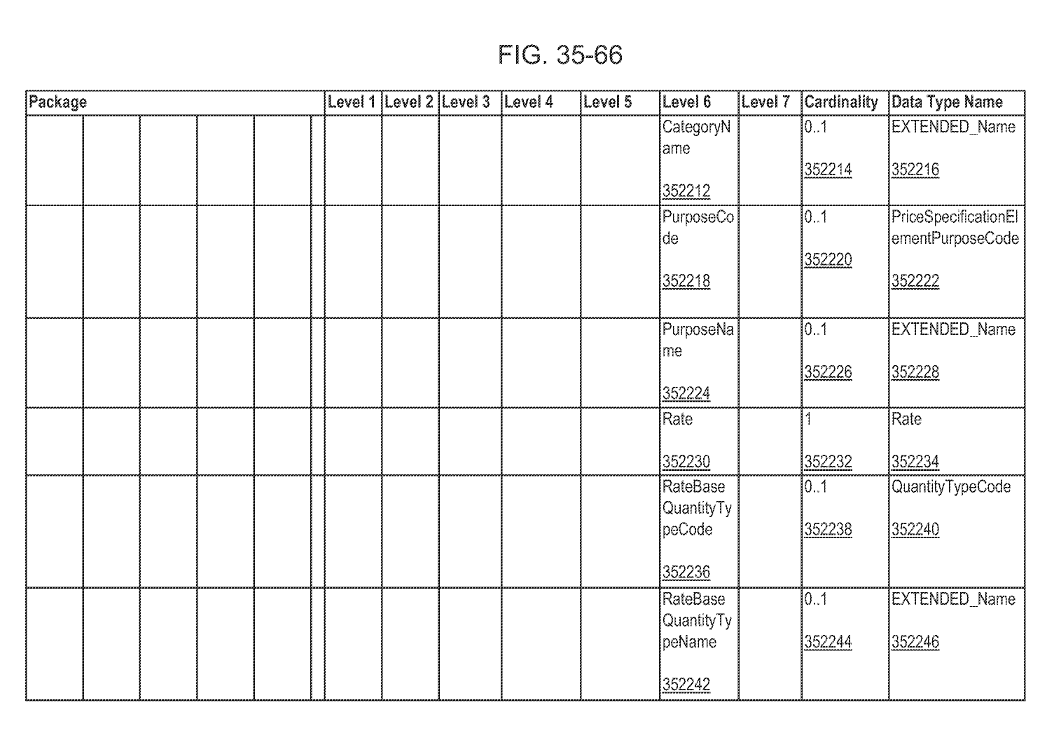

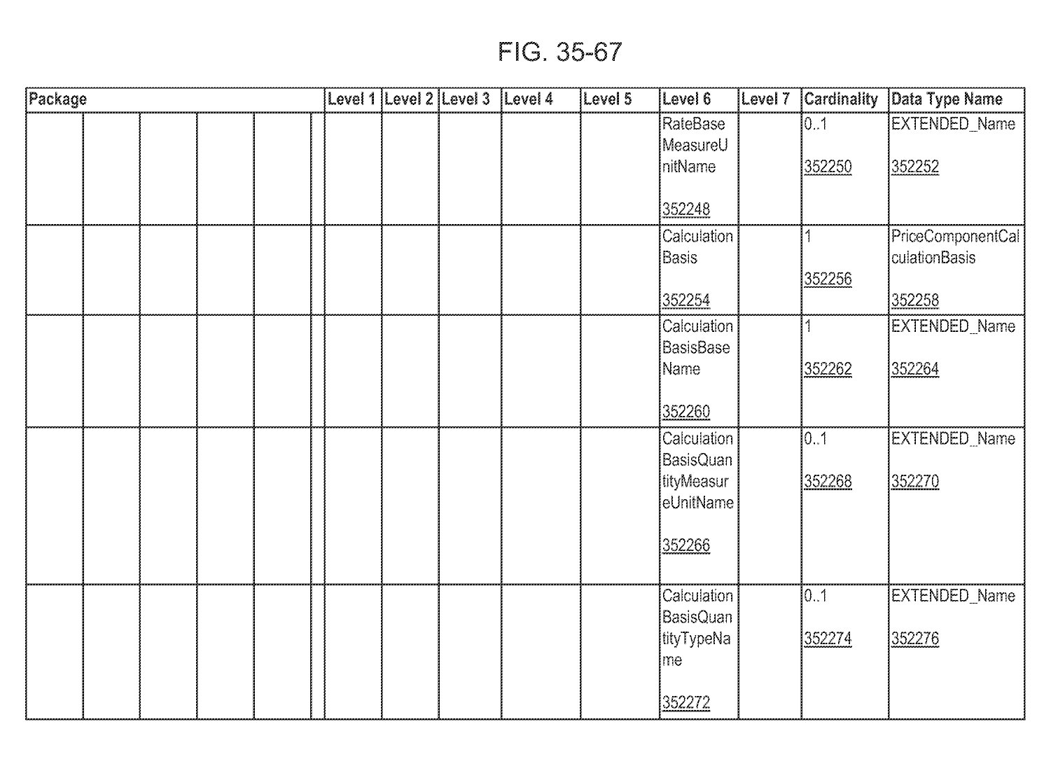

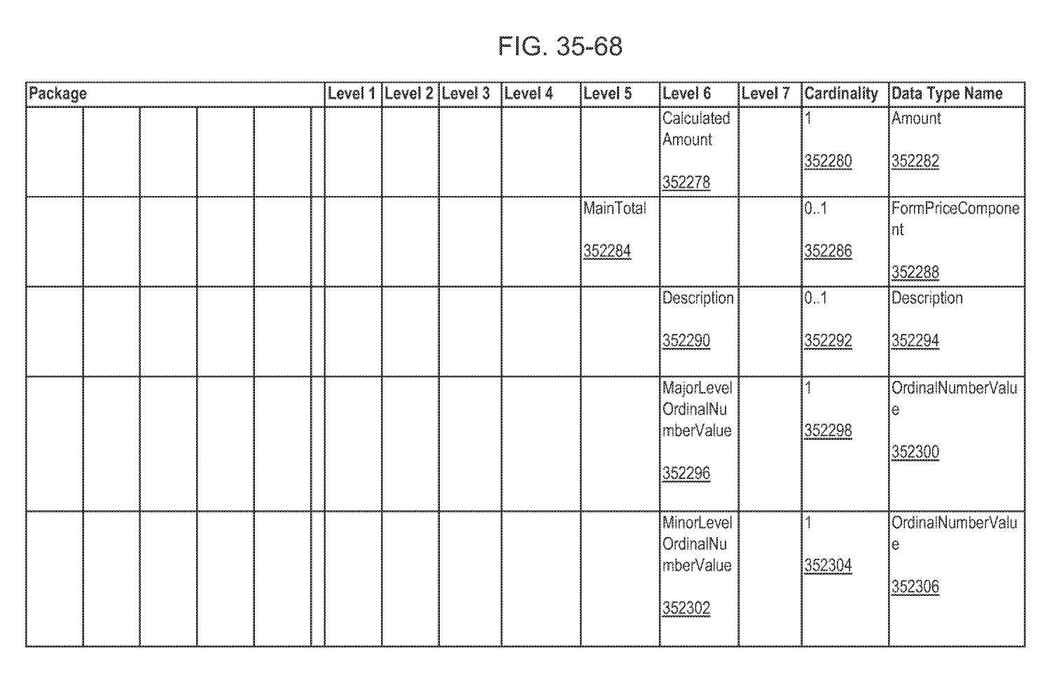

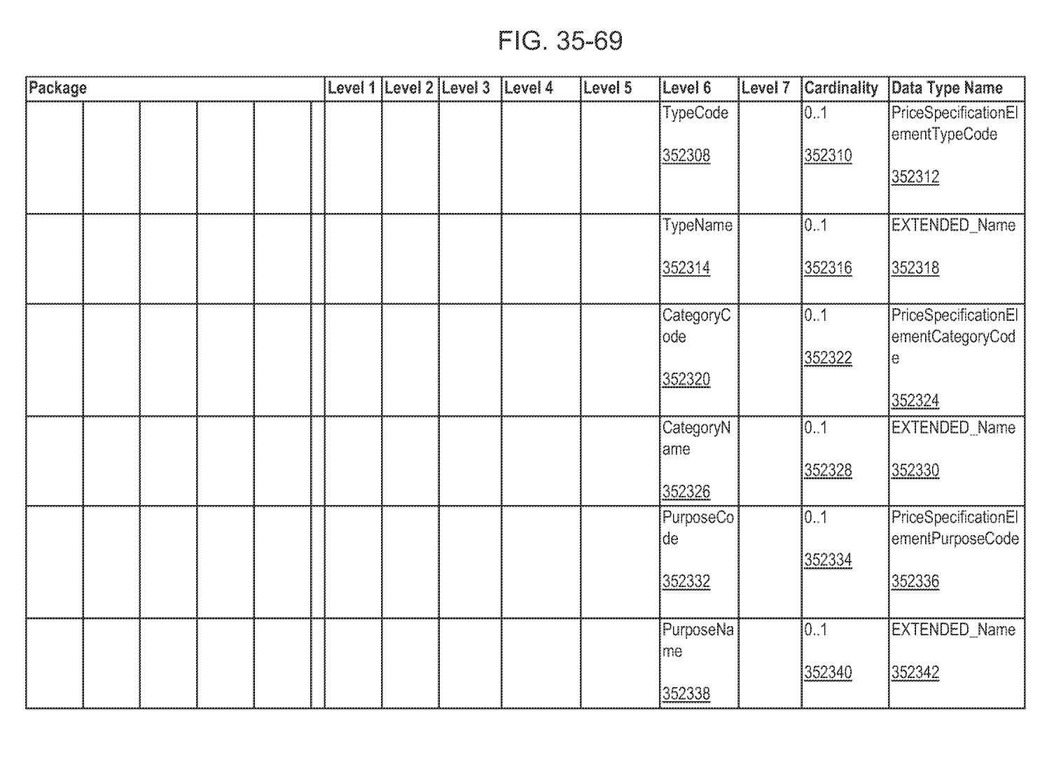

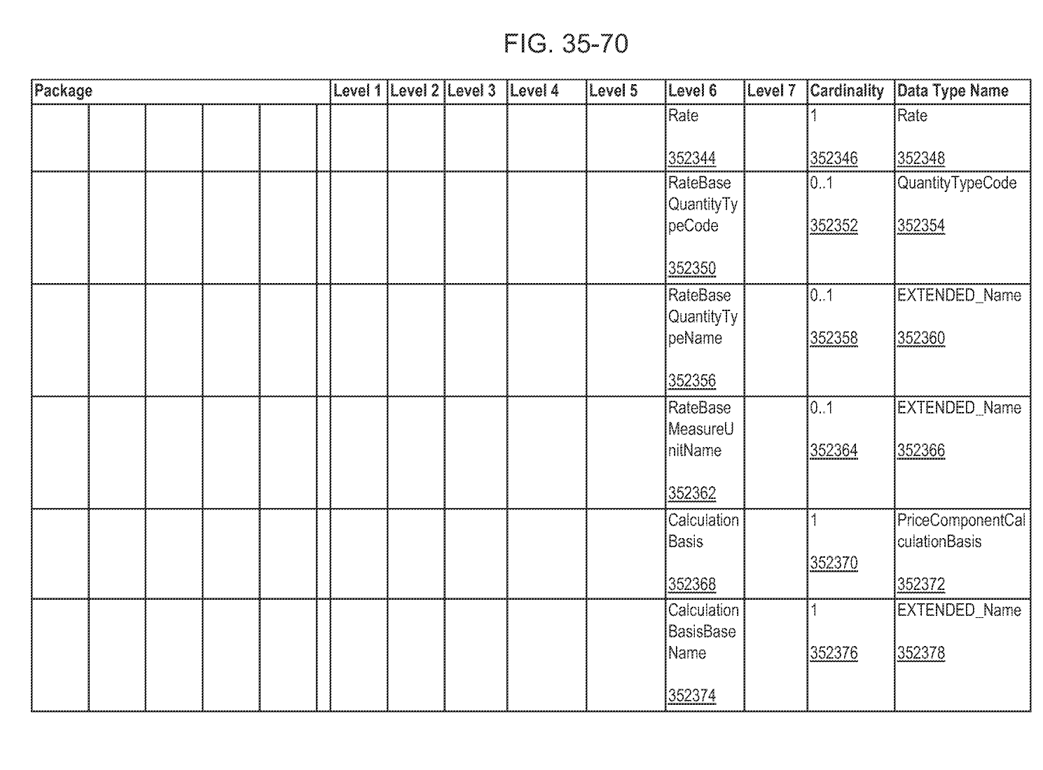

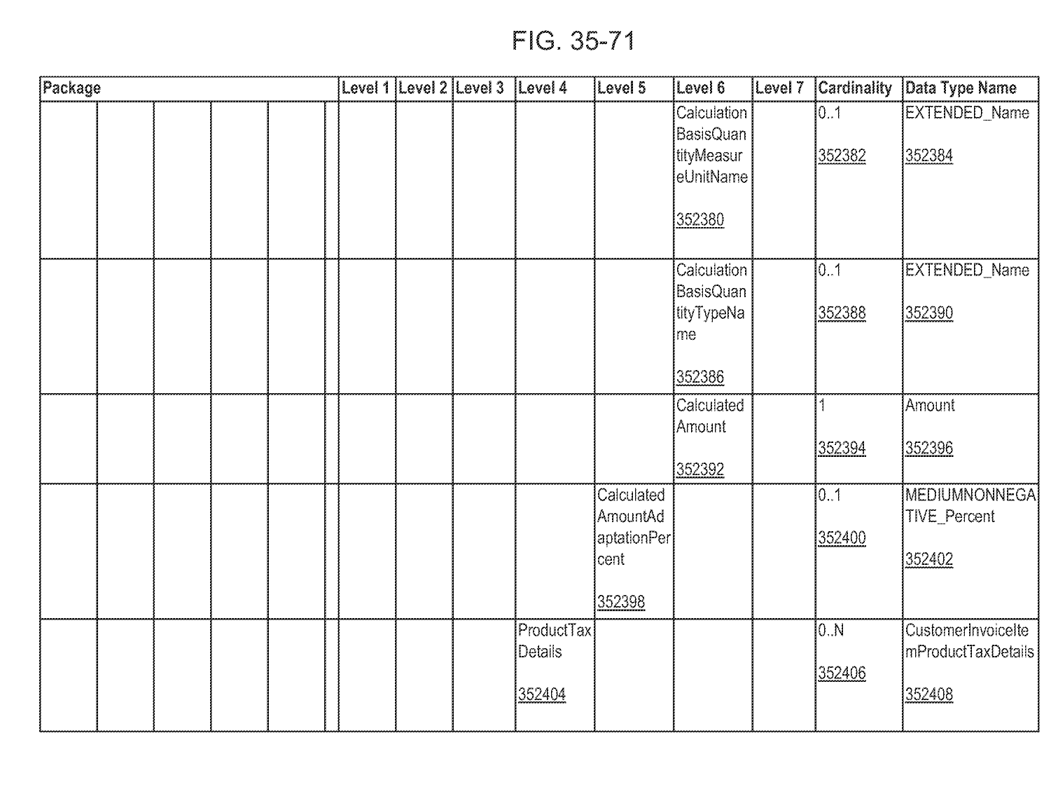

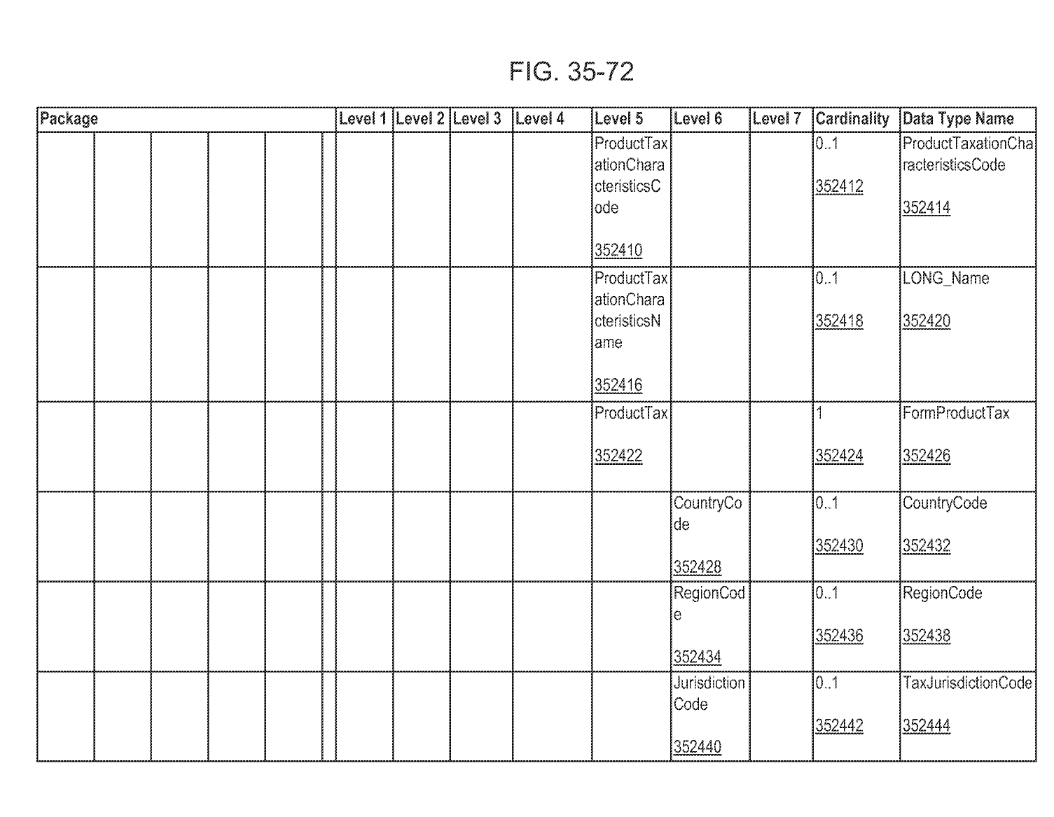

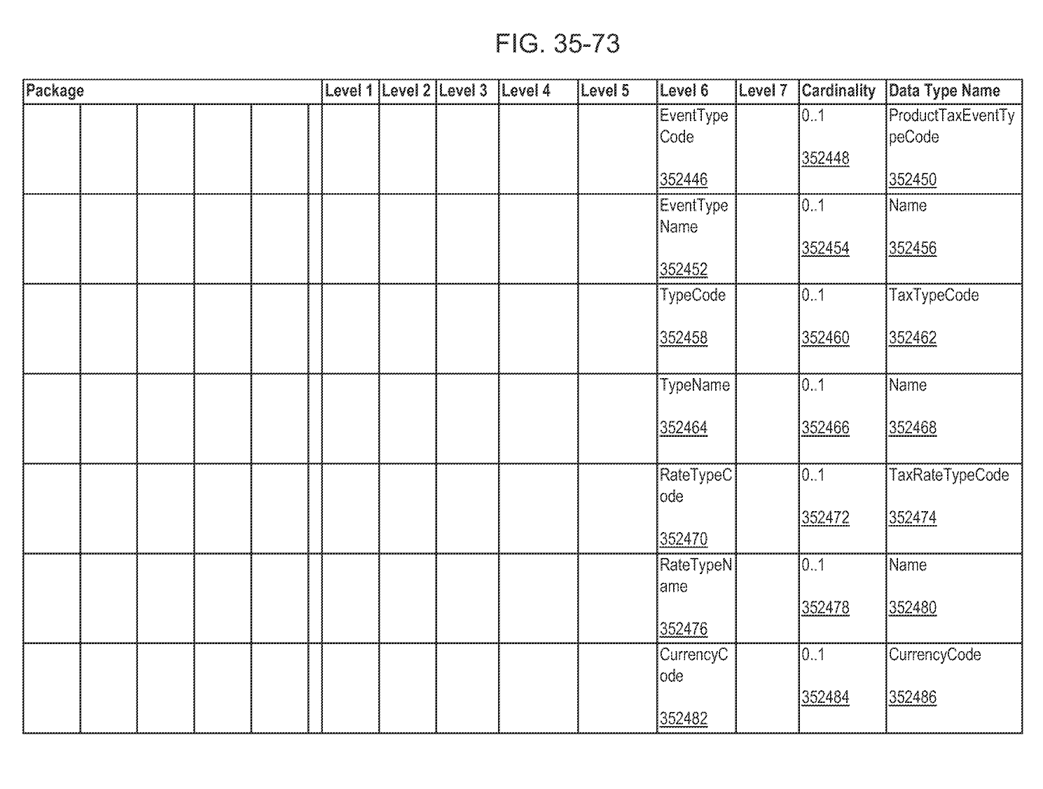

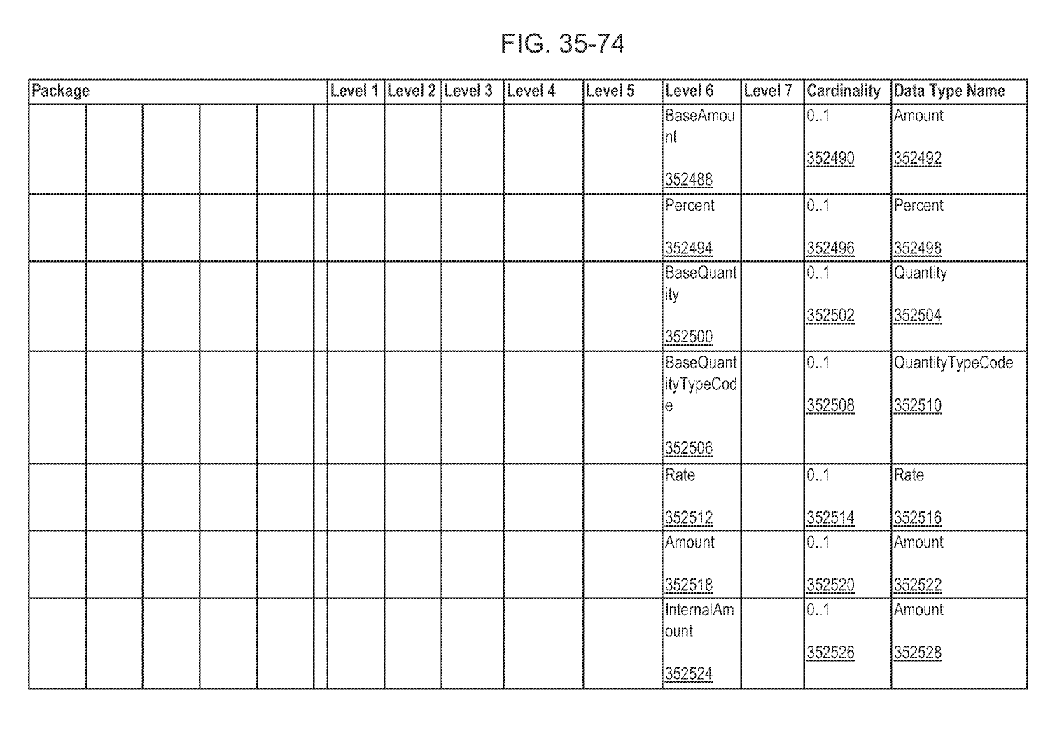

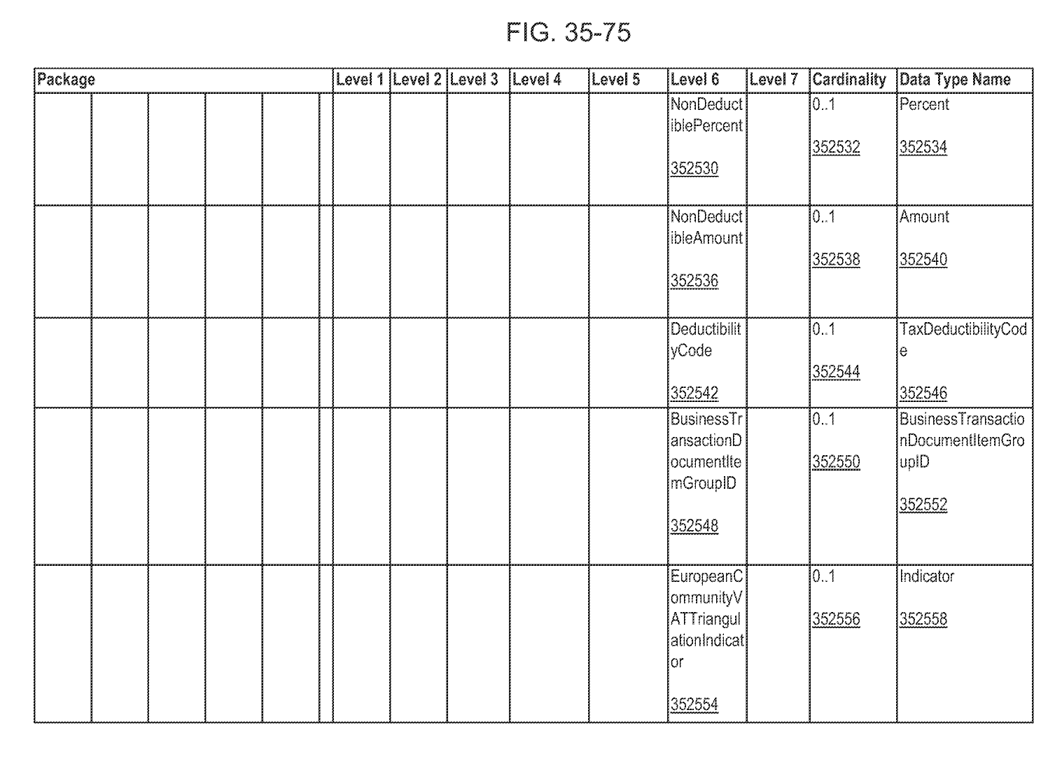

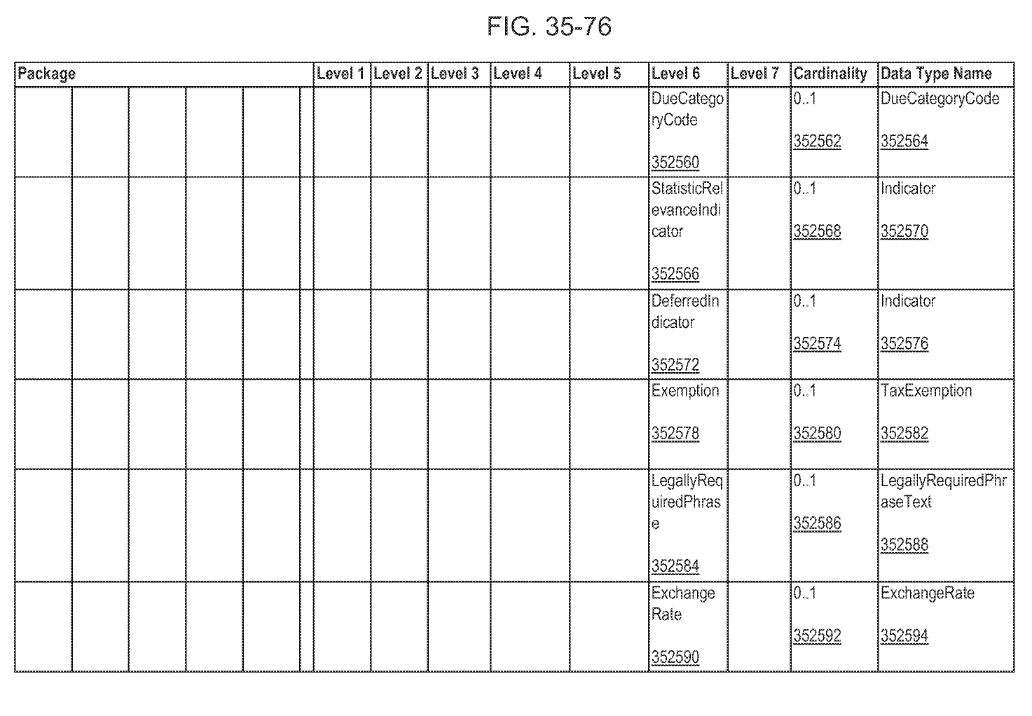

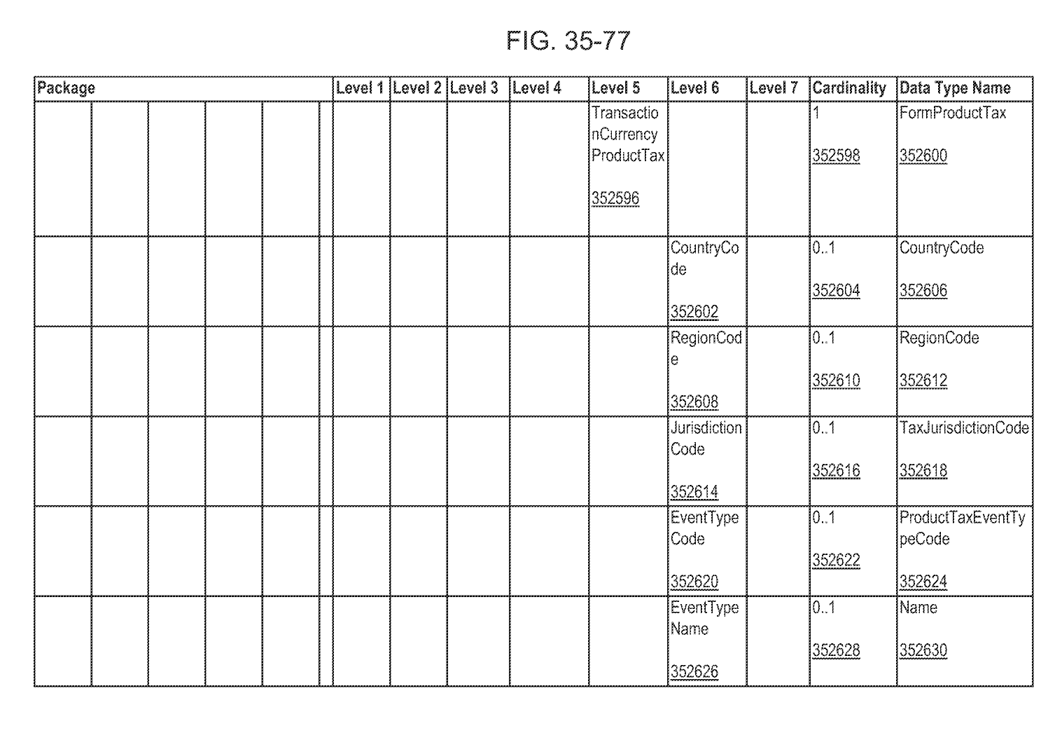

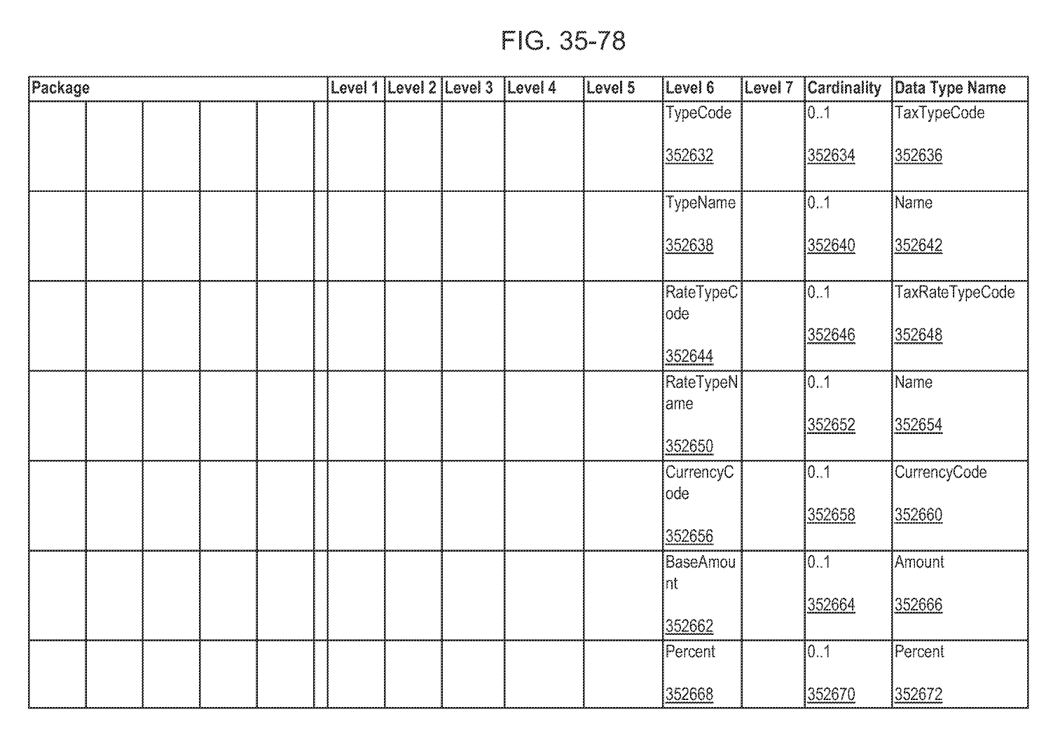

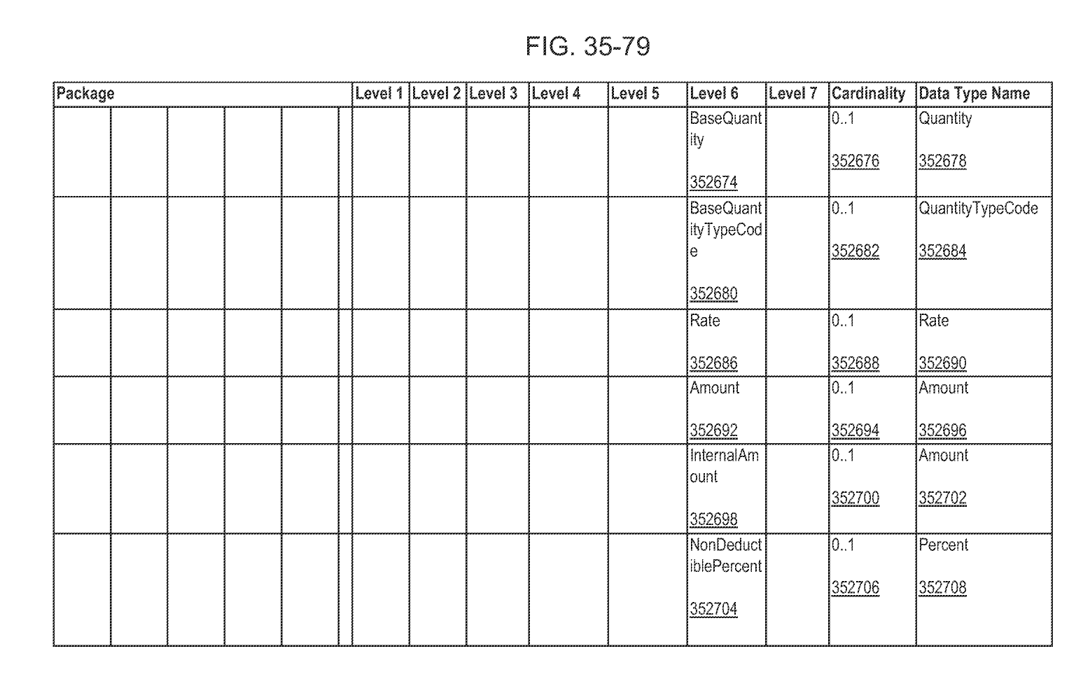

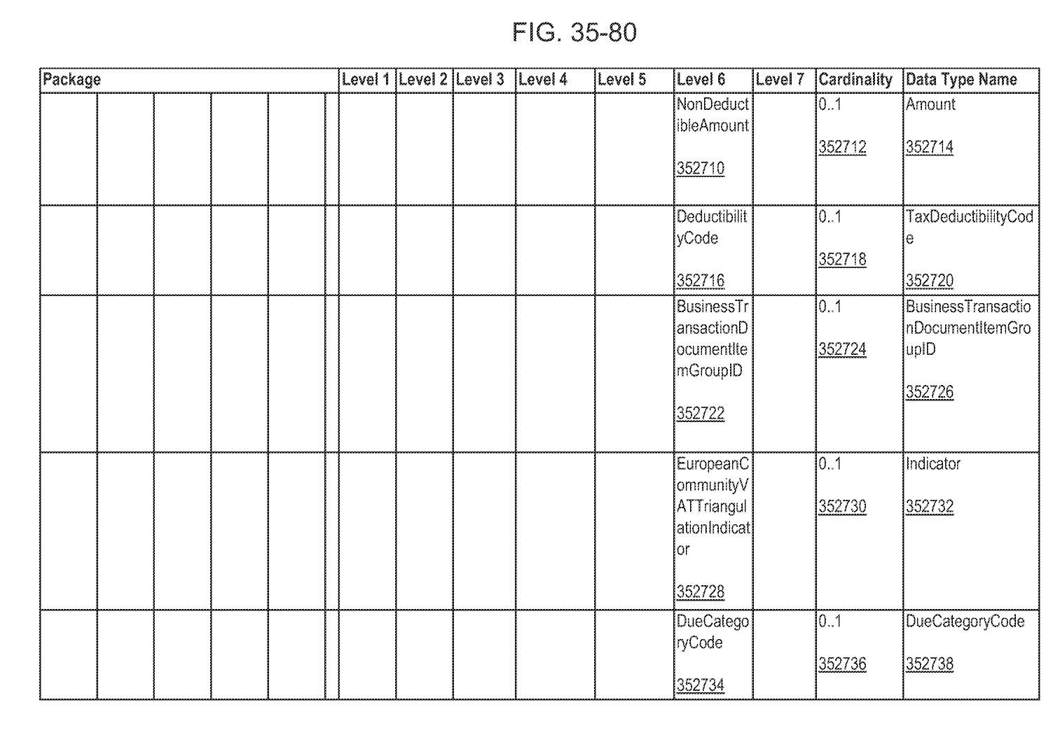

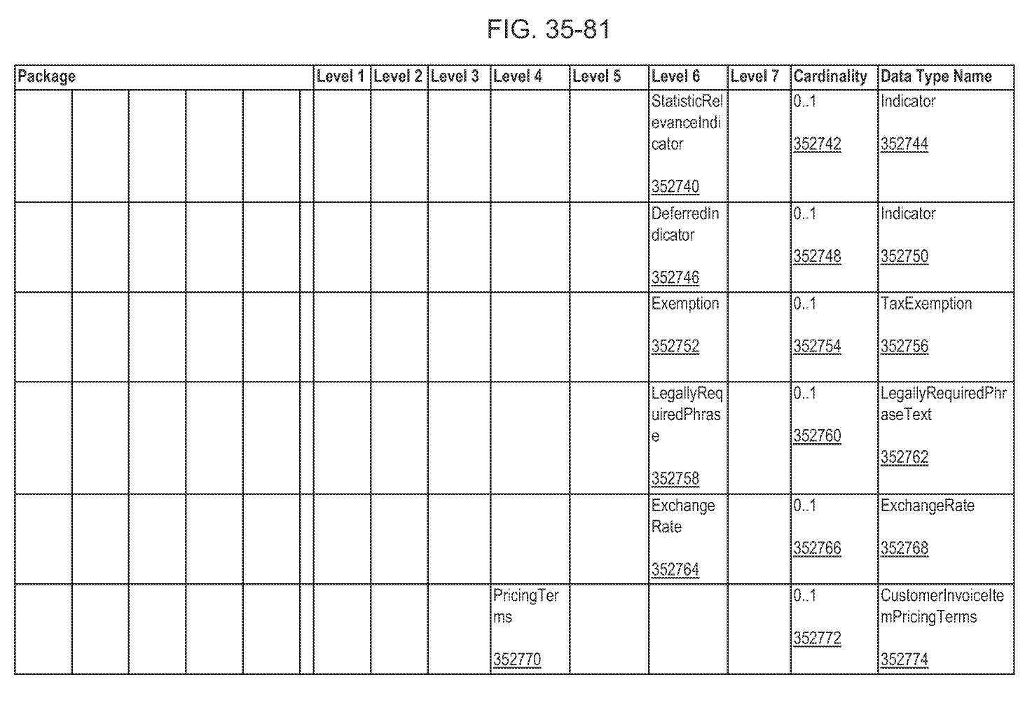

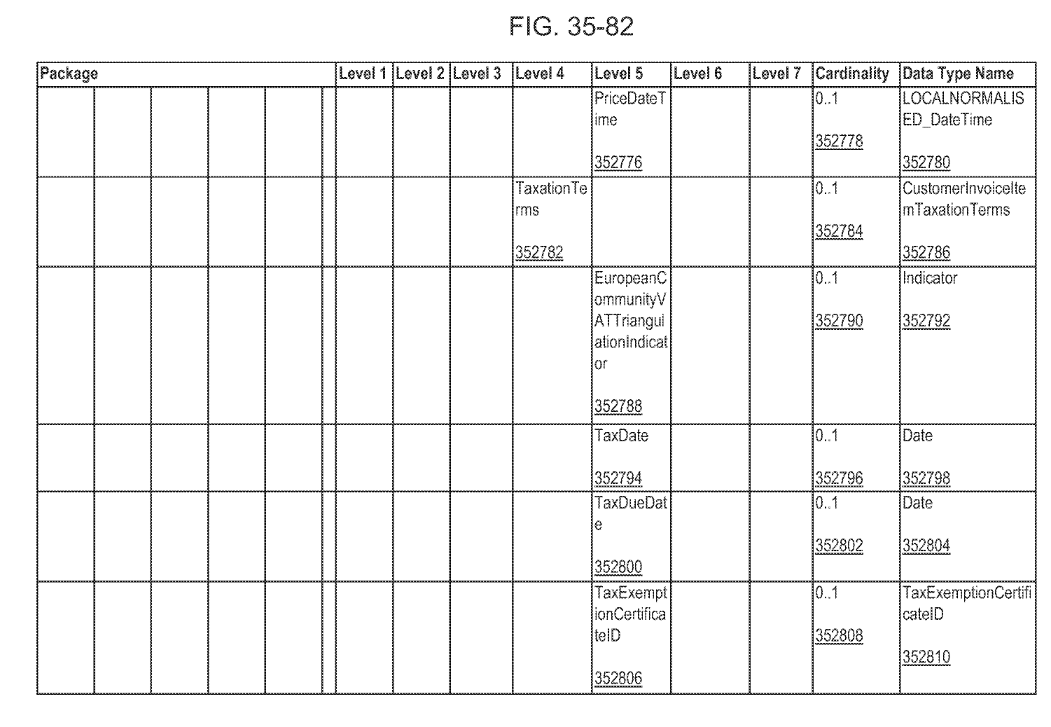

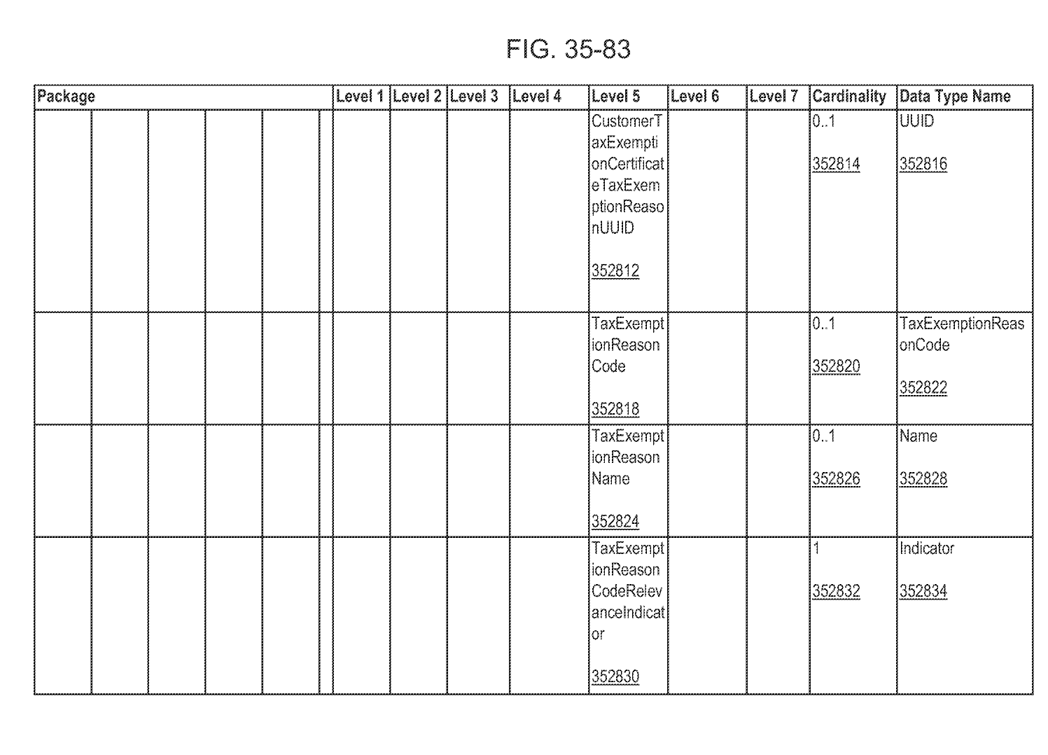

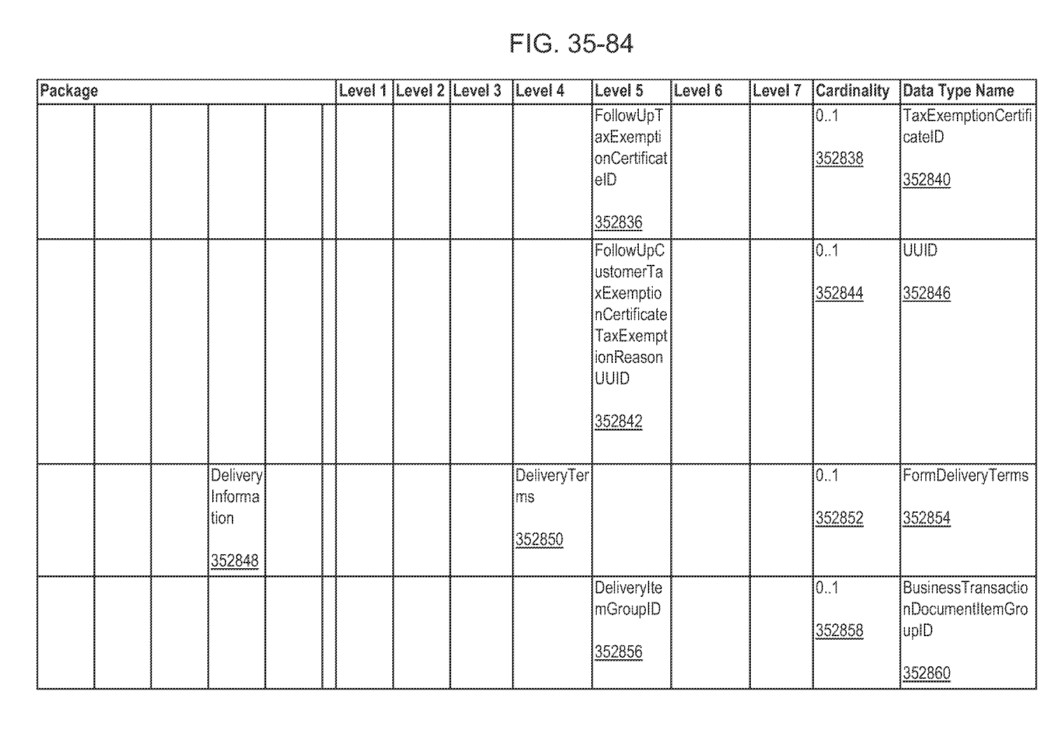

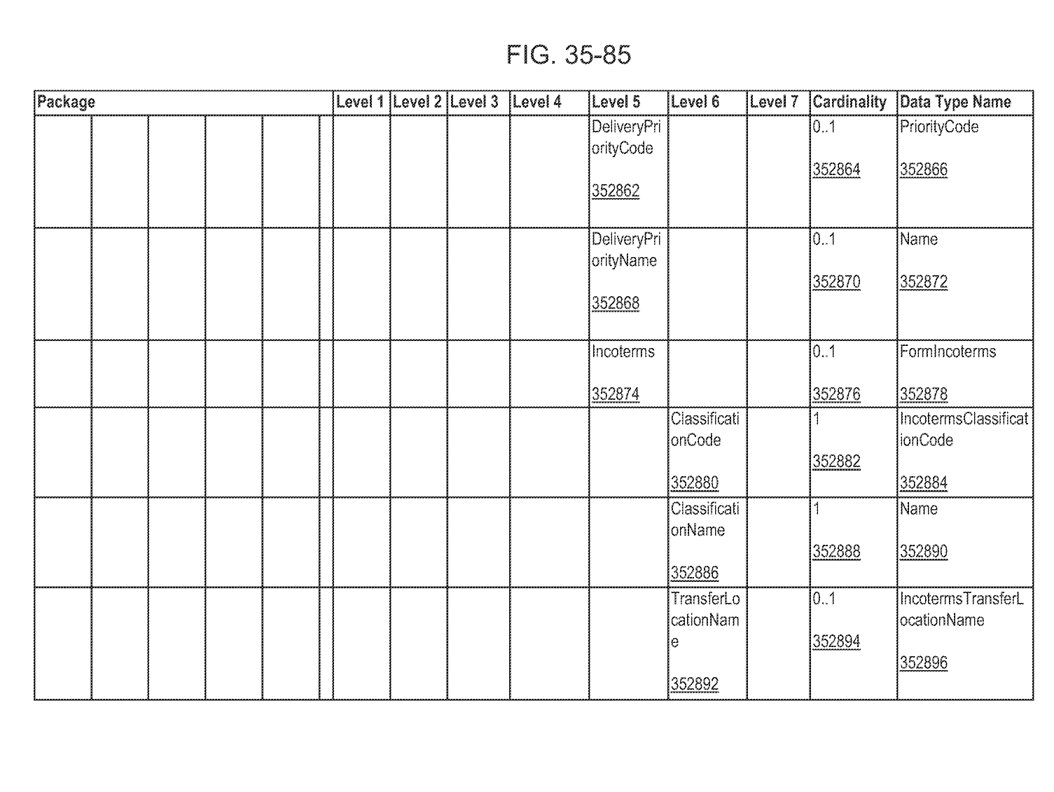

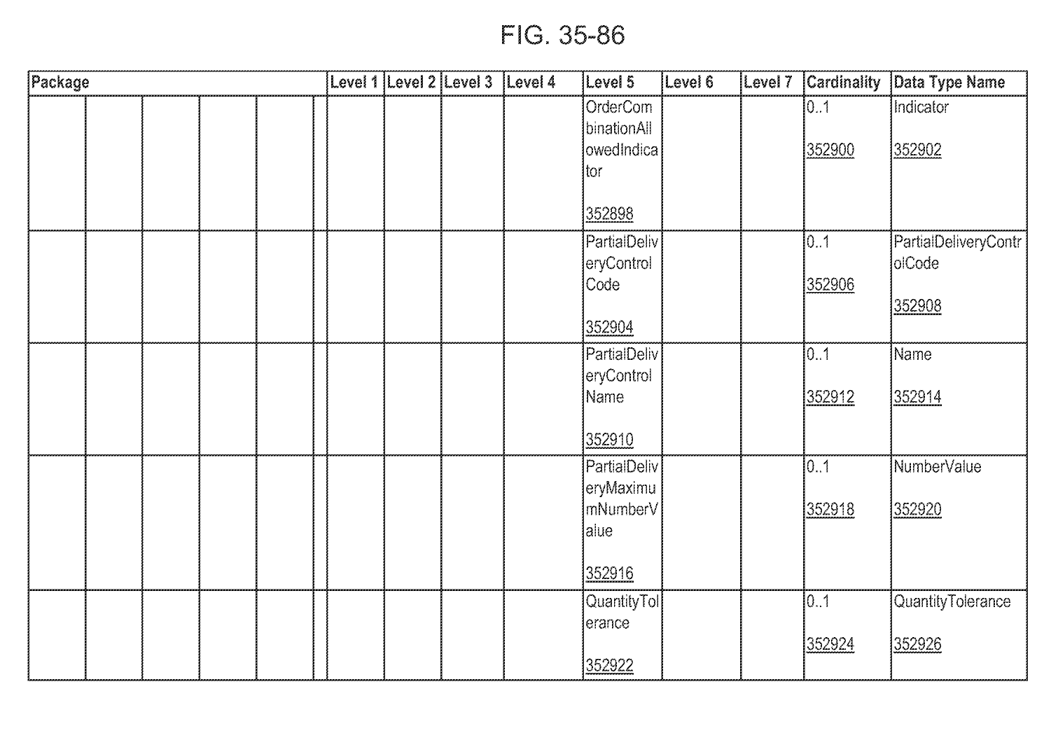

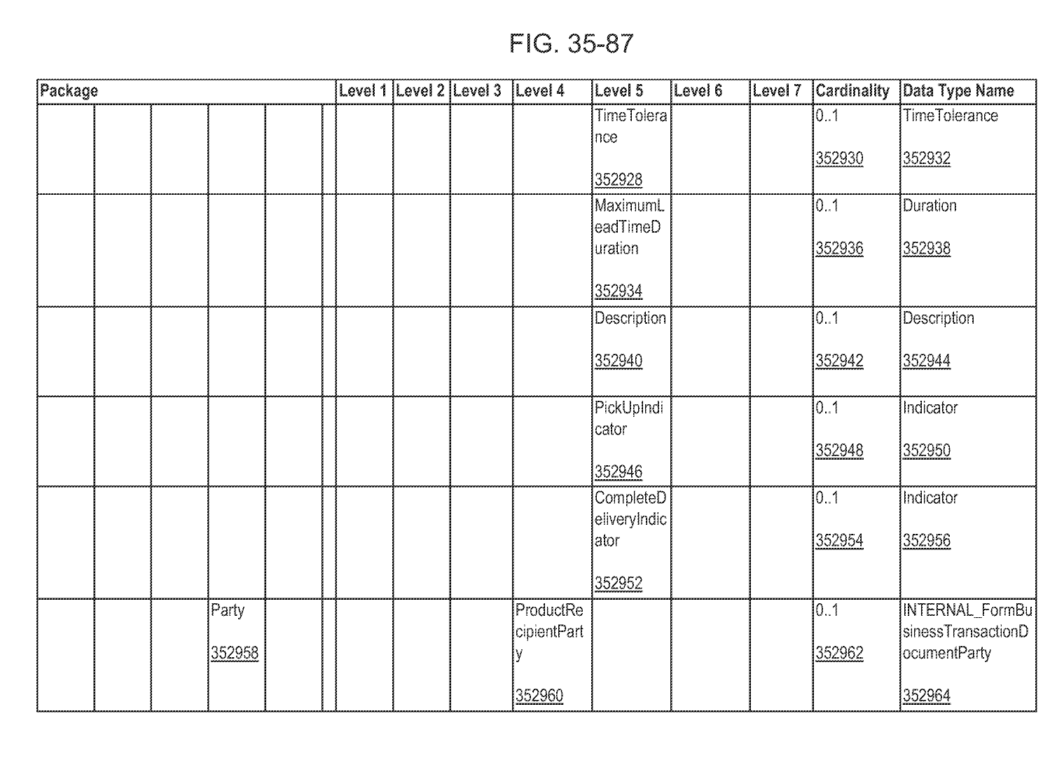

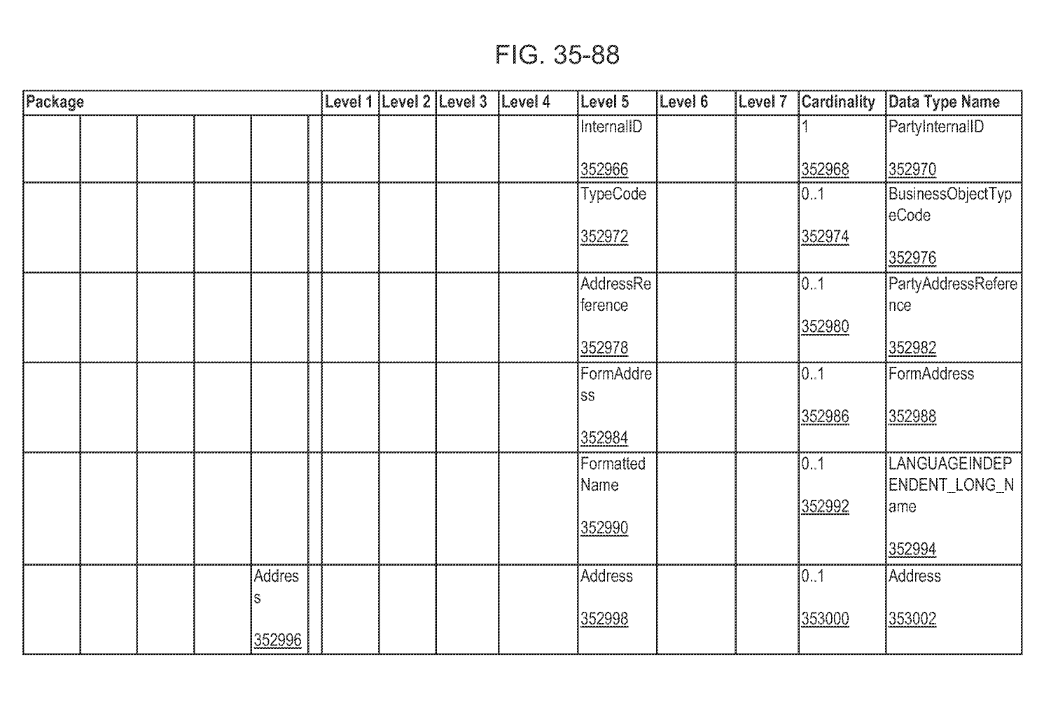

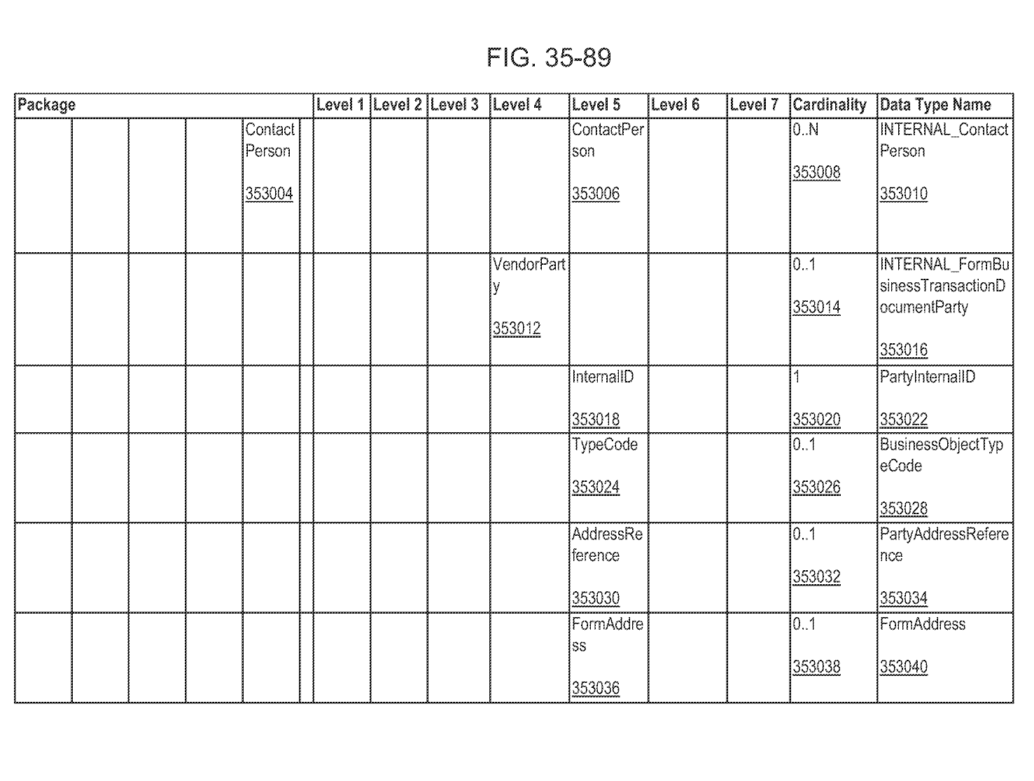

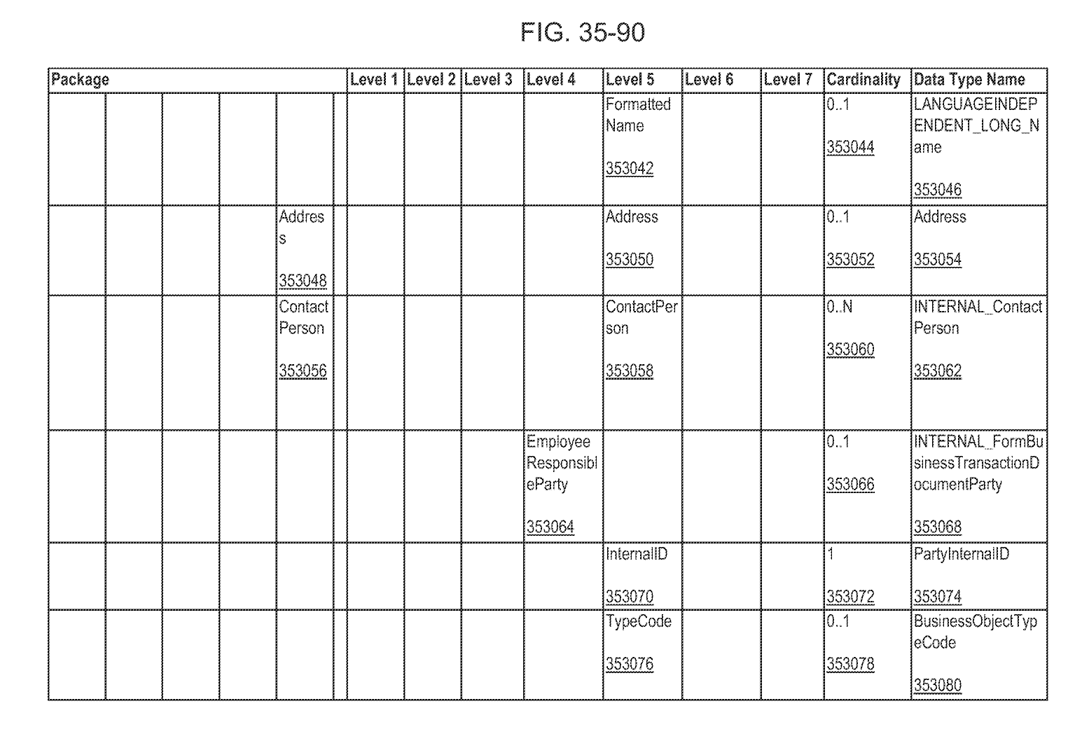

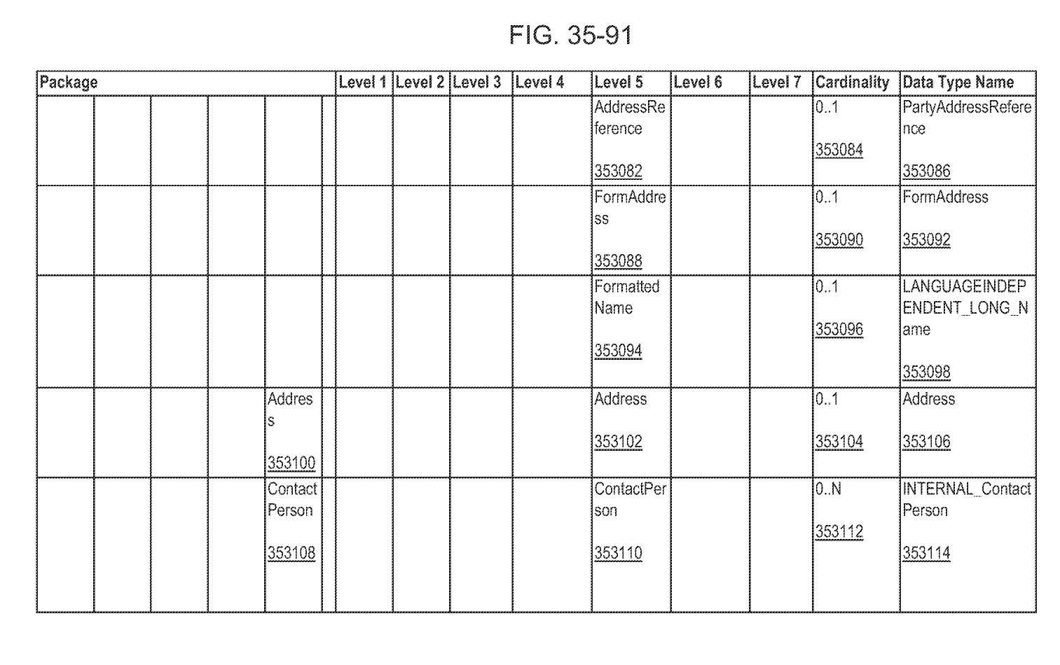

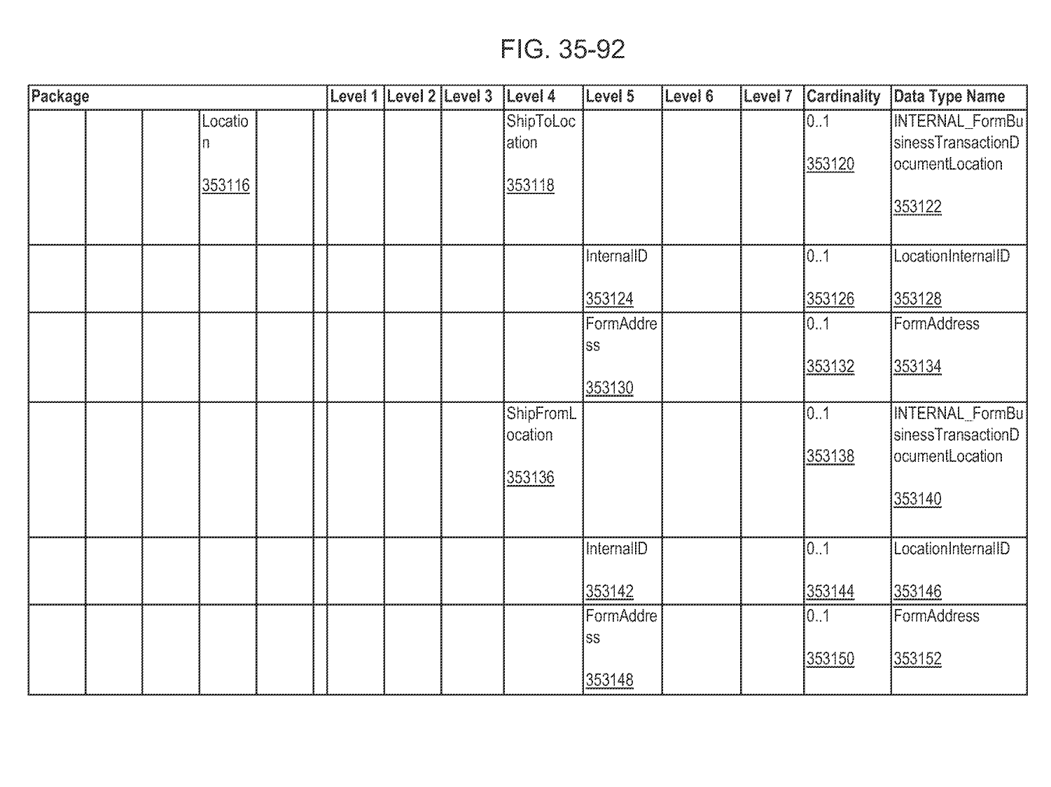

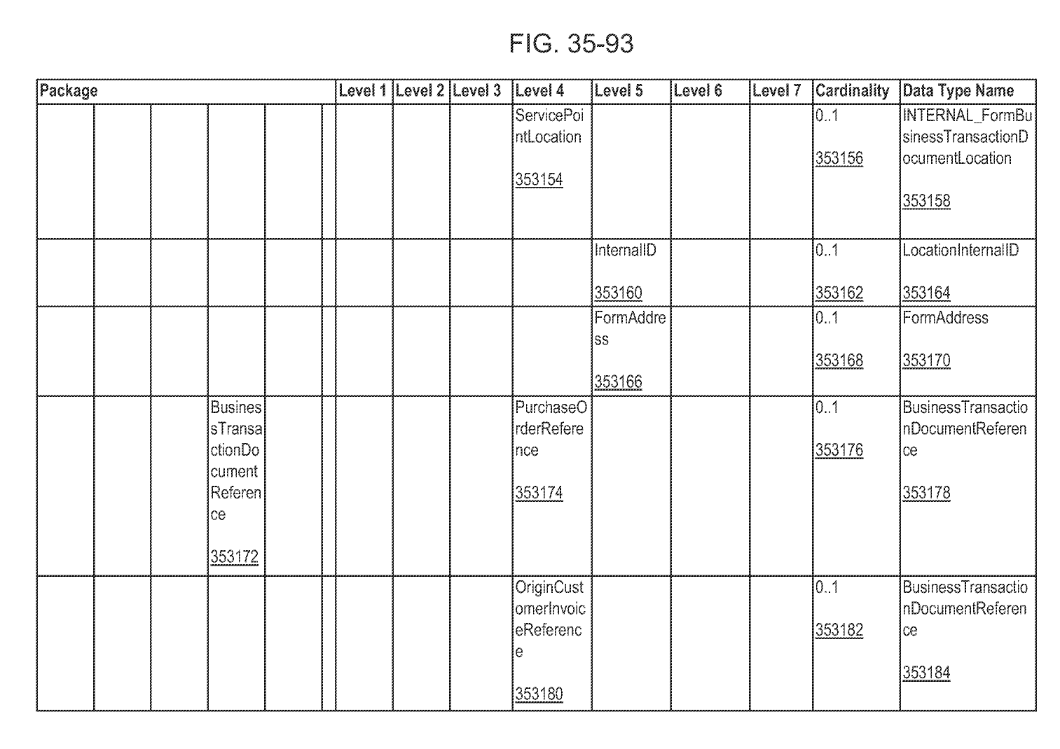

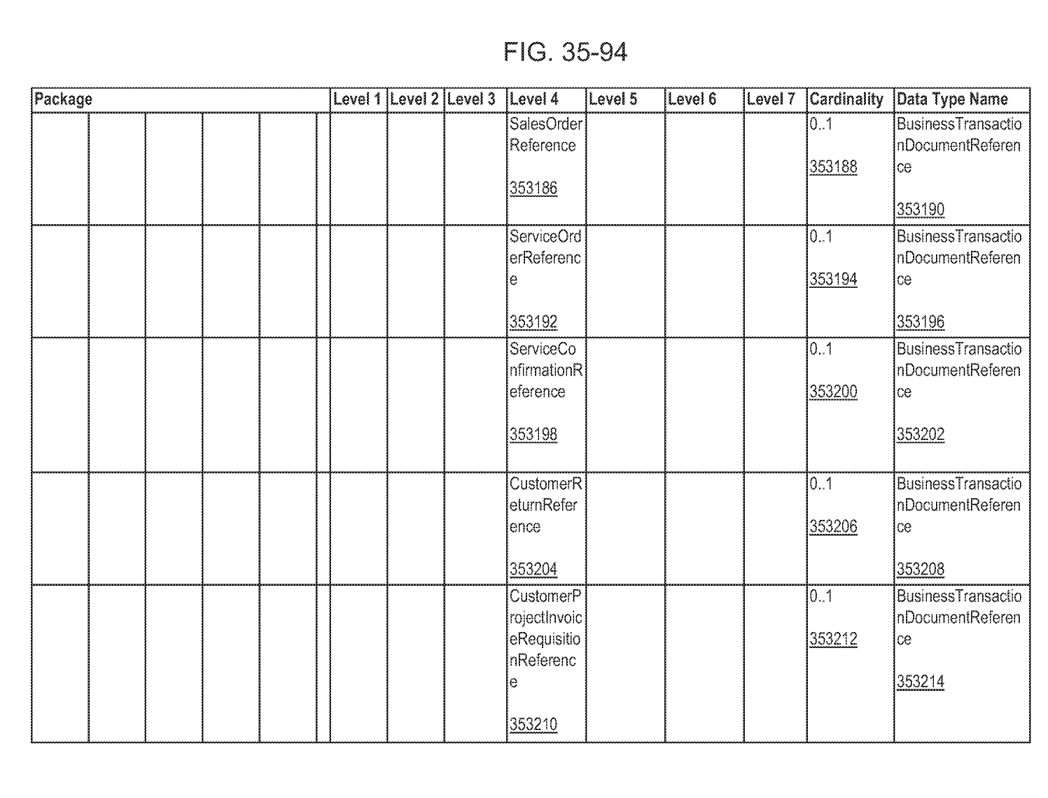

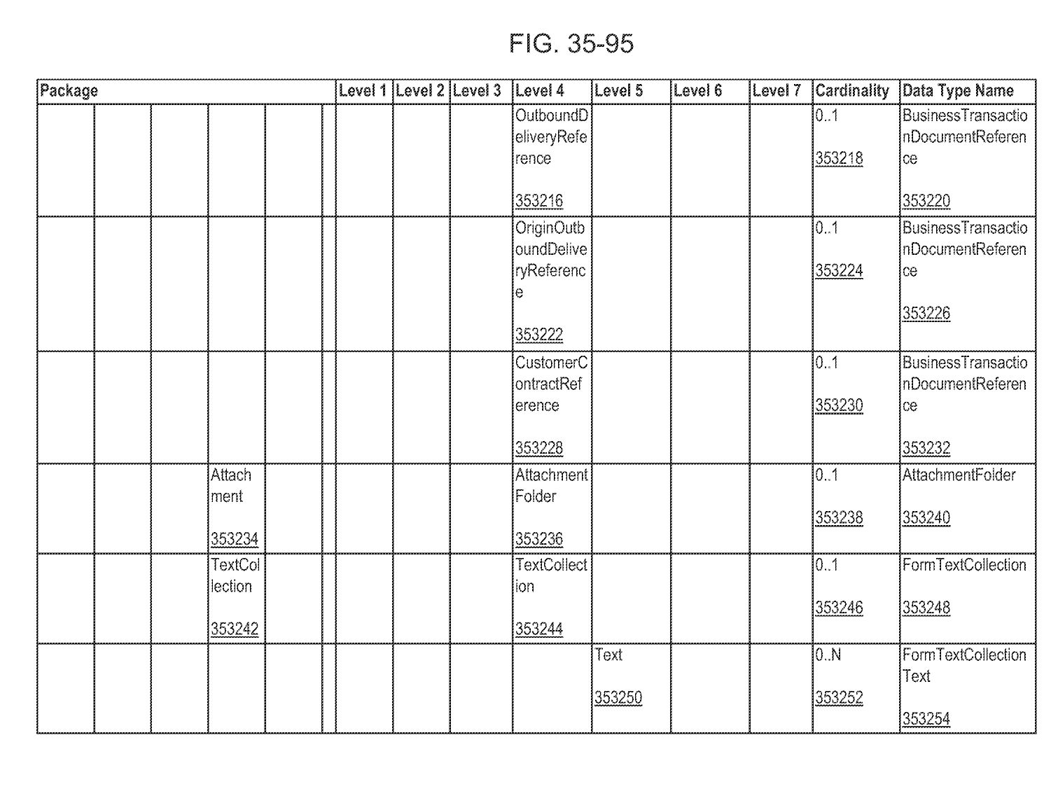

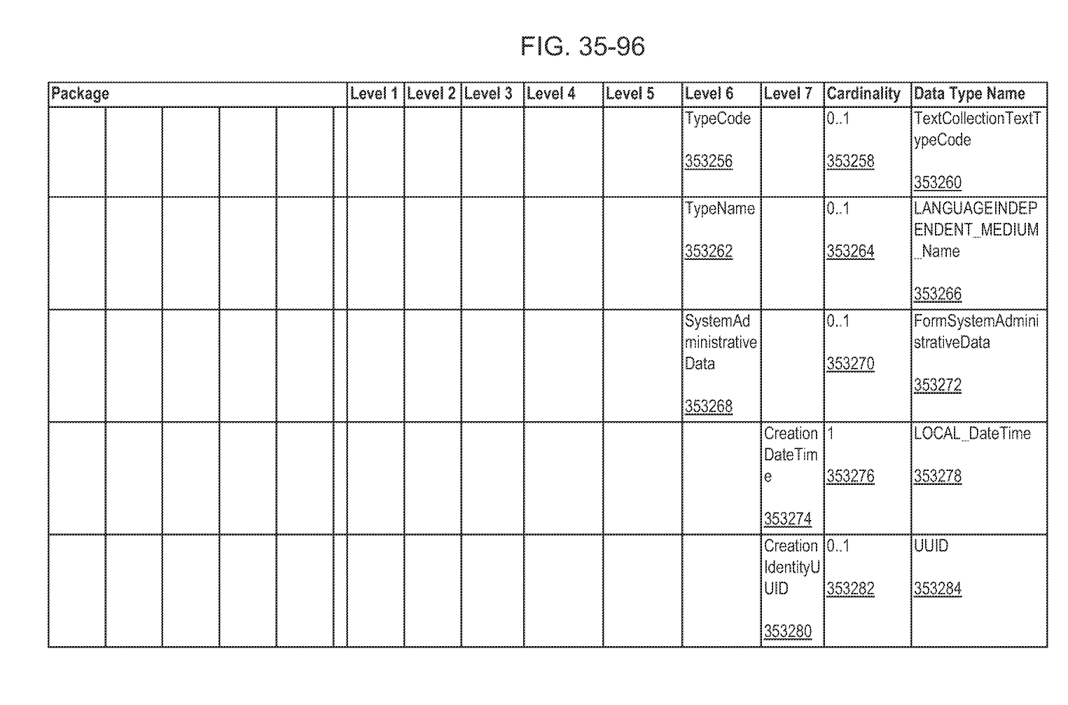

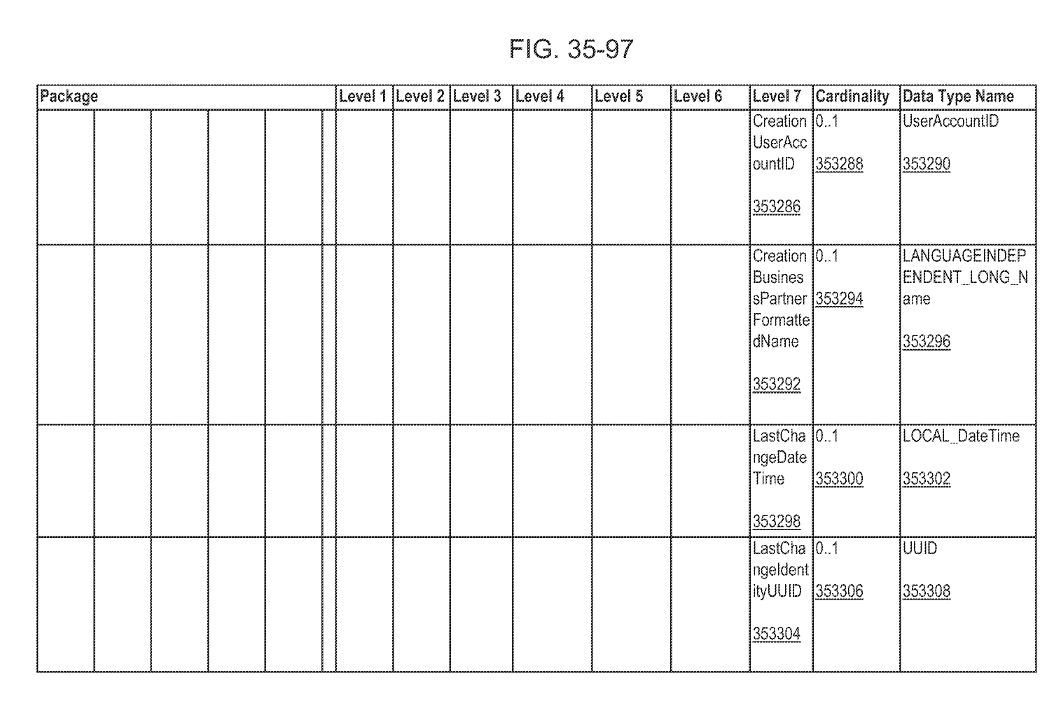

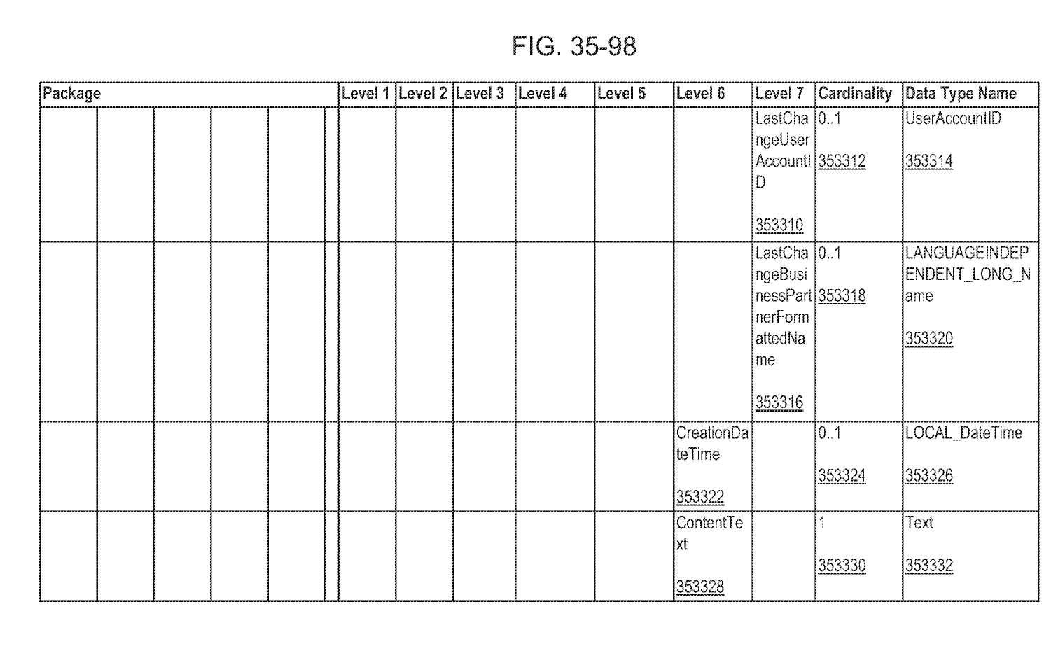

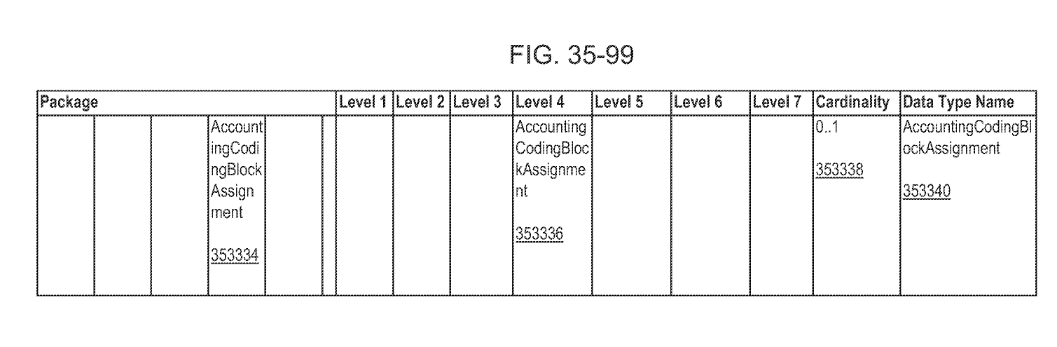

FIGS. 35-1 through 35-99 show an example configuration of an Element Structure that includes a Customer Invoice Post-Processing Request 350000 package. Specifically, these figures depict the arrangement and hierarchy of various components such as one or more levels of packages, entities, and datatypes, shown here as 350000 through 353340. As described above, packages may be used to represent hierarchy levels. Entities are discrete business elements that are used during a business transaction. Data types are used to type object entities and interfaces with a structure. For example, the Customer Invoice Post-Processing Request 350000 includes, among other things, a Customer Invoice Post-Processing Request 350002. Accordingly, heterogeneous applications may communicate using this consistent message configured as such.

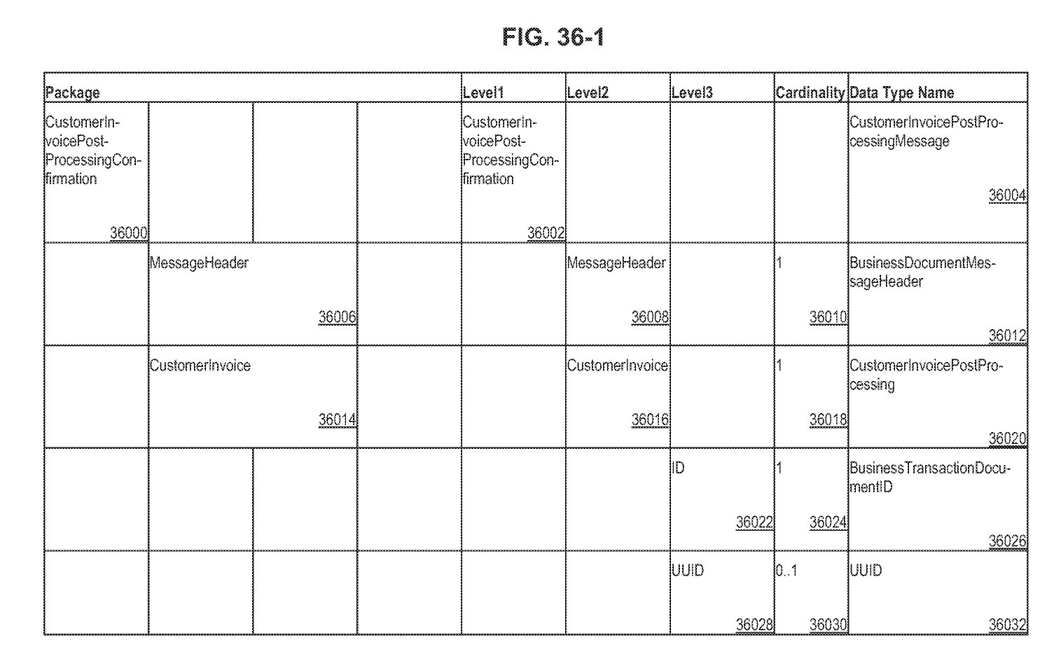

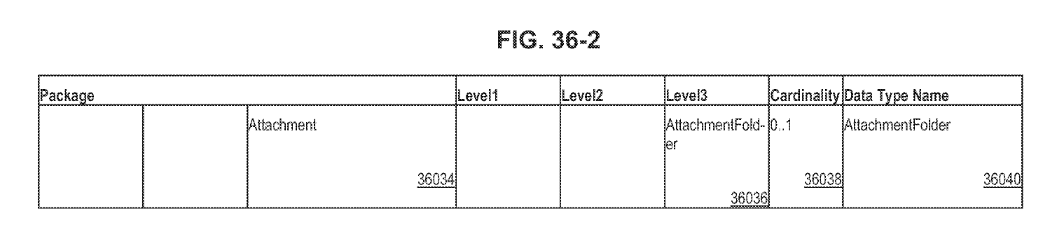

FIGS. 36-1 through 36-2 show an example configuration of an Element Structure that includes a CustomerInvoicePost-ProcessingConfirmation 36000 package. Specifically, these figures depict the arrangement and hierarchy of various components such as one or more levels of packages, entities, and datatypes, shown here as 36000 through 36040. As described above, packages may be used to represent hierarchy levels. Entities are discrete business elements that are used during a business transaction. Data types are used to type object entities and interfaces with a structure. For example, the CustomerInvoicePost-ProcessingConfirmation 36000 includes, among other things, a CustomerInvoicePost-ProcessingConfirmation 36002. Accordingly, heterogeneous applications may communicate using this consistent message configured as such.

The CustomerInvoicePost-ProcessingConfirmation 36000 package is a CustomerInvoicePostProcessingMessage 36004 data type. The CustomerInvoicePost-ProcessingConfirmation 36000 package includes a CustomerInvoicePost-ProcessingConfirmation 36002 entity. The CustomerInvoicePost-ProcessingConfirmation 36000 package includes various packages, namely a MessageHeader 36006 and a CustomerInvoice 36014.

The MessageHeader 36006 package is a BusinessDocumentMessageHeader 36012 data type. The MessageHeader 36006 package includes a MessageHeader 36008 entity. The MessageHeader 36008 entity has a cardinality of 1 36010 meaning that for each instance of the MessageHeader 36006 package there is one MessageHeader 36008 entity.

The CustomerInvoice 36014 package is a CustomerInvoicePostProcessing 36020 data type. The CustomerInvoice 36014 package includes a CustomerInvoice 36016 entity. The CustomerInvoice 36014 package includes an Attachment 36034 package. The CustomerInvoice 36016 entity has a cardinality of 1 36018 meaning that for each instance of the CustomerInvoice 36014 package there is one CustomerInvoice 36016 entity. The CustomerInvoice 36016 entity includes various attributes, namely an ID 36022 and an UUID 36028.

The ID 36022 attribute is a BusinessTransactionDocumentID 36026 data type. The ID 36022 attribute has a cardinality of 1 36024 meaning that for each instance of the CustomerInvoice 36016 entity there is one ID 36022 attribute. The UUID 36028 attribute is an UUID 36032 data type. The UUID 36028 attribute has a cardinality of 0 . . . 1 36030 meaning that for each instance of the CustomerInvoice 36016 entity there may be one UUID 36028 attribute.

The Attachment 36034 package is an AttachmentFolder 36040 data type. The Attachment 36034 package includes an AttachmentFolder 36036 entity. The AttachmentFolder 36036 entity has a cardinality of 0 . . . 1 36038 meaning that for each instance of the Attachment 36034 package there may be one AttachmentFolder 36036 entity.

A number of implementations have been described. Nevertheless, it will be understood that various modifications may be made without departing from the spirit and scope of the disclosure. Accordingly, other implementations are within the scope of the following claims.

1. A non-transitory computer readable medium including program code for providing a message-based interface for exchanging information about customer invoices, the medium comprising:
program code for receiving a first message via a message-based interface derived from a common business object model, where the common business object model includes business objects having relationships that enable derivation of message-based interfaces and message packages, the message-based interface exposing at least one service as defined in a service registry, the first message received from a heterogeneous application executing in an environment of computer systems providing message-based services, the first message for requesting to post-process a customer invoice, including a binding statement of amounts receivable, receivables adjustments, and credit memos to a business partner specifying terms of delivery and payment, the first message including a first message package derived from the common business object model, the first message package hierarchically organized in memory based on the common business object model, the first message package including:
a customer invoice post-processing request message entity; and
a customer invoice package including a customer invoice entity, a status package, a party package, and an item package, wherein the customer invoice entity includes a watermark name, an identifier (ID), a processing type code, a type code, a receivables payables property movement direction code and a date, wherein the status package includes a status entity, wherein the status entity includes a release status code, wherein the party package includes a buyer party entity, wherein the buyer party entity includes an internal ID, wherein the item package includes one or more item entities and a business process variant packages, wherein each item entity includes an ID, a type code, and a receivables property movement direction code, wherein the business process variant package includes one or more business process variant entities and a business process variant type code; and
program code for processing the first message according to the hierarchical organization of the first message package, where processing the first message includes unpacking the first message package based on the first message package's structure and the first message package's derivation from the common business object model, wherein the particular structure of the first message package is used at least in part to identify the purpose of the first message; and
program code for sending a second message to the heterogeneous application responsive to the first message, where the second message includes a second message package derived from the common business object model to provide consistent semantics with the first message package.

2. The computer readable medium of claim 1, wherein the customer invoice package further includes at least one of the following: a price information package, a payment information package, a delivery information package, a business transaction document reference package, an attachment package, a text collection package, and a due item package.

3. The computer readable medium of claim 1, wherein the customer invoice entity further includes at least one of the following: a universally unique identifier, a processing type name, a type name, a receivables payables property movement direction name, a creation date time, a cancellation document indicator, a customer invoice request name, a reference business transaction document ID, and a simulation origin code simulation origin code.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory tangible media, for requesting to post-process a customer invoice, including a binding statement of amounts receivable, receivables adjustments, and credit memos to a business partner specifying terms of delivery and payment, the instructions using a request;
a first memory storing a user interface controller executable by the at least one processor for processing the request and involving a message including a first message package derived from a common business object model, where the common business object model includes business objects having relationships that enable derivation of message-based service interfaces and message packages, the first message package hierarchically organized based on the common business object model, the hierarchical organization of the first message package including:
a customer invoice post-processing request message entity; and
a customer invoice package including a customer invoice entity, a status package, a party package, and an item package, wherein the customer invoice entity includes a watermark name, an identifier (ID), a processing type code, a type code, a receivables payables property movement direction code and a date, wherein the status package includes a status entity, wherein the status entity includes a release status code, wherein the party package includes a buyer party entity, wherein the buyer party entity includes an internal ID, wherein the item package includes one or more item entities and a business process variant package, wherein each item entity includes an ID, a type code, and a receivables property movement direction code, wherein the business process variant package includes one or more business process variant entities and a business process variant type code;
a second memory, remote from the graphical user interface, storing a plurality of service interfaces executable by the at least one processor and derived from the common business object model to provide consistent semantics with messages derived from the common business object model, wherein one of the service interfaces is operable to process the message via the service interface according to the hierarchical organization of the first message package, where processing the message includes unpacking the first message package based on the first message package's structure and the first message package's derivation from the common business object model, wherein the particular structure of the first message package is used at least in part to identify the purpose of the message.

5. The distributed system of claim 4, wherein the first memory is remote from the graphical user interface.

6. The distributed system of claim 4, wherein the first memory is remote from the second memory.
